(19) United States
(12) Patent Application Publication
(10) Pub. No.: US 2026/0222563 A1
(43) Pub. Date: Jul. 30, 2026

(54) METHOD, APPARATUS, AND RECORDING MEDIUM FOR IMAGE ENCODING/DECODING

(71) Applicant: ELECTRONICS AND TELECOMMUNICATIONS RESEARCH INSTITUTE, Daejeon (KR)

(72) Inventors: Dong-Hyun KIM, Daejeon (KR); Jong-Ho KIM, Daejeon (KR); Sung-Chang LIM, Daejeon (KR); Woong LIM, Daejeon (KR); Jin-Soo CHOI, Daejeon (KR)

(21) Appl. No.: 19/145,883

(22) PCT Filed: Jan. 4, 2024
(86) PCT No.: PCT/KR2024/000226

§ 371 Date: Jul. 3, 2025

(30) Foreign Application Priority Data
Jan. 4, 2023 (KR) 10-2023-0001441
Jan. 4, 2024 (KR) 10-2024-0001763

(51) Int. Cl. H04N 19/117; H04N 19/176

(52) U.S. Cl. CPC H04N 19/117; H04N 19/176

(57) ABSTRACT

Disclosed herein are a method, an apparatus and a storage medium for image encoding/decoding. In an image decoding method, a filter candidate list including multiple filter candidates is constructed. A final filter to be used for a target may be determined among multiple filter candidates in the filter candidate list. The final filter may be determined based on matching costs of the filter candidates. A filter candidate list may be reconstructed based on the matching costs, and reordering of the filter candidates may be performed. The final filter may be used for processing of the target, and this processing includes various processes performed in image encoding/decoding.

### CROSS-REFERENCE TO RELATED APPLICATIONS

This application is a National Phase Entry Application of PCT Application No. PCT/KR2024/000226 filed on Jan. 4, 2024, which claims priority to Korean Patent Application No. 10-2023-0001441 filed on Jan. 4, 2023, and Korean Patent Application No. 10-2024-0001763 filed on Jan. 4, 2024, in the Korean Intellectual Property Office, the entire contents of which are hereby incorporated by reference in its entirety.

### TECHNICAL FIELD

The present disclosure relates generally to a method, an apparatus and a storage medium for image encoding/decoding.

This application claims the benefit of Korean Patent Application Nos. 10-2023-0001441, filed Jan. 4, 2023 and 10-2024-0001763, filed Jan. 4, 2024, which are hereby incorporated by reference in their entireties into this application.

### BACKGROUND ART

With the continuous development of the information and communication industries, broadcasting services supporting High-Definition (HD) resolution have been popularized all over the world. Through this popularization, a large number of users have become accustomed to high-resolution and high-definition images and/or video.

To satisfy users' demand for high definition, many institutions have accelerated the development of next-generation imaging devices. Users' interest in UHD TVs, having resolution that is more than four times as high as that of Full HD (FHD) TVs, as well as High-Definition TVs (HDTV) and FHD TVs, has increased. As interest therein has increased, image encoding/decoding technology for images having higher resolution and higher definition is currently required.

As image compression technology, there are various technologies, such as inter-prediction technology, intra-prediction technology, transform, quantization technology and entropy coding technology.

Inter-prediction technology is technology for predicting the value of a pixel included in a current picture using a picture previous to and/or a picture subsequent to the current picture. Intra-prediction technology is technology for predicting the value of a pixel included in a current picture using information about pixels in the current picture. Transform and quantization technology may be technology for compressing the energy of a residual signal. The entropy coding technology is technology for assigning a short codeword to a frequently occurring value and assigning a long codeword to a less frequently occurring value.

By utilizing this image compression technology, data about images may be effectively compressed, transmitted, and stored.

### DISCLOSURE

### Technical Problem

An embodiment may provide an apparatus, a method and a storage medium, which perform encoding/decoding on a target block using filtering.

An embodiment may provide an apparatus, a method and a storage medium, which perform encoding/decoding on a target block by adaptively selecting a filter from among multiple filters.

### Technical Solution

In accordance with an aspect, there is provided a decoding method, including constructing a filter candidate list including multiple filter candidates; and determining a final filter among the multiple filter candidates.

The final filter may be determined based on matching costs of the multiple filter candidates.

The filter candidate list may be reconstructed based on the matching costs.

Reordering of the multiple filter candidates in the filter candidate list may be performed based on the matching costs.

The matching costs may be results of a calculation that uses a cost function for samples present in templates generated using the multiple filter candidates.

The multiple filter candidates may be applied to a template region of a template.

A filter candidate used in an adjacent block of a target block may be used as one of the multiple filter candidates of the target block.

In accordance with an aspect, there is provided an encoding method, including constructing a filter candidate list including multiple filter candidates; and determining a final filter among the multiple filter candidates.

The final filter may be determined based on matching costs of the multiple filter candidates.

The filter candidate list may be reconstructed based on the matching costs.

Reordering of the multiple filter candidates in the filter candidate list may be performed based on the matching costs.

The matching costs may be results of a calculation that uses a cost function for samples present in templates generated using the multiple filter candidates.

The multiple filter candidates may be applied to a template region of a template.

A filter candidate used in an adjacent block of a target block may be used as one of the multiple filter candidates of the target block.

In accordance with a further aspect, there is provided a computer-readable storage medium for storing a bitstream for image decoding, wherein the bitstream includes filter information, a filter candidate list including multiple filter candidates is constructed, and a final filter is determined among the multiple filter candidates based on the filter information.

The final filter may be determined based on matching costs of the multiple filter candidates.

The filter candidate list may be reconstructed based on the matching costs.

Reordering of the multiple filter candidates in the filter candidate list may be performed based on the matching costs.

The matching costs may be results of a calculation that uses a cost function for samples present in templates generated using the multiple filter candidates.

The multiple filter candidates may be applied to a template region of a template.

### Advantageous Effects

There are provided an apparatus, a method and a storage medium, which perform encoding/decoding on a target block using filtering.

There are provided an apparatus, a method and a storage medium, which perform encoding/decoding on a target block by adaptively selecting a filter from among multiple filters.

### DESCRIPTION OF DRAWINGS

FIG. 1 is a block diagram illustrating the configuration of an embodiment of an encoding apparatus to which the present disclosure is applied;

FIG. 2 is a block diagram illustrating the configuration of an embodiment of a decoding apparatus to which the present disclosure is applied;

FIG. 3 is a diagram schematically illustrating the partition structure of an image when the image is encoded and decoded;

FIG. 4 is a diagram illustrating the form of a Prediction Unit (PU) that a Coding Unit (CU) can include;

FIG. 5 is a diagram illustrating the form of a Transform Unit (TU) that can be included in a CU;

FIG. 6 illustrates splitting of a block according to an example;

FIG. 7 is a diagram for explaining an embodiment of an intra-prediction procedure;

FIG. 8 is a diagram illustrating reference samples used in an intra-prediction procedure;

FIG. 9 is a diagram for explaining an embodiment of an inter-prediction procedure;

FIG. 10 illustrates spatial candidates according to an embodiment;

FIG. 11 illustrates the order of addition of motion information of spatial candidates to a merge list according to an embodiment;

FIG. 12 illustrates a transform and quantization process according to an example;

FIG. 13 illustrates diagonal scanning according to an example;

FIG. 14 illustrates horizontal scanning according to an example;

FIG. 15 illustrates vertical scanning according to an example;

FIG. 16 is a configuration diagram of an encoding apparatus according to an embodiment;

FIG. 17 is a configuration diagram of a decoding apparatus according to an embodiment;

FIG. 18 illustrates partition boundaries in a geometric partitioning mode according to an example;

FIG. 19 illustrates a partition boundary, a partition offset, and a partition angle in a geometric partitioning mode according to an example;

FIG. 20 illustrates weight maps used in respective prediction blocks according to a specific partition boundary according to an example;

FIG. 21 illustrates template matching according to an example;

FIGS. 22A to 22T illustrate various examples of a subsampling method in template matching.

FIGS. 23A to 23N illustrate various other examples of a subsampling method in template matching;

FIGS. 24A to 24N illustrate various further examples of a subsampling method in template matching;

FIGS. 25A to 25J illustrate subsampling that uses the unit of subblocks for a region according to an example;

FIGS. 26A to 26L illustrate subsampling that uses the unit of subblocks for a region adjacent to a block according to an example;

FIGS. 27 to 31 illustrate search patterns in template matching according to an example;

FIG. 27 illustrates a first relationship between search patterns and resolution according to an example;

FIG. 28 illustrates a second relationship between search patterns and resolution according to an example;

FIG. 29 illustrates a third relationship between search patterns and resolution according to an example;

FIG. 30 illustrates a fourth relationship between search patterns and resolution according to an example;

FIG. 31 illustrates a fifth relationship between search patterns and resolution according to an example;

FIG. 32 illustrates a sixth relationship between search patterns and resolution according to an example;

FIG. 33 illustrates a first template configuration method in an affine mode according to an example;

FIG. 34 illustrates a second template configuration method in an affine mode according to an example;

FIG. 35A illustrates first locations from which motion information is to be derived according to an example;

FIG. 35B illustrates second locations from which motion information is to be derived according to an example;

FIG. 36 illustrates bilateral matching according to an example;

FIG. 37 illustrates a sample at a position on which current filtering is performed and samples adjacent to the sample according to an example;

FIG. 38 is a flowchart of an encoding method according to an embodiment;

FIG. 39 is a flowchart of a decoding method according to an embodiment;

FIG. 40 illustrates the determination of a final filter excluding encoding/decoding according to an example;

FIG. 41 illustrates the determination of a final filter excluding the construction of a list in encoding according to an example;

FIG. 42 illustrates the determination of a final filter excluding the construction of a list in decoding according to an example;

FIG. 43 illustrates the determination of a final filter excluding encoding/decoding and the construction of a list according to an example;

FIG. 44 is a flowchart of an encoding method using template matching costs according to an embodiment;

FIG. 45 is a flowchart of a decoding method using template matching costs according to an embodiment;

FIG. 46 illustrates the determination of a final filter excluding encoding/decoding according to an example;

FIG. 47 illustrates a vertical sample boundary and a horizontal sample boundary for a target block according to an example;

FIG. 48 illustrates a vertical sample boundary and a horizontal sample boundary for a target block according to another example;

FIG. 49 illustrates values required to determine filter candidates according to an example;

FIG. 50 illustrates blocks that are not adjacent to a target block according to an example;

FIG. 51 illustrates a luma component position corresponding to the position of a chroma component sample according to an example;

FIG. 52 illustrates intra-prediction for a template region according to an example;

FIG. 53 illustrates the locations of adjacent spatial candidates according to an example;

FIG. 54 illustrates the locations of temporal candidates according to an example;

FIG. 55 illustrates the locations of shifted temporal candidates according to an example;

FIG. 56 illustrates locations for selection of a neighbor motion vector; and

FIG. 57 illustrates the derivation of shifted temporal candidates based on a current motion vector according to an example.

### MODE FOR INVENTION

The present invention may be variously changed, and may have various embodiments, and specific embodiments will be described in detail below with reference to the attached drawings. However, it should be understood that those embodiments are not intended to limit the present invention to specific disclosure forms, and that they include all changes, equivalents or modifications included in the spirit and scope of the present invention.

Detailed descriptions of the following exemplary embodiments will be made with reference to the attached drawings illustrating specific embodiments. These embodiments are described so that those having ordinary knowledge in the technical field to which the present disclosure pertains can easily practice the embodiments. It should be noted that the various embodiments are different from each other, but do not need to be mutually exclusive of each other. For example, specific shapes, structures, and characteristics described here may be implemented as other embodiments without departing from the spirit and scope of the embodiments in relation to an embodiment. Further, it should be understood that the locations or arrangement of individual components in each disclosed embodiment can be changed without departing from the spirit and scope of the embodiments. Therefore, the accompanying detailed description is not intended to restrict the scope of the disclosure, and the scope of the exemplary embodiments is limited only by the accompanying claims, along with equivalents thereof, as long as they are appropriately described.

In the drawings, similar reference numerals are used to designate the same or similar functions in various aspects. The shapes, sizes, etc. of components in the drawings may be exaggerated to make the description clear.

Terms such as “first” and “second” may be used to describe various components, but the components are not restricted by the terms. The terms are used only to distinguish one component from another component. For example, a first component may be named a second component without departing from the scope of the present specification. Likewise, a second component may be named a first component. The terms “and/or” may include combinations of a plurality of related described items or any of a plurality of related described items.

It will be understood that when a component is referred to as being “connected” or “coupled” to another component, the two components may be directly connected or coupled to each other, or intervening components may be present between the two components. On the other hand, it will be understood that when a component is referred to as being “directly connected or coupled”, no intervening components are present between the two components.

Components described in the embodiments are independently shown in order to indicate different characteristic functions, but this does not mean that each of the components is formed of a separate piece of hardware or software. That is, the components are arranged and included separately for convenience of description. For example, at least two of the components may be integrated into a single component. Conversely, one component may be divided into multiple components. An embodiment into which the components are integrated or an embodiment in which some components are separated is included in the scope of the present specification as long as it does not depart from the essence of the present specification.

The terms used in the embodiment are merely used to describe specific embodiments and are not intended to limit the present invention. A singular expression includes a plural expression unless a description to the contrary is specifically pointed out in context. In the embodiments, it should be understood that the terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added. That is, in the embodiments, an expression describing that a component “comprises” a specific component means that additional components may be included within the scope of the practice of the present invention or the technical spirit of the present invention, but does not preclude the presence of components other than the specific component.

In the embodiments, a term “at least one” may mean one of one or more numbers, such as 1, 2, 3, and 4. In the embodiments, a term “a plurality of” may mean one of two or more numbers, such as 2, 3 and 4.

Some components of the embodiments are not essential components for performing essential functions, but may be optional components for improving only performance. The embodiments may be implemented using only essential components for implementing the essence of the embodiments. For example, a structure including only essential components, excluding optional components used only to improve performance, is also included in the scope of the embodiments.

Embodiments will be described in detail below with reference to the accompanying drawings so that those having ordinary knowledge in the technical field to which the embodiments pertain can easily practice the embodiments. In the following description of the embodiments, detailed descriptions of known functions or configurations which are deemed to make the gist of the present specification obscure will be omitted. Further, the same reference numerals are used to designate the same components throughout the drawings, and repeated descriptions of the same components will be omitted.

Hereinafter, “image” may mean a single picture constituting a video, or may mean the video itself. For example, “encoding and/or decoding of an image” may mean “encoding and/or decoding of a video”, and may also mean “encoding and/or decoding of any one of images constituting the video”.

Hereinafter, the terms “video” and “motion picture” may be used to have the same meaning, and may be used interchangeably with each other.

Hereinafter, a target image may be an encoding target image, which is the target to be encoded, and/or a decoding target image, which is the target to be decoded. Further, the target image may be an input image that is input to an encoding apparatus or an input image that is input to a decoding apparatus. And, a target image may be a current image, that is, the target to be currently encoded and/or decoded. For example, the terms “target image” and “current image” may be used to have the same meaning, and may be used interchangeably with each other.

Hereinafter, the terms “image”, “picture”, “frame”, and “screen” may be used to have the same meaning and may be used interchangeably with each other.

Hereinafter, a target block may be an encoding target block, i.e. the target to be encoded and/or a decoding target block, i.e. the target to be decoded. Further, the target block may be a current block, i.e. the target to be currently encoded and/or decoded. Here, the terms “target block” and “current block” may be used to have the same meaning, and may be used interchangeably with each other. A current block may denote an encoding target block, which is the target of encoding, during encoding and/or a decoding target block, which is the target of decoding, during decoding. Also, the current block may be at least one of a coding block, a prediction block, a residual block, and a transform block.

Hereinafter, the terms “block” and “unit” may be used to have the same meaning, and may be used interchangeably with each other. Alternatively, “block” may denote a specific unit.

Hereinafter, the terms “region” and “segment” may be used interchangeably with each other.

In the following embodiments, specific information, data, a flag, an index, an element, and an attribute may have their respective values. A value of “0” corresponding to each of the information, data, flag, index, element, and attribute may indicate a false, a logical false or a first predefined value. In other words, the value of “0”, a false, logical false, and a first predefined value may be used interchangeably with each other. A value of “1” corresponding to each of the information, data, flag, index, element, and attribute may indicate a true, a logical true or a second predefined value. In other words, the value of “1”, true, logical true, and a second predefined value may be used interchangeably with each other.

When a variable such as i or j is used to indicate a row, a column, or an index, the value of i may be an integer of 0 or more or an integer of 1 or more. In other words, in the embodiments, each of a row, a column, and an index may be counted from 0 or may be counted from 1.

In embodiments, the term “one or more” or the term “at least one” may mean the term “plural”. The term “one or more” or the term “at least one” may be used interchangeably with “plural”.

Below, the terms to be used in embodiments will be described.

Encoder: An encoder denotes a device for performing encoding. That is, an encoder may mean an encoding apparatus.

Decoder: A decoder denotes a device for performing decoding. That is, a decoder may mean a decoding apparatus.

Unit: A unit may denote the unit of image encoding and decoding. The terms “unit” and “block” may be used to have the same meaning, and may be used interchangeably with each other.
A unit may be an M×N array of samples. Each of M and N may be a positive integer. A unit may typically mean an array of samples in the form of two-dimensions.
In the encoding and decoding of an image, “unit” may be an area generated by the partitioning of one image. In other words, “unit” may be a region specified in one image. A single image may be partitioned into multiple units. Alternatively, one image may be partitioned into sub-parts, and the unit may denote each partitioned sub-part when encoding or decoding is performed on the partitioned sub-part.
In the encoding and decoding of an image, predefined processing may be performed on each unit depending on the type of the unit.
Depending on functions, the unit types may be classified into a macro unit, a Coding Unit (CU), a Prediction Unit (PU), a residual unit, a Transform Unit (TU), etc. Alternatively, depending on functions, the unit may denote a block, a macroblock, a coding tree unit, a coding tree block, a coding unit, a coding block, a prediction unit, a prediction block, a residual unit, a residual block, a transform unit, a transform block, etc. For example, a target unit, which is the target of encoding and/or decoding, may be at least one of a CU, a PU, a residual unit, and a TU.
The term “unit” may mean information including a luminance (luma) component block, a chrominance (chroma) component block corresponding thereto, and syntax elements for respective blocks so that the unit is designated to be distinguished from a block.
The size and shape of a unit may be variously implemented. Further, a unit may have any of various sizes and shapes. In particular, the shapes of the unit may include not only a square, but also a geometric figure that can be represented in two dimensions (2D), such as a rectangle, a trapezoid, a triangle, and a pentagon.
Further, unit information may include one or more of the type of a unit, the size of a unit, the depth of a unit, the order of encoding of a unit and the order of decoding of a unit, etc. For example, the type of a unit may indicate one of a CU, a PU, a residual unit and a TU.
One unit may be partitioned into sub-units, each having a smaller size than that of the relevant unit.

Depth: A depth may mean an extent to which the unit is partitioned. Further, the depth of the unit may indicate the level at which the corresponding unit is present when unit(s) are represented by a tree structure.
Unit partition information may include a depth indicating the depth of a unit. A depth may indicate the number of times the unit is partitioned and/or the degree to which the unit is partitioned.
In a tree structure, it may be considered that the depth of a root node is the smallest, and the depth of a leaf node is the largest. The root node may be the highest (top) node. The leaf node may be a lowest node.
A single unit may be hierarchically partitioned into multiple sub-units while having depth information based on a tree structure. In other words, the unit and sub-units, generated by partitioning the unit, may correspond to a node and child nodes of the node, respectively. Each of the partitioned sub-units may have a unit depth. Since the depth indicates the number of times the unit is partitioned and/or the degree to which the unit is partitioned, the partition information of the sub-units may include information about the sizes of the sub-units.
In a tree structure, the top node may correspond to the initial node before partitioning. The top node may be referred to as a “root node”. Further, the root node may have a minimum depth value. Here, the top node may have a depth of level ‘0’.
A node having a depth of level ‘1’ may denote a unit generated when the initial unit is partitioned once. A node having a depth of level ‘2’ may denote a unit generated when the initial unit is partitioned twice.
A leaf node having a depth of level ‘n’ may denote a unit generated when the initial unit has been partitioned n times.
The leaf node may be a bottom node, which cannot be partitioned any further. The depth of the leaf node may be the maximum level. For example, a predefined value for the maximum level may be 3.
A QT depth may denote a depth for a quad-partitioning. A BT depth may denote a depth for a binary-partitioning. A TT depth may denote a depth for a ternary-partitioning.

Sample: A sample may be a base unit constituting a block. A sample may be represented by values from 0 to 2^{Bd-}1 depending on the bit depth (Bd).
A sample may be a pixel or a pixel value.
Hereinafter, the terms “pixel” and “sample” may be used to have the same meaning, and may be used interchangeably with each other.

A Coding Tree Unit (CTU): A CTU may be composed of a single luma component (Y) coding tree block and two chroma component (Cb, Cr) coding tree blocks related to the luma component coding tree block. Further, a CTU may mean information including the above blocks and a syntax element for each of the blocks.
Each coding tree unit (CTU) may be partitioned using one or more partitioning methods, such as a quad tree (QT), a binary tree (BT), and a ternary tree (TT) so as to configure sub-units, such as a coding unit, a prediction unit, and a transform unit. A quad tree may mean a quarternary tree. Further, each coding tree unit may be partitioned using a multitype tree (MTT) using one or more partitioning methods.
“CTU” may be used as a term designating a pixel block, which is a processing unit in an image-decoding and encoding process, as in the case of partitioning of an input image.

Coding Tree Block (CTB): “CTB” may be used as a term designating any one of a Y coding tree block, a Cb coding tree block, and a Cr coding tree block.

Neighbor block: A neighbor block (or neighboring block) may mean a block adjacent to a target block. A neighbor block may mean a reconstructed neighbor block.

Hereinafter, the terms “neighbor block” and “adjacent block” may be used to have the same meaning and may be used interchangeably with each other.

A neighbor block may mean a reconstructed neighbor block.

Spatial neighbor block; A spatial neighbor block may a block spatially adjacent to a target block. A neighbor block may include a spatial neighbor block.
The target block and the spatial neighbor block may be included in a target picture.
The spatial neighbor block may mean a block, the boundary of which is in contact with the target block, or a block located within a predetermined distance from the target block.
The spatial neighbor block may mean a block adjacent to the vertex of the target block. Here, the block adjacent to the vertex of the target block may mean a block vertically adjacent to a neighbor block which is horizontally adjacent to the target block or a block horizontally adjacent to a neighbor block which is vertically adjacent to the target block.

Temporal neighbor block: A temporal neighbor block may be a block temporally adjacent to a target block. A neighbor block may include a temporal neighbor block.
The temporal neighbor block may include a co-located block (col block).
The col block may be a block in a previously reconstructed co-located picture (col picture). The location of the col block in the col-picture may correspond to the location of the target block in a target picture. Alternatively, the location of the col block in the col-picture may be equal to the location of the target block in the target picture. The col picture may be a picture included in a reference picture list.
The temporal neighbor block may be a block temporally adjacent to a spatial neighbor block of a target block.

Prediction mode: The prediction mode may be information indicating the mode used for intra prediction, or the mode used for inter prediction.

Prediction unit: A prediction unit may be a base unit for prediction, such as inter prediction, intra prediction, inter compensation, intra compensation, and motion compensation.
A single prediction unit may be divided into multiple partitions having smaller sizes or sub-prediction units. The multiple partitions may also be base units in the performance of prediction or compensation. The partitions generated by dividing the prediction unit may also be prediction units.

Prediction unit partition: A prediction unit partition may be the shape into which a prediction unit is divided.

Reconstructed neighbor unit: A reconstructed neighbor unit may be a unit which has already been decoded and reconstructed neighboring a target unit.
A reconstructed neighbor unit may be a unit that is spatially adjacent to the target unit or that is temporally adjacent to the target unit.
A reconstructed spatial neighbor unit may be a unit which is included in a target picture and which has already been reconstructed through encoding and/or decoding.
A reconstructed temporal neighbor unit may be a unit which is included in a reference image and which has already been reconstructed through encoding and/or decoding. The location of the reconstructed temporal neighbor unit in the reference image may be identical to that of the target unit in the target picture, or may correspond to the location of the target unit in the target picture. Also, a reconstructed temporal neighbor unit may be a block neighboring the corresponding block in a reference image. Here, the location of the corresponding block in the reference image may correspond to the location of the target block in the target image. Here, the fact that the locations of blocks correspond to each other may mean that the locations of the blocks are identical to each other, may mean that one block is included in another block, or may mean that one block occupies a specific location in another block.

Sub-picture: A picture may be divided into one or more sub-pictures. A sub-picture may be composed of one or more tile rows and one or more tile columns.
A sub-picture may be a region having a square shape or a rectangular(i.e., a non-square rectangular) shape in a picture. Further, a sub-picture may include one or more CTUs.
A sub-picture may be a rectangular region of one or more slices in a picture.
One sub-picture may include one or more tiles, one or more bricks, and/or one or more slices.

Tile: A tile may be a region having a square shape or rectangular (i.e., a non-square rectangular) shape in a picture.
A tile may include one or more CTUs.
A tile may be partitioned into one or more bricks.

Brick: A brick may denote one or more CTU rows in a tile.
A tile may be partitioned into one or more bricks. Each brick may include one or more CTU rows.
A tile that is not partitioned into two parts may also denote a brick.

Slice: A slice may include one or more tiles in a picture. Alternatively, a slice may include one or more bricks in a tile.
A sub-picture may contain one or more slices that collectively cover a rectangular region of a picture. Consequently, each sub-picture boundary is also always a slice boundary, and each vertical sub-picture boundary is always also a vertical tile boundary.

Parameter set: A parameter set may correspond to header information in the internal structure of a bitstream.
A parameter set may include at least one of a video parameter set (VPS), a sequence parameter set (SPS), a picture parameter set (PPS), an adaptation parameter set (APS), a decoding parameter set (DPS), etc.
Information signaled through each parameter set may be applied to pictures which refer to the corresponding parameter set. For example, information in a VPS may be applied to pictures which refer to the VPS. Information in an SPS may be applied to pictures which refer to the SPS. Information in a PPS may be applied to pictures which refer to the PPS.
Each parameter set may refer to a higher parameter set. For example, a PPS may refer to an SPS. An SPS may refer to a VPS.
Further, a parameter set may include a tile group, slice header information, and tile header information. The tile group may be a group including multiple tiles. Also, the meaning of “tile group” may be identical to that of “slice”.

Rate-distortion optimization: An encoding apparatus may use rate-distortion optimization so as to provide high coding efficiency by utilizing combinations of the size of a coding unit (CU), a prediction mode, the size of a prediction unit (PU), motion information, and the size of a transform unit (TU).
A rate-distortion optimization scheme may calculate rate-distortion costs of respective combinations so as to select an optimal combination from among the combinations. The rate-distortion costs may be calculated using the equation “D+λ*R”. Generally, a combination enabling the rate-distortion cost to be minimized may be selected as the optimal combination in the rate-distortion optimization scheme.
D may denote distortion. D may be the mean of squares of differences (i.e. mean square error) between original transform coefficients and reconstructed transform coefficients in a transform unit.
R may denote the rate, which may denote a bit rate using related-context information.
λ denotes a Lagrangian multiplier. R may include not only coding parameter information, such as a prediction mode, motion information, and a coded block flag, but also bits generated due to the encoding of transform coefficients.
An encoding apparatus may perform procedures, such as inter prediction and/or intra prediction, transform, quantization, entropy encoding, inverse quantization (dequantization), and/or inverse transform so as to calculate precise D and R. These procedures may greatly increase the complexity of the encoding apparatus.
Bitstream: A bitstream may denote a stream of bits including encoded image information.

Parsing: Parsing may be the decision on the value of a syntax element, made by performing entropy decoding on a bitstream. Alternatively, the term “parsing” may mean such entropy decoding itself.

Symbol: A symbol may be at least one of the syntax element, the coding parameter, and the transform coefficient of an encoding target unit and/or a decoding target unit. Further, a symbol may be the target of entropy encoding or the result of entropy decoding.

Reference picture: A reference picture may be an image referred to by a unit so as to perform inter prediction or motion compensation. Alternatively, a reference picture may be an image including a reference unit referred to by a target unit so as to perform inter prediction or motion compensation.

Hereinafter, the terms “reference picture” and “reference image” may be used to have the same meaning, and may be used interchangeably with each other.

Reference picture list: A reference picture list may be a list including one or more reference images used for inter prediction or motion compensation.

The types of a reference picture list may include List Combined (LC), List 0 (L0), List 1 (L1), List 2 (L2), List 3 (L3), etc.
For inter prediction, one or more reference picture lists may be used.

Inter-prediction indicator: An inter-prediction indicator may indicate the inter-prediction direction for a target unit. Inter prediction may be one of unidirectional prediction and bidirectional prediction. Alternatively, the inter-prediction indicator may denote the number of reference pictures used to generate a prediction unit of a target unit. Alternatively, the inter-prediction indicator may denote the number of prediction blocks used for inter prediction or motion compensation of a target unit.

Prediction list utilization flag: A prediction list utilization flag may indicate whether a prediction unit is generated using at least one reference picture in a specific reference picture list.
An inter-prediction indicator may be derived using the prediction list utilization flag. In contrast, the prediction list utilization flag may be derived using the inter-prediction indicator. For example, the case where the prediction list utilization flag indicates “0”, which is a first value, may indicate that, for a target unit, a prediction block is not generated using a reference picture in a reference picture list. The case where the prediction list utilization flag indicates “1”, which is a second value, may indicate that, for a target unit, a prediction unit is generated using the reference picture list.

Reference picture index: A reference picture index may be an index indicating a specific reference picture in a reference picture list.

Picture Order Count (POC): A POC value for a picture may denote an order in which the corresponding picture is displayed.

Motion vector (MV): A motion vector may be a 2D vector used for inter prediction or motion compensation. A motion vector may mean an offset between a target image and a reference image.
For example, a MV may be represented in a form such as (mvₓ, mv_{y}). mvₓ may indicate a horizontal component, and mv_{y} may indicate a vertical component.
Search range: A search range may be a 2D area in which a search for a MV is performed during inter prediction. For example, the size of the search range may be M×N. M and N may be respective positive integers.

Motion vector candidate: A motion vector candidate may be a block that is a prediction candidate or the motion vector of the block that is a prediction candidate when a motion vector is predicted.
A motion vector candidate may be included in a motion vector candidate list.

Motion vector candidate list: A motion vector candidate list may be a list configured using one or more motion vector candidates.

Motion vector candidate index: A motion vector candidate index may be an indicator for indicating a motion vector candidate in the motion vector candidate list. Alternatively, a motion vector candidate index may be the index of a motion vector predictor.

Motion information: Motion information may be information including at least one of a reference picture list, a reference image, a motion vector candidate, a motion vector candidate index, a merge candidate, and a merge index, as well as a motion vector, a reference picture index, and an inter-prediction indicator.

Merge candidate list: A merge candidate list may be a list configured using one or more merge candidates.

Merge candidate: A merge candidate may be a spatial merge candidate, a temporal merge candidate, a combined merge candidate, a combined bi-prediction merge candidate, a candidate based on a history, a candidate based on an average of two candidates, a zero-merge candidate, etc. A merge candidate may include an inter-prediction indicator, and may include motion information such as prediction type information, a reference picture index for each list, a motion vector, a prediction list utilization flag, and an inter-prediction indicator.

Merge index: A merge index may be an indicator for indicating a merge candidate in a merge candidate list.
A merge index may indicate a reconstructed unit used to derive a merge candidate between a reconstructed unit spatially adjacent to a target unit and a reconstructed unit temporally adjacent to the target unit.
A merge index may indicate at least one of pieces of motion information of a merge candidate.

Transform unit: A transform unit may be the base unit of residual signal encoding and/or residual signal decoding, such as transform, inverse transform, quantization, dequantization, transform coefficient encoding, and transform coefficient decoding. A single transform unit may be partitioned into multiple sub-transform units having a smaller size. Here, a transform may include one or more of a primary transform and a secondary transform, and an inverse transform may include one or more of a primary inverse transform and a secondary inverse transform.

Scaling: Scaling may denote a procedure for multiplying a factor by a transform coefficient level.
As a result of scaling of the transform coefficient level, a transform coefficient may be generated. Scaling may also be referred to as “dequantization”.

Quantization Parameter (QP): A quantization parameter may be a value used to generate a transform coefficient level for a transform coefficient in quantization. Alternatively, a quantization parameter may also be a value used to generate a transform coefficient by scaling the transform coefficient level in dequantization. Alternatively, a quantization parameter may be a value mapped to a quantization step size.

Delta quantization parameter: A delta quantization parameter may mean a difference value between a predicted quantization parameter and the quantization parameter of a target unit.

Scan: Scan may denote a method for aligning the order of coefficients in a unit, a block or a matrix. For example, a method for aligning a 2D array in the form of a one-dimensional (1D) array may be referred to as a “scan”. Alternatively, a method for aligning a 1D array in the form of a 2D array may also be referred to as a “scan” or an “inverse scan”.

Transform coefficient: A transform coefficient may be a coefficient value generated as an encoding apparatus performs a transform. Alternatively, the transform coefficient may be a coefficient value generated as a decoding apparatus performs at least one of entropy decoding and dequantization.
A quantized level or a quantized transform coefficient level generated by applying quantization to a transform coefficient or a residual signal may also be included in the meaning of the term “transform coefficient”.

Quantized level: A quantized level may be a value generated as the encoding apparatus performs quantization on a transform coefficient or a residual signal. Alternatively, the quantized level may be a value that is the target of dequantization as the decoding apparatus performs dequantization.
A quantized transform coefficient level, which is the result of transform and quantization, may also be included in the meaning of a quantized level.

Non-zero transform coefficient: A non-zero transform coefficient may be a transform coefficient having a value other than 0 or a transform coefficient level having a value other than 0. Alternatively, a non-zero transform coefficient may be a transform coefficient, the magnitude of the value of which is not 0, or a transform coefficient level, the magnitude of the value of which is not 0.

Quantization matrix: A quantization matrix may be a matrix used in a quantization procedure or a dequantization procedure so as to improve the subjective image quality or objective image quality of an image. A quantization matrix may also be referred to as a “scaling list”.

Quantization matrix coefficient: A quantization matrix coefficient may be each element in a quantization matrix. A quantization matrix coefficient may also be referred to as a “matrix coefficient”.

Default matrix: A default matrix may be a quantization matrix predefined by the encoding apparatus and the decoding apparatus.

Non-default matrix: A non-default matrix may be a quantization matrix that is not predefined by the encoding apparatus and the decoding apparatus. The non-default matrix may mean a quantization matrix to be signaled from the encoding apparatus to the decoding apparatus by a user.

Most Probable Mode (MPM): An MPM may denote an intra-prediction mode having a high probability of being used for intra prediction for a target block.

An encoding apparatus and a decoding apparatus may determine one or more MPMs based on coding parameters related to the target block and the attributes of entities related to the target block.

The encoding apparatus and the decoding apparatus may determine one or more MPMs based on the intra-prediction mode of a reference block. The reference block may include multiple reference blocks. The multiple reference blocks may include spatial neighbor blocks adjacent to the left of the target block and spatial neighbor blocks adjacent to the top of the target block. In other words, depending on which intra-prediction modes have been used for the reference blocks, one or more different MPMs may be determined.
The one or more MPMs may be determined in the same manner both in the encoding apparatus and in the decoding apparatus. That is, the encoding apparatus and the decoding apparatus may share the same MPM list including one or more MPMs.

MPM list: An MPM list may be a list including one or more MPMs. The number of the one or more MPMs in the MPM list may be defined in advance.

MPM indicator: An MPM indicator may indicate an MPM to be used for intra prediction for a target block among one or more MPMs in the MPM list. For example, the MPM indicator may be an index for the MPM list.
Since the MPM list is determined in the same manner both in the encoding apparatus and in the decoding apparatus, there may be no need to transmit the MPM list itself from the encoding apparatus to the decoding apparatus.
The MPM indicator may be signaled from the encoding apparatus to the decoding apparatus. As the MPM indicator is signaled, the decoding apparatus may determine the MPM to be used for intra prediction for the target block among the MPMs in the MPM list.

MPM use indicator: An MPM use indicator may indicate whether an MPM usage mode is to be used for prediction for a target block. The MPM usage mode may be a mode in which the MPM to be used for intra prediction for the target block is determined using the MPM list.
The MPM use indicator may be signaled from the encoding apparatus to the decoding apparatus.

Signaling: “signaling” may denote that information is transferred from an encoding apparatus to a decoding apparatus. Alternatively, “signaling” may mean information is included in in a bitstream or a recoding medium by an encoding apparatus. Information signaled by an encoding apparatus may be used by a decoding apparatus.
The encoding apparatus may generate encoded information by performing encoding on information to be signaled. The encoded information may be transmitted from the encoding apparatus to the decoding apparatus. The decoding apparatus may obtain information by decoding the transmitted encoded information. Here, the encoding may be entropy encoding, and the decoding may be entropy decoding.

Selective Signaling: Information may be signaled selectively. A selective signaling FOR information may mean that an encoding apparatus selectively includes information (according to a specific condition) in a bitstream or a recording medium. Selective signaling for information may mean that a decoding apparatus selectively extracts information from a bitstream (according to a specific condition).

Omission of signaling: Signaling for information may be omitted. Omission of signaling for information on information may mean that an encoding apparatus does not include information (according to a specific condition) in a bitstream or a recording medium. Omission of signaling for information may mean that a decoding apparatus does not extract information from a bitstream (according to a specific condition).

Statistic value: A variable, a coding parameter, a constant, etc. may have values that can be calculated. The statistic value may be a value generated by performing calculations (operations) on the values of specified targets. For example, the statistic value may indicate one or more of the average, weighted average, weighted sum, minimum value, maximum value, mode, median value, and interpolated value of the values of a specific variable, a specific coding parameter, a specific constant, or the like.

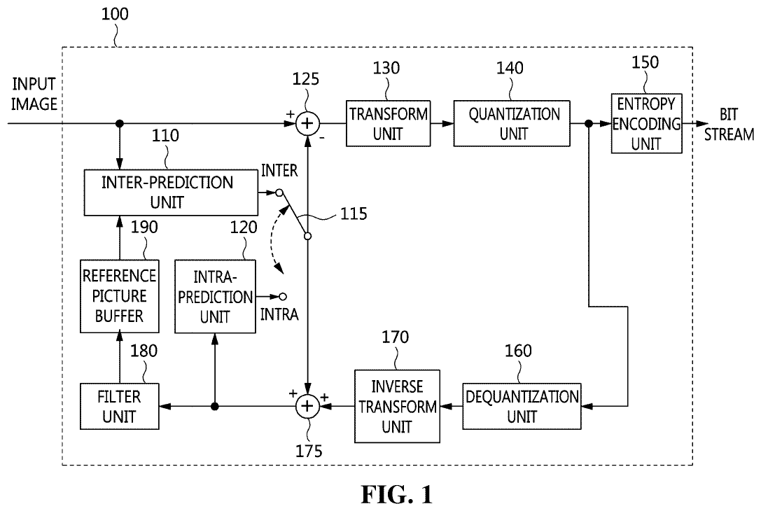

FIG. 1 is a block diagram illustrating the configuration of an embodiment of an encoding apparatus to which the present disclosure is applied.

An encoding apparatus 100 may be an encoder, a video encoding apparatus or an image encoding apparatus. A video may include one or more images (pictures). The encoding apparatus 100 may sequentially encode one or more images of the video.

Referring to FIG. 1, the encoding apparatus 100 includes an inter-prediction unit 110, an intra-prediction unit 120, a switch 115, a subtractor 125, a transform unit 130, a quantization unit 140, an entropy encoding unit 150, a dequantization (inverse quantization) unit 160, an inverse transform unit 170, an adder 175, a filter unit 180, and a reference picture buffer 190.

The encoding apparatus 100 may perform encoding on a target image using an intra mode and/or an inter mode. In other words, a prediction mode for a target block may be one of an intra mode and an inter mode.

Hereinafter, the terms “intra mode”, “intra-prediction mode”, “intra-picture mode” and “intra-picture prediction mode” may be used to have the same meaning, and may be used interchangeably with each other.

Hereinafter, the terms “inter mode”, “inter-prediction mode”, “inter-picture mode” and “inter-picture prediction mode” may be used to have the same meaning, and may be used interchangeably with each other.

Hereinafter, the term “image” may indicate only part of an image, or may indicate a block. Also, the processing of an “image” may indicate sequential processing of multiple blocks.

Further, the encoding apparatus 100 may generate a bitstream, including encoded information, via encoding on the target image, and may output and store the generated bitstream. The generated bitstream may be stored in a computer-readable storage medium and may be streamed through a wired and/or wireless transmission medium.

When the intra mode is used as a prediction mode, the switch 115 may switch to the intra mode. When the inter mode is used as a prediction mode, the switch 115 may switch to the inter mode.

The encoding apparatus 100 may generate a prediction block of a target block. Further, after the prediction block has been generated, the encoding apparatus 100 may encode a residual block for the target block using a residual between the target block and the prediction block.

When the prediction mode is the intra mode, the intra-prediction unit 120 may use pixels of previously encoded/decoded neighbor blocks adjacent to the target block as reference samples. The intra-prediction unit 120 may perform spatial prediction on the target block using the reference samples, and may generate prediction samples for the target block via spatial prediction. the prediction samples may mean samples in the prediction block.

The inter-prediction unit 110 may include a motion prediction unit and a motion compensation unit.

When the prediction mode is an inter mode, the motion prediction unit may search a reference image for the area most closely matching the target block in a motion prediction procedure, and may derive a motion vector for the target block and the found area based on the found area. Here, the motion-prediction unit may use a search range as a target area for searching.

The reference image may be stored in the reference picture buffer 190. More specifically, an encoded and/or decoded reference image may be stored in the reference picture buffer 190 when the encoding and/or decoding of the reference image have been processed.

Since a decoded picture is stored, the reference picture buffer 190 may be a Decoded Picture Buffer (DPB).

The motion compensation unit may generate a prediction block for the target block by performing motion compensation using a motion vector. Here, the motion vector may be a two-dimensional (2D) vector used for inter-prediction. Further, the motion vector may indicate an offset between the target image and the reference image.

The motion prediction unit and the motion compensation unit may generate a prediction block by applying an interpolation filter to a partial area of a reference image when the motion vector has a value other than an integer. In order to perform inter prediction or motion compensation, it may be determined which one of a skip mode, a merge mode, an advanced motion vector prediction (AMVP) mode, and a current picture reference mode corresponds to a method for predicting the motion of a PU included in a CU, based on the CU, and compensating for the motion, and inter prediction or motion compensation may be performed depending on the mode.

The subtractor 125 may generate a residual block, which is the differential between the target block and the prediction block. A residual block may also be referred to as a “residual signal”.

The residual signal may be the difference between an original signal and a prediction signal. Alternatively, the residual signal may be a signal generated by transforming or quantizing the difference between an original signal and a prediction signal or by transforming and quantizing the difference. A residual block may be a residual signal for a block unit.

The transform unit 130 may generate a transform coefficient by transforming the residual block, and may output the generated transform coefficient. Here, the transform coefficient may be a coefficient value generated by transforming the residual block.

The transform unit 130 may use one of multiple predefined transform methods when performing a transform.

The multiple predefined transform methods may include a Discrete Cosine Transform (DCT), a Discrete Sine Transform (DST), a Karhunen-Loeve Transform (KLT), etc.

The transform method used to transform a residual block may be determined depending on at least one of coding parameters for a target block and/or a neighbor block. For example, the transform method may be determined based on at least one of an inter-prediction mode for a PU, an intra-prediction mode for a PU, the size of a TU, and the shape of a TU. Alternatively, transformation information indicating the transform method may be signaled from the encoding apparatus 100 to the decoding apparatus 200.

When a transform skip mode is used, the transform unit 130 may omit transforming the residual block.

By applying quantization to the transform coefficient, a quantized transform coefficient level or a quantized level may be generated. Hereinafter, in the embodiments, each of the quantized transform coefficient level and the quantized level may also be referred to as a ‘transform coefficient’.

The quantization unit 140 may generate a quantized transform coefficient level (i.e., a quantized level or a quantized coefficient) by quantizing the transform coefficient depending on quantization parameters. The quantization unit 140 may output the quantized transform coefficient level that is generated. In this case, the quantization unit 140 may quantize the transform coefficient using a quantization matrix.

The entropy encoding unit 150 may generate a bitstream by performing probability distribution-based entropy encoding based on values, calculated by the quantization unit 140, and/or coding parameter values, calculated in the encoding procedure. The entropy encoding unit 150 may output the generated bitstream.

The entropy encoding unit 150 may perform entropy encoding on information about the pixels of the image and information required to decode the image. For example, the information required to decode the image may include syntax elements or the like.

When entropy encoding is applied, fewer bits may be assigned to more frequently occurring symbols, and more bits may be assigned to rarely occurring symbols. As symbols are represented by means of this assignment, the size of a bit string for target symbols to be encoded may be reduced. Therefore, the compression performance of video encoding may be improved through entropy encoding.

Further, for entropy encoding, the entropy encoding unit 150 may use a coding method such as exponential Golomb, Context-Adaptive Variable Length Coding (CAVLC), or Context-Adaptive Binary Arithmetic Coding (CABAC). For example, the entropy encoding unit 150 may perform entropy encoding using a Variable Length Coding/Code (VLC) table. For example, the entropy encoding unit 150 may derive a binarization method for a target symbol. Further, the entropy encoding unit 150 may derive a probability model for a target symbol/bin. The entropy encoding unit 150 may perform arithmetic coding using the derived binarization method, a probability model, and a context model.

The entropy encoding unit 150 may transform the coefficient of the form of a 2D block into the form of a 1D vector through a transform coefficient scanning method so as to encode a quantized transform coefficient level.

The coding parameters may be information required for encoding and/or decoding. The coding parameters may include information encoded by the encoding apparatus 100 and transferred from the encoding apparatus 100 to a decoding apparatus, and may also include information that may be derived in the encoding or decoding procedure. For example, information transferred to the decoding apparatus may include syntax elements.

The coding parameters may include not only information (or a flag or an index), such as a syntax element, which is encoded by the encoding apparatus and is signaled by the encoding apparatus to the decoding apparatus, but also information derived in an encoding or decoding process. Further, the coding parameters may include information required so as to encode or decode images. For example, the coding parameters may include at least one value, combinations or statistics of a size of a unit/block, a shape/form of a unit/block, a depth of a unit/block, partition information of a unit/block, a partition structure of a unit/block, information indicating whether a unit/block is partitioned in a quad-tree structure, information indicating whether a unit/block is partitioned in a binary tree structure, a partitioning direction of a binary tree structure (horizontal direction or vertical direction), a partitioning form of a binary tree structure (symmetrical partitioning or asymmetrical partitioning), information indicating whether a unit/block is partitioned in a ternary tree structure, a partitioning direction of a ternary tree structure (horizontal direction or vertical direction), a partitioning form of a ternary tree structure (symmetrical partitioning or asymmetrical partitioning, etc.), information indicating whether a unit/block is partitioned in a multi-type tree structure, a combination and a direction (horizontal direction or vertical direction, etc.) of a partitioning of the multi-type tree structure, a partitioning form of a multi-type tree structure (symmetrical partitioning or asymmetrical partitioning, etc.), a partitioning tree (a binary tree or a ternary tree) of the multi-type tree form, a type of a prediction (intra prediction or inter prediction), an intra-prediction mode/direction, an intra luma prediction mode/direction, an intra chroma prediction mode/direction, an intra partitioning information, an inter partitioning information, a coding block partitioning flag, a prediction block partitioning flag, a transform block partitioning flag, a reference sample filtering method, a reference sample filter tap, a reference sample filter coefficient, a prediction block filtering method, a prediction block filter tap, a prediction block filter coefficient, a prediction block boundary filtering method, a prediction block boundary filter tap, a prediction block boundary filter coefficient, an inter-prediction mode, motion information, a motion vector, a motion vector difference, a reference picture index, an inter-prediction direction, an inter-prediction indicator, a prediction list utilization flag, a reference picture list, a reference image, a POC, a motion vector predictor, a motion vector prediction index, a motion vector prediction candidate, a motion vector candidate list, information indicating whether a merge mode is used, a merge index, a merge candidate, a merge candidate list, information indicating whether a skip mode is used, a type of an interpolation filter, a tap of an interpolation filter, a filter coefficient of an interpolation filter, a magnitude of a motion vector, accuracy of motion vector representation, a transform type, a transform size, information indicating whether a first transform is used, information indicating whether an additional (secondary) transform is used, first transform selection information (or a first transform index), secondary transform selection information (or a secondary transform index), information indicating a presence or absence of a residual signal, a coded block pattern, a coded block flag, a quantization parameter, a residual quantization parameter, a quantization matrix, information about an intra-loop filter, information indicating whether an intra-loop filter is applied, a coefficient of an intra-loop filter, a tap of an intra-loop filter, a shape/form of an intra-loop filter, information indicating whether a deblocking filter is applied, a coefficient of a deblocking filter, a tap of a deblocking filter, deblocking filter strength, a shape/form of a deblocking filter, information indicating whether an adaptive sample offset is applied, a value of an adaptive sample offset, a category of an adaptive sample offset, a type of an adaptive sample offset, information indicating whether an adaptive in-loop filter is applied, a coefficient of an adaptive in-loop filter, a tap of an adaptive in-loop filter, a shape/form of an adaptive in-loop filter, a binarization/inverse binarization method, a context model, a context model decision method, a context model update method, information indicating whether a regular mode is performed, information whether a bypass mode is performed, a significant coefficient flag, a last significant coefficient flag, a coding flag for a coefficient group, a position of a last significant coefficient, information indicating whether a value of a coefficient is greater than 1, information indicating whether a value of a coefficient is greater than 2, information indicating whether a value of a coefficient is greater than 3, a remaining coefficient value information, a sign information, a reconstructed luma sample, a reconstructed chroma sample, a context bin, a bypass bin, a residual luma sample, a residual chroma sample, a transform coefficient, a luma transform coefficient, a chroma transform coefficient, a quantized level, a luma quantized level, a chroma quantized level, a transform coefficient level, a transform coefficient level scanning method, a size of a motion vector search region on a side of a decoding apparatus, a shape/form of a motion vector search region on a side of a decoding apparatus, the number of a motion vector search on a side of a decoding apparatus, a size of a CTU, a minimum block size, a maximum block size, a maximum block depth, a minimum block depth, an image display/output order, slice identification information, a slice type, slice partition information, tile group identification information, a tile group type, a tile group partitioning information, tile identification information, a tile type, tile partitioning information, a picture type, bit depth, input sample bit depth, reconstructed sample bit depth, residual sample bit depth, transform coefficient bit depth, quantized level bit depth, information about a luma signal, information about a chroma signal, a color space of a target block and a color space of a residual block. Further, the above-described coding parameter-related information may also be included in the coding parameter. Information used to calculate and/or derive the above-described coding parameter may also be included in the coding parameter. Information calculated or derived using the above-described coding parameter may also be included in the coding parameter.

The first transform selection information may indicate a first transform which is applied to a target block.

The second transform selection information may indicate a second transform which is applied to a target block.

The residual signal may denote the difference between the original signal and a prediction signal. Alternatively, the residual signal may be a signal generated by transforming the difference between the original signal and the prediction signal. Alternatively, the residual signal may be a signal generated by transforming and quantizing the difference between the original signal and the prediction signal. A residual block may be the residual signal for a block.

Here, signaling information may mean that the encoding apparatus 100 includes an entropy-encoded information, generated by performing entropy encoding a flag or an index, in a bitstream, and that the decoding apparatus 200 acquires information by performing entropy decoding on the entropy-encoded information, extracted from the bitstream. Here, the information may comprise a flag, an index, etc.

A signal may mean information to be signaled. Hereinafter, information for an image and a block may be referred to as a signal. Further, hereinafter, the terms “information” and “signal” may be used to have the same meaning and may be used interchangeably with each other. For example, a specific signal may be a signal representing a specific block. An original signal may be a signal representing a target block. A prediction signal may be a signal representing a prediction block. A residual signal may be a signal representing a residual block.

A bitstream may include information based on a specific syntax. The encoding apparatus 100 may generate a bitstream including information depending on a specific syntax. The decoding apparatus 200 may acquire information from the bitstream depending on a specific syntax.

Since the encoding apparatus 100 performs encoding via inter prediction, the encoded target image may be used as a reference image for additional image(s) to be subsequently processed. Therefore, the encoding apparatus 100 may reconstruct or decode the encoded target image and store the reconstructed or decoded image as a reference image in the reference picture buffer 190. For decoding, dequantization and inverse transform on the encoded target image may be processed.

The quantized level may be inversely quantized by the dequantization unit 160, and may be inversely transformed by the inverse transform unit 170. The dequantization unit 160 may generate an inversely quantized coefficient by performing inverse transform for the quantized level. The inverse transform unit 170 may generate a inversely quantized and inversely transformed coefficient by performing inverse transform for the inversely quantized coefficient.

The inversely quantized and inversely transformed coefficient may be added to the prediction block by the adder 175. The inversely quantized and inversely transformed coefficient and the prediction block are added, and then a reconstructed block may be generated. Here, the inversely quantized and/or inversely transformed coefficient may denote a coefficient on which one or more of dequantization and inverse transform are performed, and may also denote a reconstructed residual block. Here, the reconstructed block may mean a recovered block or a decoded block.

The reconstructed block may be subjected to filtering through the filter unit 180. The filter unit 180 may apply one or more of a deblocking filter, a Sample Adaptive Offset (SAO) filter, an Adaptive Loop Filter (ALF), and a Non Local Filter (NLF) to a reconstructed sample, the reconstructed block or a reconstructed picture. The filter unit 180 may also be referred to as an “in-loop filter”.

The deblocking filter may eliminate block distortion occurring at the boundaries between blocks in a reconstructed picture. In order to determine whether to apply the deblocking filter, the number of columns or rows which are included in a block and which include pixel(s) based on which it is determined whether to apply the deblocking filter to a target block may be decided on.

When the deblocking filter is applied to the target block, the applied filter may differ depending on the strength of the required deblocking filtering. In other words, among different filters, a filter decided on in consideration of the strength of deblocking filtering may be applied to the target block. When a deblocking filter is applied to a target block, one or more filters of a long-tap filter, a strong filter, a weak filter and Gaussian filter may be applied to the target block depending on the strength of required deblocking filtering.

Also, when vertical filtering and horizontal filtering are performed on the target block, the horizontal filtering and the vertical filtering may be processed in parallel.

The SAO may add a suitable offset to the values of pixels to compensate for coding error. The SAO may perform, for the image to which deblocking is applied, correction that uses an offset in the difference between an original image and the image to which deblocking is applied, on a pixel basis. To perform an offset correction for an image, a method for dividing the pixels included in the image into a certain number of regions, determining a region to which an offset is to be applied, among the divided regions, and applying an offset to the determined region may be used, and a method for applying an offset in consideration of edge information of each pixel may also be used.

The ALF may perform filtering based on a value obtained by comparing a reconstructed image with an original image. After pixels included in an image have been divided into a predetermined number of groups, filters to be applied to each group may be determined, and filtering may be differentially performed for respective groups. information related to whether to apply an adaptive loop filter may be signaled for each CU. Such information may be signaled for a luma signal. The shapes and filter coefficients of ALFs to be applied to respective blocks may differ for respective blocks. Alternatively, regardless of the features of a block, an ALF having a fixed form may be applied to the block.

A non-local filter may perform filtering based on reconstructed blocks, similar to a target block. A region similar to the target block may be selected from a reconstructed picture, and filtering of the target block may be performed using the statistical properties of the selected similar region. Information about whether to apply a non-local filter may be signaled for a Coding Unit (CU). Also, the shapes and filter coefficients of the non-local filter to be applied to blocks may differ depending on the blocks.

The reconstructed block or the reconstructed image subjected to filtering through the filter unit 180 may be stored in the reference picture buffer 190 as a reference picture. The reconstructed block subjected to filtering through the filter unit 180 may be a part of a reference picture. In other words, the reference picture may be a reconstructed picture composed of reconstructed blocks subjected to filtering through the filter unit 180. The stored reference picture may be subsequently used for inter prediction or a motion compensation.

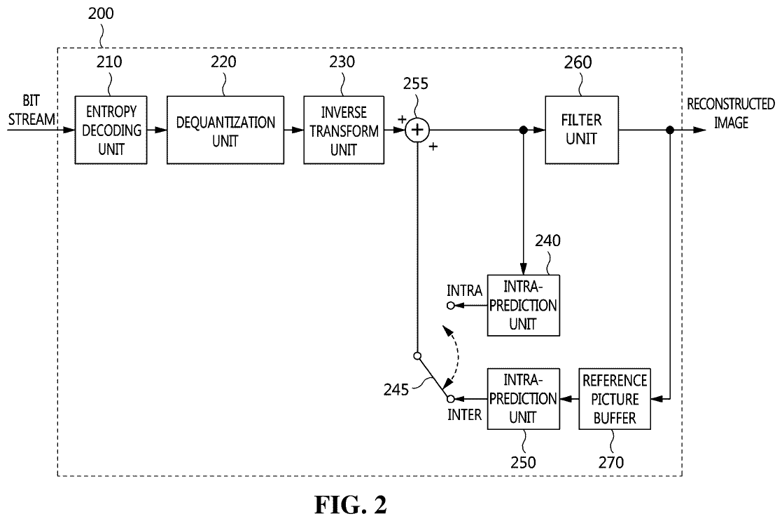

FIG. 2 is a block diagram illustrating the configuration of an embodiment of a decoding apparatus to which the present disclosure is applied.

A decoding apparatus 200 may be a decoder, a video decoding apparatus or an image decoding apparatus.

Referring to FIG. 2, the decoding apparatus 200 may include an entropy decoding unit 210, a dequantization (inverse quantization) unit 220, an inverse transform unit 230, an intra-prediction unit 240, an inter-prediction unit 250, a switch 245 an adder 255, a filter unit 260, and a reference picture buffer 270.

The decoding apparatus 200 may receive a bitstream output from the encoding apparatus 100. The decoding apparatus 200 may receive a bitstream stored in a computer-readable storage medium, and may receive a bitstream that is streamed through a wired/wireless transmission medium.

The decoding apparatus 200 may perform decoding on the bitstream in an intra mode and/or an inter mode. Further, the decoding apparatus 200 may generate a reconstructed image or a decoded image via decoding, and may output the reconstructed image or decoded image.

For example, switching to an intra mode or an inter mode based on the prediction mode used for decoding may be performed by the switch 245. When the prediction mode used for decoding is an intra mode, the switch 245 may be operated to switch to the intra mode. When the prediction mode used for decoding is an inter mode, the switch 245 may be operated to switch to the inter mode.

The decoding apparatus 200 may acquire a reconstructed residual block by decoding the input bitstream, and may generate a prediction block. When the reconstructed residual block and the prediction block are acquired, the decoding apparatus 200 may generate a reconstructed block, which is the target to be decoded, by adding the reconstructed residual block and the prediction block.

The entropy decoding unit 210 may generate symbols by performing entropy decoding on the bitstream based on the probability distribution of a bitstream. The generated symbols may include symbols in a form of a quantized transform coefficient level (i.e., a quantized level or a quantized coefficient). Here, the entropy decoding method may be similar to the above-described entropy encoding method. That is, the entropy decoding method may be the reverse procedure of the above-described entropy encoding method.

The entropy decoding unit 210 may change a coefficient having a one-dimensional (1D) vector form to a 2D block shape through a transform coefficient scanning method in order to decode a quantized transform coefficient level.

For example, the coefficients of the block may be changed to 2D block shapes by scanning the block coefficients using up-right diagonal scanning. Alternatively, which one of up-right diagonal scanning, vertical scanning, and horizontal scanning is to be used may be determined depending on the size and/or the intra-prediction mode of the corresponding block.

The quantized coefficient may be inversely quantized by the dequantization unit 220. The dequantization unit 220 may generate an inversely quantized coefficient by performing dequantization on the quantized coefficient. Further, the inversely quantized coefficient may be inversely transformed by the inverse transform unit 230. The inverse transform unit 230 may generate a reconstructed residual block by performing an inverse transform on the inversely quantized coefficient. As a result of performing dequantization and the inverse transform on the quantized coefficient, the reconstructed residual block may be generated. Here, the dequantization unit 220 may apply a quantization matrix to the quantized coefficient when generating the reconstructed residual block.

When the intra mode is used, the intra-prediction unit 240 may generate a prediction block by performing spatial prediction that uses the pixel values of previously decoded neighbor blocks adjacent to a target block for the target block.

The inter-prediction unit 250 may include a motion compensation unit. Alternatively, the inter-prediction unit 250 may be designated as a “motion compensation unit”.

When the inter mode is used, the motion compensation unit may generate a prediction block by performing motion compensation that uses a motion vector and a reference image stored in the reference picture buffer 270 for the target block.

The motion compensation unit may apply an interpolation filter to a partial area of the reference image when the motion vector has a value other than an integer, and may generate a prediction block using the reference image to which the interpolation filter is applied. In order to perform motion compensation, the motion compensation unit may determine which one of a skip mode, a merge mode, an Advanced Motion Vector Prediction (AMVP) mode, and a current picture reference mode corresponds to the motion compensation method used for a PU included in a CU, based on the CU, and may perform motion compensation depending on the determined mode.

The reconstructed residual block and the prediction block may be added to each other by the adder 255. The adder 255 may generate a reconstructed block by adding the reconstructed residual block to the prediction block.

The reconstructed block may be subjected to filtering through the filter unit 260. The filter unit 260 may apply at least one of a deblocking filter, an SAO filter, an ALF, and a NLF to the reconstructed block or the reconstructed image. The reconstructed image may be a picture including the reconstructed block.

The filter unit may output the reconstructed image.

The reconstructed image and/or the reconstructed block subjected to filtering through the filter unit 260 may be stored as a reference picture in the reference picture buffer 270. The reconstructed block subjected to filtering through the filter unit 260 may be a part of the reference picture. In other words, the reference picture may be an image composed of reconstructed blocks subjected to filtering through the filter unit 260. The stored reference picture may be subsequently used for inter prediction or a motion compensation.

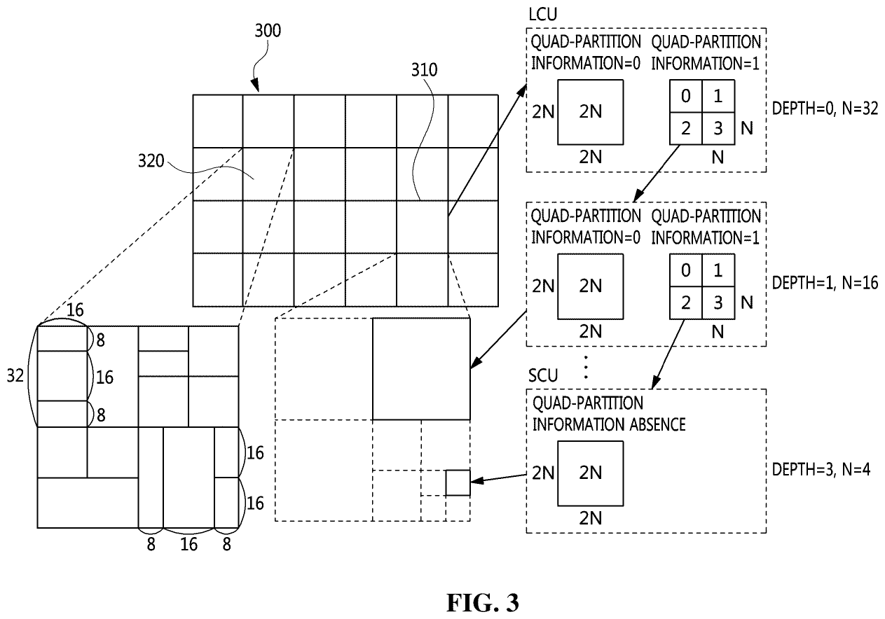

FIG. 3 is a diagram schematically illustrating the partition structure of an image when the image is encoded and decoded.

FIG. 3 may schematically illustrate an example in which a single unit is partitioned into multiple sub-units.

In order to efficiently partition the image, a Coding Unit (CU) may be used in encoding and decoding. The term “unit” may be used to collectively designate 1) a block including image samples and 2) a syntax element. For example, the “partitioning of a unit” may mean the “partitioning of a block corresponding to a unit”.

A CU may be used as a base unit for image encoding/decoding. A CU may be used as a unit to which one mode selected from an intra mode and an inter mode in image encoding/decoding is applied. In other words, in image encoding/decoding, which one of an intra mode and an inter mode is to be applied to each CU may be determined.

Further, a CU may be a base unit in prediction, transform, quantization, inverse transform, dequantization, and encoding/decoding of transform coefficients.

Referring to FIG. 3, an image 200 may be sequentially partitioned into units corresponding to a Largest Coding Unit (LCU), and a partition structure may be determined for each LCU. Here, the LCU may be used to have the same meaning as a Coding Tree Unit (CTU).

The partitioning of a unit may mean the partitioning of a block corresponding to the unit. Block partition information may include depth information about the depth of a unit. The depth information may indicate the number of times the unit is partitioned and/or the degree to which the unit is partitioned. A single unit may be hierarchically partitioned into a plurality of sub-units while having depth information based on a tree structure.

Each of partitioned sub-units may have depth information. The depth information may be information indicating the size of a CU. The depth information may be stored for each CU.

Each CU may have depth information. When the CU is partitioned, CUs resulting from partitioning may have a depth increased from the depth of the partitioned CU by 1.

The partition structure may mean the distribution of Coding Units (CUs) to efficiently encode the image in an LCU 310. Such a distribution may be determined depending on whether a single CU is to be partitioned into multiple CUs. The number of CUs generated by partitioning may be a positive integer of 2 or more, including 2, 3, 4, 8, 16, etc.

The horizontal size and the vertical size of each of CUs generated by the partitioning may be less than the horizontal size and the vertical size of a CU before being partitioned, depending on the number of CUs generated by partitioning. For example, the horizontal size and the vertical size of each of CUs generated by the partitioning may be half of the horizontal size and the vertical size of a CU before being partitioned.

Each partitioned CU may be recursively partitioned into four CUs in the same way. Via the recursive partitioning, at least one of the horizontal size and the vertical size of each partitioned CU may be reduced compared to at least one of the horizontal size and the vertical size of the CU before being partitioned.

The partitioning of a CU may be recursively performed up to a predefined depth or a predefined size.

For example, the depth of a CU may have a value ranging from 0 to 3. The size of the CU may range from a size of 64×64 to a size of 8×8 depending on the depth of the CU.

For example, the depth of an LCU 310 may be 0, and the depth of a Smallest Coding Unit (SCU) may be a predefined maximum depth. Here, as described above, the LCU may be the CU having the maximum coding unit size, and the SCU may be the CU having the minimum coding unit size.

Partitioning may start at the LCU 310, and the depth of a CU may be increased by 1 whenever the horizontal and/or vertical sizes of the CU are reduced by partitioning.

For example, for respective depths, a CU that is not partitioned may have a size of 2N×2N. Further, in the case of a CU that is partitioned, a CU having a size of 2N×2N may be partitioned into four CUs, each having a size of N×N. The value of N may be halved whenever the depth is increased by 1.

Referring to FIG. 3, an LCU having a depth of 0 may have 64×64 pixels or 64×64 blocks. 0 may be a minimum depth. An SCU having a depth of 3 may have 8×8 pixels or 8×8 blocks. 3 may be a maximum depth. Here, a CU having 64×64 blocks, which is the LCU, may be represented by a depth of 0. A CU having 32×32 blocks may be represented by a depth of 1. A CU having 16×16 blocks may be represented by a depth of 2. A CU having 8×8 blocks, which is the SCU, may be represented by a depth of 3.

Information about whether the corresponding CU is partitioned may be represented by the partition information of the CU. The partition information may be 1-bit information. All CUs except the SCU may include partition information. For example, the value of the partition information of a CU that is not partitioned may be a first value. The value of the partition information of a CU that is partitioned may be a second value. When the partition information indicates whether a CU is partitioned or not, the first value may be “0” and the second value may be “1”.

For example, when a single CU is partitioned into four CUs, the horizontal size and vertical size of each of four CUs generated by partitioning may be half the horizontal size and the vertical size of the CU before being partitioned. When a CU having a 32×32 size is partitioned into four CUs, the size of each of four partitioned CUs may be 16×16. When a single CU is partitioned into four CUs, it may be considered that the CU has been partitioned in a quad-tree structure. In other words, it may be considered that a quad-tree partition has been applied to a CU.

For example, when a single CU is partitioned into two CUs, the horizontal size or the vertical size of each of two CUs generated by partitioning may be half the horizontal size or the vertical size of the CU before being partitioned. When a CU having a 32×32 size is vertically partitioned into two CUs, the size of each of two partitioned CUs may be 16×32. When a CU having a 32×32 size is horizontally partitioned into two CUs, the size of each of two partitioned CUs may be 32×16. When a single CU is partitioned into two CUs, it may be considered that the CU has been partitioned in a binary-tree structure. In other words, it may be considered that a binary-tree partition has been applied to a CU.

For example, when a single CU is partitioned (or split) into three CUs, the original CU before being partitioned is partitioned so that the horizontal size or vertical size thereof is divided at a ratio of 1:2:1, thus enabling three sub-CUs to be generated. For example, when a CU having a 16×32 size is horizontally partitioned into three sub-CUs, the three sub-CUs resulting from the partitioning may have sizes of 16×8, 16×16, and 16×8, respectively, in a direction from the top to the bottom. For example, when a CU having a 32×32 size is vertically partitioned into three sub-CUs, the three sub-CUs resulting from the partitioning may have sizes of 8×32, 16×32, and 8×32, respectively, in a direction from the left to the right. When a single CU is partitioned into three CUs, it may be considered that the CU is partitioned in a ternary-tree form. In other words, it may be considered that a ternary-tree partition has been applied to the CU.

Both of quad-tree partitioning and binary-tree partitioning are applied to the LCU 310 of FIG. 3.

In the encoding apparatus 100, a Coding Tree Unit (CTU) having a size of 64×64 may be partitioned into multiple smaller CUs by a recursive quad-tree structure. A single CU may be partitioned into four CUs having the same size. Each CU may be recursively partitioned, and may have a quad-tree structure.

By the recursive partitioning of a CU, an optimal partitioning method that incurs a minimum rate-distortion cost may be selected.

The Coding Tree Unit (CTU) 320 in FIG. 3 is an example of a CTU to which all of a quad-tree partition, a binary-tree partition, and a ternary-tree partition are applied.

As described above, in order to partition a CTU, at least one of a quad-tree partition, a binary-tree partition, and a ternary-tree partition may be applied to the CTU. Partitions may be applied based on specific priority.

For example, a quad-tree partition may be preferentially applied to the CTU. A CU that cannot be partitioned in a quad-tree form any further may correspond to a leaf node of a quad-tree. A CU corresponding to the leaf node of the quad-tree may be a root node of a binary tree and/or a ternary tree. That is, the CU corresponding to the leaf node of the quad-tree may be partitioned in a binary-tree form or a ternary-tree form, or may not be partitioned any further. In this case, each CU, which is generated by applying a binary-tree partition or a ternary-tree partition to the CU corresponding to the leaf node of a quad-tree, is prevented from being subjected again to quad-tree partitioning, thus effectively performing partitioning of a block and/or signaling of block partition information.

The partition of a CU corresponding to each node of a quad-tree may be signaled using quad-partition information. Quad-partition information having a first value (e.g., “1”) may indicate that the corresponding CU is partitioned in a quad-tree form. Quad-partition information having a second value (e.g., “0”) may indicate that the corresponding CU is not partitioned in a quad-tree form. The quad-partition information may be a flag having a specific length (e.g., 1 bit).

Priority may not exist between a binary-tree partition and a ternary-tree partition. That is, a CU corresponding to the leaf node of a quad-tree may be partitioned in a binary-tree form or a ternary-tree form. Also, the CU generated through a binary-tree partition or a ternary-tree partition may be further partitioned in a binary-tree form or a ternary-tree form, or may not be partitioned any further.

Partitioning performed when priority does not exist between a binary-tree partition and a ternary-tree partition may be referred to as a “multi-type tree partition”. That is, a CU corresponding to the leaf node of a quad-tree may be the root node of a multi-type tree. Partitioning of a CU corresponding to each node of the multi-type tree may be signaled using at least one of information indicating whether the CU is partitioned in a multi-type tree, partition direction information, and partition tree information. For partitioning of a CU corresponding to each node of a multi-type tree, information indicating whether partitioning in the multi-type tree is performed, partition direction information, and partition tree information may be sequentially signaled.

For example, information indicating whether a CU is partitioned in a multi-type tree and having a first value (e.g., “1”) may indicate that the corresponding CU is partitioned in a multi-type tree form. Information indicating whether a CU is partitioned in a multi-type tree and having a second value (e.g., “0”) may indicate that the corresponding CU is not partitioned in a multi-type tree form.

When a CU corresponding to each node of a multi-type tree is partitioned in a multi-type tree form, the corresponding CU may further include partition direction information.

The partition direction information may indicate the partition direction of the multi-type tree partition. Partition direction information having a first value (e.g., “1”) may indicate that the corresponding CU is partitioned in a vertical direction. Partition direction information having a second value (e.g., “0”) may indicate that the corresponding CU is partitioned in a horizontal direction.

When a CU corresponding to each node of a multi-type tree is partitioned in a multi-type tree form, the corresponding CU may further include partition-tree information. The partition-tree information may indicate the tree that is used for a multi-type tree partition.

For example, partition-tree information having a first value (e.g., “1”) may indicate that the corresponding CU is partitioned in a binary-tree form. Partition-tree information having a second value (e.g., “0”) may indicate that the corresponding CU is partitioned in a ternary-tree form.

Here, each of the above-described information indicating whether partitioning in the multi-type tree is performed, partition-tree information, and partition direction information may be a flag having a specific length (e.g., 1 bit).

At least one of the above-described quad-partition information, information indicating whether partitioning in the multi-type tree is performed, partition direction information, and partition-tree information may be entropy-encoded and/or entropy-decoded. In order to perform entropy encoding/decoding of such information, information of a neighbor CU adjacent to a target CU may be used.

For example, it may be considered that there is a high probability that the partition form of a left CU and/or an above CU (i.e., partitioning/non-partitioning, a partition tree and/or a partition direction) and the partition form of a target CU will be similar to each other. Therefore, based on the information of a neighbor CU, context information for entropy encoding and/or entropy decoding of the information of the target CU may be derived. Here, the information of the neighbor CU may include at least one of 1) quad-partition information of the neighbor CU, 2) information indicating whether the neighbor CU is partitioned in a multi-type tree, 3) partition direction information of the neighbor CU, and 4) partition-tree information of the neighbor CU.

In another embodiment, of a binary-tree partition and a ternary-tree partition, the binary-tree partition may be preferentially performed. That is, the binary-tree partition may be first applied, and then a CU corresponding to the leaf node of a binary tree may be set to the root node of a ternary tree. In this case, a quad-tree partition or a binary-tree partition may not be performed on the CU corresponding to the node of the ternary tree.

A CU, which is not partitioned any further through a quad-tree partition, a binary-tree partition, and/or a ternary-tree partition, may be the unit of encoding, prediction and/or transform. That is, the CU may not be partitioned any further for prediction and/or transform. Therefore, a partition structure for partitioning the CU into Prediction Units (PUs) and/or Transform Units (TUs), partition information thereof, etc. may not be present in a bitstream.

However, when the size of a CU, which is the unit of partitioning, is greater than the size of a maximum transform block, the CU may be recursively partitioned until the size of the CU becomes less than or equal to the size of the maximum transform block. For example, when the size of a CU is 64×64 and the size of the maximum transform block is 32×32, the CU may be partitioned into four 32×32 blocks so as to perform a transform. For example, when the size of a CU is 32×64 and the size of the maximum transform block is 32×32, the CU may be partitioned into two 32×32 blocks.

In this case, information indicating whether a CU is partitioned for a transform may not be separately signaled. Without signaling, whether a CU is partitioned may be determined via a comparison between the horizontal size (and/or vertical size) of the CU and the horizontal size (and/or vertical size) of the maximum transform block. For example, when the horizontal size of the CU is greater than the horizontal size of the maximum transform block, the CU may be vertically bisected. Further, when the vertical size of the CU is greater than the vertical size of the maximum transform block, the CU may be horizontally bisected.

Information about the maximum size and/or minimum size of a CU and information about the maximum size and/or minimum size of a transform block may be signaled or determined at a level higher than that of the CU. For example, the higher level may be a sequence level, a picture level, a tile level, a tile group level or a slice level. For example, the minimum size of the CU may be set to 4×4. For example, the maximum size of the transform block may be set to 64×64. For example, the maximum size of the transform block may be set to 4×4.

Information about the minimum size of a CU corresponding to the leaf node of a quad-tree (i.e., the minimum size of the quad-tree) and/or information about the maximum depth of a path from the root node to the leaf node of a multi-type tree (i.e., the maximum depth of a multi-type tree) may be signaled or determined at a level higher than that of the CU. For example, the higher level may be a sequence level, a picture level, a slice level, a tile group level or a tile level. Information about the minimum size of a quad-tree and/or information about the maximum depth of a multi-type tree may be separately signaled or determined at each of an intra-slice level and an inter-slice level.

Information about the difference between the size of a CTU and the maximum size of a transform block may be signaled or determined at a level higher than that of a CU. For example, the higher level may be a sequence level, a picture level, a slice level, a tile group level or a tile level. Information about the maximum size of a CU corresponding to each node of a binary tree (i.e., the maximum size of the binary tree) may be determined based on the size and the difference information of a CTU. The maximum size of a CU corresponding to each node of a ternary tree (i.e., the maximum size of the ternary tree) may have different values depending on the type of slice. For example, the maximum size of the ternary tree at an intra-slice level may be 32×32. For example, the maximum size of the ternary tree at an inter-slice level may be 128×128. For example, the minimum size of a CU corresponding to each node of a binary tree (i.e., the minimum size of the binary tree) and/or the minimum size of a CU corresponding to each node of a ternary tree (i.e., the minimum size of the ternary tree) may be set to the minimum size of a CU.

In a further example, the maximum size of a binary tree and/or the maximum size of a ternary tree may be signaled or determined at a slice level. Also, the minimum size of a binary tree and/or the minimum size of a ternary tree may be signaled or determined at a slice level.

Based on the above-described various block sizes and depths, quad-partition information, information indicating whether partitioning in a multi-type tree is performed, partition tree information and/or partition direction information may or may not be present in a bitstream.

For example, when the size of a CU is not greater than the minimum size of a quad-tree, the CU may not include quad-partition information, and quad-partition information of the CU may be inferred as a second value.

For example, when the size of a CU corresponding to each node of a multi-type tree (horizontal size and vertical size) is greater than the maximum size of a binary tree (horizontal size and vertical size) and/or the maximum size of a ternary tree (horizontal size and vertical size), the CU may not be partitioned in a binary-tree form and/or a ternary-tree form. By means of this determination manner, information indicating whether partitioning in a multi-type tree is performed may not be signaled, but may be inferred as a second value.

Alternatively, when the size of a CU corresponding to each node of a multi-type tree (horizontal size and vertical size) is equal to the minimum size of a binary tree (horizontal size and vertical size), or when the size of a CU (horizontal size and vertical size) is equal to twice the minimum size of a ternary tree (horizontal size and vertical size), the CU may not be partitioned in a binary tree form and/or a ternary tree form. By means of this determination manner, information indicating whether partitioning in a multi-type tree is performed may not be signaled, but may be inferred as a second value. The reason for this is that, when a CU is partitioned in a binary tree form and/or a ternary tree form, a CU smaller than the minimum size of the binary tree and/or the minimum size of the ternary tree is generated.

Alternatively, a binary-tree partition or a ternary-tree partition may be limited based on the size of a virtual pipeline data unit (i.e., the size of a pipeline buffer). For example, when a CU is partitioned into sub-CUs unsuitable for the size of a pipeline buffer through a binary-tree partition or a ternary-tree partition, a binary-tree partition or a ternary-tree partition may be limited. The size of the pipeline buffer may be equal to the maximum size of a transform block (e.g., 64×64).

For example, when the size of the pipeline buffer is 64×64, the following partitions may be limited.
Ternary-tree partition for N×M CU (where N and/or M are 128)
Horizontal binary-tree partition for 128×N CU (where N<=64)
Vertical binary-tree partition for N×128 CU (where N<=64)

Alternatively, when the depth of a CU corresponding to each node of a multi-type tree is equal to the maximum depth of the multi-type tree, the CU may not be partitioned in a binary-tree form and/or a ternary-tree form. By means of this determination manner, information indicating whether partitioning in a multi-type tree is performed may not be signaled, but may be inferred as a second value.

Alternatively, information indicating whether partitioning in a multi-type tree is performed may be signaled only when at least one of a vertical binary-tree partition, a horizontal binary-tree partition, a vertical ternary-tree partition, and a horizontal ternary-tree partition is possible for a CU corresponding to each node of a multi-type tree. Otherwise, the CU may not be partitioned in a binary-tree form and/or a ternary-tree form. By means of this determination manner, information indicating whether partitioning in a multi-type tree is performed may not be signaled, but may be inferred as a second value.

Alternatively, partition direction information may be signaled only when both a vertical binary-tree partition and a horizontal binary-tree partition are possible or only when both a vertical ternary-tree partition and a horizontal ternary-tree partition are possible, for a CU corresponding to each node of a multi-type tree. Otherwise, the partition direction information may not be signaled, but may be inferred as a value indicating the direction in which the CU can be partitioned.

Alternatively, partition tree information may be signaled only when both a vertical binary-tree partition and a vertical ternary-tree partition are possible or only when both a horizontal binary-tree partition and a horizontal ternary-tree partition are possible, for a CU corresponding to each node of a multi-type tree. Otherwise, the partition tree information may not be signaled, but may be inferred as a value indicating a tree that can be applied to the partition of the CU.

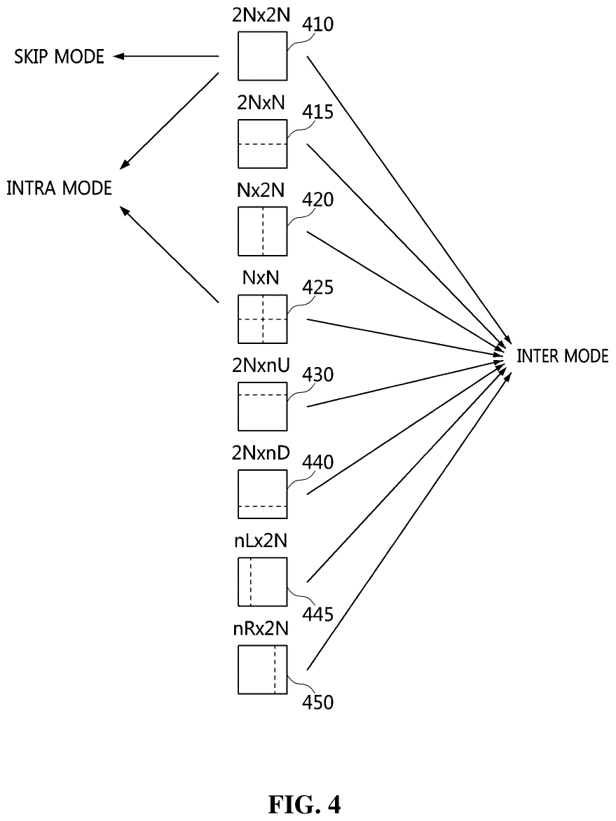

FIG. 4 is a diagram illustrating the form of a Prediction Unit that a Coding Unit can include.

When, among CUs partitioned from an LCU, a CU, which is not partitioned any further, may be divided into one or more Prediction Units (PUs). Such division is also referred to as “partitioning”.

A PU may be a base unit for prediction. A PU may be encoded and decoded in any one of a skip mode, an inter mode, and an intra mode. A PU may be partitioned into various shapes depending on respective modes. For example, the target block, described above with reference to FIG. 1, and the target block, described above with reference to FIG. 2, may each be a PU.

A CU may not be split into PUs. When the CU is not split into PUs, the size of the CU and the size of a PU may be equal to each other.

In a skip mode, partitioning may not be present in a CU. In the skip mode, a 2N×2N mode 410, in which the sizes of a PU and a CU are identical to each other, may be supported without partitioning.

In an inter mode, 8 types of partition shapes may be present in a CU. For example, in the inter mode, the 2N×2N mode 410, a 2N×N mode 415, an N×2N mode 420, an N×N mode 425, a 2N×nU mode 430, a 2N×nD mode 435, an nL×2N mode 440, and an nR×2N mode 445 may be supported.

In an intra mode, the 2N×2N mode 410 and the N×N mode 425 may be supported.

In the 2N×2N mode 410, a PU having a size of 2N×2N may be encoded. The PU having a size of 2N×2N may mean a PU having a size identical to that of the CU. For example, the PU having a size of 2N×2N may have a size of 64×64, 32×32, 16×16 or 8×8.

In the N×N mode 425, a PU having a size of N×N may be encoded.

For example, in intra prediction, when the size of a PU is 8×8, four partitioned PUs may be encoded. The size of each partitioned PU may be 4×4.

When a PU is encoded in an intra mode, the PU may be encoded using any one of multiple intra-prediction modes. For example, HEVC technology may provide 35 intra-prediction modes, and the PU may be encoded in any one of the 35 intra-prediction modes.

Which one of the 2N×2N mode 410 and the N×N mode 425 is to be used to encode the PU may be determined based on rate-distortion cost.

The encoding apparatus 100 may perform an encoding operation on a PU having a size of 2N×2N. Here, the encoding operation may be the operation of encoding the PU in each of multiple intra-prediction modes that can be used by the encoding apparatus 100. Through the encoding operation, the optimal intra-prediction mode for a PU having a size of 2N×2N may be derived. The optimal intra-prediction mode may be an intra-prediction mode in which a minimum rate-distortion cost occurs upon encoding the PU having a size of 2N×2N, among multiple intra-prediction modes that can be used by the encoding apparatus 100.

Further, the encoding apparatus 100 may sequentially perform an encoding operation on respective PUs obtained from N×N partitioning. Here, the encoding operation may be the operation of encoding a PU in each of multiple intra-prediction modes that can be used by the encoding apparatus 100. By means of the encoding operation, the optimal intra-prediction mode for the PU having a size of N×N may be derived. The optimal intra-prediction mode may be an intra-prediction mode in which a minimum rate-distortion cost occurs upon encoding the PU having a size of N×N, among multiple intra-prediction modes that can be used by the encoding apparatus 100.

The encoding apparatus 100 may determine which of a PU having a size of 2N×2N and PUs having sizes of N×N to be encoded based on a comparison of a rate-distortion cost of the PU having a size of 2N×2N and a rate-distortion costs of the PUs having sizes of N×N.

A single CU may be partitioned into one or more PUs, and a PU may be partitioned into multiple PUs.

For example, when a single PU is partitioned into four PUs, the horizontal size and vertical size of each of four PUs generated by partitioning may be half the horizontal size and the vertical size of the PU before being partitioned. When a PU having a 32×32 size is partitioned into four PUs, the size of each of four partitioned PUs may be 16×16. When a single PU is partitioned into four PUs, it may be considered that the PU has been partitioned in a quad-tree structure.

For example, when a single PU is partitioned into two PUs, the horizontal size or the vertical size of each of two PUs generated by partitioning may be half the horizontal size or the vertical size of the PU before being partitioned. When a PU having a 32×32 size is vertically partitioned into two PUs, the size of each of two partitioned PUs may be 16×32. When a PU having a 32×32 size is horizontally partitioned into two PUs, the size of each of two partitioned PUs may be 32×16. When a single PU is partitioned into two PUs, it may be considered that the PU has been partitioned in a binary-tree structure.

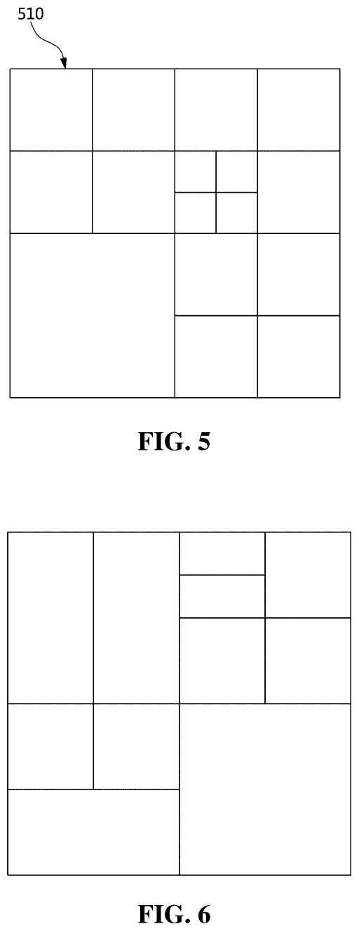

FIG. 5 is a diagram illustrating the form of a Transform Unit that can be included in a Coding Unit.

A Transform Unit (TU) may have a base unit that is used for a procedure, such as transform, quantization, inverse transform, dequantization, entropy encoding, and entropy decoding, in a CU.

A TU may have a square shape or a rectangular shape. A shape of a TU may be determined based on a size and/or a shape of a CU.

Among CUs partitioned from the LCU, a CU which is not partitioned into CUs any further may be partitioned into one or more TUs. Here, the partition structure of a TU may be a quad-tree structure. For example, as shown in FIG. 5, a single CU 510 may be partitioned one or more times depending on the quad-tree structure. By means of this partitioning, the single CU 510 may be composed of TUs having various sizes.

It can be considered that when a single CU is split two or more times, the CU is recursively split. Through splitting, a single CU may be composed of Transform Units (TUs) having various sizes.

Alternatively, a single CU may be split into one or more TUs based on the number of vertical lines and/or horizontal lines that split the CU.

A CU may be split into symmetric TUs or asymmetric TUs. For splitting into asymmetric TUs, information about the size and/or shape of each TU may be signaled from the encoding apparatus 100 to the decoding apparatus 200. Alternatively, the size and/or shape of each TU may be derived from information about the size and/or shape of the CU.

A CU may not be split into TUs. When the CU is not split into TUs, the size of the CU and the size of a TU may be equal to each other.

A single CU may be partitioned into one or more TUs, and a TU may be partitioned into multiple TUs.

For example, when a single TU is partitioned into four TUs, the horizontal size and vertical size of each of four TUs generated by partitioning may be half the horizontal size and the vertical size of the TU before being partitioned. When a TU having a 32×32 size is partitioned into four TUs, the size of each of four partitioned TUs may be 16×16. When a single TU is partitioned into four TUs, it may be considered that the TU has been partitioned in a quad-tree structure.

For example, when a single TU is partitioned into two TUs, the horizontal size or the vertical size of each of two TUs generated by partitioning may be half the horizontal size or the vertical size of the TU before being partitioned. When a TU having a 32×32 size is vertically partitioned into two TUs, the size of each of two partitioned TUs may be 16×32. When a TU having a 32×32 size is horizontally partitioned into two TUs, the size of each of two partitioned TUs may be 32×16. When a single TU is partitioned into two TUs, it may be considered that the TU has been partitioned in a binary-tree structure.

In a way differing from that illustrated in FIG. 5, a CU may be split.

For example, a single CU may be split into three CUs. The horizontal sizes or vertical sizes of the three CUs generated from splitting may be ¼, ½, and ¼, respectively, of the horizontal size or vertical size of the original CU before being split.

For example, when a CU having a 32×32 size is vertically split into three CUs, the sizes of the three CUs generated from the splitting may be 8×32, 16×32, and 8×32, respectively. In this way, when a single CU is split into three CUs, it may be considered that the CU is split in the form of a ternary tree.

One of exemplary splitting forms, that is, quad-tree splitting, binary tree splitting, and ternary tree splitting, may be applied to the splitting of a CU, and multiple splitting schemes may be combined and used together for splitting of a CU. Here, the case where multiple splitting schemes are combined and used together may be referred to as “complex tree-format splitting”.

FIG. 6 illustrates the splitting of a block according to an example.

In a video encoding and/or decoding process, a target block may be split, as illustrated in FIG. 6. For example, the target block may be a CU.

For splitting of the target block, an indicator indicating split information may be signaled from the encoding apparatus 100 to the decoding apparatus 200. The split information may be information indicating how the target block is split.

The split information may be one or more of a split flag (hereinafter referred to as “split_flag”), a quad-binary flag (hereinafter referred to as “QB_flag”), a quad-tree flag (hereinafter referred to as “quadtree_flag”), a binary tree flag (hereinafter referred to as “binarytree_flag”), and a binary type flag (hereinafter referred to as “Btype_flag”).

“split_flag” may be a flag indicating whether a block is split. For example, a split_flag value of 1 may indicate that the corresponding block is split. A split_flag value of 0 may indicate that the corresponding block is not split.

“QB_flag” may be a flag indicating which one of a quad-tree form and a binary tree form corresponds to the shape in which the block is split. For example, a QB_flag value of 0 may indicate that the block is split in a quad-tree form. A QB_flag value of 1 may indicate that the block is split in a binary tree form. Alternatively, a QB_flag value of 0 may indicate that the block is split in a binary tree form. A QB_flag value of 1 may indicate that the block is split in a quad-tree form.

“quadtree_flag” may be a flag indicating whether a block is split in a quad-tree form. For example, a quadtree_flag value of 1 may indicate that the block is split in a quad-tree form. A quadtree_flag value of 0 may indicate that the block is not split in a quad-tree form.

“binarytree_flag” may be a flag indicating whether a block is split in a binary tree form. For example, a binarytree_flag value of 1 may indicate that the block is split in a binary tree form. A binarytree_flag value of 0 may indicate that the block is not split in a binary tree form.

“Btype_flag” may be a flag indicating which one of a vertical split and a horizontal split corresponds to a split direction when a block is split in a binary tree form. For example, a Btype_flag value of 0 may indicate that the block is split in a horizontal direction. A Btype_flag value of 1 may indicate that a block is split in a vertical direction. Alternatively, a Btype_flag value of 0 may indicate that the block is split in a vertical direction. A Btype_flag value of 1 may indicate that a block is split in a horizontal direction.

For example, the split information of the block in FIG. 6 may be derived by signaling at least one of quadtree_flag, binarytree_flag, and Btype_flag, as shown in the following Table 1.

TABLE 1

| quadtree_flag | binarytree_flag | Btype_flag |
|---|---|---|
| 1 | | |
| 0 | | |
| | 1 | |
| | | 1 |
| | 0 | |
| | 0 | |
| 1 | | |
| 0 | | |
| | 1 | |
| | | 0 |
| | 0 | |
| | 0 | |
| 0 | | |
| | 0 | |
| 0 | | |
| | 0 | |
| 0 | | |
| | 0 | |
| 0 | | |
| | 1 | |
| | | 0 |
| | 1 | |
| | | 1 |
| | 0 | |
| | 0 | |
| | 0 | |
| 0 | | |
| | 0 | |

For example, the split information of the block in FIG. 6 may be derived by signaling at least one of split-flag, QB-flag and Btype-flag, as shown in the following Table 2.

TABLE 2

| split_flag | QB_flag | Btype_flag |
|---|---|---|
| 1 | | |
| | 0 | |
| 1 | | |
| | 1 | |
| | | 1 |
| 0 | | |
| 0 | | |
| 1 | | |
| | 0 | |
| 1 | | |
| | 1 | |
| | | 0 |
| 0 | | |
| 0 | | |
| 0 | | |
| 0 | | |
| 0 | | |
| 1 | | |
| | 1 | |
| | | 0 |
| 1 | | |
| | | 1 |
| 0 | | |
| 0 | | |
| 0 | | |
| 0 | | |

The splitting method may be limited only to a quad-tree or to a binary tree depending on the size and/or shape of the block. When this limitation is applied, split-flag may be a flag indicating whether a block is split in a quad-tree form or a flag indicating whether a block is split in a binary tree form. The size and shape of a block may be derived depending on the depth information of the block, and the depth information may be signaled from the encoding apparatus 100 to the decoding apparatus 200.

When the size of a block falls within a specific range, only splitting in a quad-tree form may be possible. For example, the specific range may be defined by at least one of a maximum block size and a minimum block size at which only splitting in a quad-tree form is possible.

Information indicating the maximum block size and the minimum block size at which only splitting in a quad-tree form is possible may be signaled from the encoding apparatus 100 to the decoding apparatus 200 through a bitstream. Further, this information may be signaled for at least one of units such as a video, a sequence, a picture, a parameter, a tile group, and a slice (or a segment).

Alternatively, the maximum block size and/or the minimum block size may be fixed sizes predefined by the encoding apparatus 100 and the decoding apparatus 200. For example, when the size of a block is above 64×64 and below 256×256, only splitting in a quad-tree form may be possible. In this case, split_flag may be a flag indicating whether splitting in a quad-tree form is performed.

When the size of a block is greater than the maximum size of a transform block, only partitioning in a quad-tree form may be possible. Here, a subblock resulting from partitioning may be at least one of a CU and a TU.

In this case, split_flag may be a flag indicating whether a CU is partitioned in a quad-tree form.

When the size of a block falls within the specific range, only splitting in a binary tree form or a ternary tree form may be possible. For example, the specific range may be defined by at least one of a maximum block size and a minimum block size at which only splitting in a binary tree form or a ternary tree form is possible.

Information indicating the maximum block size and/or the minimum block size at which only splitting in a binary tree form or splitting in a ternary tree form is possible may be signaled from the encoding apparatus 100 to the decoding apparatus 200 through a bitstream. Further, this information may be signaled for at least one of units such as a sequence, a picture, and a slice (or a segment).

Alternatively, the maximum block size and/or the minimum block size may be fixed sizes predefined by the encoding apparatus 100 and the decoding apparatus 200. For example, when the size of a block is above 8×8 and below 16×16, only splitting in a binary tree form may be possible. In this case, split_flag may be a flag indicating whether splitting in a binary tree form or a ternary tree form is performed.

The above description of partitioning in a quad-tree form may be equally applied to a binary-tree form and/or a ternary-tree form.

The partition of a block may be limited by a previous partition. For example, when a block is partitioned in a specific binary-tree form and then multiple subblocks are generated from the partitioning, each subblock may be additionally partitioned only in a specific tree form.

Here, the specific tree form may be at least one of a binary-tree form, a ternary-tree form, and a quad-tree form.

When the horizontal size or vertical size of a partition block is a size that cannot be split further, the above-described indicator may not be signaled.

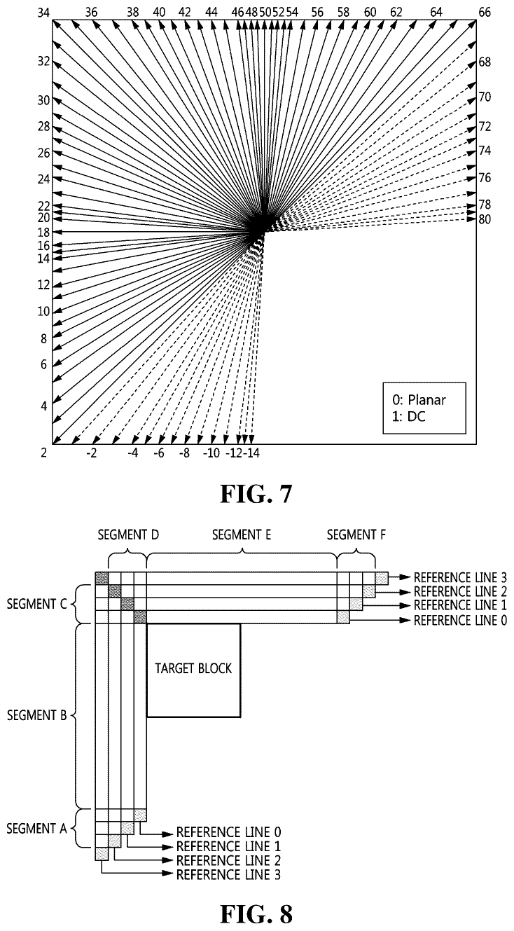

FIG. 7 is a diagram for explaining an embodiment of an intra-prediction process.

Arrows radially extending from the center of the graph in FIG. 7 indicate the prediction directions of intra-prediction modes. Further, numbers appearing near the arrows indicate examples of mode values assigned to intra-prediction modes or to the prediction directions of the intra-prediction modes.

In FIG. 7, A number 0 may represent a Planar mode which is a non-directional intra prediction mode. A number 1 may represent a DC mode which is a non-directional intra prediction mode

Intra encoding and/or decoding may be performed using a reference sample of neighbor block of a target block. The neighbor block may be a reconstructed neighbor block. The reference sample may mean a neighbor sample.

For example, intra encoding and/or decoding may be performed using the value of a reference sample which are included in are reconstructed neighbor block or the coding parameters of the reconstructed neighbor block.

The encoding apparatus 100 and/or the decoding apparatus 200 may generate a prediction block by performing intra prediction on a target block based on information about samples in a target image. When intra prediction is performed, the encoding apparatus 100 and/or the decoding apparatus 200 may generate a prediction block for the target block by performing intra prediction based on information about samples in the target image. When intra prediction is performed, the encoding apparatus 100 and/or the decoding apparatus 200 may perform directional prediction and/or non-directional prediction based on at least one reconstructed reference sample.

A prediction block may be a block generated as a result of performing intra prediction.

A prediction block may correspond to at least one of a CU, a PU, and a TU.

The unit of a prediction block may have a size corresponding to at least one of a CU, a PU, and a TU. The prediction block may have a square shape having a size of 2N×2N or N×N. The size of N×N may include sizes of 4×4, 8×8, 16×16, 32×32, 64×64, or the like.

Alternatively, a prediction block may a square block having a size of 2×2, 4×4, 8×8, 16×16, 32×32, 64×64 or the like or a rectangular block having a size of 2×8, 4×8, 2×16, 4×16, 8×16, or the like.

Intra prediction may be performed in consideration of the intra-prediction mode for the target block. The number of intra-prediction modes that the target block can have may be a predefined fixed value, and may be a value determined differently depending on the attributes of a prediction block. For example, the attributes of the prediction block may include the size of the prediction block, the type of prediction block, etc. Further, the attribute of a prediction block may indicate a coding parameter for the prediction block.

For example, the number of intra-prediction modes may be fixed at N regardless of the size of a prediction block. Alternatively, the number of intra-prediction modes may be, for example, 3, 5, 9, 17, 34, 35, 36, 65, 67 or 95.

The intra-prediction modes may be non-directional modes or directional modes.

For example, the intra-prediction modes may include two non-directional modes and 65 directional modes corresponding to numbers 0 to 66 illustrated in FIG. 7.

For example, the intra-prediction modes may include two non-directional modes and 93 directional modes corresponding to numbers −14 to 80 illustrated in FIG. 7 in a case that a specific intra prediction method is used.

The two non-directional modes may include a DC mode and a planar mode.

A directional mode may be a prediction mode having a specific direction or a specific angle. The directional mode may also be referred to as an “angular mode”.

An intra-prediction mode may be represented by at least one of a mode number, a mode value, a mode angle, and a mode direction. In other words, the terms “(mode) number of the intra-prediction mode”, “(mode) value of the intra-prediction mode”, “(mode) angle of the intra-prediction mode”, and “(mode) direction of the intra-prediction mode” may be used to have the same meaning, and may be used interchangeably with each other.

The number of intra-prediction modes may be M. The value of M may be 1 or more. In other words, the number of intra-prediction modes may be M, which includes the number of non-directional modes and the number of directional modes.

The number of intra-prediction modes may be fixed to M regardless of the size and/or the color component of a block. For example, the number of intra-prediction modes may be fixed at any one of 35 and 67 regardless of the size of a block.

Alternatively, the number of intra-prediction modes may differ depending on the shape, the size and/or the type of the color component of a block.

For example, in FIG. 7, directional prediction modes illustrated as dashed lines may be applied only for a prediction for a non-square block.

For example, the larger the size of the block, the greater the number of intra-prediction modes. Alternatively, the larger the size of the block, the smaller the number of intra-prediction modes. When the size of the block is 4×4 or 8×8, the number of intra-prediction modes may be 67. When the size of the block is 16×16, the number of intra-prediction modes may be 35. When the size of the block is 32×32, the number of intra-prediction modes may be 19. When the size of a block is 64×64, the number of intra-prediction modes may be 7.

For example, the number of intra prediction modes may differ depending on whether a color component is a luma signal or a chroma signal. Alternatively, the number of intra-prediction modes corresponding to a luma component block may be greater than the number of intra-prediction modes corresponding to a chroma component block.

For example, in a vertical mode having a mode value of 50, prediction may be performed in a vertical direction based on the pixel value of a reference sample. For example, in a horizontal mode having a mode value of 18, prediction may be performed in a horizontal direction based on the pixel value of a reference sample.

Even in directional modes other than the above-described mode, the encoding apparatus 100 and the decoding apparatus 200 may perform intra prediction on a target unit using reference samples depending on angles corresponding to the directional modes.

Intra-prediction modes located on a right side with respect to the vertical mode may be referred to as ‘vertical-right modes’. Intra-prediction modes located below the horizontal mode may be referred to as ‘horizontal-below modes’. For example, in FIG. 7, the intra-prediction modes in which a mode value is one of 51, 52, 53, 54, 55, 56, 57, 58, 59, 60, 61, 62, 63, 64, 65, and 66 may be vertical-right modes. Intra-prediction modes in which a mode value is one of 2, 3, 4, 5, 6, 7, 8, 9, 10, 11, 12, 13, 14, 15, 16, and 17 may be horizontal-below modes.

The non-directional mode may include a DC mode and a planar mode. For example, a value of the DC mode may be 1. A value of the planar mode may be 0.

The directional mode may include an angular mode. Among the plurality of the intra prediction modes, remaining modes except for the DC mode and the planar mode may be directional modes.

When the intra-prediction mode is a DC mode, a prediction block may be generated based on the average of pixel values of a plurality of reference pixels. For example, a value of a pixel of a prediction block may be determined based on the average of pixel values of a plurality of reference pixels.

The number of above-described intra-prediction modes and the mode values of respective intra-prediction modes are merely exemplary. The number of above-described intra-prediction modes and the mode values of respective intra-prediction modes may be defined differently depending on the embodiments, implementation and/or requirements.

In order to perform intra prediction on a target block, the step of checking whether samples included in a reconstructed neighbor block can be used as reference samples of a target block may be performed. When a sample that cannot be used as a reference sample of the target block is present among samples in the neighbor block, a value generated via copying and/or interpolation that uses at least one sample value, among the samples included in the reconstructed neighbor block, may replace the sample value of the sample that cannot be used as the reference sample. When the value generated via copying and/or interpolation replaces the sample value of the existing sample, the sample may be used as the reference sample of the target block.

When intra prediction is used, a filter may be applied to at least one of a reference sample and a prediction sample based on at least one of the intra-prediction mode and the size of the target block.

The type of filter to be applied to at least one of a reference sample and a prediction sample may differ depending on at least one of the intra-prediction mode of a target block, the size of the target block, and the shape of the target block. The types of filters may be classified depending on one or more of the length of filter tap, the value of a filter coefficient, and filter strength. The length of filter tap may mean the number of filter taps. Also, the number of filter tap may mean the length of the filter.

When the intra-prediction mode is a planar mode, a sample value of a prediction target block may be generated using a weighted sum of an above reference sample of the target block, a left reference sample of the target block, an above-right reference sample of the target block, and a below-left reference sample of the target block depending on the location of the prediction target sample in the prediction block when the prediction block of the target block is generated.

When the intra-prediction mode is a DC mode, the average of reference samples above the target block and the reference samples to the left of the target block may be used when the prediction block of the target block is generated. Also, filtering using the values of reference samples may be performed on specific rows or specific columns in the target block. The specific rows may be one or more upper rows adjacent to the reference sample. The specific columns may be one or more left columns adjacent to the reference sample.

When the intra-prediction mode is a directional mode, a prediction block may be generated using the above reference samples, left reference samples, above-right reference sample and/or below-left reference sample of the target block.

In order to generate the above-described prediction sample, real-number-based interpolation may be performed.

The intra-prediction mode of the target block may be predicted from intra prediction mode of a neighbor block adjacent to the target block, and the information used for prediction may be entropy-encoded/decoded.

For example, when the intra-prediction modes of the target block and the neighbor block are identical to each other, it may be signaled, using a predefined flag, that the intra-prediction modes of the target block and the neighbor block are identical.

For example, an indicator for indicating an intra-prediction mode identical to that of the target block, among intra-prediction modes of multiple neighbor blocks, may be signaled.

When the intra-prediction modes of the target block and a neighbor block are different from each other, information about the intra-prediction mode of the target block may be encoded and/or decoded using entropy encoding and/or decoding.

FIG. 8 is a diagram illustrating reference samples used in an intra-prediction procedure.

Reconstructed reference samples used for intra prediction of the target block may include below-left reference samples, left reference samples, an above-left corner reference sample, above reference samples, and above-right reference samples.

For example, the left reference samples may mean reconstructed reference pixels adjacent to the left side of the target block. The above reference samples may mean reconstructed reference pixels adjacent to the top of the target block. The above-left corner reference sample may mean a reconstructed reference pixel located at the above-left corner of the target block. The below-left reference samples may mean reference samples located below a left sample line composed of the left reference samples, among samples located on the same line as the left sample line. The above-right reference samples may mean reference samples located to the right of an above sample line composed of the above reference samples, among samples located on the same line as the above sample line.

When the size of a target block is N×N, the numbers of the below-left reference samples, the left reference samples, the above reference samples, and the above-right reference samples may each be N.

By performing intra prediction on the target block, a prediction block may be generated. The generation of the prediction block may include the determination of the values of pixels in the prediction block. The sizes of the target block and the prediction block may be equal.

The reference samples used for intra prediction of the target block may vary depending on the intra-prediction mode of the target block. The direction of the intra-prediction mode may represent a dependence relationship between the reference samples and the pixels of the prediction block. For example, the value of a specified reference sample may be used as the values of one or more specified pixels in the prediction block. In this case, the specified reference sample and the one or more specified pixels in the prediction block may be the sample and pixels which are positioned in a straight line in the direction of an intra-prediction mode. In other words, the value of the specified reference sample may be copied as the value of a pixel located in a direction reverse to the direction of the intra-prediction mode. Alternatively, the value of a pixel in the prediction block may be the value of a reference sample located in the direction of the intra-prediction mode with respect to the location of the pixel.

In an example, when the intra-prediction mode of a target block is a vertical mode, the above reference samples may be used for intra prediction. When the intra-prediction mode is the vertical mode, the value of a pixel in the prediction block may be the value of a reference sample vertically located above the location of the pixel. Therefore, the above reference samples adjacent to the top of the target block may be used for intra prediction. Furthermore, the values of pixels in one row of the prediction block may be identical to those of the above reference samples.

In an example, when the intra-prediction mode of a target block is a horizontal mode, the left reference samples may be used for intra prediction. When the intra-prediction mode is the horizontal mode, the value of a pixel in the prediction block may be the value of a reference sample horizontally located left to the location of the pixel. Therefore, the left reference samples adjacent to the left of the target block may be used for intra prediction. Furthermore, the values of pixels in one column of the prediction block may be identical to those of the left reference samples.

In an example, when the mode value of the intra-prediction mode of the current block is 34, at least some of the left reference samples, the above-left corner reference sample, and at least some of the above reference samples may be used for intra prediction. When the mode value of the intra-prediction mode is 34, the value of a pixel in the prediction block may be the value of a reference sample diagonally located at the above-left corner of the pixel.

Further, At least a part of the above-right reference samples may be used for intra prediction in a case that an intra prediction mode of which a mode value is a value ranging from 52 to 66.

Further, At least a part of the below-left reference samples may be used for intra prediction in a case that an intra prediction mode of which a mode value is a value ranging from 2 to 17.

Further, the above-left corner reference sample may be used for intra prediction in a case that an intra prediction mode of which a mode value is a value ranging from 19 to 49.

The number of reference samples used to determine the pixel value of one pixel in the prediction block may be either 1, or 2 or more.

As described above, the pixel value of a pixel in the prediction block may be determined depending on the location of the pixel and the location of a reference sample indicated by the direction of the intra-prediction mode. When the location of the pixel and the location of the reference sample indicated by the direction of the intra-prediction mode are integer positions, the value of one reference sample indicated by an integer position may be used to determine the pixel value of the pixel in the prediction block.

When the location of the pixel and the location of the reference sample indicated by the direction of the intra-prediction mode are not integer positions, an interpolated reference sample based on two reference samples closest to the location of the reference sample may be generated. The value of the interpolated reference sample may be used to determine the pixel value of the pixel in the prediction block. In other words, when the location of the pixel in the prediction block and the location of the reference sample indicated by the direction of the intra-prediction mode indicate the location between two reference samples, an interpolated value based on the values of the two samples may be generated.

The prediction block generated via prediction may not be identical to an original target block. In other words, there may be a prediction error which is the difference between the target block and the prediction block, and there may also be a prediction error between the pixel of the target block and the pixel of the prediction block.

Hereinafter, the terms “difference”, “error”, and “residual” may be used to have the same meaning, and may be used interchangeably with each other.

For example, in the case of directional intra prediction, the longer the distance between the pixel of the prediction block and the reference sample, the greater the prediction error that may occur. Such a prediction error may result in discontinuity between the generated prediction block and neighbor blocks.

In order to reduce the prediction error, filtering for the prediction block may be used. Filtering may be configured to adaptively apply a filter to an area, regarded as having a large prediction error, in the prediction block. For example, the area regarded as having a large prediction error may be the boundary of the prediction block. Further, an area regarded as having a large prediction error in the prediction block may differ depending on the intra-prediction mode, and the characteristics of filters may also differ depending thereon.

As illustrated in FIG. 8, for intra prediction of a target block, at least one of reference line 0 to reference line 3 may be used.

Each reference line in FIG. 8 may indicate a reference sample line comprising one or more reference samples. As the number of the reference line is lower, a line of reference samples closer to a target block may be indicated.

Samples in segment A and segment F may be acquired through padding that uses samples closest to the target block in segment B and segment E instead of being acquired from reconstructed neighbor blocks.

Index information indicating a reference sample line to be used for intra-prediction of the target block may be signaled. The index information may indicate a reference sample line to be used for intra-prediction of the target block, among multiple reference sample lines. For example, the index information may have a value corresponding to any one of 0 to 3.

When the top boundary of the target block is the boundary of a CTU, only reference sample line 0 may be available. Therefore, in this case, index information may not be signaled.

When an additional reference sample line other than reference sample line 0 is used, filtering of a prediction block, which will be described later, may not be performed.

In the case of inter-color intra prediction, a prediction block for a target block of a second color component may be generated based on the corresponding reconstructed block of a first color component.

For example, the first color component may be a luma component, and the second color component may be a chroma component.

In order to perform inter-color intra prediction, parameters for a linear model between the first color component and the second color component may be derived based on a template.

The template may include reference samples above the target block (above reference samples) and/or reference samples to the left of the target block (left reference samples), and may include above reference samples and/or left reference samples of a reconstructed block of the first color component, which correspond to the reference samples.

For example, parameters for a linear model may be derived using 1) the value of the sample of a first color component having the maximum value, among the samples in the template, 2) the value of the sample of a second color component corresponding to the sample of the first color component, 3) the value of the sample of a first color component having the minimum value, among the samples in the template, and 4) the value of the sample of a second color component corresponding to the sample of the first color component.

When the parameters for the linear model are derived, a prediction block for the target block may be generated by applying the corresponding reconstructed block to the linear model.

Depending on the image format, sub-sampling may be performed on samples adjacent to the reconstructed block of the first color component and the corresponding reconstructed block of the first color component. For example, when one sample of the second color component corresponds to four samples of the first color component, one corresponding sample may be calculated by performing sub-sampling on the four samples of the first color component. When sub-sampling is performed, derivation of the parameters for the linear model and inter-color intra prediction may be performed based on the sub-sampled corresponding sample.

Information about whether inter-color intra prediction is performed and/or the range of the template may be signaled in an intra-prediction mode.

The target block may be partitioned into two or four subblocks in a horizontal direction and/or a vertical direction.

The subblocks resulting from the partitioning may be sequentially reconstructed. That is, as intra-prediction is performed on each subblock, a sub-prediction block for the subblock may be generated. Also, as dequantization (inverse quantization) and/or an inverse transform are performed on each subblock, a sub-residual block for the corresponding subblock may be generated. A reconstructed subblock may be generated by adding the sub-prediction block to the sub-residual block. The reconstructed subblock may be used as a reference sample for intra prediction of the subblock having the next priority.

A subblock may be a block including a specific number (e.g., 16) of samples or more. For example, when the target block is an 8×4 block or a 4×8 block, the target block may be partitioned into two subblocks. Also, when the target block is a 4×4 block, the target block cannot be partitioned into subblocks. When the target block has another size, the target block may be partitioned into four subblocks.

Information about whether intra prediction based on such subblocks is performed and/or information about a partition direction (horizontal direction or vertical direction) may be signaled.

Such subblock-based intra prediction may be limited such that it is performed only when reference sample line 0 is used. When subblock-based intra-prediction is performed, filtering of a prediction block, which will be described below, may not be performed.

A final prediction block may be generated by performing filtering on the prediction block generated via intra prediction.

Filtering may be performed by applying specific weights to a filtering target sample, which is the target to be filtered, a left reference sample, an above reference sample, and/or an above-left reference sample.

The weights and/or reference samples (e.g., the range of reference samples, the locations of the reference samples, etc.) used for filtering may be determined based on at least one of a block size, an intra-prediction mode, and the location of the filtering target sample in a prediction block.

For example, filtering may be performed only in a specific intra-prediction mode (e.g., DC mode, planar mode, vertical mode, horizontal mode, diagonal mode and/or adjacent diagonal mode).

The adjacent diagonal mode may be a mode having a number obtained by adding k to the number of the diagonal mode, and may be a mode having a number obtained by subtracting k from the number of the diagonal mode. In other words, the number of the adjacent diagonal mode may be the sum of the number of the diagonal mode and k, or may be the difference between the number of the diagonal mode and k. For example, k may be a positive integer of 8 or less.

The intra-prediction mode of a target block may be derived using the intra-prediction mode of a neighboring block present around the target block, and such a derived intra-prediction mode may be entropy-encoded and/or entropy-decoded.

For example, when the intra-prediction mode of the target block is identical to the intra-prediction mode of the neighbor block, information indicating that the intra-prediction mode of the target block is identical to the intra-prediction mode of the neighbor block may be signaled using specific flag information.

Further, for example, indicator information for a neighbor block having an intra-prediction mode identical to the intra-prediction mode of the target block, among intra-prediction modes of multiple neighbor blocks, may be signaled.

For example, when the intra-prediction mode of the target block is different from the intra-prediction mode of the neighbor block, entropy encoding and/or entropy decoding may be performed on information about the intra-prediction mode of the target block by performing entropy encoding and/or entropy decoding based on the intra-prediction mode of the neighbor block.

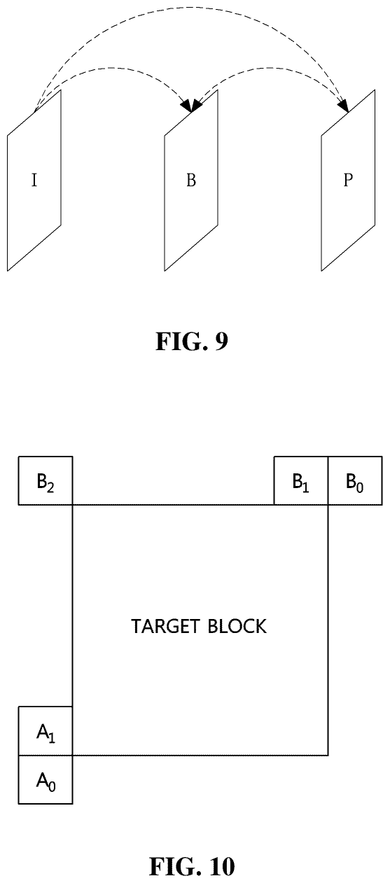

FIG. 9 is a diagram for explaining an embodiment of an inter prediction procedure.

The rectangles shown in FIG. 9 may represent images (or pictures). Further, in FIG. 9, arrows may represent prediction directions. An arrow pointing from a first picture to a second picture means that the second picture refers to the first picture. That is, each image may be encoded and/or decoded depending on the prediction direction.

Images may be classified into an Intra Picture (I picture), a Uni-prediction Picture or Predictive Coded Picture (P picture), and a Bi-prediction Picture or Bi-predictive Coded Picture (B picture) depending on the encoding type. Each picture may be encoded and/or decoded depending on the encoding type thereof.

When a target image that is the target to be encoded is an I picture, the target image may be encoded using data contained in the image itself without inter prediction that refers to other images. For example, an I picture may be encoded only via intra prediction.

When a target image is a P picture, the target image may be encoded via inter prediction, which uses reference pictures existing in one direction. Here, the one direction may be a forward direction or a backward direction.

When a target image is a B picture, the image may be encoded via inter prediction that uses reference pictures existing in two directions, or may be encoded via inter prediction that uses reference pictures existing in one of a forward direction and a backward direction. Here, the two directions may be the forward direction and the backward direction.

A P picture and a B picture that are encoded and/or decoded using reference pictures may be regarded as images in which inter prediction is used.

Below, inter prediction in an inter mode according to an embodiment will be described in detail.

Inter prediction or a motion compensation may be performed using a reference image and motion information.

In an inter mode, the encoding apparatus 100 may perform inter prediction and/or motion compensation on a target block. The decoding apparatus 200 may perform inter prediction and/or motion compensation, corresponding to inter prediction and/or motion compensation performed by the encoding apparatus 100, on a target block.

Motion information of the target block may be individually derived by the encoding apparatus 100 and the decoding apparatus 200 during the inter prediction. The motion information may be derived using motion information of a reconstructed neighbor block, motion information of a col block, and/or motion information of a block adjacent to the col block.

For example, the encoding apparatus 100 or the decoding apparatus 200 may perform prediction and/or motion compensation by using motion information of a spatial candidate and/or a temporal candidate as motion information of the target block. The target block may mean a PU and/or a PU partition.

A spatial candidate may be a reconstructed block which is spatially adjacent to the target block.

A temporal candidate may be a reconstructed block corresponding to the target block in a previously reconstructed co-located picture (col picture).

In inter prediction, the encoding apparatus 100 and the decoding apparatus 200 may improve encoding efficiency and decoding efficiency by utilizing the motion information of a spatial candidate and/or a temporal candidate. The motion information of a spatial candidate may be referred to as ‘spatial motion information’. The motion information of a temporal candidate may be referred to as ‘temporal motion information’.

Below, the motion information of a spatial candidate may be the motion information of a PU including the spatial candidate. The motion information of a temporal candidate may be the motion information of a PU including the temporal candidate. The motion information of a candidate block may be the motion information of a PU including the candidate block.

Inter prediction may be performed using a reference picture.

The reference picture may be at least one of a picture previous to a target picture and a picture subsequent to the target picture. The reference picture may be an image used for the prediction of the target block.

In inter prediction, a region in the reference picture may be specified by utilizing a reference picture index (or refIdx) for indicating a reference picture, a motion vector, which will be described later, etc. Here, the region specified in the reference picture may indicate a reference block.

Inter prediction may select a reference picture, and may also select a reference block corresponding to the target block from the reference picture. Further, inter prediction may generate a prediction block for the target block using the selected reference block.

The motion information may be derived during inter prediction by each of the encoding apparatus 100 and the decoding apparatus 200.

A spatial candidate may be a block 1) which is present in a target picture, 2) which has been previously reconstructed via encoding and/or decoding, and 3) which is adjacent to the target block or is located at the corner of the target block. Here, the “block located at the corner of the target block” may be either a block vertically adjacent to a neighbor block that is horizontally adjacent to the target block, or a block horizontally adjacent to a neighbor block that is vertically adjacent to the target block. Further, “block located at the corner of the target block” may have the same meaning as “block adjacent to the corner of the target block”. The meaning of “block located at the corner of the target block” may be included in the meaning of “block adjacent to the target block”.

For example, a spatial candidate may be a reconstructed block located to the left of the target block, a reconstructed block located above the target block, a reconstructed block located at the below-left corner of the target block, a reconstructed block located at the above-right corner of the target block, or a reconstructed block located at the above-left corner of the target block.

Each of the encoding apparatus 100 and the decoding apparatus 200 may identify a block present at the location spatially corresponding to the target block in a col picture. The location of the target block in the target picture and the location of the identified block in the col picture may correspond to each other.

Each of the encoding apparatus 100 and the decoding apparatus 200 may determine a col block present at the predefined relative location for the identified block to be a temporal candidate. The predefined relative location may be a location present inside and/or outside the identified block.

For example, the col block may include a first col block and a second col block. When the coordinates of the identified block are (xP, yP) and the size of the identified block is represented by (nPSW, nPSH), the first col block may be a block located at coordinates (xP+nPSW, yP+nPSH). The second col block may be a block located at coordinates (xP+(nPSW>>1), yP+(nPSH>>1)). The second col block may be selectively used when the first col block is unavailable.

The motion vector of the target block may be determined based on the motion vector of the col block. Each of the encoding apparatus 100 and the decoding apparatus 200 may scale the motion vector of the col block. The scaled motion vector of the col block may be used as the motion vector of the target block. Further, a motion vector for the motion information of a temporal candidate stored in a list may be a scaled motion vector.

The ratio of the motion vector of the target block to the motion vector of the col block may be identical to the ratio of a first temporal distance to a second temporal distance. The first temporal distance may be the distance between the reference picture and the target picture of the target block. The second temporal distance may be the distance between the reference picture and the col picture of the col block.

The scheme for deriving motion information may change depending on the inter-prediction mode of a target block. For example, as inter-prediction modes applied for inter prediction, an Advanced Motion Vector Predictor (AMVP) mode, a merge mode, a skip mode, a merge mode with a motion vector difference, a sub block merge mode, a triangle partition mode, an inter-intra combined prediction mode, an affine inter mode, a current picture reference mode, etc. may be present. The merge mode may also be referred to as a “motion merge mode”. Individual modes will be described in detail below.

### 1) AMVP Mode

When an AMVP mode is used, the encoding apparatus 100 may search a neighbor region of a target block for a similar block. The encoding apparatus 100 may acquire a prediction block by performing prediction on the target block using motion information of the found similar block. The encoding apparatus 100 may encode a residual block, which is the difference between the target block and the prediction block.

### 1-1) Creation of List of Prediction Motion Vector Candidates

When an AMVP mode is used as the prediction mode, each of the encoding apparatus 100 and the decoding apparatus 200 may create a list of prediction motion vector candidates using the motion vector of a spatial candidate, the motion vector of a temporal candidate, and a zero vector. The prediction motion vector candidate list may include one or more prediction motion vector candidates. At least one of the motion vector of a spatial candidate, the motion vector of a temporal candidate, and a zero vector may be determined and used as a prediction motion vector candidate.

Hereinafter, the terms “prediction motion vector (candidate)” and “motion vector (candidate)” may be used to have the same meaning, and may be used interchangeably with each other.

Hereinafter, the terms “prediction motion vector candidate” and “AMVP candidate” may be used to have the same meaning, and may be used interchangeably with each other.

Hereinafter, the terms “prediction motion vector candidate list” and “AMVP candidate list” may be used to have the same meaning, and may be used interchangeably with each other.

Spatial candidates may include a reconstructed spatial neighbor block. In other words, the motion vector of the reconstructed neighbor block may be referred to as a “spatial prediction motion vector candidate”.

Temporal candidates may include a col block and a block adjacent to the col block. In other words, the motion vector of the col block or the motion vector of the block adjacent to the col block may be referred to as a “temporal prediction motion vector candidate”.

The zero vector may be a (0, 0) motion vector.

The prediction motion vector candidates may be motion vector predictors for predicting a motion vector. Also, in the encoding apparatus 100, each prediction motion vector candidate may be an initial search location for a motion vector.

1-2) Search for Motion Vectors that Use List of Prediction Motion Vector Candidates

The encoding apparatus 100 may determine the motion vector to be used to encode a target block within a search range using a list of prediction motion vector candidates. Further, the encoding apparatus 100 may determine a prediction motion vector candidate to be used as the prediction motion vector of the target block, among prediction motion vector candidates present in the prediction motion vector candidate list.

The motion vector to be used to encode the target block may be a motion vector that can be encoded at minimum cost.

Further, the encoding apparatus 100 may determine whether to use the AMVP mode to encode the target block.

### 1-3) Transmission of Inter-Prediction Information

The encoding apparatus 100 may generate a bitstream including inter-prediction information required for inter prediction. The decoding apparatus 200 may perform inter prediction on the target block using the inter-prediction information of the bitstream.

The inter-prediction information may contain 1) mode information indicating whether an AMVP mode is used, 2) a prediction motion vector index, 3) a Motion Vector Difference (MVD), 4) a reference direction, and 5) a reference picture index.

Hereinafter, the terms “prediction motion vector index” and “AMVP index” may be used to have the same meaning, and may be used interchangeably with each other.

Further, the inter-prediction information may contain a residual signal.

The decoding apparatus 200 may acquire a prediction motion vector index, an MVD, a reference direction, and a reference picture index from the bitstream through entropy decoding when mode information indicates that the AMVP mode is used.

The prediction motion vector index may indicate a prediction motion vector candidate to be used for the prediction of a target block, among prediction motion vector candidates included in the prediction motion vector candidate list.

1-4) Inter Prediction in AMVP Mode that Uses Inter-Prediction Information

The decoding apparatus 200 may derive prediction motion vector candidates using a prediction motion vector candidate list, and may determine the motion information of a target block based on the derived prediction motion vector candidates.

The decoding apparatus 200 may determine a motion vector candidate for the target block, among the prediction motion vector candidates included in the prediction motion vector candidate list, using a prediction motion vector index. The decoding apparatus 200 may select a prediction motion vector candidate, indicated by the prediction motion vector index, from among prediction motion vector candidates included in the prediction motion vector candidate list, as the prediction motion vector of the target block.

The encoding apparatus 100 may generate an entropy-encoded prediction motion vector index by applying entropy encoding to a prediction motion vector index, and may generate a bitstream including the entropy-encoded prediction motion vector index. The entropy-encoded prediction motion vector index may be signaled from the encoding apparatus 100 to the decoding apparatus 200 through a bitstream. The decoding apparatus 200 may extract the entropy-encoded prediction motion vector index from the bitstream, and may acquire the prediction motion vector index by applying entropy decoding to the entropy-encoded prediction motion vector index.

The motion vector to be actually used for inter prediction of the target block may not match the prediction motion vector. In order to indicate the difference between the motion vector to be actually used for inter prediction of the target block and the prediction motion vector, an MVD may be used. The encoding apparatus 100 may derive a prediction motion vector similar to the motion vector to be actually used for inter prediction of the target block so as to use an MVD that is as small as possible.

A Motion Vector Difference (MVD) may be the difference between the motion vector of the target block and the prediction motion vector. The encoding apparatus 100 may calculate the MVD, and may generate an entropy-encoded MVD by applying entropy encoding to the MVD. The encoding apparatus 100 may generate a bitstream including the entropy-encoded MVD.

The MVD may be transmitted from the encoding apparatus 100 to the decoding apparatus 200 through the bitstream. The decoding apparatus 200 may extract the entropy-encoded MVD from the bitstream, and may acquire the MVD by applying entropy decoding to the entropy-encoded MVD.

The decoding apparatus 200 may derive the motion vector of the target block by summing the MVD and the prediction motion vector. In other words, the motion vector of the target block derived by the decoding apparatus 200 may be the sum of the MVD and the motion vector candidate.

Also, the encoding apparatus 100 may generate entropy-encoded MVD resolution information by applying entropy encoding to calculated MVD resolution information, and may generate a bitstream including the entropy-encoded MVD resolution information. The decoding apparatus 200 may extract the entropy-encoded MVD resolution information from the bitstream, and may acquire MVD resolution information by applying entropy decoding to the entropy-encoded MVD resolution information. The decoding apparatus 200 may adjust the resolution of the MVD using the MVD resolution information.

Meanwhile, the encoding apparatus 100 may calculate an MVD based on an affine model. The decoding apparatus 200 may derive the affine control motion vector of the target block through the sum of the MVD and an affine control motion vector candidate, and may derive the motion vector of a subblock using the affine control motion vector.

The reference direction may indicate a list of reference pictures to be used for prediction of the target block. For example, the reference direction may indicate one of a reference picture list L0 and a reference picture list L1.

The reference direction merely indicates the reference picture list to be used for prediction of the target block, and may not mean that the directions of reference pictures are limited to a forward direction or a backward direction. In other words, each of the reference picture list L0 and the reference picture list L1 may include pictures in a forward direction and/or a backward direction.

That the reference direction is unidirectional may mean that a single reference picture list is used. That the reference direction is bidirectional may mean that two reference picture lists are used. In other words, the reference direction may indicate one of the case where only the reference picture list L0 is used, the case where only the reference picture list L1 is used, and the case where two reference picture lists are used.

The reference picture index may indicate a reference picture that is used for prediction of the target block, among reference pictures present in a reference picture list. The encoding apparatus 100 may generate an entropy-encoded reference picture index by applying entropy encoding to the reference picture index, and may generate a bitstream including the entropy-encoded reference picture index. The entropy-encoded reference picture index may be signaled from the encoding apparatus 100 to the decoding apparatus 200 through the bitstream. The decoding apparatus 200 may extract the entropy-encoded reference picture index from the bitstream, and may acquire the reference picture index by applying entropy decoding to the entropy-encoded reference picture index.

When two reference picture lists are used to predict the target block, a single reference picture index and a single motion vector may be used for each of the reference picture lists. Further, when two reference picture lists are used to predict the target block, two prediction blocks may be specified for the target block. For example, the (final) prediction block of the target block may be generated using the average or weighted sum of the two prediction blocks for the target block.

The motion vector of the target block may be derived by the prediction motion vector index, the MVD, the reference direction, and the reference picture index.

The decoding apparatus 200 may generate a prediction block for the target block based on the derived motion vector and the reference picture index. For example, the prediction block may be a reference block, indicated by the derived motion vector, in the reference picture indicated by the reference picture index.

Since the prediction motion vector index and the MVD are encoded without the motion vector itself of the target block being encoded, the number of bits transmitted from the encoding apparatus 100 to the decoding apparatus 200 may be decreased, and encoding efficiency may be improved.

For the target block, the motion information of reconstructed neighbor blocks may be used. In a specific inter-prediction mode, the encoding apparatus 100 may not separately encode the actual motion information of the target block. The motion information of the target block is not encoded, and additional information that enables the motion information of the target block to be derived using the motion information of reconstructed neighbor blocks may be encoded instead. As the additional information is encoded, the number of bits transmitted to the decoding apparatus 200 may be decreased, and encoding efficiency may be improved.

For example, as inter-prediction modes in which the motion information of the target block is not directly encoded, there may be a skip mode and/or a merge mode. Here, each of the encoding apparatus 100 and the decoding apparatus 200 may use an identifier and/or an index that indicates a unit, the motion information of which is to be used as the motion information of the target unit, among reconstructed neighbor units.

### 2) Merge Mode

As a scheme for deriving the motion information of a target block, there is merging. The term “merging” may mean the merging of the motion of multiple blocks. “Merging” may mean that the motion information of one block is also applied to other blocks. In other words, a merge mode may be a mode in which the motion information of the target block is derived from the motion information of a neighbor block.

When a merge mode is used, the encoding apparatus 100 may predict the motion information of a target block using the motion information of a spatial candidate and/or the motion information of a temporal candidate. The spatial candidate may include a reconstructed spatial neighbor block that is spatially adjacent to the target block. The spatial neighbor block may include a left neighbor block and an above neighbor block. The temporal candidate may include a col block. The terms “spatial candidate” and “spatial merge candidate” may be used to have the same meaning, and may be used interchangeably with each other. The terms “temporal candidate” and “temporal merge candidate” may be used to have the same meaning, and may be used interchangeably with each other.

The encoding apparatus 100 may acquire a prediction block via prediction. The encoding apparatus 100 may encode a residual block, which is the difference between the target block and the prediction block.

### 2-1) Creation of Merge Candidate List

When the merge mode is used, each of the encoding apparatus 100 and the decoding apparatus 200 may create a merge candidate list using the motion information of a spatial candidate and/or the motion information of a temporal candidate. The motion information may include 1) a motion vector, 2) a reference picture index, and 3) a reference direction. The reference direction may be unidirectional or bidirectional. The reference direction may mean a inter prediction indicator.

The merge candidate list may include merge candidates. The merge candidates may be motion information. In other words, the merge candidate list may be a list in which pieces of motion information are stored.

The merge candidates may be pieces of motion information of temporal candidates and/or spatial candidates. In other words, the merge candidates list may comprise motion information of a temporal candidates and/or spatial candidates, etc.

Further, the merge candidate list may include new merge candidates generated by a combination of merge candidates that are already present in the merge candidate list. In other words, the merge candidate list may include new motion information generated by a combination of pieces of motion information previously present in the merge candidate list.

Also, a merge candidate list may include history-based merge candidates. The history-based merge candidates may be the motion information of a block which is encoded and/or decoded prior to a target block.

Also, a merge candidate list may include a merge candidate based on an average of two merge candidates.

The merge candidates may be specific modes deriving inter prediction information. The merge candidate may be information indicating a specific mode deriving inter prediction information. Inter prediction information of a target block may be derived according to a specific mode which the merge candidate indicates. Furthermore, the specific mode may include a process of deriving a series of inter prediction information. This specific mode may be an inter prediction information derivation mode or a motion information derivation mode.

The inter prediction information of the target block may be derived according to the mode indicated by the merge candidate selected by the merge index among the merge candidates in the merge candidate list.

For example, the motion information derivation modes in the merge candidate list may be at least one of 1) motion information derivation mode for a subblock unit and 2) an affine motion information derivation mode.

Furthermore, the merge candidate list may include motion information of a zero vector. The zero vector may also be referred to as a “zero-merge candidate”.

In other words, pieces of motion information in the merge candidate list may be at least one of 1) motion information of a spatial candidate, 2) motion information of a temporal candidate, 3) motion information generated by a combination of pieces of motion information previously present in the merge candidate list, and 4) a zero vector.

Motion information may include 1) a motion vector, 2) a reference picture index, and 3) a reference direction. The reference direction may also be referred to as an “inter-prediction indicator”. The reference direction may be unidirectional or bidirectional. The unidirectional reference direction may indicate L0 prediction or L1 prediction.

The merge candidate list may be created before prediction in the merge mode is performed.

The number of merge candidates in the merge candidate list may be predefined. Each of the encoding apparatus 100 and the decoding apparatus 200 may add merge candidates to the merge candidate list depending on the predefined scheme and predefined priorities so that the merge candidate list has a predefined number of merge candidates. The merge candidate list of the encoding apparatus 100 and the merge candidate list of the decoding apparatus 200 may be made identical to each other using the predefined scheme and the predefined priorities.

Merging may be applied on a CU basis or a PU basis. When merging is performed on a CU basis or a PU basis, the encoding apparatus 100 may transmit a bitstream including predefined information to the decoding apparatus 200. For example, the predefined information may contain 1) information indicating whether to perform merging for individual block partitions, and 2) information about a block with which merging is to be performed, among blocks that are spatial candidates and/or temporal candidates for the target block.

2-2) Search for Motion Vector that Uses Merge Candidate List

The encoding apparatus 100 may determine merge candidates to be used to encode a target block. For example, the encoding apparatus 100 may perform prediction on the target block using merge candidates in the merge candidate list, and may generate residual blocks for the merge candidates. The encoding apparatus 100 may use a merge candidate that incurs the minimum cost in prediction and in the encoding of residual blocks to encode the target block.

Further, the encoding apparatus 100 may determine whether to use a merge mode to encode the target block.

### 2-3) Transmission of Inter-Prediction Information

The encoding apparatus 100 may generate a bitstream that includes inter-prediction information required for inter prediction. The encoding apparatus 100 may generate entropy-encoded inter-prediction information by performing entropy encoding on inter-prediction information, and may transmit a bitstream including the entropy-encoded inter-prediction information to the decoding apparatus 200. Through the bitstream, the entropy-encoded inter-prediction information may be signaled to the decoding apparatus 200 by the encoding apparatus 100. The decoding apparatus 200 may extract entropy-encoded inter-prediction information from the bitstream, and may acquire inter-prediction information by applying entropy decoding to the entropy-encoded inter-prediction information.

The decoding apparatus 200 may perform inter prediction on the target block using the inter-prediction information of the bitstream.

The inter-prediction information may contain 1) mode information indicating whether a merge mode is used, 2) a merge index and 3) correction information.

Further, the inter-prediction information may contain a residual signal.

The decoding apparatus 200 may acquire the merge index from the bitstream only when the mode information indicates that the merge mode is used.

The mode information may be a merge flag. The unit of the mode information may be a block. Information about the block may include mode information, and the mode information may indicate whether a merge mode is applied to the block.

The merge index may indicate a merge candidate to be used for the prediction of the target block, among merge candidates included in the merge candidate list. Alternatively, the merge index may indicate a block with which the target block is to be merged, among neighbor blocks spatially or temporally adjacent to the target block.

The encoding apparatus 100 may select a merge candidate having the highest encoding performance among the merge candidates included in the merge candidate list and set a value of the merge index to indicate the selected merge candidate.

Correction information may be information used to correct a motion vector. The encoding apparatus 100 may generate correction information. The decoding apparatus 200 may correct the motion vector of a merge candidate selected by a merge index based on the correction information.

The correction information may include at least one of information indicating whether correction is to be performed, correction direction information, and correction size information.

A prediction mode in which the motion vector is corrected based on the signaled correction information may be referred to as a “merge mode having a motion vector difference”.

2-4) Inter Prediction of Merge Mode that Uses Inter-Prediction Information

The decoding apparatus 200 may perform prediction on the target block using the merge candidate indicated by the merge index, among merge candidates included in the merge candidate list.

The motion vector of the target block may be specified by the motion vector, reference picture index, and reference direction of the merge candidate indicated by the merge index.

### 3) Skip Mode

A skip mode may be a mode in which the motion information of a spatial candidate or the motion information of a temporal candidate is applied to the target block without change. Also, the skip mode may be a mode in which a residual signal is not used. In other words, when the skip mode is used, a reconstructed block may be the same as a prediction block.

The difference between the merge mode and the skip mode lies in whether or not a residual signal is transmitted or used. That is, the skip mode may be similar to the merge mode except that a residual signal is not transmitted or used.

When the skip mode is used, the encoding apparatus 100 may transmit information about a block, the motion information of which is to be used as the motion information of the target block, among blocks that are spatial candidates or temporal candidates, to the decoding apparatus 200 through a bitstream. The encoding apparatus 100 may generate entropy-encoded information by performing entropy encoding on the information, and may signal the entropy-encoded information to the decoding apparatus 200 through a bitstream. The decoding apparatus 200 may extract entropy-encoded information from the bitstream, and may acquire information by applying entropy decoding to the entropy-encoded information.

Further, when the skip mode is used, the encoding apparatus 100 may not transmit other syntax information, such as an MVD, to the decoding apparatus 200. For example, when the skip mode is used, the encoding apparatus 100 may not signal a syntax element related to at least one of an MVD, a coded block flag, and a transform coefficient level to the decoding apparatus 200.

### 3-1) Creation of Merge Candidate List

The skip mode may also use a merge candidate list. In other words, a merge candidate list may be used both in the merge mode and in the skip mode. In this aspect, the merge candidate list may also be referred to as a “skip candidate list” or a “merge/skip candidate list”.

Alternatively, the skip mode may use an additional candidate list different from that of the merge mode. In this case, in the following description, a merge candidate list and a merge candidate may be replaced with a skip candidate list and a skip candidate, respectively.

The merge candidate list may be created before prediction in the skip mode is performed.

3-2) Search for Motion Vector that Uses Merge Candidate List

The encoding apparatus 100 may determine the merge candidates to be used to encode a target block. For example, the encoding apparatus 100 may perform prediction on the target block using the merge candidates in a merge candidate list. The encoding apparatus 100 may use a merge candidate that incurs the minimum cost in prediction to encode the target block.

Further, the encoding apparatus 100 may determine whether to use a skip mode to encode the target block.

### 3-3) Transmission of Inter-Prediction Information

The encoding apparatus 100 may generate a bitstream that includes inter-prediction information required for inter prediction. The decoding apparatus 200 may perform inter prediction on the target block using the inter-prediction information of the bitstream.

The inter-prediction information may include 1) mode information indicating whether a skip mode is used, and 2) a skip index.

The skip index may be identical to the above-described merge index.

When the skip mode is used, the target block may be encoded without using a residual signal. The inter-prediction information may not contain a residual signal. Alternatively, the bitstream may not include a residual signal.

The decoding apparatus 200 may acquire a skip index from the bitstream only when the mode information indicates that the skip mode is used. As described above, a merge index and a skip index may be identical to each other. The decoding apparatus 200 may acquire the skip index from the bitstream only when the mode information indicates that the merge mode or the skip mode is used.

The skip index may indicate the merge candidate to be used for the prediction of the target block, among the merge candidates included in the merge candidate list.

3-4) Inter Prediction in Skip Mode that Uses Inter-Prediction Information

The decoding apparatus 200 may perform prediction on the target block using a merge candidate indicated by a skip index, among the merge candidates included in a merge candidate list.

The motion vector of the target block may be specified by the motion vector, reference picture index, and reference direction of the merge candidate indicated by the skip index.

### 4) Current Picture Reference Mode

The current picture reference mode may denote a prediction mode that uses a previously reconstructed region in a target picture to which a target block belongs.

A motion vector for specifying the previously reconstructed region may be used. Whether the target block has been encoded in the current picture reference mode may be determined using the reference picture index of the target block.

A flag or index indicating whether the target block is a block encoded in the current picture reference mode may be signaled by the encoding apparatus 100 to the decoding apparatus 200. Alternatively, whether the target block is a block encoded in the current picture reference mode may be inferred through the reference picture index of the target block.

When the target block is encoded in the current picture reference mode, the target picture may exist at a fixed location or an arbitrary location in a reference picture list for the target block.

For example, the fixed location may be either a location where a value of the reference picture index is 0 or the last location.

When the target picture exists at an arbitrary location in the reference picture list, an additional reference picture index indicating such an arbitrary location may be signaled by the encoding apparatus 100 to the decoding apparatus 200.

### 5) Subblock Merge Mode

A subblock merge mode may be a mode in which motion information is derived from the subblock of a CU.

When the subblock merge mode is applied, a subblock merge candidate list may be generated using the motion information of a co-located subblock (col-subblock) of a target subblock (i.e., a subblock-based temporal merge candidate) in a reference image and/or an affine control point motion vector merge candidate.

### 6) Triangle Partition Mode

In a triangle partition mode, a target block may be partitioned in a diagonal direction, and sub-target blocks resulting from partitioning may be generated. For each sub-target block, motion information of the corresponding sub-target block may be derived, and a prediction sample for each sub-target block may be derived using the derived motion information. A prediction sample for the target block may be derived through a weighted sum of the prediction samples for the sub-target blocks resulting from the partitioning.

### 7) Combination Inter-Intra Prediction Mode

The combination inter-intra prediction mode may be a mode in which a prediction sample for a target block is derived using a weighted sum of a prediction sample generated via inter-prediction and a prediction sample generated via intra-prediction.

In the above-described modes, the decoding apparatus 200 may autonomously correct derived motion information. For example, the decoding apparatus 200 may search a specific area for motion information having the minimum sum of Absolute Differences (SAD) based on a reference block indicated by the derived motion information, and may derive the found motion information as corrected motion information.

In the above-described modes, the decoding apparatus 200 may compensate for the prediction sample derived via inter prediction using an optical flow.

In the above-described AMVP mode, merge mode, skip mode, etc., motion information to be used for prediction of the target block may be specified among pieces of motion information in a list using the index information of the list.

In order to improve encoding efficiency, the encoding apparatus 100 may signal only the index of an element that incurs the minimum cost in inter prediction of the target block, among elements in the list. The encoding apparatus 100 may encode the index, and may signal the encoded index.

Therefore, the above-described lists (i.e. the prediction motion vector candidate list and the merge candidate list) must be able to be derived by the encoding apparatus 100 and the decoding apparatus 200 using the same scheme based on the same data. Here, the same data may include a reconstructed picture and a reconstructed block. Further, in order to specify an element using an index, the order of the elements in the list must be fixed.

FIG. 10 illustrates spatial candidates according to an embodiment.

In FIG. 10, the locations of spatial candidates are illustrated.

The large block in the center of the drawing may denote a target block. Five small blocks may denote spatial candidates.

The coordinates of the target block may be (xP, yP), and the size of the target block may be represented by (nPSW, nPSH).

Spatial candidate A₀ may be a block adjacent to the below-left corner of the target block. A₀ may be a block that occupies pixels located at coordinates (xP−1, yP+nPSH).

Spatial candidate A₁ may be a block adjacent to the left of the target block. A₁ may be a lowermost block, among blocks adjacent to the left of the target block. Alternatively, A₁ may be a block adjacent to the top of A₀. A₁ may be a block that occupies pixels located at coordinates (xP−1, yP+nPSH−1).

Spatial candidate B₀ may be a block adjacent to the above-right corner of the target block. B₀ may be a block that occupies pixels located at coordinates (xP+nPSW, yP−1).

Spatial candidate B₁ may be a block adjacent to the top of the target block. B₁ may be a rightmost block, among blocks adjacent to the top of the target block. Alternatively, B₁ may be a block adjacent to the left of B₀. B₁ may be a block that occupies pixels located at coordinates (xP+nPSW−1, yP−1).

Spatial candidate B₂ may be a block adjacent to the above-left corner of the target block. B₂ may be a block that occupies pixels located at coordinates (xP−1, yP−1).

### Determination of Availability of Spatial Candidate and Temporal Candidate

In order to include the motion information of a spatial candidate or the motion information of a temporal candidate in a list, it must be determined whether the motion information of the spatial candidate or the motion information of the temporal candidate is available.

Hereinafter, a candidate block may include a spatial candidate and a temporal candidate.

For example, the determination may be performed by sequentially applying the following steps 1) to 4).
Step 1) When a PU including a candidate block is out of the boundary of a picture, the availability of the candidate block may be set to “false”. The expression “availability is set to false” may have the same meaning as “set to be unavailable”.
Step 2) When a PU including a candidate block is out of the boundary of a slice, the availability of the candidate block may be set to “false”. When the target block and the candidate block are located in different slices, the availability of the candidate block may be set to “false”.
Step 3) When a PU including a candidate block is out of the boundary of a tile, the availability of the candidate block may be set to “false”. When the target block and the candidate block are located in different tiles, the availability of the candidate block may be set to “false”.
Step 4) When the prediction mode of a PU including a candidate block is an intra-prediction mode, the availability of the candidate block may be set to “false”. When a PU including a candidate block does not use inter prediction, the availability of the candidate block may be set to “false”.

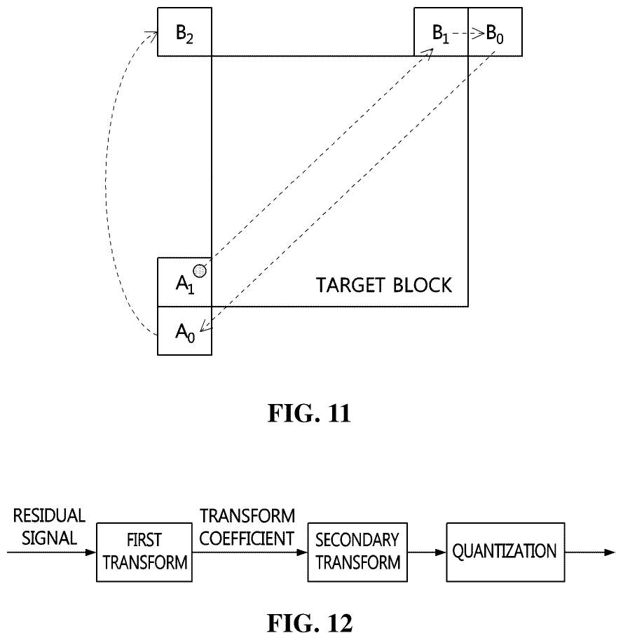

FIG. 11 illustrates the order of addition of motion information of spatial candidates to a merge list according to an embodiment.

As shown in FIG. 11, when pieces of motion information of spatial candidates are added to a merge list, the order of A₁, B₁, B₀, A₀, and B₂ may be used. That is, pieces of motion information of available spatial candidates may be added to the merge list in the order of A₁, B₁, B₀, A₀, and B₂.

### Method for Deriving Merge List in Merge Mode and Skip Mode

As described above, the maximum number of merge candidates in the merge list may be set. The set maximum number is indicated by “N”. The set number may be transmitted from the encoding apparatus 100 to the decoding apparatus 200. The slice header of a slice may include N. In other words, the maximum number of merge candidates in the merge list for the target block of the slice may be set by the slice header. For example, the value of N may be basically 5.

Pieces of motion information (i.e., merge candidates) may be added to the merge list in the order of the following steps 1) to 4).

Step 1) Among spatial candidates, available spatial candidates may be added to the merge list. Pieces of motion information of the available spatial candidates may be added to the merge list in the order illustrated in FIG. 11. Here, when the motion information of an available spatial candidate overlaps other motion information already present in the merge list, the motion information may not be added to the merge list. The operation of checking whether the corresponding motion information overlaps other motion information present in the list may be referred to in brief as an “overlap check”.

The maximum number of pieces of motion information that are added may be N.

Step 2) When the number of pieces of motion information in the merge list is less than N and a temporal candidate is available, the motion information of the temporal candidate may be added to the merge list. Here, when the motion information of the available temporal candidate overlaps other motion information already present in the merge list, the motion information may not be added to the merge list.

Step 3) When the number of pieces of motion information in the merge list is less than N and the type of a target slice is “B”, combined motion information generated by combined bidirectional prediction (bi-prediction) may be added to the merge list.

The target slice may be a slice including a target block.

The combined motion information may be a combination of L0 motion information and L1 motion information. L0 motion information may be motion information that refers only to a reference picture list L0. L1 motion information may be motion information that refers only to a reference picture list L1.

In the merge list, one or more pieces of L0 motion information may be present. Further, in the merge list, one or more pieces of L1 motion information may be present.

The combined motion information may include one or more pieces of combined motion information. When the combined motion information is generated, L0 motion information and L1 motion information, which are to be used for generation, among the one or more pieces of L0 motion information and the one or more pieces of L1 motion information, may be predefined. One or more pieces of combined motion information may be generated in a predefined order via combined bidirectional prediction, which uses a pair of different pieces of motion information in the merge list. One of the pair of different pieces of motion information may be L0 motion information and the other of the pair may be L1 motion information.

For example, combined motion information that is added with the highest priority may be a combination of L0 motion information having a merge index of 0 and L1 motion information having a merge index of 1. When motion information having a merge index of 0 is not L0 motion information or when motion information having a merge index of 1 is not L1 motion information, the combined motion information may be neither generated nor added. Next, the combined motion information that is added with the next priority may be a combination of L0 motion information, having a merge index of 1, and L1 motion information, having a merge index of 0. Subsequent detailed combinations may conform to other combinations of video encoding/decoding fields.

Here, when the combined motion information overlaps other motion information already present in the merge list, the combined motion information may not be added to the merge list.

Step 4) When the number of pieces of motion information in the merge list is less than N, motion information of a zero vector may be added to the merge list.

The zero-vector motion information may be motion information for which the motion vector is a zero vector.

The number of pieces of zero-vector motion information may be one or more. The reference picture indices of one or more pieces of zero-vector motion information may be different from each other. For example, the value of the reference picture index of first zero-vector motion information may be 0. The value of the reference picture index of second zero-vector motion information may be 1.

The number of pieces of zero-vector motion information may be identical to the number of reference pictures in the reference picture list.

The reference direction of zero-vector motion information may be bidirectional. Both of the motion vectors may be zero vectors. The number of pieces of zero-vector motion information may be the smaller one of the number of reference pictures in the reference picture list L0 and the number of reference pictures in the reference picture list L1. Alternatively, when the number of reference pictures in the reference picture list L0 and the number of reference pictures in the reference picture list L1 are different from each other, a reference direction that is unidirectional may be used for a reference picture index that may be applied only to a single reference picture list.

The encoding apparatus 100 and/or the decoding apparatus 200 may sequentially add the zero-vector motion information to the merge list while changing the reference picture index.

When zero-vector motion information overlaps other motion information already present in the merge list, the zero-vector motion information may not be added to the merge list.

The order of the above-described steps 1) to 4) is merely exemplary, and may be changed. Further, some of the above steps may be omitted depending on predefined conditions.

### Method for Deriving Prediction Motion Vector Candidate List in AMVP Mode

The maximum number of prediction motion vector candidates in a prediction motion vector candidate list may be predefined. The predefined maximum number is indicated by N. For example, the predefined maximum number may be 2.

Pieces of motion information (i.e. prediction motion vector candidates) may be added to the prediction motion vector candidate list in the order of the following steps 1) to 3).

Step 1) Available spatial candidates, among spatial candidates, may be added to the prediction motion vector candidate list. The spatial candidates may include a first spatial candidate and a second spatial candidate.

The first spatial candidate may be one of A₀, A₁, scaled A₀, and scaled A₁. The second spatial candidate may be one of B₀, B₁, B₂, scaled B₀, scaled B₁, and scaled B₂.

Pieces of motion information of available spatial candidates may be added to the prediction motion vector candidate list in the order of the first spatial candidate and the second spatial candidate. In this case, when the motion information of an available spatial candidate overlaps other motion information already present in the prediction motion vector candidate list, the motion information may not be added to the prediction motion vector candidate list. In other words, when the value of N is 2, if the motion information of a second spatial candidate is identical to the motion information of a first spatial candidate, the motion information of the second spatial candidate may not be added to the prediction motion vector candidate list.

The maximum number of pieces of motion information that are added may be N.

Step 2) When the number of pieces of motion information in the prediction motion vector candidate list is less than N and a temporal candidate is available, the motion information of the temporal candidate may be added to the prediction motion vector candidate list. In this case, when the motion information of the available temporal candidate overlaps other motion information already present in the prediction motion vector candidate list, the motion information may not be added to the prediction motion vector candidate list.

Step 3) When the number of pieces of motion information in the prediction motion vector candidate list is less than N, zero-vector motion information may be added to the prediction motion vector candidate list.

The zero-vector motion information may include one or more pieces of zero-vector motion information. The reference picture indices of the one or more pieces of zero-vector motion information may be different from each other.

The encoding apparatus 100 and/or the decoding apparatus 200 may sequentially add pieces of zero-vector motion information to the prediction motion vector candidate list while changing the reference picture index.

When zero-vector motion information overlaps other motion information already present in the prediction motion vector candidate list, the zero-vector motion information may not be added to the prediction motion vector candidate list.

The description of the zero-vector motion information, made above in connection with the merge list, may also be applied to zero-vector motion information. A repeated description thereof will be omitted.

The order of the above-described steps 1) to 3) is merely exemplary, and may be changed. Further, some of the steps may be omitted depending on predefined conditions.

FIG. 12 illustrates a transform and quantization process according to an example.

As illustrated in FIG. 12, quantized levels may be generated by performing a transform and/or quantization process on a residual signal.

A residual signal may be generated as the difference between an original block and a prediction block. Here, the prediction block may be a block generated via intra prediction or inter prediction.

The residual signal may be transformed into a signal in a frequency domain through a transform procedure that is a part of a quantization procedure.

A transform kernel used for a transform may include various DCT kernels, such as Discrete Cosine Transform (DCT) type 2 (DCT-II) and Discrete Sine Transform (DST) kernels.

These transform kernels may perform a separable transform or a two-dimensional (2D) non-separable transform on the residual signal. The separable transform may be a transform indicating that a one-dimensional (1D) transform is performed on the residual signal in each of a horizontal direction and a vertical direction.

The DCT type and the DST type, which are adaptively used for a 1D transform, may include DCT-V, DCT-VIII, DST-I, and DST-VII in addition to DCT-II, as shown in each of the following Table 3 and the following table 4.

TABLE 3

| Transform set | Transform candidates |
|---|---|
| 0 | DST-VII, DCT-VIII |
| 1 | DST-VII, DST-I |
| 2 | DST-VII, DCT-V |

TABLE 4

| Transform set | Transform candidates |
|---|---|
| 0 | DST-VII, DCT-VIII, DST-I |
| 1 | DST-VII, DST-I, DCT-VIII |
| 2 | DST-VII, DCT-V, DST-I |

As shown in Table 3 and Table 4, when a DCT type or a DST type to be used for a transform is derived, transform sets may be used. Each transform set may include multiple transform candidates. Each transform candidate may be a DCT type or a DST type.

The following Table 5 shows examples of a transform set to be applied to a horizontal direction and a transform set to be applied to a vertical direction depending on intra-prediction modes.

TABLE 5

| | Intra-prediction mode | | | | | | | | | |
|---|---|---|---|---|---|---|---|---|---|---|
| | 0 | 1 | 2 | 3 | 4 | 5 | 6 | 7 | 8 | 9 |
| Vertical | 2 | 1 | 0 | 1 | 0 | 1 | 0 | 1 | 0 | 1 |
| transform set | | | | | | | | | | |
| Horizontal | 2 | 1 | 0 | 1 | 0 | 1 | 0 | 1 | 0 | 1 |
| transform set | | | | | | | | | | |
| | Intra-prediction mode | | | | | | | | | |
| | 10 | 11 | 12 | 13 | 14 | 15 | 16 | 17 | 18 | 19 |
| Vertical | 0 | 1 | 0 | 1 | 0 | 0 | 0 | 0 | 0 | 0 |
| transform set | | | | | | | | | | |
| Horizontal | 0 | 1 | 0 | 1 | 2 | 2 | 2 | 2 | 2 | 2 |
| transform set | | | | | | | | | | |
| | Intra-prediction mode | | | | | | | | | |
| | 20 | 21 | 22 | 23 | 24 | 25 | 26 | 27 | 28 | 29 |
| Vertical | 0 | 0 | 0 | 1 | 0 | 1 | 0 | 1 | 0 | 1 |
| transform set | | | | | | | | | | |
| Horizontal | 2 | 2 | 2 | 1 | 0 | 1 | 0 | 1 | 0 | 1 |
| transform set | | | | | | | | | | |
| | Intra-prediction mode | | | | | | | | | |
| | 30 | 31 | 32 | 33 | 34 | 35 | 36 | 37 | 38 | 39 |
| Vertical | 0 | 1 | 0 | 1 | 0 | 1 | 0 | 1 | 0 | 1 |
| transform set | | | | | | | | | | |
| Horizontal | 0 | 1 | 0 | 1 | 0 | 1 | 0 | 1 | 0 | 1 |
| transform set | | | | | | | | | | |
| | Intra-prediction mode | | | | | | | | | |
| | 40 | 41 | 42 | 43 | 44 | 45 | 46 | 47 | 48 | 49 |
| Vertical | 0 | 1 | 0 | 1 | 0 | 1 | 2 | 2 | 2 | 2 |
| transform set | | | | | | | | | | |
| Horizontal | 0 | 1 | 0 | 1 | 0 | 1 | 0 | 0 | 0 | 0 |
| transform set | | | | | | | | | | |
| | Intra-prediction mode | | | | | | | | | |
| | 50 | 51 | 52 | 53 | 54 | 55 | 56 | 57 | 58 | 59 |
| Vertical | 2 | 2 | 2 | 2 | 2 | 1 | 0 | 1 | 0 | 1 |
| transform set | | | | | | | | | | |
| Horizontal | 0 | 0 | 0 | 0 | 0 | 1 | 0 | 1 | 0 | 1 |
| transform set | | | | | | | | | | |

Intra-prediction mode

| | 60 | 61 | 62 | 63 | 64 | 65 | 66 |
|---|---|---|---|---|---|---|---|
| Vertical | 0 | 1 | 0 | 1 | 0 | 1 | 0 |
| transform set | | | | | | | |
| Horizontal | 0 | 1 | 0 | 1 | 0 | 1 | 0 |
| transform set | | | | | | | |

In Table 5, numbers of vertical transform sets and horizontal transform sets that are to be applied to the horizontal direction of a residual signal depending on the intra-prediction modes of the target block are indicated.

As exemplified in FIGS. 4 and 5, transform sets to be applied to the horizontal direction and the vertical direction may be predefined depending on the intra-prediction mode of the target block. The encoding apparatus 100 may perform a transform and an inverse transform on the residual signal using a transform included in the transform set corresponding to the intra-prediction mode of the target block. Further, the decoding apparatus 200 may perform an inverse transform on the residual signal using a transform included in the transform set corresponding to the intra-prediction mode of the target block.

In the transform and inverse transform, transform sets to be applied to the residual signal may be determined, as exemplified in Tables 3, 4, and 5, and may not be signaled. Transform indication information may be signaled from the encoding apparatus 100 to the decoding apparatus 200. The transform indication information may be information indicating which one of multiple transform candidates included in the transform set to be applied to the residual signal is used.

For example, when the size of the target block is 64×64, transform sets, each having three transforms, may be configured depending on the intra-prediction mode. An optimal transform method may be selected from among a total of nine multiple transform methods resulting from combinations of three transforms in a horizontal direction and three transforms in a vertical direction. Through such an optimal transform method, the residual signal may be encoded and/or decoded, and thus coding efficiency may be improved.

Here, information indicating which one of transforms belonging to each transform set has been used for at least one of a vertical transform and a horizontal transform may be entropy-encoded and/or -decoded. Here, truncated unary binarization may be used to encode and/or decode such information.

As described above, methods using various transforms may be applied to a residual signal generated via intra prediction or inter prediction.

The transform may include at least one of a first transform and a secondary transform. A transform coefficient may be generated by performing the first transform on the residual signal, and a secondary transform coefficient may be generated by performing the secondary transform on the transform coefficient.

The first transform may be referred to as a “primary transform”. Further, the first transform may also be referred to as an “Adaptive Multiple Transform (AMT) scheme”. AMT may mean that, as described above, different transforms are applied to respective 1D directions (i.e. a vertical direction and a horizontal direction).

A secondary transform may be a transform for improving energy concentration on a transform coefficient generated by the first transform. Similar to the first transform, the secondary transform may be a separable transform or a non-separable transform. Such a non-separable transform may be a Non-Separable Secondary Transform (NSST).

The first transform may be performed using at least one of predefined multiple transform methods. For example, the predefined multiple transform methods may include a Discrete Cosine Transform (DCT), a Discrete Sine Transform (DST), a Karhunen-Loeve Transform (KLT), etc.

Further, a first transform may be a transform having various transform types depending on a kernel function that defines a Discrete Cosine Transform (DCT) or a Discrete Sine Transform (DST).

For example, the transform type may be determined based at least one of 1) a prediction mode of a target block (for example, one of an intra prediction and an inter prediction), 2) a size of a target block, 3) a shape of a target block, 4) an intra prediction mode of a target block, 5) a component of a target block (for example, one of a luma component an a chroma component), and 6) a partitioning type applied to a target block (for example, one of a Quad Tree, a Binary Tree and a Ternary Tree).

For example, the first transform may include transforms, such as DCT-2, DCT-5, DCT-7, DST-7, DST-1, DST-8, and DCT-8 depending on the transform kernel presented in the following Table 6. In the following Table 6, various transform types and transform kernel functions for Multiple Transform Selection (MTS) are exemplified.

MTS may refer to the selection of combinations of one or more DCT and/or DST kernels so as to transform a residual signal in a horizontal and/or vertical direction.

TABLE 6

| Transform | |
|---|---|
| type | Transform kernel function Tᵢ(j) |
| DCT-2 | ${T}_{i} ( j ) = {ω}_{0} \cdot \sqrt{\frac{2}{N}} \cdot cos ( \frac{π \cdot i \cdot ( 2 j + 1 )}{2 N} ) where {ω}_{0} = \sqrt{\frac{2}{N}} ( i = 0 ) or 1 ( otherwise )$ |
| DST-7 | ${T}_{i} ( j ) = \sqrt{\frac{4}{2 N + 1}} \cdot sin ( \frac{π \cdot ( 2 j + 1 ) \cdot ( j + 1 )}{2 N + 1} )$ |
| DCT-5 | ${T}_{i} ( j ) = {ω}_{0} \cdot {ω}_{1} \cdot \sqrt{\frac{2}{2 N - 1}} \cdot cos ( \frac{2 π \cdot i \cdot j}{2 N + 1} ) where {ω}_{0 / 1} = \sqrt{\frac{2}{N}} ( i or j = 0 ) or 1 ( otherwise )$ |
| DCT-8 | ${T}_{i} ( j ) = \sqrt{\frac{4}{2 N + 1}} \cdot cos ( \frac{π \cdot ( 2 j + 1 ) \cdot ( 2 j + 1 )}{4 N + 2} )$ |
| DST-1 | ${T}_{i} ( j ) = \sqrt{\frac{2}{N + 1}} \cdot sin ( \frac{π \cdot ( i + 1 ) \cdot ( j + 1 )}{N + 1} )$ |

In Table 6, i and j may be integer values that are equal to or greater than 0 and are less than or equal to N−1.

The secondary transform may be performed on the transform coefficient generated by performing the first transform.

As in the first transform, transform sets may also be defined in a secondary transform. The methods for deriving and/or determining the above-described transform sets may be applied not only to the first transform but also to the secondary transform.

The first transform and the secondary transform may be determined for a specific target.

For example, a first transform and a secondary transform may be applied to signal components corresponding to one or more of a luminance (luma) component and a chrominance (chroma) component. Whether to apply the first transform and/or the secondary transform may be determined depending on at least one of coding parameters for a target block and/or a neighbor block. For example, whether to apply the first transform and/or the secondary transform may be determined depending on the size and/or shape of the target block.

In the encoding apparatus 100 and the decoding apparatus 200, transform information indicating the transform method to be used for the target may be derived by utilizing specified information.

For example, the transform information may include a transform index to be used for a primary transform and/or a secondary transform. Alternatively, the transform information may indicate that a primary transform and/or a secondary transform are not used.

For example, when the target of a primary transform and a secondary transform is a target block, the transform method(s) to be applied to the primary transform and/or the secondary transform indicated by the transform information may be determined depending on at least one of coding parameters for the target block and/or blocks neighbor the target block.

Alternatively, transform information indicating a transform method for a specific target may be signaled from the encoding apparatus 100 to the decoding apparatus 200.

For example, for a single CU, whether to use a primary transform, an index indicating the primary transform, whether to use a secondary transform, and an index indicating the secondary transform may be derived as the transform information by the decoding apparatus 200. Alternatively, for a single CU, the transform information, which indicates whether to use a primary transform, an index indicating the primary transform, whether to use a secondary transform, and an index indicating the secondary transform, may be signaled.

The quantized transform coefficient (i.e. the quantized levels) may be generated by performing quantization on the result, generated by performing the first transform and/or the secondary transform, or on the residual signal.

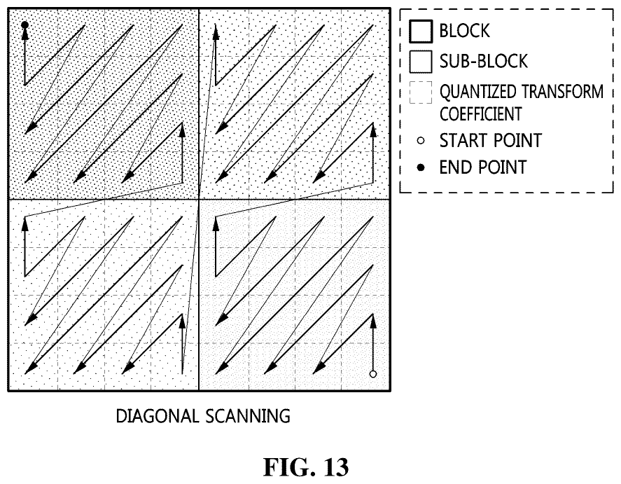

FIG. 13 illustrates diagonal scanning according to an example.

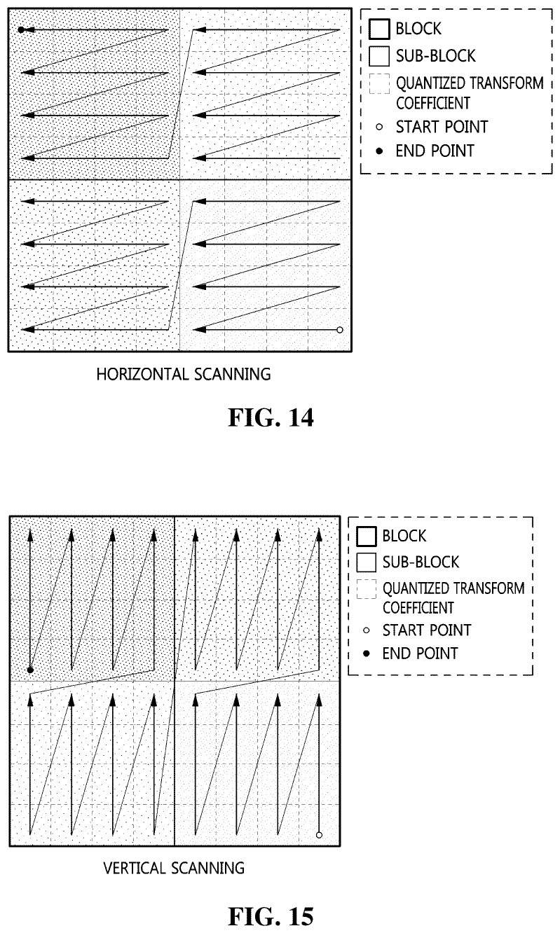

FIG. 14 illustrates horizontal scanning according to an example.

FIG. 15 illustrates vertical scanning according to an example.

Quantized transform coefficients may be scanned via at least one of (up-right) diagonal scanning, vertical scanning, and horizontal scanning depending on at least one of an intra-prediction mode, a block size, and a block shape. The block may be a Transform Unit (TU).

Each scanning may be initiated at a specific start point, and may be terminated at a specific end point.

For example, quantized transform coefficients may be changed to 1D vector forms by scanning the coefficients of a block using diagonal scanning of FIG. 13. Alternatively, horizontal scanning of FIG. 14 or vertical scanning of FIG. 15, instead of diagonal scanning, may be used depending on the size and/or intra-prediction mode of a block.

Vertical scanning may be the operation of scanning 2D block-type coefficients in a column direction. Horizontal scanning may be the operation of scanning 2D block-type coefficients in a row direction.

In other words, which one of diagonal scanning, vertical scanning, and horizontal scanning is to be used may be determined depending on the size and/or inter-prediction mode of the block.

As illustrated in FIGS. 13, 14, and 15, the quantized transform coefficients may be scanned along a diagonal direction, a horizontal direction or a vertical direction.

The quantized transform coefficients may be represented by block shapes. Each block may include multiple subblocks. Each subblock may be defined depending on a minimum block size or a minimum block shape.

In scanning, a scanning sequence depending on the type or direction of scanning may be primarily applied to subblocks. Further, a scanning sequence depending on the direction of scanning may be applied to quantized transform coefficients in each subblock.

For example, as illustrated in FIGS. 13, 14, and 15, when the size of a target block is 8×8, quantized transform coefficients may be generated through a first transform, a secondary transform, and quantization on the residual signal of the target block. Therefore, one of three types of scanning sequences may be applied to four 4×4 subblocks, and quantized transform coefficients may also be scanned for each 4×4 subblock depending on the scanning sequence.

The encoding apparatus 100 may generate entropy-encoded quantized transform coefficients by performing entropy encoding on scanned quantized transform coefficients, and may generate a bitstream including the entropy-encoded quantized transform coefficients.

The decoding apparatus 200 may extract the entropy-encoded quantized transform coefficients from the bitstream, and may generate quantized transform coefficients by performing entropy decoding on the entropy-encoded quantized transform coefficients. The quantized transform coefficients may be aligned in the form of a 2D block via inverse scanning. Here, as the method of inverse scanning, at least one of up-right diagonal scanning, vertical scanning, and horizontal scanning may be performed.

In the decoding apparatus 200, dequantization may be performed on the quantized transform coefficients. A secondary inverse transform may be performed on the result generated by performing dequantization depending on whether to perform the secondary inverse transform. Further, a first inverse transform may be performed on the result generated by performing the secondary inverse transform depending on whether the first inverse transform is to be performed. A reconstructed residual signal may be generated by performing the first inverse transform on the result generated by performing the secondary inverse transform.

For a luma component which is reconstructed via intra prediction or inter prediction, inverse mapping having a dynamic range may be performed before in-loop filtering.

The dynamic range may be divided into 16 equal pieces, and mapping functions for respective pieces may be signaled. Such a mapping function may be signaled at a slice level or a tile group level.

An inverse mapping function for performing inverse mapping may be derived based on the mapping function.

In-loop filtering, the storage of a reference picture, and motion compensation may be performed in an inverse mapping area.

A prediction block generated via inter prediction may be changed to a mapped area through mapping using a mapping function, and the changed prediction block may be used to generate a reconstructed block. However, since intra prediction is performed in the mapped area, a prediction block generated via intra prediction may be used to generate a reconstructed block without requiring mapping and/or inverse mapping.

For example, when the target block is a residual block of a chroma component, the residual block may be changed to an inversely mapped area by scaling the chroma component of the mapped area.

Whether scaling is available may be signaled at a slice level or a tile group level.

For example, scaling may be applied only to the case where mapping is available for a luma component and where the partitioning of the luma component and the partitioning of the chroma component follow the same tree structure.

Scaling may be performed based on the average of the values of samples in a luma prediction block, which corresponds to a chroma prediction block. Here, when the target block uses inter prediction, the luma prediction block may mean a mapped luma prediction block.

A value required for scaling may be derived by referring to a look-up table using the index of a piece to which the average of sample values of the luma prediction block belongs.

The residual block may be changed to an inversely mapped area by scaling the residual block using a finally derived value. Thereafter, for the block of a chroma component, reconstruction, intra prediction, inter prediction, in-loop filtering, and the storage of a reference picture may be performed in the inversely mapped area.

For example, information indicating whether the mapping and/or inverse mapping of a luma component and a chroma component are available may be signaled through a sequence parameter set.

A prediction block for the target block may be generated based on a block vector. The block vector may indicate displacement between the target block and a reference block. The reference block may be a block in a target image.

In this way, a prediction mode in which the prediction block is generated by referring to the target image may be referred to as an “Intra-Block Copy (IBC) mode”.

An IBC mode may be applied to a CU having a specific size. For example, the IBC mode may be applied to an M×N CU. Here, M and N may be less than or equal to 64.

The IBC mode may include a skip mode, a merge mode, an AMVP mode, etc. In the case of the skip mode or the merge mode, a merge candidate list may be configured, and a merge index is signaled, and thus a single merge candidate may be specified among merge candidates present in the merge candidate list. The block vector of the specified merge candidate may be used as the block vector of the target block.

In the case of the AMVP mode, a differential block vector may be signaled. Also, a prediction block vector may be derived from the left neighbor block and the above neighbor block of the target block. Further, an index indicating which neighbor block is to be used may be signaled.

A prediction block in the IBC mode may be included in a target CTU or a left CTU, and may be limited to a block within a previously reconstructed area. For example, the value of a block vector may be limited so that a prediction block for a target block is located in a specific area. The specific area may be an area defined by three 64×64 blocks that are encoded and/or decoded prior to a 64×64 block including the target block. The value of the block vector is limited in this way, and thus memory consumption and device complexity caused by the implementation of the IBC mode may be decreased.

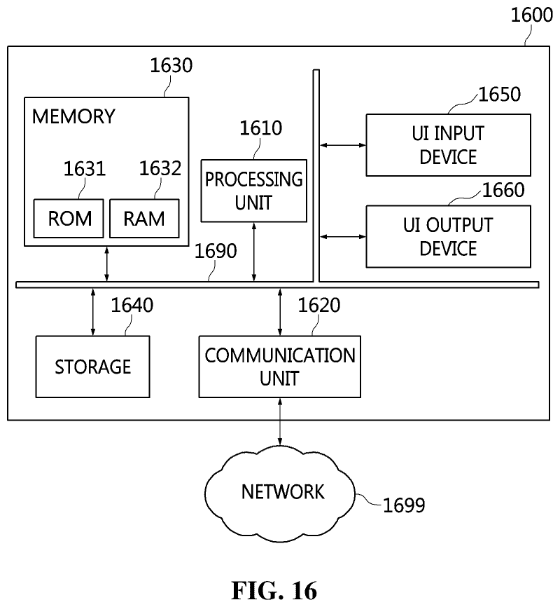

FIG. 16 is a configuration diagram of an encoding apparatus according to an embodiment.

An encoding apparatus 1600 may correspond to the above-described encoding apparatus 100.

The encoding apparatus 1600 may include a processing unit 1610, memory 1630, a user interface (UI) input device 1650, a UI output device 1660, and storage 1640, which communicate with each other through a bus 1690. The encoding apparatus 1600 may further include a communication unit 1620 coupled to a network 1699.

The processing unit 1610 may be a Central Processing Unit (CPU) or a semiconductor device for executing processing instructions stored in the memory 1630 or the storage 1640. The processing unit 1610 may be at least one hardware processor.

The processing unit 1610 may generate and process signals, data or information that are input to the encoding apparatus 1600, are output from the encoding apparatus 1600, or are used in the encoding apparatus 1600, and may perform examination, comparison, determination, etc. related to the signals, data or information. In other words, in embodiments, the generation and processing of data or information and examination, comparison and determination related to data or information may be performed by the processing unit 1610.

The processing unit 1610 may include an inter-prediction unit 110, an intra-prediction unit 120, a switch 115, a subtractor 125, a transform unit 130, a quantization unit 140, an entropy encoding unit 150, a dequantization unit 160, an inverse transform unit 170, an adder 175, a filter unit 180, and a reference picture buffer 190.

At least some of the inter-prediction unit 110, the intra-prediction unit 120, the switch 115, the subtractor 125, the transform unit 130, the quantization unit 140, the entropy encoding unit 150, the dequantization unit 160, the inverse transform unit 170, the adder 175, the filter unit 180, and the reference picture buffer 190 may be program modules, and may communicate with an external device or system. The program modules may be included in the encoding apparatus 1600 in the form of an operating system, an application program module, or other program modules.

The program modules may be physically stored in various types of well-known storage devices. Further, at least some of the program modules may also be stored in a remote storage device that is capable of communicating with the encoding apparatus 1200.

The program modules may include, but are not limited to, a routine, a subroutine, a program, an object, a component, and a data structure for performing functions or operations according to an embodiment or for implementing abstract data types according to an embodiment.

The program modules may be implemented using instructions or code executed by at least one processor of the encoding apparatus 1600.

The processing unit 1610 may execute instructions or code in the inter-prediction unit 110, the intra-prediction unit 120, the switch 115, the subtractor 125, the transform unit 130, the quantization unit 140, the entropy encoding unit 150, the dequantization unit 160, the inverse transform unit 170, the adder 175, the filter unit 180, and the reference picture buffer 190.

A storage unit may denote the memory 1630 and/or the storage 1640. Each of the memory 1630 and the storage 1640 may be any of various types of volatile or nonvolatile storage media. For example, the memory 1630 may include at least one of Read-Only Memory (ROM) 1631 and Random Access Memory (RAM) 1632.

The storage unit may store data or information used for the operation of the encoding apparatus 1600. In an embodiment, the data or information of the encoding apparatus 1600 may be stored in the storage unit.

For example, the storage unit may store pictures, blocks, lists, motion information, inter-prediction information, bitstreams, etc.

The encoding apparatus 1600 may be implemented in a computer system including a computer-readable storage medium.

The storage medium may store at least one module required for the operation of the encoding apparatus 1600. The memory 1630 may store at least one module, and may be configured such that the at least one module is executed by the processing unit 1610.

Functions related to communication of the data or information of the encoding apparatus 1600 may be performed through the communication unit 1620.

For example, the communication unit 1620 may transmit a bitstream to a decoding apparatus 1600, which will be described later.

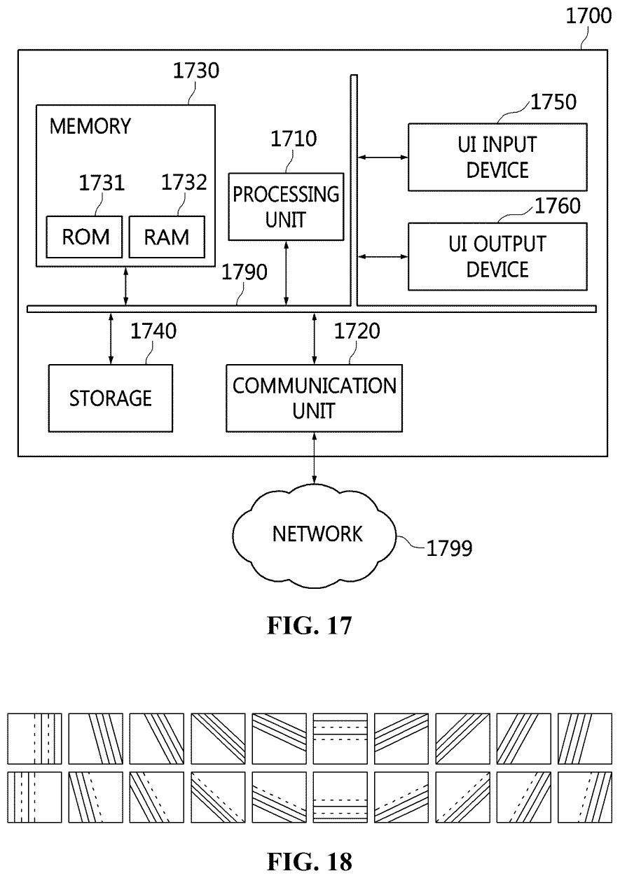

FIG. 17 is a configuration diagram of a decoding apparatus according to an embodiment.

The decoding apparatus 1700 may correspond to the above-described decoding apparatus 200.

The decoding apparatus 1700 may include a processing unit 1710, memory 1730, a user interface (UI) input device 1750, a UI output device 1760, and storage 1740, which communicate with each other through a bus 1790. The decoding apparatus 1700 may further include a communication unit 1720 coupled to a network 1799.

The processing unit 1710 may be a Central Processing Unit (CPU) or a semiconductor device for executing processing instructions stored in the memory 1730 or the storage 1740. The processing unit 1710 may be at least one hardware processor.

The processing unit 1710 may generate and process signals, data or information that are input to the decoding apparatus 1700, are output from the decoding apparatus 1700, or are used in the decoding apparatus 1700, and may perform examination, comparison, determination, etc. related to the signals, data or information. In other words, in embodiments, the generation and processing of data or information and examination, comparison and determination related to data or information may be performed by the processing unit 1710.

The processing unit 1710 may include an entropy decoding unit 210, a dequantization unit 220, an inverse transform unit 230, an intra-prediction unit 240, an inter-prediction unit 250, a switch 245, an adder 255, a filter unit 260, and a reference picture buffer 270.

At least some of the entropy decoding unit 210, the dequantization unit 220, the inverse transform unit 230, the intra-prediction unit 240, the inter-prediction unit 250, the adder 255, the switch 245, the filter unit 260, and the reference picture buffer 270 of the decoding apparatus 200 may be program modules, and may communicate with an external device or system. The program modules may be included in the decoding apparatus 1700 in the form of an operating system, an application program module, or other program modules.

The program modules may be physically stored in various types of well-known storage devices. Further, at least some of the program modules may also be stored in a remote storage device that is capable of communicating with the decoding apparatus 1700.

The program modules may include, but are not limited to, a routine, a subroutine, a program, an object, a component, and a data structure for performing functions or operations according to an embodiment or for implementing abstract data types according to an embodiment.

The program modules may be implemented using instructions or code executed by at least one processor of the decoding apparatus 1700.

The processing unit 1710 may execute instructions or code in the entropy decoding unit 210, the dequantization unit 220, the inverse transform unit 230, the intra-prediction unit 240, the inter-prediction unit 250, the switch 245, the adder 255, the filter unit 260, and the reference picture buffer 270.

A storage unit may denote the memory 1730 and/or the storage 1740. Each of the memory 1730 and the storage 1740 may be any of various types of volatile or nonvolatile storage media. For example, the memory 1730 may include at least one of ROM 1731 and RAM 1732.

The storage unit may store data or information used for the operation of the decoding apparatus 1700. In an embodiment, the data or information of the decoding apparatus 1700 may be stored in the storage unit.

For example, the storage unit may store pictures, blocks, lists, motion information, inter-prediction information, bitstreams, etc.

The decoding apparatus 1700 may be implemented in a computer system including a computer-readable storage medium.

The storage medium may store at least one module required for the operation of the decoding apparatus 1700. The memory 1730 may store at least one module, and may be configured such that the at least one module is executed by the processing unit 1710.

Functions related to communication of the data or information of the decoding apparatus 1700 may be performed through the communication unit 1720.

For example, the communication unit 1720 may receive a bitstream from the encoding apparatus 1700.

Hereinafter, a processing unit may represent the processing unit 1610 of the encoding apparatus 1600 and/or the processing unit 1710 of the decoding apparatus 1700. For example, as to functions relating to prediction, the processing unit may represent the switch 115 and/or the switch 245. As to functions relating to inter prediction, the processing unit may represent the inter-prediction unit 110, the subtractor 125 and the adder 175, and may represent the inter prediction unit 250 and the adder 255. As to functions relating to intra prediction, the processing unit may represent the intra prediction unit 120, the subtractor 125, and the adder 175, and may represent the intra prediction unit 240 and the adder 255. As to functions related to transform, the processing unit may represent the transform unit 130 and the inverse transform unit 170, and may represent the inverse transform unit 230. As to functions relating quantization, the processing unit may represent the quantization unit 140 and the inverse quantization unit 160, and may indicate the inverse quantization unit 220. As to functions relating to entropy encoding and/or entropy decoding, the processing unit may represent the entropy encoding unit 150 and/or the entropy decoding unit 210. As to functions relating filtering, the processing unit may represent the filter unit 180 and/or the filter unit 260. As to functions relating a reference picture, the processing unit may indicate the reference picture buffer 190 and/or the reference picture buffer 270.

### Adaptive Filter Selection

In typical inter-prediction, when a prediction block is generated, a fixed motion compensation filter is used, and thus there may be a limitation in improving coding efficiency.

In order to improve coding efficiency, embodiments may provide an image encoding/decoding method, apparatus, and bitstream storage medium, which include an adaptive filter selection method.

### Definition of Terms Used in Embodiments

Neighbor block: A neighbor block may refer to a block adjacent to a target block. A neighbor block may include a spatial neighbor block and a temporal neighbor block. A neighbor block may also refer to a reconstructed neighbor block in a reference image. A neighbor block is not necessarily required to be in contact with the target block.

Spatial neighbor block: A spatial neighbor block may be a block spatially adjacent to the target block.

A target block and a spatial neighbor block may be included in a target image.

A spatial neighbor block may include a block, at least a part of the boundary of which comes into contact with at least a part of the boundary of the target block. Alternatively, a spatial neighbor block may include a block to which the distance from the target block is less than or equal to a reference value.

A spatial neighbor block may include a block diagonally adjacent to the vertex of the target block.

A spatial neighbor block may include a left-above block adjacent to the top-left of the target block, an above block adjacent to the top of the target block, a right-above block adjacent to the top-right of the target block, a left block adjacent to the left of the target block, a right block adjacent to the right of the target block, a left-below block adjacent to the bottom-left of the target block, a below block adjacent to the bottom of the target block, and a right-below block adjacent to the bottom-right of the target block.

Temporal neighbor block: A temporal neighbor block may be a block temporally adjacent to the target block.

A temporal neighbor block may include a collocated block (col block). A col block may be a block in a reconstructed image stored in a reference image buffer. A collocated image (collocated picture: col picture) may refer to a picture including a col block. A col image may be an image included in a reference image list.

A col block may be determined based on the location of the target block in the target image. The fact that two blocks are ‘temporally adjacent to each other’ may mean that the locations of the two blocks satisfy a specific condition.

The location of the col block in the col image may be identical to that of the target block in the target image. Alternatively, the location of the col block in the col image may correspond to that of the target block in the target image. Here, the case where the locations of blocks correspond to each other may mean that the regions of the blocks are identical to each other, may mean that the region of one block is included in the region of another block, and may mean that one block occupies a specific location of another block.

For example, the location of the col block in the col image may be identical to that of the target block in the target image. Alternatively, the col block may be a block including a col pixel in the col image. A col pixel may be a pixel having coordinates identical to those of a specific pixel in the target block.

A temporal neighbor block may be a block temporally adjacent to the spatial neighbor block of the target block.

Neighbor sample: A neighbor sample may refer to a sample in a neighbor block. A neighbor sample may include a prediction sample, a reconstructed sample, a residual sample, and a decoded sample.

Hereinafter, terms listed in one line may be used as the same meaning in embodiments, and may be used interchangeably with each other in embodiments.
“motion information”, “motion vector”, “block vector”
“bi-prediction”, “bidirectional prediction”, “inter bi-prediction”, and “bidirectional inter-prediction”

Predefined value: A predefined value may refer to a value used in common in the encoding apparatus 1600 and the decoding apparatus 1700. For example, the predefined value may be construed as being limited to a fixed value. Alternatively, a predefined value may be a value shared between the encoding apparatus 1600 and the decoding apparatus 1700 through signaling. Alternatively, the predefined value may be a value derived through the same procedure in the encoding apparatus 1600 and the decoding apparatus 1700 so that the encoding apparatus 1600 and the decoding apparatus 1700 have a common value. Alternatively, the predefined value may be a common value which the encoding apparatus and the decoding apparatus have.

The value derived through the same procedure in the encoding apparatus 1600 and the decoding apparatus 1700 may include a value that is derived through the same procedure for the same value and/or the same information in the encoding apparatus 1600 and the decoding apparatus 1700.

The value derived through the same procedure by the encoding apparatus 1600 and the decoding apparatus 1700 may include a value that is derived by utilizing the same conditional statement for the same value and/or the same information in the encoding apparatus 1600 and the decoding apparatus 1700.

Description of the predefined value may also be applied to predefined information. In the above descriptions, ‘value’ may be replaced with ‘information’.

Motion information: Motion information may refer to information including at least one of reference picture list information, a reference image, a motion vector candidate, a motion vector candidate index, a merge candidate and a merge index, a block vector, a block vector candidate, and a block vector candidate index, as well as a motion vector, a reference picture index, and an inter-prediction indicator.

In embodiments, “the case where an indicator indicating whether a specific method is performed is true” may mean the case where whether the specific method is performed is true in a prediction mode; motion information; a coding parameter; and/or a location which are indicated by the indicator.

For example, an indicator indicating whether a specific mode is performed may have values ranging from 0 to 3, and the specific mode may be performed only when the indicator has a value of 1 or 3. In this case, “the case where the indicator indicating whether the specific mode is performed is true” may mean the case where the indicator indicating whether the specific mode is performed has a value of 1 or 3.

In embodiments, “the case where the indicator indicating whether the specific method is performed is false” may mean the case where the indicator indicating whether the specific method is performed is not true.

### Extension of Embodiments of Inter-Prediction Mode

An inter-prediction mode, an Intra Block Copy (IBC) mode, and an Intra Template Matching Prediction mode may have common features in that a specific reconstructed block is referenced for prediction for the target block.

In the following embodiments, ‘intra template matching prediction’ and ‘intra template matching’ may be used to have the same meaning, and may be used interchangeably with each other in embodiments.

Therefore, in embodiments, an inter-prediction mode may be replaced with an IBC mode or an intra template matching mode. Description of the case where the inter-prediction mode is used for the target block may also be applied to the case where the IBC mode or the intra template matching mode is used for the target block. Description of the inter-prediction mode may be applied to the IBC mode or the intra template matching mode, and the inter-prediction mode may be replaced with the IBC mode or the intra template matching mode. Further, information related to the inter-prediction mode may be regarded as information related to the IBC mode or the intra template matching mode. Description of the information related to the inter-prediction mode may be applied to the information related to the IBC mode or the intra template matching mode. For example, when the IBC mode or the intra template matching mode is used for the target block, the value of an inter-prediction mode indicator may be 0 (or false). However, in this case, the value of an IBC mode indicator or an intra template matching mode indicator may be 1 (or true).

Furthermore, in embodiments, a Motion Vector (MV) for inter-prediction may be replaced with a Block Vector (BV) for IBC. Description of the case where the MV is used for the target block may also be applied to the case where the BV is used for the target block. Description of the MV may be applied to the BV, and the MV may be replaced with the BV. Further, information related to the MV may be regarded as information related to the BV. Description of the information related to the MV may be applied to the information related to the BV. However, the BV may be information indicating a specific reconstructed block in a target image including the target block, rather than a reference image.

In embodiments related to the inter-prediction mode, a reference block and a reference template for template matching are described as being present in a reference image. On the other hand, when the IBC mode or the intra template matching mode is used for the target block, a reference block and a reference template may be present only in a target image. Therefore, in embodiments, the reference image described in relation to the inter-prediction mode may be regarded as a target image in the IBC mode and the intra template matching mode. Alternatively, in embodiments, the reference image described in relation to the inter-prediction mode may be limited to the target image in the IBC mode and the intra template matching mode, and images, other than the target image, may not be referenced in the IBC mode and the intra template matching mode.

### Adaptive Motion Vector Resolution (AMVR)

In embodiments, the term “resolution” may refer to the term “motion vector resolution”.

In adaptive motion vector resolution, the resolution of a motion vector difference may be adjusted on a block basis.

Adaptive motion vector resolution information may indicate the resolution of the motion vector difference. The resolution of the motion vector difference for the target block may be determined through signaling/encoding/decoding on the adaptive motion vector resolution information.

Motion vector resolutions applicable to blocks may be identical to or different from each other.

For example, the resolutions of the motion vector applicable to the target block may be determined based on at least one of the coding parameter, motion information and mode information of the target block.

The adaptive motion vector resolution may improve encoding efficiency by adjusting the resolution of the motion vector difference.

For example, the adjusted resolution may be one of 16-pel (pixel), 8-pel, 4-pel, full-pel, half-pel, and quarter-pel, and is not limited to the above-listed pel values.

Pel may refer to the number of pixels used as a unit. For example, when the adjusted resolution of a target block is 4-pel, each component of a motion vector difference may represent a multiple of four pixels.

When the value of the component of the motion vector difference is changed by 1 in case the adjusted resolution is n-pel, a location indicated by the motion vector difference may be changed by n pixel(s). In other words, when the adjusted resolution of the target block is n-pel, each component of the motion vector difference may indicate a reference block in units of n pixels.

The resolution of the motion vector difference may be predefined.

### Subsampling

Performing subsampling may mean that only some of samples in a specific region are selected.

Performing subsampling may mean that, when only some of samples in the specific area are selected, 1) a sample at a SUBSAMPLE_START_HOR-th position in a horizontal direction and at a SUBSAMPLE_START_VER-th position in a vertical direction with respect to a specific sample, and 2) a sample having a sample interval of a multiple of SUBSAMPLE_STEP_HOR in the horizontal direction and a multiple of SUBSAMPLE_STEP_VER in the vertical direction from the sample in 1) are selected. Alternatively, performing subsampling may mean that some of the sample in 1) and the sample in 2) are selected.

The specific position may indicate a top-left sample of an area on which subsampling is performed. However, the specific position is not limited to the top-left sample of the area on which subsampling is performed.

Each of SUBSAMPLE_START_HOR and SUBSAMPLE_START_VER may be 0 or a positive integer. Information about at least one of SUBSAMPLE_START_HOR and SUBSAMPLE_START_VER may be signaled/encoded/decoded or, alternatively, the values of SUBSAMPLE_START_HOR and/or SUBSAMPLE_START_VER may be determined to be predefined values without requiring signaling/encoding/decoding of the information.

Each of SUBSAMPLE_STEP_HOR and SUBSAMPLE_STEP_VER may be 0, 1, 2 or a positive integer. Information about at least one of SUBSAMPLE_STEP_HOR and SUBSAMPLE_STEP_VER may be signaled/encoded/decoded or, alternatively, the values of SUBSAMPLE_STEP_HOR and/or SUBSAMPLE_STEP_VER may be determined to be predefined values without requiring signaling/encoding/decoding of the information.

Subsampling methods may be classified by an area on which subsampling is performed, the location of the area on which subsampling is performed, the size of the area on which subsampling is performed, SUBSAMPLE_START_HOR, SUBSAMPLE_START_VER, SUBSAMPLE_STEP_HOR, and SUBSAMPLE_STEP_VER. However, criteria based on which the subsampling methods are classified are not limited to the above-described values.

Information about each subsampling method may be signaled/encoded/decoded or, alternatively, a predefined subsampling method may be used without requiring signaling/encoding/decoding.

Information about each subsampling method may be information for determining the corresponding subsampling method.

For example, the information about each subsampling method may be information about at least one of the area on which subsampling is performed, the location of the area on which subsampling is performed, the size of the area on which subsampling is performed, SUBSAMPLE_START_HOR, SUBSAMPLE_START_VER, SUBSAMPLE_STEP_HOR and SUBSAMPLE_STEP_VER.

For example, the subsampling method may be determined based on at least one of the motion information, the coding parameter, the size, and the prediction mode of the target block.

The subsampling method may be determined in at least one unit among a sequence level, a picture level, a tile level, a tile group level, a slice level, a Coding Tree Unit (CTU) level, a Coding Unit (CU) level, and a Prediction Unit (PU) level, but the unit at which the subsampling method is determined is not limited thereto, and the subsampling method may be determined for the specific unit described in the embodiments.

### Geometric Partitioning Mode (GPM)

A GPM may be a method for determining a partition boundary for a target block and deriving a weighted sum of two prediction blocks (or reference blocks) as a final prediction block. Here, the partition boundary may partition the target block in one of various directions.

For the weighted sum, a weight map may be determined based on the partition boundary. For example, at least one prediction block (or at least one reference block) in the geometric partitioning mode may refer to a prediction block generated by unidirectional prediction and/or bidirectional prediction, or a reference block in at least one direction in unidirectional prediction and/or bidirectional prediction.

Alternatively, for example, at least one prediction block in the geometric partitioning mode may refer to a prediction block generated by intra-prediction.

For example, one prediction block may be generated by inter-prediction in the geometric partitioning mode, and another prediction block may be generated by intra-prediction.

FIG. 18 illustrates a partition boundary in a geometric partitioning mode according to an example.

In FIG. 18, rectangles may represent blocks. Solid lines or dotted lines in respective rectangles may represent partition boundaries of geometric partitioning.

In FIG. 18, 20 square blocks for 20 predefined angles are illustrated. In other words, one block may indicate one angle. In each square block, four partition boundaries corresponding to four distances are illustrated as solid lines or dotted lines.

In FIG. 18, the partition boundaries illustrated in one block may represent partition boundaries of partitioning modes for geometric partitioning that can be selected by specific angle θ and ρ to the angle θ.

Each partitioning mode may be a value indicating a partition boundary. Each partitioning mode may refer to a mode in which geometric partitioning is to be performed.

The value of the partitioning mode may indicate a combination of θ and ρ. The specific value of the partitioning mode may indicate a combination of specific θ and specific ρ.

The partitioning mode may be an integer value. In other words, the combination of the specific θ and the specific ρ may be represented by the value of one partitioning mode, and may be signaled between the encoding apparatus 1600 and the decoding apparatus 1700.

A predefined number of partitioning modes of GPM may be determined depending on a limitation of θ and ρ. For example, 80 partitioning modes of GPM may be defined and used depending on 20 predefined angles for the above-described θ and four predefined distances for ρ.

The combination of the specific θ and the specific ρ may be excluded from the partitioning modes of geometric partitioning. For example, such an excluded combination may be a combination overlapping other combinations. Alternatively, such an excluded combination may refer to the same partitioning method as another partitioning method for the target block.

In FIG. 18, each dotted line may indicate the combination of θ and ρ, which is excluded from the partitioning modes of geometric partitioning. By such exclusion, 64 partitioning modes of GPM may be defined and used.

The partitioning modes of GPM may specify the shape of GPM and the partition boundary of GPM. Based on this specification, hereinafter, the term “partitioning mode” of GPM may have the same meaning as “shape” of GPM or “partition boundary” of GPM, and the terms “mode”, “partitioning mode”, “shape”, and “partition boundary” may be used interchangeably with each other.

Each partitioning mode of GPM may be indicated by an integer value or an index. Hereinafter, the partitioning mode of GPM may refer to an integer value and/or an index for determining and/or identifying the shape of GPM and/or the partition boundary of GPM.

Here, no values may be assigned to partitioning modes indicated by dotted lines in FIG. 18. That is, the partitioning modes indicated by the dotted lines in FIG. 18 are used only to determine the order of the partitioning modes, and may not be actually used in GPM.

A partitioning information candidate list for the geometric partitioning mode may include multiple partitioning information candidates. Each of the partitioning information candidates may be information for specifying the processing of the geometric partitioning mode. For example, each of the partitioning information candidates may include information for specifying a partition boundary/partition line. The partition information candidates may specify different processes, respectively.

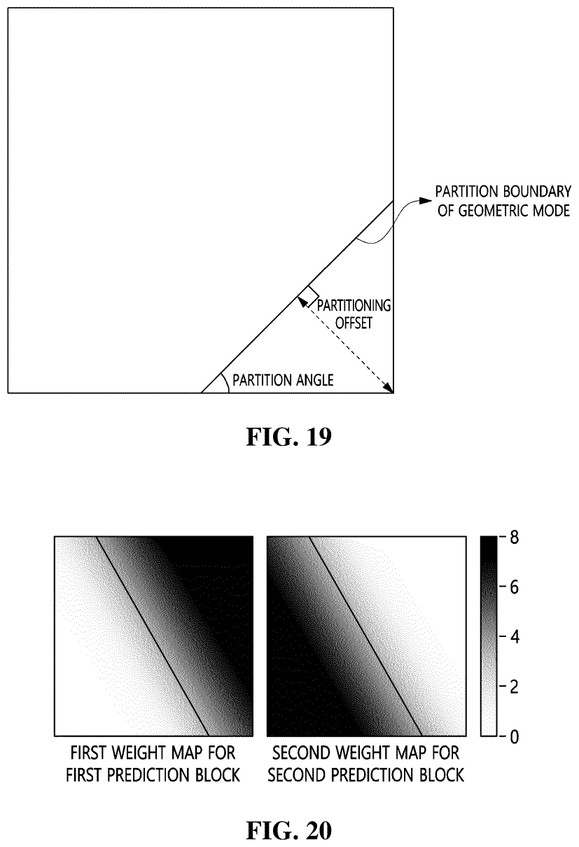

FIG. 19 illustrates a partition boundary, a partition offset, and a partition angle in a geometric partitioning mode according to an example.

Geometric partitioning in the GPM may be specified by the partition angle and the partitioning offset.

Hereinafter, θ(Theta) may indicate the partition angle. Also, this may be specified by the partitioning offset ρ(Rho).

θ may be the angle of the partition boundary. For example, θ may be an angle between the bottom line of a target block and the partition boundary. Alternatively, θ may be an angle between an X axis and the partition boundary.

ρ may be the (shortest) distance between a specific location of the target block and the partition boundary. Alternatively, ρ may be the distance between two points in a line that passes through the specific location of the target block and that is perpendicular to the partition boundary. The two points may be a point at the specific location of the target block and a point on the partition boundary.

For example, as illustrated in FIG. 19, the specific point may be the bottom-right corner of the target block. The specific point may be the lowermost-rightmost pixel of the target block.

For example, the specific point may be the center of the target block. The specific location may be the center pixel of the target block.

For example, the specific point may be the bottom-left corner of the target block. The specific point may be the lowermost-leftmost pixel of the target block.

θ may be limited to predefined values. For example, θ may be one of 20 predefined angles.

ρ may be limited to predefined values. For example, ρ may be one of four predefined distances.

The predefined distances may be changed by θ. Alternatively, the predefined distances may be determined based on θ.

The predefined distances may be changed by the size of the target block. Alternatively, the predefined distances may be determined based on the size of the target block.

θ and ρ may be implemented as fixed point values, and may be represented by integers.

Two partition regions of the target block may be specified depending on the partition boundary of the geometric partitioning mode. The partition boundary may partition the target block into two partition regions. A first partition region may be an above-left region, an above region or a left region of the partition boundary. A second partition region may be a below-right region, a below region or a right region of the partition boundary. In other words, when the partition straight line is not a vertical line, the first partition region may be a region above the partition straight line, and the second partition region may be a region below the partition straight line. In other words, when the partition straight line is a vertical line, the first partition region may be a region to the left of the partition straight line, and the second partition region may be a region to the right of the partition straight line.

FIG. 20 illustrates weight maps used in respective prediction blocks depending on a specific partition boundary according to an example.

In FIG. 20, a first weight map for a first prediction block and a second weight map for a second prediction block are illustrated.

The first prediction block may be one of two prediction blocks generated in a geometric partitioning mode. The second prediction block may be the other of the two prediction blocks generated in the geometric partitioning mode. The first weight map for the first prediction block may indicate weights of pixels in the first prediction block. The second weight map for the second prediction block may indicate weights of pixels in the second prediction block.

By means of the first weight map and the second weight map, the weights of the pixels corresponding to the first prediction block and the second prediction block may be determined. Here, the corresponding pixels may be pixels having the same coordinates.

The first prediction block may be a prediction block for a first partition region. Here, “the first prediction block for the first partition region” may mean that the first prediction block is used to determine the value of each of all pixels in the first partition region. Among the weights in the first weight map for the first prediction block, weights included in the first partition region may be 0 or more. Among the weights in the first weight map for the first prediction block, at least some of weights included in the second partition region may be 0. In other words, the first prediction block may not be used to determine the values of at least some of the pixels included in the second partition region. Alternatively, the values of at least some of the pixels included in the first partition region may be determined only by the first prediction block regardless of the second prediction block. The values of at least some of the pixels included in the second partition region may be determined only by the second prediction block regardless of the first prediction block.

The second prediction block may be a prediction block for the second partition region. Here, “the second prediction block for the second partition region” may mean that the second prediction block is used to determine the value of each of all pixels in the second partition region. Among the weights in the second weight map for the second prediction block, weights included in the second partition region may be 0 or more. Among the weights in the second weight map for the second prediction block, at least some of weights included in the first partition region may be 0. In other words, the second prediction block may not be used to determine the values of at least some of the pixels included in the first partition region. Alternatively, the values of at least some of the pixels included in the second partition region may be determined only by the second prediction block regardless of the first prediction block. The values of at least some of the pixels included in the first partition region may be determined only by the first prediction block regardless of the second prediction block.

In FIG. 20, a white region in the weight map for each prediction block may mean that the prediction block does not affect the configuration of a white region in a final prediction block. That is, the white region in the weight map for the prediction block may indicate that the weights of pixels in the white region in the prediction block are 0.

The weight of a specific pixel in the first prediction block may be determined based on the distance between the specific pixel and the partition boundary. The weight of a specific pixel in the second prediction block may be determined based on the distance between the specific pixel and the partition boundary.

The weight of a specific pixel in the first prediction block may be determined depending on the distance between the specific pixel and the partition boundary. The weight of a specific pixel in the second prediction block may be determined depending on the distance between the specific pixel and the partition boundary.

For example, when the distance between the specific pixel in the target block and the partition boundary is less than a reference value, the value of the specific pixel may be a weighted sum of the value of the first pixel in the first prediction block and the value of the second pixel in the second prediction block. Here, the location of the specific pixel, the location of the first pixel, and the location of the second pixel may be identical to each other. In this case, when the first pixel is included in the first partition region, the first weight for the first pixel may be larger as the first pixel is located farther from the partition boundary. When the first pixel is included in the second partition region, the weight for the first pixel may be smaller as the first pixel is located farther from the partition boundary. When the second pixel is included in the second partition region, the weight for the second pixel may be larger as the second pixel is located farther from the partition boundary. When the second pixel is included in the first partition region, the weight for the second pixel may be smaller as the second pixel is located farther from the partition boundary.

For example, when the distance between the specific pixel in the target block and the partition boundary is greater than a reference value, the value of the specific pixel may be the value of the first pixel in the first prediction block or the value of the second pixel in the second prediction block. In this case, when the specific pixel is included in the first partition region, the value of the first pixel in the first prediction block may be used as the value of the specific pixel. When the specific pixel is included in the second partition region, the value of the second pixel in the second prediction block may be used as the value of the specific pixel. Here, the location of the specific pixel, the location of the first pixel, and the location of the second pixel may be identical to each other.

The following [Equation 1] indicates the generation of prediction signals of GPM corresponding to the weight maps illustrated in FIG. 20.

$${P}_{G} = ( {W}_{0} \cdot {P}_{0} + {W}_{1} \cdot {P}_{1} + 4 ) >> 3 \qquad [ Equation 1 ]$$

P₀ may be the pixel value of a pixel at a specific location in the first prediction block.
W₀ may be a weight for the specific location among the weights in the first weight map.
P₁ may be the pixel value of a pixel at a specific location in the second prediction block.
W₁ may be a weight for the specific location among the weights in the second weight map.
P_{G} may be the pixel value of a pixel at a specific location in the final prediction block.

Respective partition information candidates in the partition information candidate list may include pieces of information for specifying weight maps in the geometric partitioning mode.

The partition information candidates in the partition information candidate list may specify different processes, respectively, in the geometric partitioning mode. Here, the processes in the geometric partitioning mode may include partition boundaries and weight maps.

### Template Matching (TM)

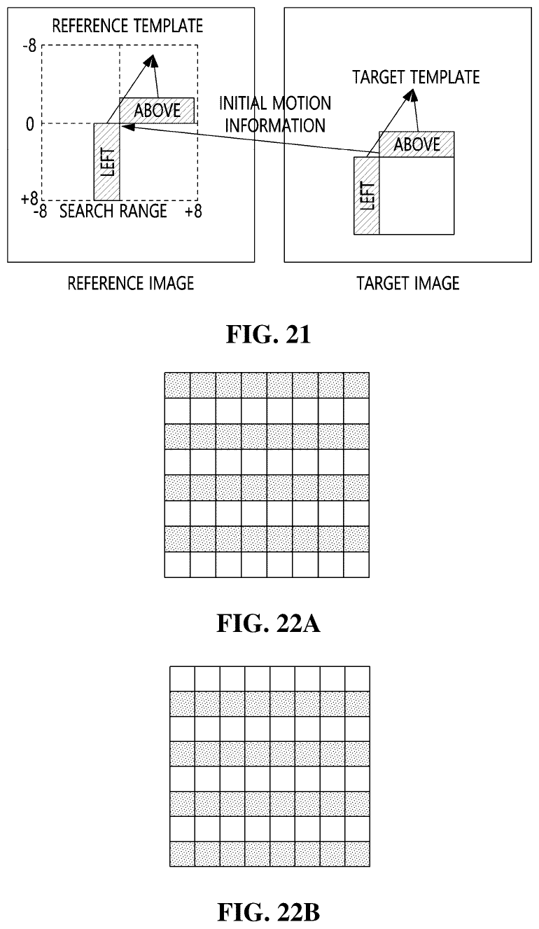

FIG. 21 illustrates template matching according to an example.

In template matching, motion information of the target block may be determined and/or changed based on the result of calculating a cost function between a target template and a reference template. The determination and/or change of the motion information may refer to the refinement of the motion information.

The target template may be the template of a target block. The reference template may be the template of a reference block.

In embodiments, the cost function may be at least one of the Sum of Absolute Differences (SAD), the Sum of Absolute Transformed Differences (SATD), the Mean-Removed Sum of Absolute Differences (MR-SAD), Mean Squared Error (MSE), and the Sum of Squared Error (SSE). However, cost functions are not limited to the above-listed items.

The reference block may include at least one of 1) a block indicated by initial motion information, 2) a block indicated by motion information derived in a search process of template matching, 3) a block indicated by motion information finally refined through template matching, 4) a block in which a sample (or position) within the search range of template matching is one of a top-left sample (or position), a bottom-left sample (or position), a top-right sample (or position), a bottom-right sample (or position), and a central sample (or position), and 5) a block finally determined through template matching.

The size of the reference block may be equal to that of the target block.

The motion information refined by template matching may be motion information having the lowest matching cost, derived in the search process of template matching. However, a method for deriving the motion information is not limited to the above-described criteria.

Template matching cost may refer to the result of calculation using a cost function between the template of the target block and the template of the reference block which are used in template matching.

Each of a reference block, a reference template, and a reference region may include at least one of a prediction sample, a reconstructed sample, a residual sample, and a decoded sample for a reference image. Alternatively, each of the reference block, the reference template, and the reference region may include at least one of a prediction sample, a reconstructed sample, a residual sample, and a decoded sample for a target image.

### Template Configuration in Template Matching

### Configuration of Target Template

A target template may include the surrounding sample of a target block.

A reference region for the target block may include the surrounding sample of the target block.

For example, the reference region for the target block may include at least one of samples located in a left-below region, a left region, a left-above region, an above region, and a right-above region around the target block.

For example, the target template in template matching may be identical to the reference region for the target block.

For example, samples in a target template specified based on the target block as a reference may be samples corresponding to samples in a reference template specified based on the reference block.

In embodiments, specifying the specific sample based on the specific block may mean that the specific sample is determined according to a relative position with respect to the specific block.

For example, when the target template is configured in template matching, some of samples in the reference region of the target block may be selected. The target template may be configured using the selected samples.

For example, samples selected to configure the target template based on the target block may be samples corresponding to samples selected to configure the template of the reference block based on the reference block.

For example, the reference region of the target block specified based on the target block may be a region corresponding to the reference region of the reference block specified based on the reference block.

### Configuration of Reference Template

A reference template may include surrounding samples of a reference block.

The reference region of the reference block may include surrounding samples of the reference block.

For example, the reference region of the reference block may include at least one of samples located in a left-below region, a left region, a left-above region, an above region, and a right-above region around the reference block.

For example, the reference template in template matching may be identical to the reference region of the reference block.

For example, samples in the reference template specified based on the reference block as a reference may be samples corresponding to samples in a target template specified based on the target block.

In embodiments, specifying the specific sample based on the specific block may mean that the specific sample is determined according to a relative position with respect to the specific block.

For example, when a reference template is configured in template matching, some of samples in the reference region of the reference block may be selected. The reference template may be configured using the selected samples.

For example, the samples selected to configure the reference template based on the reference block may be samples corresponding to samples selected to configure the template of the target block based on the target block.

For example, the reference region of the reference block specified based on the reference block may be a region corresponding to the reference region of the target block specified based on the target block.

A template matching method may include at least one of an intra template matching mode and an inter template matching mode.

An intra template matching mode may refer to a template matching method in which each of the reference block, the reference template, and the reference region includes at least one of the prediction sample, the reconstructed sample, the residual sample, and the decoded sample for the target image.

An inter template matching mode may refer to a template matching method in which each of the reference block, the reference template, and the reference region includes at least one of the prediction sample, the reconstructed sample, the residual sample, and the decoded sample for the reference image.

The target/reference template in template matching may include at least one of 1) at least one of samples in TMSIZE_LEFT lines adjacent to the left of the target/reference block; and 2) at least one of samples in TMSIZE_ABOVE lines adjacent to the top of the target/reference block.

However, a positional relationship between each sample in the template and the target/reference block and/or a template configuration method are not limited to the above-described relationships or methods.

Each of TMSIZE_LEFT and TMSIZE_ABOVE may be 0, 1, 2, 3, 4 or a positive integer of 4 or more.

TMSIZE_LEFT and TMSIZE_ABOVE may be identical to each other. Alternatively, TMSIZE_LEFT and TMSIZE_ABOVE may be different from each other.

Each of TMSIZE_LEFT and TMSIZE_ABOVE may be a predefined value or a value determined based on signaled/encoded/decoded information.

Each of TMSIZE_LEFT and TMSIZE_ABOVE may be determined based on at least one of the motion information, coding parameter, size, and prediction mode of the target block.

### Subsampling in Template Matching

### Subsampling for Template Configuration

When a template for template matching is configured, all of samples in a reference region may be used or, alternatively, only some of the samples in the reference region may be used.

The template for template matching may refer to at least one of the template of a target block and the template of a reference block.

The reference region may refer to at least one of the reference region of the target block for template matching and the reference region of the reference block.

When the template for template matching is configured using only some samples located in the reference region, subsampling may be performed on all or part of the reference region.

When the template for template matching is configured using only some samples located in the reference region, the reference region may be divided into two or more regions. Each of the divided regions may be one of 1) a first region on which subsampling is performed, 2) a second region on which subsampling is not performed and that is used for template configuration, and 3) a third region that is not used for template configuration. The template for template matching may be configured using samples selected by subsampling in the first region and samples in the second region.

For example, the first region may be a region located to the left and/or at the left-above of the block among regions in the reference region.

For example, the first corresponding region may be a region located above and/or at the left-above of the block among the regions in the reference region.

Alternatively, when the template for template matching is configured using only some samples located in the reference region, the reference region may be divided into two or more regions. Each of the divided regions may be one of 1) a first region on which subsampling is performed and 2) a third region that is not used to configure a template. The template for template matching may be configured using the samples selected in the first region by the subsampling.

### Subsampling for Cost Function Calculation

When a cost function between a target template and a reference template is calculated in template matching, all of samples in each template may be used or, alternatively, only some of the samples in each template may be used. That is, only for some samples, the calculation of the cost function may be performed.

When the cost function between the templates is calculated using only some samples in the template, subsampling may be performed on all or part of the template region.

When the cost function between the templates is calculated using only some samples in the template, the region of each template for template matching may be divided into two or more regions. Each of the divided regions may be one of 1) a first region on which subsampling is performed, 2) a second region on which subsampling is not performed and that is used to calculate a cost function, and 3) a third region that is not used to calculate a cost function. The cost function between templates in template matching may be calculated using 1) samples selected by subsampling in the first region and 2) samples in the second region.

Alternatively, when the cost function between the templates is calculated using only some samples in the template, the region of each template for template matching may be divided into two or more regions. Each of the divided regions may be one of 1) a first region on which subsampling is performed and 2) a third region that is not used to calculate a cost function. The cost function between the templates in template matching may be calculated using the samples selected by subsampling in the first region.

### Subsampling for Search Area

When a search process in template matching is performed, all of the samples/positions in a search area may be used or, alternatively, only some of the samples/positions in the search area may be selected. Search and/or matching cost calculation may be performed only on the selected samples/positions. Alternatively, search and/or matching cost calculation may be performed only on pieces of motion information indicating the selected samples/positions.

When the search process in template matching is performed using only some of the samples/positions in the search area, subsampling may be performed on all or part of the search area.

When the search process in template matching is configured using only some of the samples/positions in the search area, each search area may be divided into two or more regions. Each of the divided regions may be one of 1) a first region on which subsampling is performed, 2) a second region on which subsampling is not performed and a search process is performed, and 3) a third region on which a search process is not performed. The search process in template matching may be performed on pixels and/or positions selected by subsampling in the first region and samples/positions in the second region. Alternatively, the search process in template matching may be performed on pieces of motion information indicating samples/positions selected by subsampling in the first region and samples/positions in the second region.

Alternatively, when the search process in template matching is configured using only some of the samples/positions in the search area, each search area may be divided into two or more regions. Each of the divided regions may be one of 1) a first region on which subsampling is performed and 2) a second region on which a search process is not performed. The search process in template matching may be performed using the samples/positions selected by subsampling in the first region. Alternatively, the search process in template matching may be performed on pieces of motion information indicating the samples/positions selected by subsampling in the first region.

### Examples of Subsampling

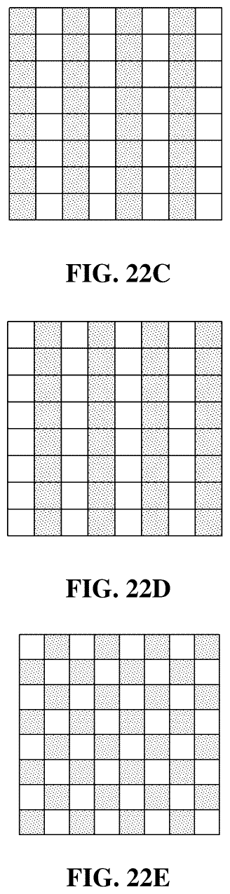

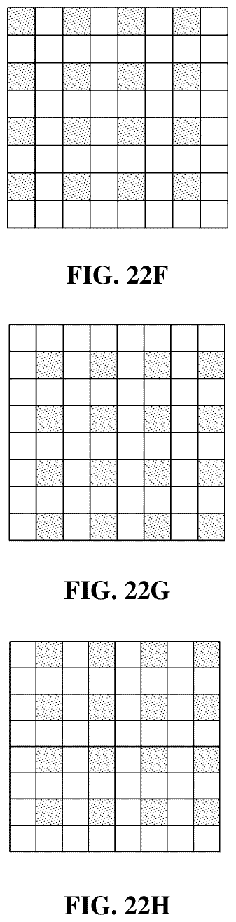

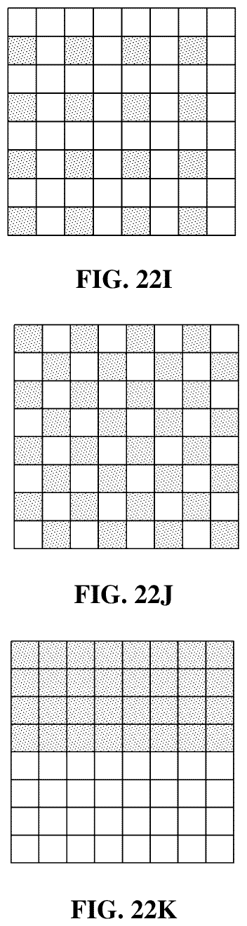

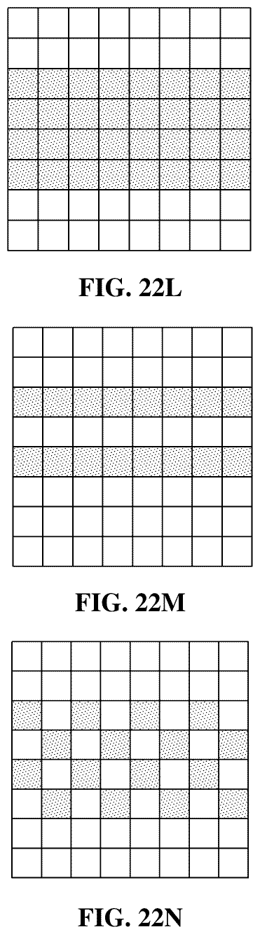

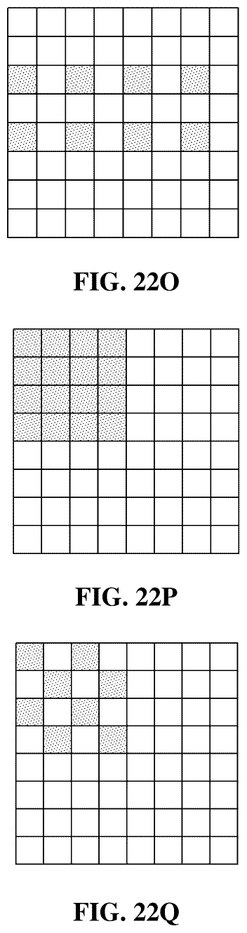

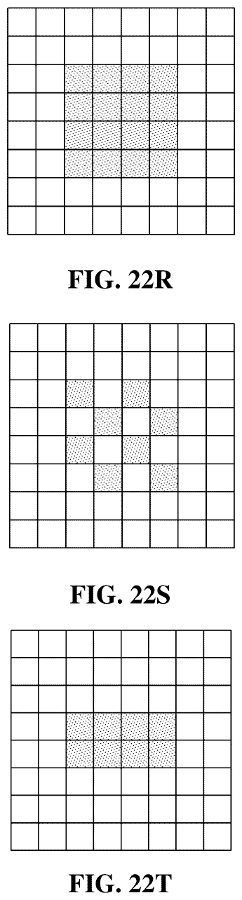

FIGS. 22A to 22T illustrate various examples of a subsampling method in template matching.

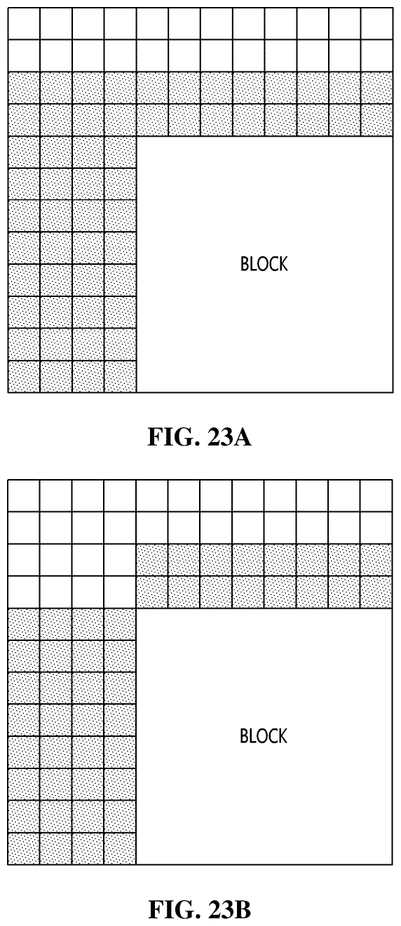

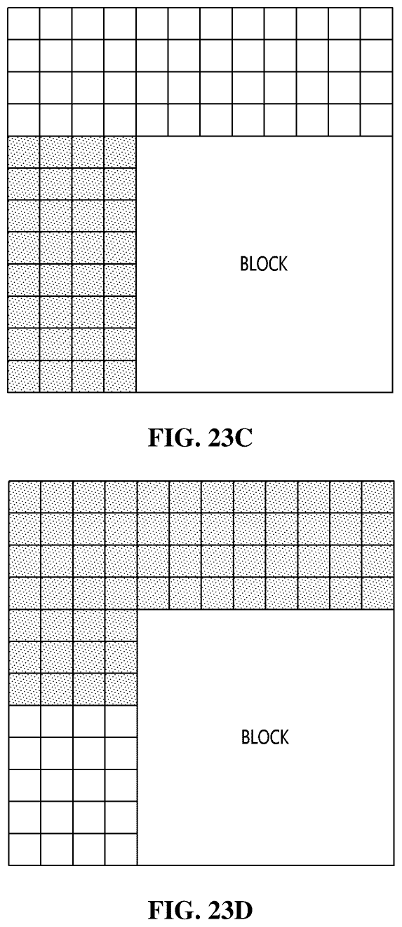

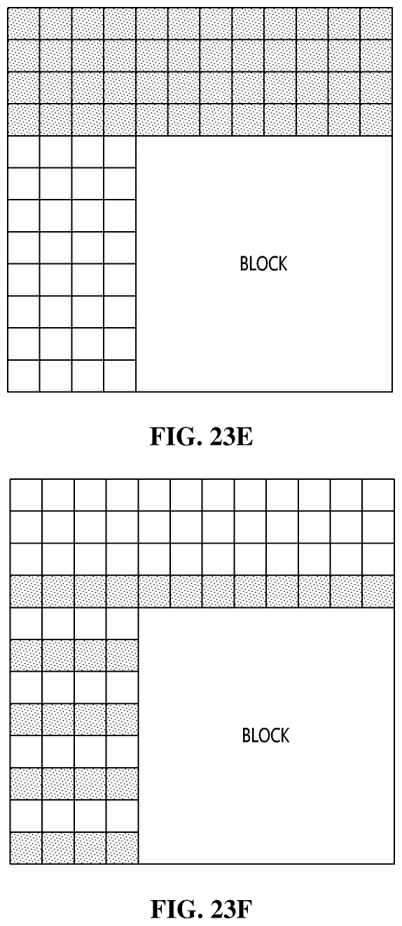

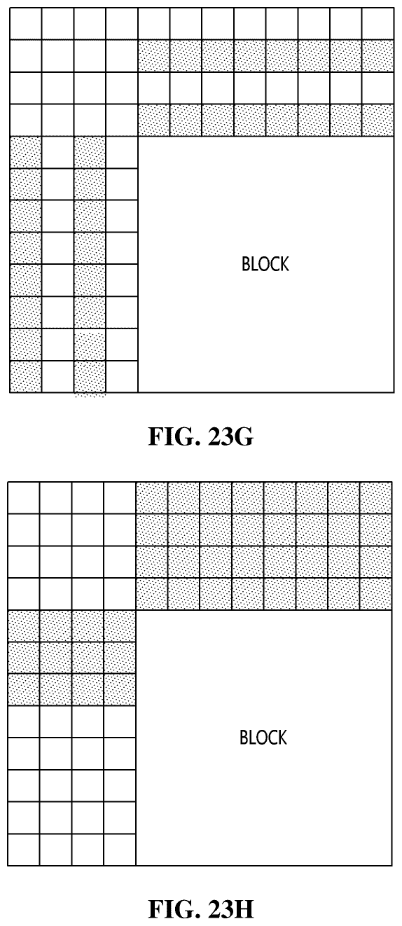

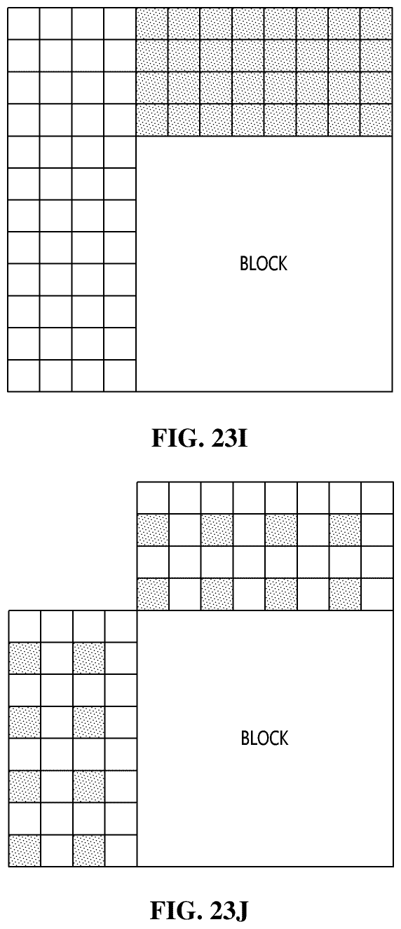

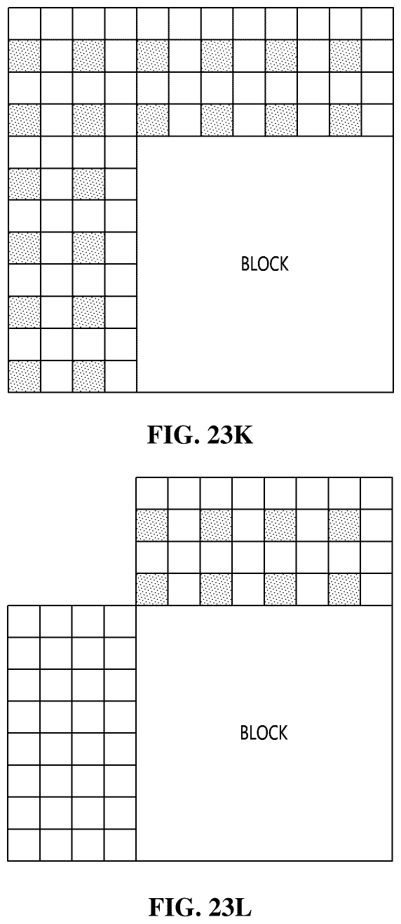

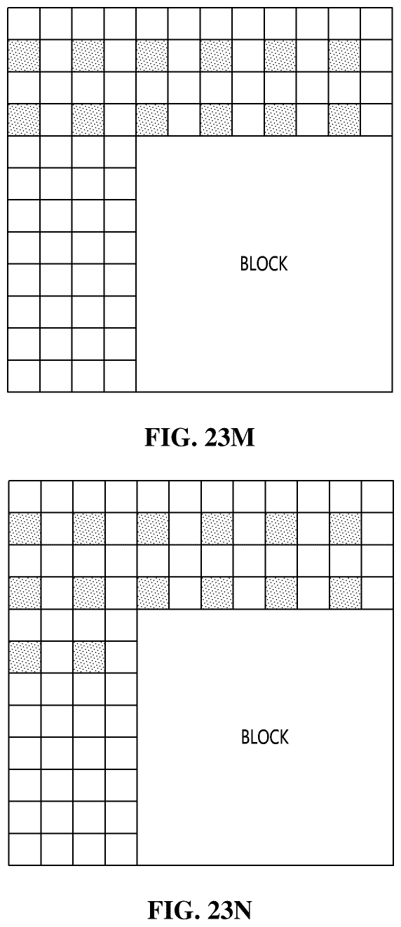

FIGS. 23A to 23N illustrate various other examples of a subsampling method in template matching.

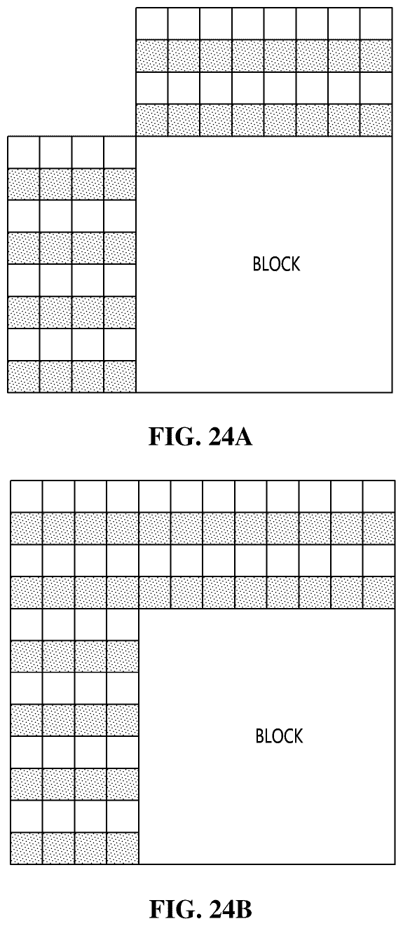

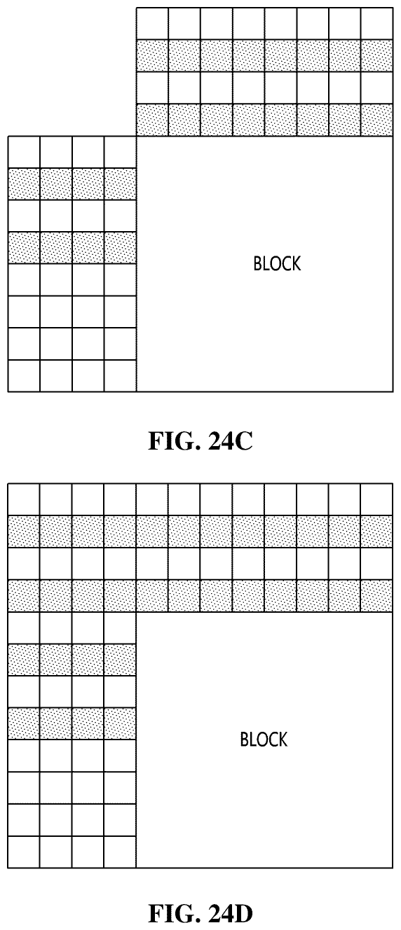

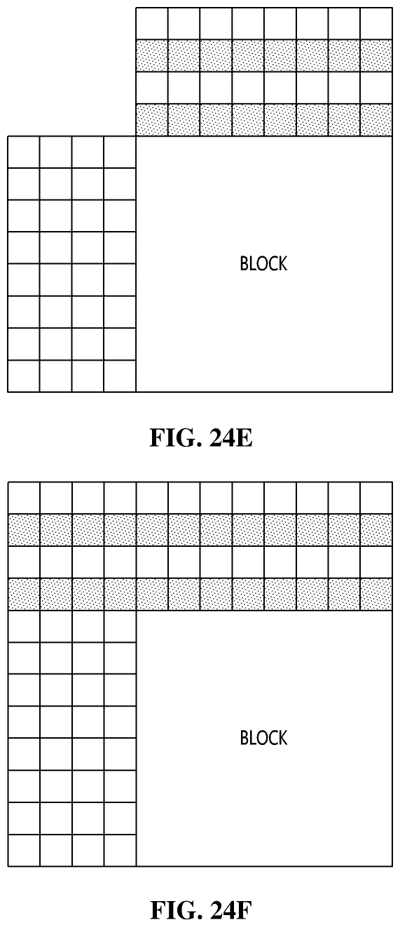

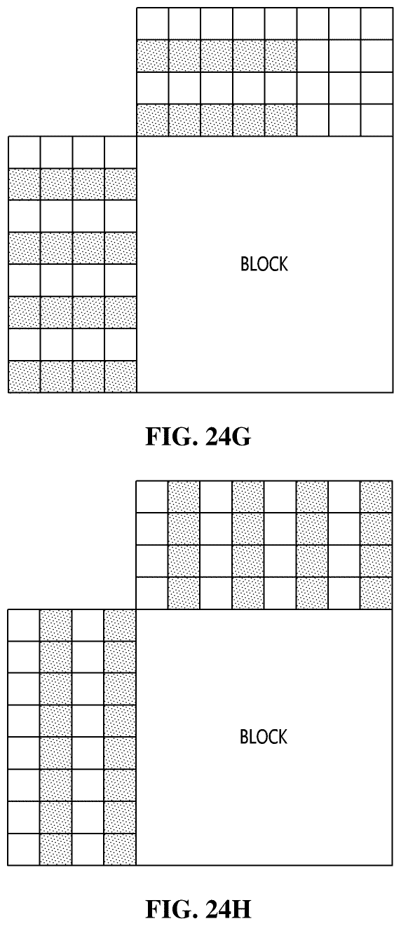

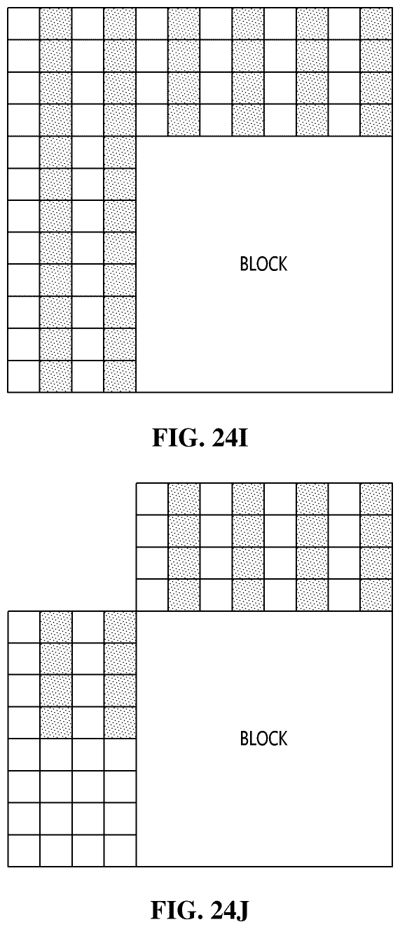

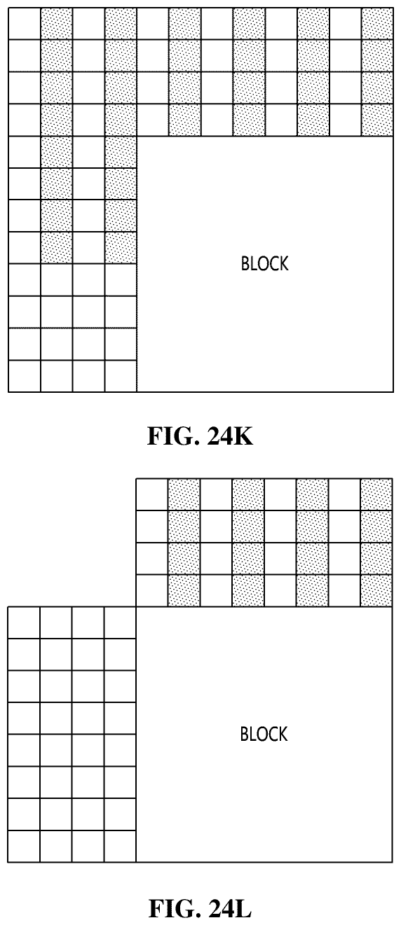

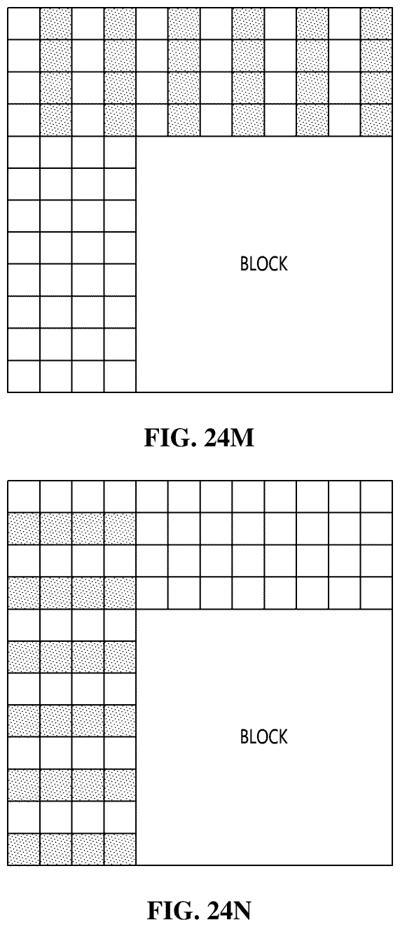

FIGS. 24A to 24N illustrate various further examples of a subsampling method in template matching.

Each drawing of FIGS. 22A to 22T, FIGS. 23A to 23N, and FIGS. 24A to 24N may illustrate a region to which subsampling is applied. Small rectangles in each drawing may represent samples or positions. The region may be a reference region, a region of a reference block and/or a template region.

For example, in each drawing of FIGS. 22A to 22T, a leftmost-uppermost rectangle in each region may be a sample or position having coordinates (0, 0) in the region.

In FIGS. 22A to 22T, although the size of the region is illustrated as 8×8, the size is only an example, and the subsampling method illustrated in FIGS. 22A to 22T may also be applied to regions having various sizes.

Each drawing of FIGS. 22A to 22T, FIGS. 23A to 23N, and FIGS. 24A to 24N may illustrate a block and a region to which sampling is applied. Small rectangles in each drawing may represent samples or positions. The block may be a target block or a reference block. The region may be a reference region, a region of a reference block and/or a template region.

For example, in each of FIGS. 23A to 23N and FIGS. 24A to 24N, top-left coordinates of the block may be (0, 0).

The size of each region in FIGS. 23A to 23N and FIGS. 24A to 24N is merely exemplary, and the sampling method illustrated in drawings of FIGS. 23A to 23N and FIG. 24A to 24N may also be applied to regions having different sizes.

The samples (or positions) indicated using shading in the region of each drawing may represent samples (or positions) selected by subsampling. The samples (or positions) indicated in white color in the region of each drawing may represent samples (or positions) that are not selected by subsampling.

As illustrated in FIG. 22A to 22T, subsampling may be applied to all or part of the reference region, and a template may be configured using only samples (or positions) selected by subsampling.

As illustrated in FIGS. 23A to 23N and FIGS. 24A to 24N, subsampling may be performed on all or part of a template region in template matching, and calculation of a cost function may be performed only on the samples (or positions) selected by subsampling.

As illustrated in FIGS. 22A to 22T, subsampling may be performed on all or part of the search area in template matching, and search and/or matching cost calculation may be performed only on the pixels and/or positions selected by subsampling.

As illustrated in FIGS. 22A to 22T, subsampling may be performed on all or part of a search area in template matching, and search and/or matching cost calculation may be performed only on pieces of motion information indicating pixels and/or positions selected by subsampling.

### Subsampling Using Unit of Subblocks

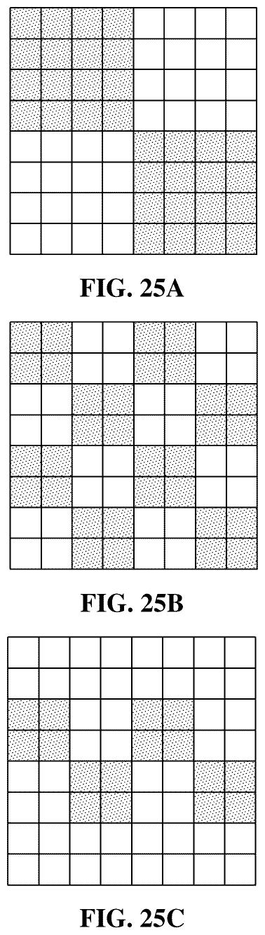

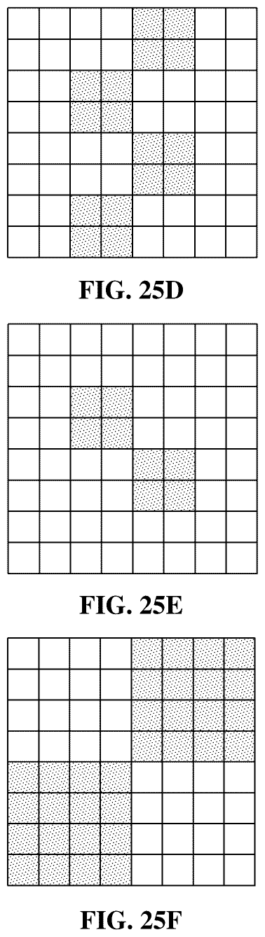

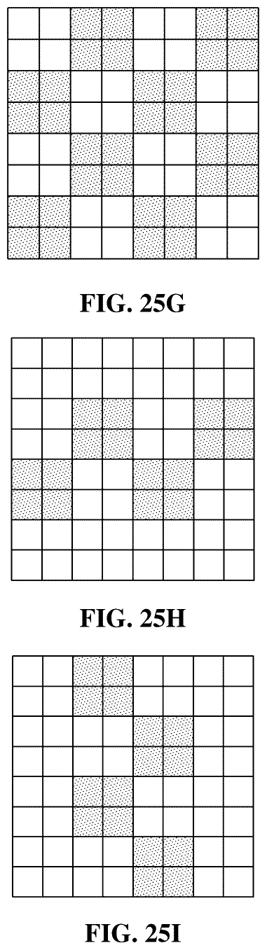

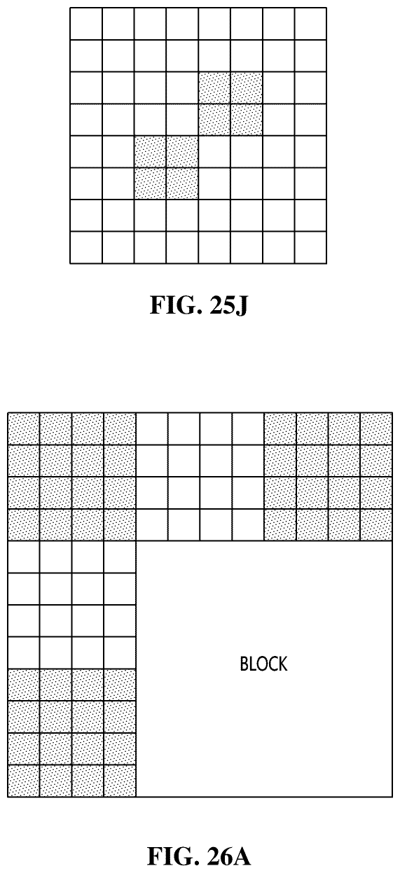

FIGS. 25A to 25J illustrate subsampling that uses the unit of subblocks for a region according to an example.

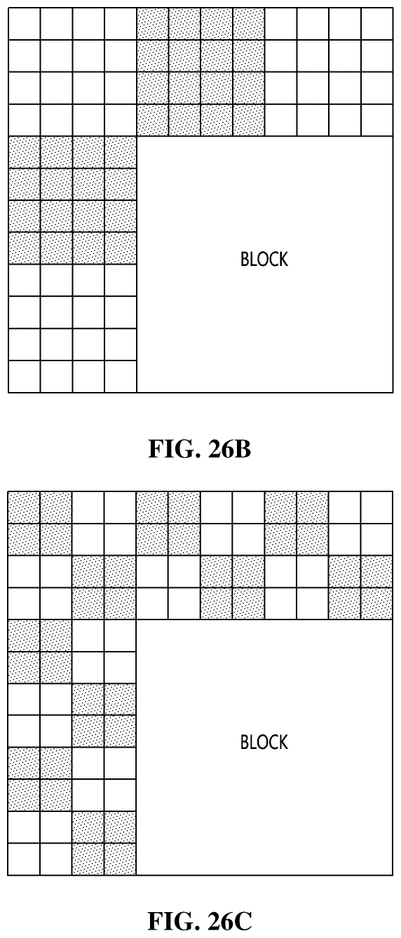

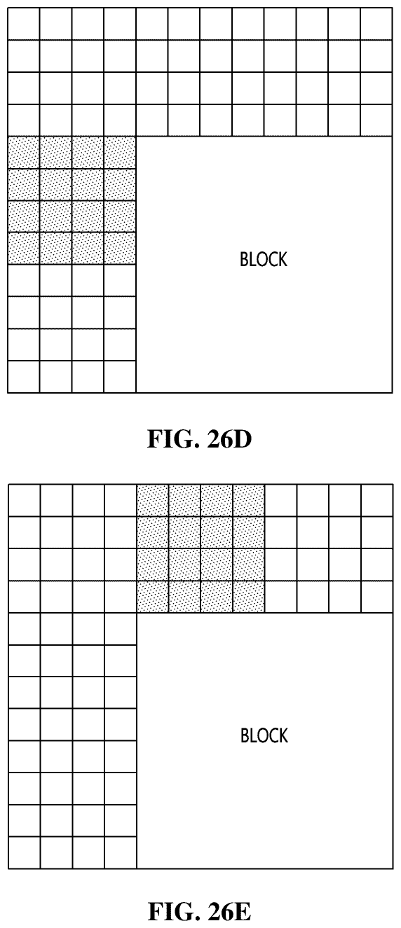

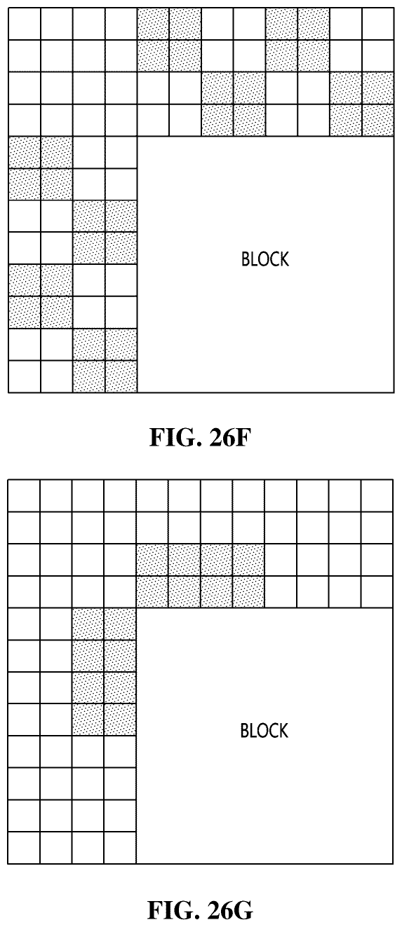

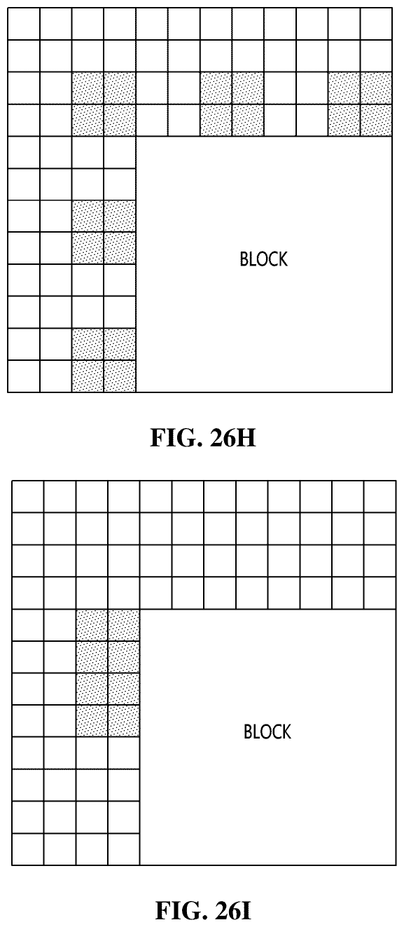

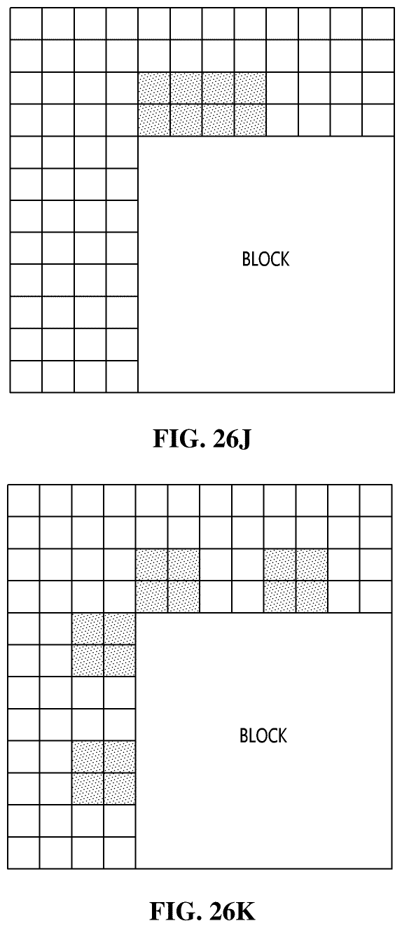

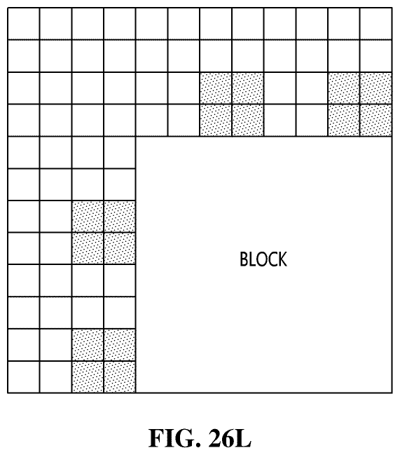

FIGS. 26A to 26L illustrate subsampling that uses the unit of subblocks for a region adjacent to a block according to an example.

In embodiments, when subsampling is applied to a region, the unit of selection is described as being a pixel (or position). However, the unit of selection in subsampling may be a subblock. In other words, in description of subsampling, a pixel or a position may be replaced with a subblock.

In embodiments, each subblock may be a partitioned portion in the block described in embodiments. The block may be partitioned into multiple subblocks. Further, each subblock may be a partitioned portion in the region described in embodiments. The region may be partitioned into multiple subblocks.

In other words, each subblock may indicate multiple pixels (or positions) in the block or region. Here, blocks or positions may be adjacent to each other.

In other words, description of selection of a pixel or a position in subsampling, described in embodiments, may also be applied to a subblock.

Each of a left region, a left-above region, and an above region, descried in embodiments, may also be regarded as a subblock.

A subblock may have a specific size. Description of the size of the block or region, described in embodiments, may also be applied to the subblock.

The shapes of the block and region, described in embodiments, may also be applied to the subblock.

For example, as illustrated in FIGS. 25A to 25J, subblocks may be squares having sizes, such as 16×16, 8×8, 4×4 and 2×2.

For example, as illustrated in FIGS. 26A to 26L, subblocks may be rectangles having sizes, such as 8×4, 4×8, 4×4, 4×2, 2×4 and 2×2.

### Search Method in Template Matching

### Definition of Search

For example, search in embodiments may be performed using the calculation of a cost function for determining similarity between NUM_TEMPLATE_COMPARE templates.

In embodiments, search may include a process of determining at least one piece of motion information that satisfies a specific condition within a specific search range. Based on at least one piece of motion information determined by the search, motion information of a target block may be determined and/or changed.

For example, motion information satisfying the specific condition may refer to motion information having the lowest matching cost among pieces of motion information within the search range. However, the motion information satisfying the specific condition is not limited thereto.

In embodiments, search may include a process of determining at least one block that satisfies a specific condition within a specific search range. Motion information indicating the block determined through the search may be used as the motion information of the target block.

For example, the block satisfying the specific condition may be one of reference blocks within the search range.

In embodiments, NUM_TEMPLATE_COMPARE may be 0, 1, 2 or a positive integer.

### Cost Function

A cost function may refer to a function used to determine the similarity between at least one sample in a target template and at least one sample in a reference template.

The similarity between a first value and a second value may be determined using at least one of 1) the difference between the two values, 2) the ratio of the two values, and 3) an operation of comparing the difference between two values with a specific value.

The cost function may be a function of determining the similarity between at least one sample in the target template and a sample in the reference template corresponding thereto.

The cost function may be one or more of the Sum of Absolute Differences (SAD), the Sum of Absolute Transformed Differences (SATD), the Mean-Removed Sum of Absolute Differences (MR-SAD), Mean Squared Error (MSE), and the Sum of Squared Error (SSE). However, cost functions are not limited to the above-listed items.

The cost function used in template matching may be predefined, or may be determined based on signaled/encoded/decoded information.

For example, in the case where the target block satisfies the enabling condition of bilateral matching and/or a part of the enabling condition of bilateral matching, or in the case where bilateral matching is performed on the target block, MR-SAD may be used as a cost function in template matching.

For example, in the case where the target block does not satisfy the enabling condition of bilateral matching and/or a part of the enabling condition of bilateral matching, or in the case where bilateral matching is not performed on the target block, SAD may be used as the cost function in template matching.

For example, based on whether the specific condition is satisfied in bilateral matching, the type of cost function in bilateral matching may be determined. In this case, the type of cost function in template matching may be determined based on whether 1) the enabling condition of bilateral matching and 2) the specific condition for determining the type of cost function in bilateral matching are satisfied.

For example, when the target block satisfies 1) the enabling condition of bilateral matching and 2) the specific condition, MR-SAD may be used as a cost function in bilateral matching, whereas when the target block does not satisfy those conditions, SAD may be used as a cost function in bilateral matching.

For example, in the case where the target block satisfies the enabling condition of bilateral matching; and inter weighted bi-prediction is performed or the number of samples in the target block is greater than a specific value, MR-SAD may be used as a cost function in template matching, otherwise SAD may be used as a cost function in template matching.

### Search Range

In embodiments, a search range may be a specific range centered on the position indicated by initial motion information. In other words, the center of the search range may be the position indicated by the initial motion information. The specific range may be a range having a predefined area.

The search range may be a specific range centered on the position indicated by the initial motion information. In other words, the center position of the search range may be the position indicated by the initial motion information.

Alternatively, the search range may be a specific range in which the position indicated by the initial motion information is a top-left position. In other words, the top-left position of the search range may be the position indicated by the initial motion information.

Alternatively, the search range may include at least one of samples located in a left-below region, a left region, a left-above region, an above region and a right-above region around the target block.

Alternatively, the search range may be composed of previously reconstructed regions around the target block. For example, the search range may include at least one of samples (or the positions of the samples) located in a left-below region, a left region, a left-above region, an above region and a right-above region around the target block.

At least one of the size and shape of the search range for the target block may be predefined by the encoding apparatus 1600 and the decoding apparatus 1700.

Alternatively, at least one of the size and shape of the search range of the target block may be determined based on at least one of the size of the target block, the coding parameter of the target block, the motion information of the target block, and the prediction mode of the target block.

Alternatively, information indicating one of the size and shape of the search range for the target block may be encoded/decoded/signaled.

The search range may have a rectangular shape, a horizontal length of which is SR_X and a vertical length of which is SR_Y. Alternatively, the search range may have a diamond shape, a horizontal length of which is SR_X and a vertical length of which is SR_Y. However, the shape and size of the search range are not limited by the above-described embodiments.

Each of SR_X and SR_Y may be a positive integer. Each of SR_X and SR_Y may be a predefined value or a value determined based on signaled/encoded/decoded information.

The initial motion information may be determined based on at least one of motion information of the target block, a coding parameter of the target block, a motion vector of the target block, a reference image of the target block, a block vector of the target block, a motion vector predictor of the target block, a block vector predictor of the target block, motion information of at least one neighboring block of the target block, a merge candidate of the target block, a motion vector difference of the target block, and a block vector difference of the target block.

### Search Method

Types of the search method may be classified depending on one or more of 1) a search pattern, 2) search resolution, 3) a search range, 4) initial motion information, and 5) a unit in which initial motion information is derived. However, criteria based on which the types of search method are classified are not limited to such conditions.

Each search method may be determined based on at least one of the motion information of a target block, the coding parameter of the target block, the size of the target block, the prediction mode of the target block, the reference image of the target block, the sample value of at least one sample within the target block, a target template, the sample value of at least one sample within the target template, and the region of the target template.

### Search Pattern

The search pattern may be one of a diamond pattern, a cross pattern, and a full-search pattern. However, the search pattern is not limited to the above-listed patterns.

A search using the diamond pattern may refer to an operation of searching for one or more of locations of (0, 2×RR), (RR, RR), (2×RR, 0), (RR, −RR), (0, −RR), (−RR, −RR), (−RR, 0), (−RR, RR), and (0, 0) when (0, 0) represents a location indicated by initial motion information.

A search using the cross pattern may be an operation of searching for one or more of locations of (0, RR), (RR, 0), (0, −RR), (−RR, 0) and (0, 0) when (0, 0) represents a location indicated by initial motion information.

RR may refer to search resolution, and may be a predefined positive number.

The search using the full-search pattern may be an operation of searching for all locations within a predefined search range.

For example, assuming that FS_i has values ranging from −FS_X to FS_X and FS_j has values from −FS_Y to FS_Y, the search using the full-search pattern may refer to an operation of searching for locations corresponding to (FS_i×RR, FS_j×RR). Here, (0, 0) may be a location indicated by the initial motion information. However, the search range is not limited to the above-described locations. Each of FS_X and FS_Y may be a predefined positive number.

### Search Resolution

The search resolution may be one of 4-pel, full-pel, half-pel, and quarter-pel. However, the search resolution is not limited to the above-described pels.

The search resolution may be predefined. Alternatively, the search resolution may be determined based on at least one of pieces of information about the resolution of an adaptive motion vector. Further, the search resolution may be determined based on signaled/encoded/decoded values.

### Derivation of Motion Information

In embodiments, a unit in which motion information is derived may be the entire block or a subblock.

In other words, motion information may be derived for the entire block. Pieces of motion information may be derived for subblocks, respectively.

### Search Method in Template Matching

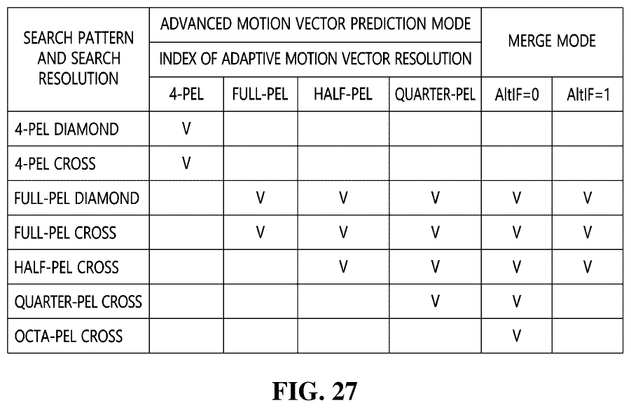

FIGS. 27 to 31 illustrate search patterns in template matching according to an example.

FIG. 27 illustrates a first relationship between search patterns and resolution according to an example.

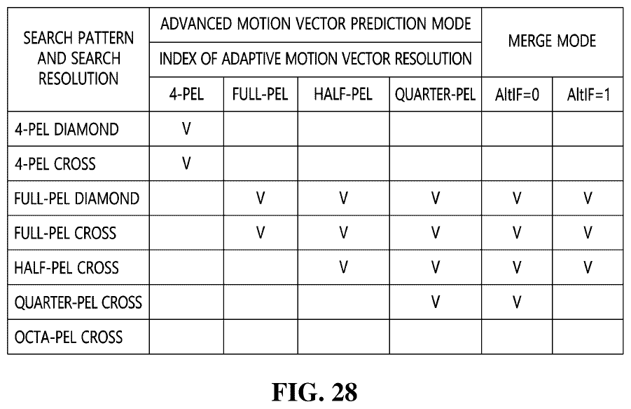

FIG. 28 illustrates a second relationship between search patterns and resolution according to an example.

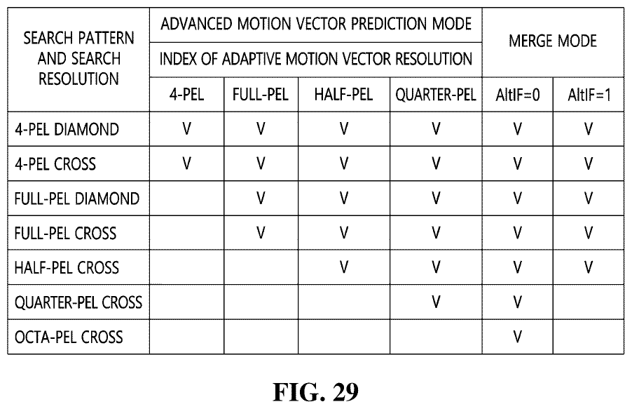

FIG. 29 illustrates a third relationship between search patterns and resolution according to an example.

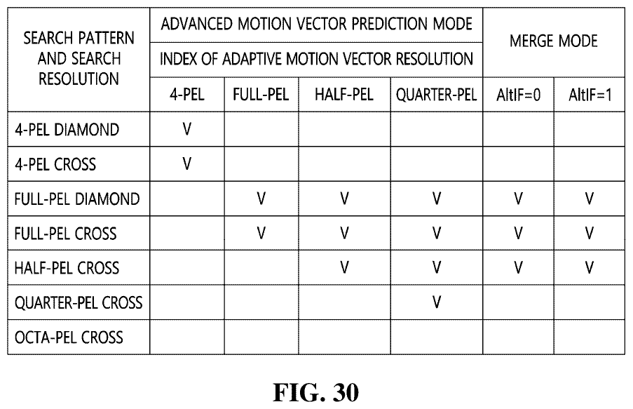

FIG. 30 illustrates a fourth relationship between search patterns and resolution according to an example.

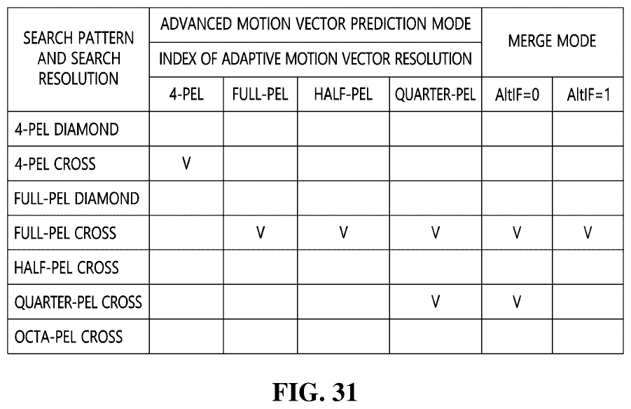

FIG. 31 illustrates a fifth relationship between search patterns and resolution according to an example.

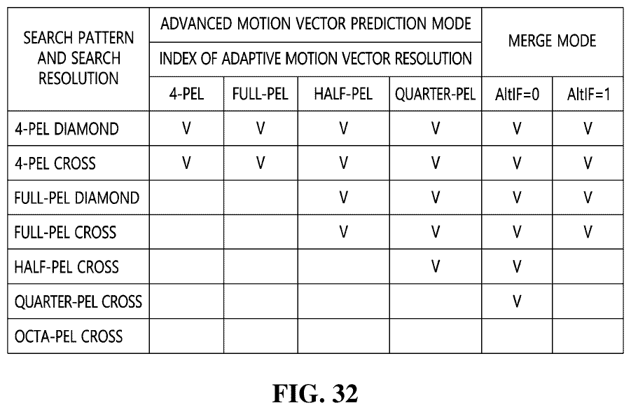

FIG. 32 illustrates a sixth relationship between search patterns and resolution according to an example.

In an embodiment, the search patterns and resolution may be configured based on the motion information, coding parameter, prediction mode and adaptive motion vector resolution of the target block. The search patterns and resolution may be changed depending on the motion information, coding parameter, prediction mode, and adaptive motion vector resolution of the target block.

The search patterns and resolution in a search step of template matching may be configured based on tables illustrated in FIGS. 27 to 32.

A specific column may be selected from the tables illustrated in FIGS. 27 to 32 based on the motion information, coding parameter, prediction mode and adaptive motion vector resolution of the target block. Search using search patterns and search resolution, which correspond to rows in which “v” is marked in the order from the top to bottom of the selected column, may be performed.

For example, in FIG. 27, when an AMVP mode is used for the target block and resolution determined through adaptive motion vector resolution is 4-pel, search for a diamond pattern using 4-pel search resolution is performed, after which search for a cross pattern using the 4-pel search resolution may be performed.

AltIF may denote the index of an adaptive interpolation filter. In order to calculate a pixel value at the sample position of specific resolution, an interpolation filter may be applied. The adaptive interpolation filter may be an interpolation filter selected by the index from among multiple interpolation filters. In other words, when the adaptive interpolation filter is applied, different interpolation filters may be used depending on the index so as to calculate the pixel value at the sample position of specific resolution.

For example, the specific resolution may be half-pel. However, the specific resolution is not limited to the half-pel.

For example, the interpolation filter determined by the index may be one of a 6-tap interpolation filter and an 8-tap interpolation filter. However, a method for determining the interpolation filter is not limited to the above-described determination method.

### Template Configuration Method in Affine Mode

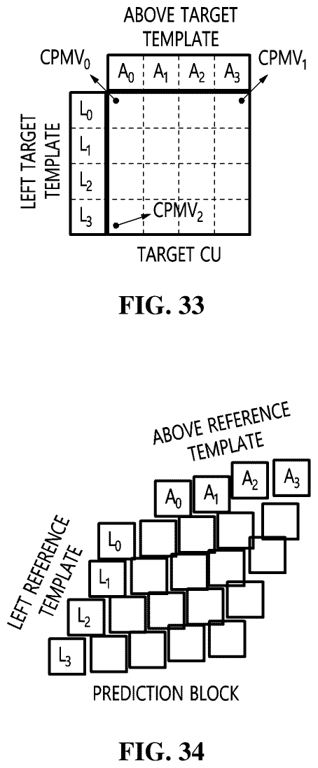

FIG. 33 illustrates a first template configuration method in an affine mode according to an example.

FIG. 34 illustrates a second template configuration method in an affine mode according to an example.

A CPMV may refer to an affine control point motion vector. The motion vector of each subblock in a target block may be derived using the CPMV.

When the affine mode is used for the target block, the target block may be partitioned into units of subblocks. Here, the width of each subblock may be N, and the height thereof may be M.

The motion information of each subblock may be determined based on at least one of the motion information, the coding parameter, and the size of the target block.

Template matching cost for the target block may be determined based on at least one of template matching costs for partitioned subblocks. For example, template matching cost for the target block may be the sum of the template matching costs for the partitioned subblocks, or the average of the template matching costs for the subblocks.

Each of N and M may 2, 4, 8 or a positive integer.

Each of N and M may be a predefined value, or may be a value determined based on signaled/encoded/decoded information.

### Template Matching in Bidirectional Prediction Block

In embodiments, the value of specific information of a specific target may be used as the value of specific information of another target. Alternatively, the specific information of another target may be determined based on the specific information of the specific target. Such usage and determination may be represented by “inheritance”.

For example, the motion information of the target block may be determined based on the motion information of the neighboring block. A determination based on the dependency relationship may be represented by “the target block has inherited motion information from the neighboring block”.

For example, when a merge mode is used for the target block, one merge candidate may be specified from a merge candidate list based on a merge index, and motion information of the specified merge candidate may be used as the motion information of the target block.

For example, when an AMVP mode is used for the target block, one MV candidate may be specified from an MV candidate list based on an MV candidate index, and motion information of the specified MV candidate may be used as the motion information of the target block.

When the motion information inherited by the target block from the neighboring block indicates bidirectional prediction, an embodiment in which template matching is performed on the target block may be described in the following steps:

[Step 1] Template matching may be performed in each of an L0 direction and an L1 direction. Template matching costs C0 and C1 for pieces of motion information determined for the L0 direction and the L1 direction may be calculated.

Here, when template matching for each direction is performed, template matching may be performed depending on the same method as a method for performing template matching in unidirectional prediction for the corresponding direction without considering motion information in other directions.

Here, when the target block satisfies a predefined condition, MR-SAD may be used as a cost function, whereas when the target block does not satisfy the predefined condition, SAD may be used as the cost function.

The predefined condition may be a condition based on at least one of whether a model-based prediction method is performed on the target block; an indicator indicating whether the model-based prediction method is performed on the target block; whether bilateral matching is performed on the target block; an indicator indicating whether bilateral matching is performed on the target block; the motion information of the target block; the size of the target block; the coding parameter of the target block; the motion information of a neighboring block of the target block; the coding parameter of the neighboring block of the target block; and the type of cost function in template matching in the neighboring block of the target block.

For example, when the model-based prediction method is performed on the target block or when the indicator indicating whether the model-based prediction method is performed on the target block is true, MR-SAD may be used as a cost function, otherwise SAD may be used as the cost function.

For example, when bilateral matching is performed on the target block or when an indicator indicating whether bilateral matching is performed on the target block is true; and the number of samples in the target block is equal to or greater than a specific value, MR-SAD may be used as a cost function, otherwise SAD may be used as the cost function.

The cost function may refer to a cost function used for search in template matching; and/or a cost function used to calculate at least one of C0, C1 and C′. The cost function used for search in template matching and the cost function used to calculate at least one of C0, C1 and C′ may be identical to or different from each other.

For example, during search in template matching, MR-SAD may be used as the cost function, and C0, C1 and C′ may be calculated using SAD.

[Step 2] When C0<C1, a new target template T′ may be generated using the target template and a template in the L0 direction.

For example, T may be the target template, TO may be a reference template in the L0 direction, and T1 may be a reference template in the L1 direction.

Here, T′ may be determined by the following [Equation 2].

$${T}^{′} = {w}_{r} \times T + {w}_{r 0} \times T 0 \qquad [ Equation 2 ]$$

Each of wᵣ and wᵣ₀ may be a predefined value.

Each of wᵣ and wᵣ₀ may be a value determined based on whether inter weighted bi-prediction is performed on the target block; and/or weights in the inter weighted bi-prediction.

For example, wᵣ may be 2. wᵣ₀ may be −1.

When C0>C1, a new target template T′ may be generated using the target template and a template in the L1 direction.

When one of the cases where value of C0 and the value of C1 are equal to each other, where C0<C1, and where C1>C0 is present, a procedure corresponding to [Step 2] may be performed.

[Step 3] When C0<C1, template matching may be performed using T′ as a target template in the L1 direction. Template matching cost C′ for motion information determined for the L1 direction may be calculated.

When C0>C1, template matching may be performed using T′ as a target template in the L0 direction. Template matching cost C′ for motion information determined for the L0 direction may be calculated.

When one of the cases where value of C0 and the value of C1 are equal to each other, where C0<C1, and where C1>C0 is present, a procedure corresponding to [Step 3] may be performed.

[Step 4] When the following Equation 3 is satisfied, the motion information of the target block may be changed to motion information indicating unidirectional prediction in the L0 direction or L1 direction based on the value of C0 and the value of C1.

$${C}^{′} = {w}_{c 0} \times C 0 + {w}_{c 1} \times T 1 \qquad [ Equation 3 ]$$

When C0<C1, the motion information of the target block may be changed to motion information indicating unidirectional prediction in the L0 direction. Alternatively, it may be considered that motion information in the L1 direction is unavailable in the target block.

When C0>C1, the motion information of the target block may be changed to motion information indicating unidirectional prediction in the L0 direction. Alternatively, it may be considered that motion information in the L1 direction is unavailable in the target block.

When one of the cases where value of C0 and the value of C1 are equal to each other, where C0<C1, and where C1>C0 is present, a procedure corresponding to [Step 4] may be performed.

Each of w_{c0} and w_{c1} may be a predefined value.

Each of w_{c0} and w_{c1} may be a value determined based on whether inter weighted bi-prediction is performed on the target block; and/or weights in inter weighted bi-prediction.

For example, w_{c0} may be 1, and w_{c1} may be ⅛.

For example, [Step 2] to [Step 4] may be performed only when the target block satisfies a predefined condition.

For example, the [Step 2] to [Step 4] may be performed only 1) when bidirectional prediction is used for the target block; and 2) when bilateral matching is not performed on the target block or when the target block does not satisfy the enabling condition of bilateral matching.

### Signaling Based on Neighboring Availability

Whether at least one of signaling, encoding, and decoding of information for a specific mode is performed may be determined based on the availability of the neighboring block of a target block or the availability of the surrounding sample of the target block.

When processing of the target block is performed, the specific mode may be a mode which refers to the neighboring block of the target block and/or the surrounding sample of the target block.

In embodiments, processing may include at least one of prediction, reconstruction, and decoding.

For example, when processing of the target block is performed, the specific mode may be a mode in which a template including the neighboring block of the target block and/or the surrounding sample of the target block is configured.

For example, the specific mode may include a template matching mode.

At least one of signaling, encoding, and decoding of information for the specific mode may be performed only when the neighboring block of the target block and/or the surrounding sample of the target block is available.

For example, the availability of the neighboring block of the target block and/or the availability of the surrounding sample of the target block may be verified, and at least one of signaling, encoding, and decoding of the information for the specific mode may be performed only when the neighboring block of the target block and/or the surrounding sample of the target block are available. Otherwise, at least one of signaling, encoding, and decoding of information for information for the specific mode may not be performed, and information for the specific mode may be determined to be a predefined value.

The predefined value may be 0 or false. Alternatively, the predefined value may be 1 or true. Alternatively, the predefined value may be an integer.

### Average Template

A target template may include a surrounding reconstructed sample of a target block.

However, because a target template for the target block cannot be configured until the reconstruction of the surrounding sample is performed and it is required to wait for the completion of reconstruction of the surrounding sample, a latency issue may occur.

In order to solve this latency issue, the target template may be replaced with an average template in the description of embodiments.

For example, template matching cost may refer to the result of calculation of a cost function between the reference template and the average template.

In embodiments, description of the target template and the reference template may also be equally applied to the average template. For example, such description may include a template configuration method, subsampling, and the like.

The average template may be determined based on at least one piece of motion information.

For example, the average template may be a reference template for a block indicated by one piece of motion information.

Alternatively, the average template may be determined based on N reference templates for N blocks indicated by N pieces of motion information.

Alternatively, the average template may be determined to be the statistical value of N reference templates for N blocks indicated by N pieces of motion information.

Alternatively, the average template may be determined to be the statistical value, described in embodiments, of N reference templates for N blocks indicated by N pieces of motion information.

For example, the statistical value may be one of an average value, a median value, and a weighted average value.

N may be 2, 3, 4, 5, 6, 8, 12, or a positive integer.

N may be a fixed value, and may be a value determined regardless of the target block.

Alternatively, N may be a value determined based on at least one of the prediction mode of the target block; the motion information of the target block; the coding parameter of the target block; the size of the target block; the range of values the luma component of the target block can have; the range of values the chroma component of the target block can have; the availability of the neighboring block of the target block; the coding parameter of the neighboring block of the target block; the surrounding sample of the target block; and motion information.

For example, assuming that the value of N is 2, a first reference template is configured as {sample1(1), sample 1(2)}, a second reference template is configured as {sample2(1), sample2(2)}, the average and the weighted average value of the first reference template and the second reference template may be {(sample1(1)+sample2(1))/2, (sample1(2)+sample2(2))/2} and {α×sample1(1)+(1−α)×sample2(1), α×sample1(2)+(1−α)×sample2(2)}, respectively.

α may be a real number.

Location from which Motion Information Required to Determine Average Template is Derived

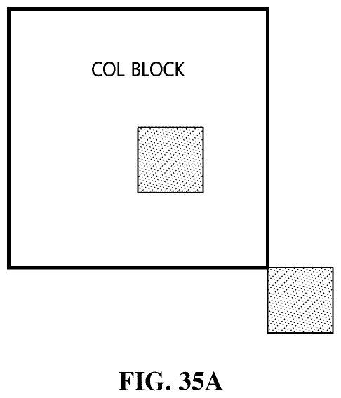

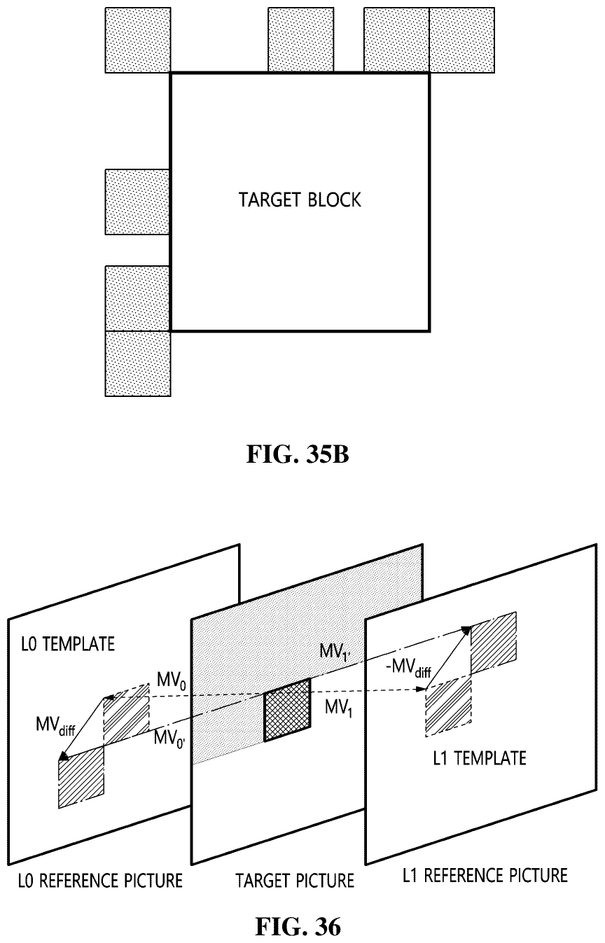

FIG. 35A illustrates first locations from which motion information is to be derived according to an example.

FIG. 35B illustrates second locations from which motion information is to be derived according to an example.

The first locations may be the locations determined based on a col block.

The second locations may be locations determined based on a target block.

At least one of pieces of motion information required to determine the average template may be at least one of motion information of the surroundings of the target block and/or motion information in a specific motion information list.

For example, at least one of pieces of motion information required to determine the average template may be motion information at a specific location around the target block.

The specific location may be one of shaded locations in FIGS. 35A and 35B.

For the shaded locations in FIGS. 35A and 35B, whether motion information is present may be checked based on a predetermined order. For the location for which motion information is first determined to be present, a reference template for a block indicated by motion information at the corresponding location may be used as an average template.

Alternatively, for the shaded locations in FIGS. 35A and 35B, whether motion information is present may be checked based on a predetermined order. For NN locations for which motion information is first determined to be present, the average value of reference templates for blocks indicated by pieces of motion information at the corresponding NN locations may be used as the average template.

For example, at least one of pieces of motion information required to determine the average template may be one of pieces of motion information in an AMVP candidate list or a merge candidate list.

For example, for NN pieces of motion information having the lowest index in the merge candidate list, the average value of reference templates of blocks indicated by the pieces of motion information may be used as the average template.

NN may be 2, 3, 4, 5, 6, 8, 12, or a positive integer.

NN may be a fixed value, and may be a value determined regardless of the target block. Alternatively, NN may be a value determined based on at least one of the prediction mode of the target block; the motion information of the target block; the coding parameter of the target block; the size of the target block; the range of values the luma component of the target block can have; the range of values the chroma component of the target block can have; the availability of the neighboring block of the target block; the coding parameter of the neighboring block of the target block; the surrounding sample of the target block; and motion information.

### Bilateral Matching (BM)

Bilateral matching may use a reference block in an L0 direction and a reference block in an L1 direction as templates, and may calculate a cost function (or bilateral matching cost) between the two templates. Based on the result of calculation of the cost function between the two templates, the motion information of a target block may be determined and/or changed. The determination and/or change of the motion information may refer to the refinement of the motion information.

A reference block may include at least one of 1) a reference block indicated by motion information, 2) a reference block indicated by motion information derived in a search process in bilateral matching, and 3) a reference block indicated by motion information finally refined by bilateral matching.

The bilateral matching cost may refer to the result value of calculation using the cost function between the templates of the reference block in the L0 direction and the reference block in the L1 direction, which are used in bilateral matching.

### Subsampling in Bilateral Matching

### Subsampling in Template Configuration for Bilateral Matching

For example, when a template for bilateral matching is configured, a reference block in an L0 direction and a reference block in an L1 direction may be used as templates.

When a template for bilateral matching is configured, only some of pixels and/or positions within the reference block in the L0 direction and the reference block in the L1 direction may be selected. The template may be configured using only the selected pixels and/or the selected positions.

The template for bilateral matching may refer to at least one of a template in the L0 direction and a template in the L1 direction.

For example, when the template for bilateral matching is configured, subsampling for the reference block in the L0 direction and the reference block in the L1 direction may be used.

For example, when the template for bilateral matching is configured, subsampling for a part of the reference block in the L0 direction and a part of the reference block in the L1 direction may be used.

Alternatively, for example, when the template for bilateral matching is configured, each of the reference block in the L0 direction and the reference block in the L1 direction may be partitioned into two or more regions. Each of the partitioned regions may be one of 1) a first region to which subsampling is applied, 2) a second region to which subsampling is not applied and which is used to configure a template, and 3) a third region which is not used to configure a template. The template for bilateral matching may be configured using pixels and/or positions selected by subsampling on the first region and pixels and/or positions in the second region.

Alternatively, for example, when the template for bilateral matching is configured, each of the reference block in the L0 direction and the reference block in the L1 direction may be partitioned into two or more regions. Each of the partitioned regions may be one of 1) a first region to which subsampling is applied and 2) a third region which is not used to configure a template. The template for bilateral matching may be configured using the pixels and/or positions selected by the subsampling on the first region.

For example, when the template for bilateral matching is configured, regions used for the configuration of the template may be a partial region of the reference block in the L0 direction and a partial region of the reference block in the L1 direction.

For example, when the template for bilateral matching is configured, pixels (or positions) used for the configuration of the template may be selected only from the partial region of the reference block in the L0 direction and the partial region of the reference block in the L1 direction.

The size of the partial region of the reference block in the L0 direction may be smaller than the size of the region of the reference block in the L0 direction.

For example, the height (or vertical size) of the partial region of the reference block in the L0 direction may be less than the height (or vertical size) of the reference block in the L0 direction.

For example, the width (or horizontal size) of the partial region of the reference block in the L0 direction may be less than the width (or horizontal size) of the reference block in the L0 direction.

The size of the partial region of the reference block in the L1 direction may be smaller than the size of the region of the reference block in the L1 direction.

For example, the height (or vertical size) of the partial region of the reference block in the L1 direction may be less than the height (or vertical size) of the reference block in the L1 direction.

For example, the width (or horizontal size) of the partial region of the reference block in the L1 direction may be less than the width (or horizontal size) of the reference block in the L1 direction.

### Subsampling in Calculating of Cost Function Between Templates for Bilateral Matching

For example, when a cost function between templates in bilateral matching is calculated, only some of pixels and/or positions in a template region may be selected. The calculation of the cost function may be performed only on the selected pixels and/or the selected positions.

For example, when the cost function between templates in bilateral matching is calculated, subsampling may be performed on a template region in an L0 direction and a template region in an L1 direction.

For example, when the cost function between templates in bilateral matching is calculated, subsampling may be performed on a portion of the template region in the L0 direction and a portion of the template region in the L1 direction.

Alternatively, for example, when the cost function between templates in bilateral matching is calculated, each of the template region in the L0 direction and the template region in the L1 direction may be partitioned into two or more regions. Each of the partitioned regions may be one of 1) a first region to which subsampling is applied, 2) a second region to which subsampling is not applied and which is used to calculate a cost function, and 3) a third region which is not used to calculate a cost function. The cost function between templates in bilateral matching may be calculated using 1) pixels and/or positions selected by subsampling on the first region and 2) pixels and/or positions in the second region.

Alternatively, for example, when the cost function between templates in bilateral matching is calculated, each of the template region in the L0 direction and the template region in the L1 direction may be partitioned into two or more regions. Each of the partitioned regions may be one of 1) a first region to which subsampling is applied and 2) a third region which is not used to calculate a cost function. The cost function between templates in bilateral matching may be calculated using the pixels and/or positions selected by the subsampling on the first region.

For example, when the cost function between templates in bilateral matching is calculated, regions used to calculate the cost function may be a partial region of the template in the L0 direction and a partial region of the template in the L1 direction.

The size of the partial region of the template in the L0 direction may be smaller than the size of the region of the template in the L0 direction.

For example, the height (vertical size) of the partial region of the template in the L0 direction may be less than the height (vertical size) of the template in the L0 direction.

For example, the width (horizontal size) of the partial region of the template in the L0 direction may be less than the width (horizontal size) of a block of the template in the L0 direction.

The size of the partial region of the template in the L1 direction may be smaller than the size of the region of the template in the L1 direction.

For example, the height (or vertical size) of the partial region of the template in the L1 direction may be less than the height (or vertical size) of the template in the L1 direction.

For example, the width (or horizontal size) of the partial region of the template in the L1 direction may be less than the width (or horizontal size) of the template in the L1 direction.

### Subsampling for Search Area in Bilateral Matching

When searching process in bilateral matching is performed, only some of pixels and/or positions in a search area may be selected. Search and/or matching cost calculation may be performed only on the selected pixels and/or the selected positions. Alternatively, search and/or matching cost calculation may be performed only on pieces of motion information indicating the selected pixels and/or the selected positions.

For example, when searching process in bilateral matching is performed, subsampling may be performed on all or part of the search area.

Alternatively, for example, when search in bilateral matching is performed, the search area may be partitioned into two or more regions. Each of the partitioned regions may be one of 1) a first region to which subsampling is applied, 2) a second region to which subsampling is not applied and searching process is applied, and 3) a third region to which searching process is not applied. Searching process in bilateral matching may be performed on pixels and/or positions selected by subsampling on the first region and pixels and/or positions in the second region. Alternatively, searching process in bilateral matching may be performed on pieces of motion information indicating the pixels and/or positions selected by subsampling on the first region and the pixels and/or positions in the second region.

Alternatively, for example, when search in bilateral matching is performed, the search area may be partitioned into two or more regions. Each of the partitioned regions may be one of 1) a first region to which subsampling is applied and 2) a third region to which search is not applied. Search in bilateral matching may be performed using 1) the pixels and/or positions selected by the subsampling on the first region. Alternatively, searching process in bilateral matching may be performed on pieces of motion information indicating the pixels and/or positions selected by subsampling on the first region.

### Examples of Subsampling in Bilateral Matching

Reference is again made to FIGS. 22A to 22T. FIGS. 22A to 22T illustrate various examples of a subsampling method in bilateral matching.

Each drawing of FIGS. 22A to 22T may show regions to which subsampling is applied. Small rectangles in each drawing may represent samples or positions. The region may be a reference region, a region of a reference block and/or a template region.

For example, in each drawing of FIGS. 22A to 22T, a leftmost-uppermost rectangle in each region may be a sample or position having coordinates (0, 0) in the region.

In FIGS. 22A to 22T, although the size of the region is illustrated as 8×8, the size is only an example, and the subsampling method illustrated in FIGS. 22A to 22T may also be applied to regions having various sizes.

The samples (or positions) indicated using shading in the region of each drawing may represent samples (or positions) selected by subsampling. The samples (or positions) indicated in white color in the region of each drawing may represent samples (or positions) that are not selected by subsampling.

Subsampling such as that shown in FIGS. 22A to 22T may be performed on the region of a reference block in an L0 direction and the region of a reference block in an L1 direction, and a template may be configured using only the samples (or positions) selected by the subsampling.

Subsampling such as that shown in FIGS. 22A to 22T may be performed on a partial region of the reference block in the L0 direction and a partial region of the reference block in the L1 direction, and a template may be configured using only the samples (or positions) selected by the subsampling.

Subsampling such as that shown in FIGS. 22A to 22T may be performed on all or part of the template region in bilateral matching, and calculation of a cost function may be performed only on the samples (or positions) selected by the subsampling.

Subsampling such as that shown in FIGS. 22A to 22T may be performed on all or part of a search area in bilateral matching, and search and/or matching cost calculation may be performed only on the pixels and/or positions selected by the subsampling.

Subsampling such as that shown in FIGS. 22A to 22T may be performed on all or part of a search area in bilateral matching, and search and/or matching cost calculation may be performed only on pieces of motion information indicating the selected pixels and/or positions.

### Enabling Condition in Bilateral Matching

Bilateral matching may be operated only when a predefined enabling condition is satisfied.

For example, bilateral matching may always be operated.

For example, bilateral matching may be performed when an inter-prediction mode is used for a target block and two or more reference blocks are used.

For example, bilateral matching may be performed only when a first direction and a second direction are different from each other and a first POC interval and a second POC interval are identical to each other.

Alternatively, for example, bilateral matching may be performed only when the first direction and the second direction are different from each other. That is, when the first direction and the second direction are different from each other, bilateral matching may be performed even in the case where the first POC interval and the second POC interval are different from each other.

Alternatively, for example, bilateral matching may be performed even when the first direction and the second direction are identical to each other.

Alternatively, bilateral matching may be performed even when the first direction and the second direction are identical to each other and one of the first POC interval and the second POC interval is identical to a reference image POC difference.

In embodiments, the reference image POC difference may be the difference between POC of a reference image in the L0 direction and POC of a reference image in the L1 direction.

Alternatively, for example, when the first direction and the second direction are identical to each other, bilateral matching may be performed only in the case where one of the first POC interval and the second POC interval is identical to a reference image POC difference.

In embodiments, the first direction may be a direction from the target image to a reference image in the L0 direction. The second direction may be a direction from the target image to a reference image in the L1 direction.

In embodiments, the first POC interval may be the difference between the POC of the target image and the POC of the reference image in the L0 direction. The second POC interval may be the difference between the POC of the target image and the POC of the reference image in the L1 direction.

For example, bilateral matching may be performed only when the first direction and the second direction are different from each other. The first direction may be the direction from the target image to the reference image in the L0 direction. The second direction may be a direction from the target image to a reference image in the L1 direction.

Here, the fact that the first direction and the second direction are different from each other may mean that the following Equation 4 is satisfied.

$$( P O {C}_{t} - POC 0 ) \times ( {POC}_{t} - POC 1 ) < 0 \qquad [ Equation 4 ]$$

Here, the fact that the first direction and the second direction are identical to each other may mean that the following Equation 5 is satisfied.

$$( P O {C}_{t} - P O C 0 ) \times ( {POC}_{t} - POC 1 ) > 0 \qquad [ Equation 5 ]$$

POCₜ may be the POC of the target image.

POC0 may be the POC of the reference image in the L0 direction.

POC1 may be the POC of the reference image in the L1 direction.

The enabling condition of bilateral matching may be determined based on at least one of at least one reference image in an L0 direction reference list; and at least one reference image in an L1 direction reference list.

Whether bilateral matching is operated may be determined based on at least one of at least one reference image in the L0 direction reference list; and at least one reference image in the L1 direction reference list.

Whether bilateral matching is permitted may be determined based on at least one of at least one reference image in the L0 direction reference list; and at least one reference image in the L1 direction reference list.

For example, when the directions of all reference images in the L0 direction reference list and all reference images in the L1 direction reference list are identical to each other, bilateral matching may not be performed on the target image.

For example, when the directions of all reference images in the L0 direction reference list and all reference images in the L1 direction reference list are not identical to each other, bilateral matching may be performed on the target image.

For example, even when the directions of all reference images in the L0 direction reference list and all reference images in the L1 direction reference list are identical to each other, bilateral matching may be performed on the target image.

### Search Range in Bilateral Matching

For example, in bilateral matching, the size of a search range (or a search area) in an L0 direction and the size of a search range (or a search area) in an L1 direction may be identical to each other.

Alternatively, for example, in bilateral matching, the size of a search range (or a search area) in an L0 direction and the size of a search range (or a search area) in an L1 direction may be determined based on a first POC interval and a second POC interval. Here, the search ranges may be identical to each other. Alternatively, the search ranges may be different from each other.

For example, in bilateral matching, a search range (or a search area) in an LX direction may be a rectangle that has a location (or a block), indicated by motion information in the LX direction, as the center, and that has a height of a first value and a width of a second value. The first value and the second value may be identical to or different from each other.

The first value and the second value may be predefined values. Alternatively, each of the first value and the second value may be a value determined based on at least one of the prediction mode of the target block; the motion information of the target block; the coding parameter of the target block; the size of the target block; the range of values the luma component of the target block can have; the range of values the chroma component of the target block can have; the availability of the neighboring block of the target block; the coding parameter of the neighboring block of the target block; the surrounding sample of the target block; and motion information.

X may be 0 or 1. X may always be 0. Alternatively, X may always be 1. Alternatively, X may be 1 when the second POC interval is greater than the first POC interval, otherwise X may be 0. Alternatively, X may be 0 when the second POC interval is greater than the first POC interval, otherwise X may be 1.

Here, a search range (or search area) in an L(1−X) direction may be a rectangle that has a location (or a block), indicated by motion information in the L(1−X) direction, as the center, and that has a height of a third value and a width of a fourth value.

The third value and the fourth value may be values determined based on the first value and the second value, respectively.

In an example, the third value may be a value determined based on the first value, the first POC interval, and the second POC interval. The fourth value may be a value determined based on the second value, the first POC interval, and the second POC interval.

In an example, the third value may be a value derived by multiplying or dividing the first value by (first POC interval/second POC interval).

In an example, the fourth value may be a value derived by multiplying or dividing the second value by (first POC interval/second POC interval).

In another example, the third value may be the larger of a derived value and a predetermined value. Here, the derived value may be a value derived by multiplying or dividing the first value by (first POC interval/second POC interval).

In a further another example, the fourth value may be the larger of the derived value and the predetermined value. Here, the derived value may be a value derived by multiplying or dividing the second value by (first POC interval/second POC interval).

For example, the predetermined value may be 4, 8, 16, 32, or a positive integer. The predetermined value may be a value determined based on at least one of the prediction mode of the target block; the motion information of the target block; the coding parameter of the target block; the size of the target block; the range of values the luma component of the target block can have; the range of values the chroma component of the target block can have; the availability of the neighboring block of the target block; the coding parameter of the neighboring block of the target block; the surrounding sample of the target block; and motion information.

### Search Steps of Bilateral Matching

Bilateral matching may include one or more search steps.

For example, bilateral matching may be configured to sequentially include 1) the step of deriving motion information of the entire block and 2) the step of deriving motion information of subblocks of the block. However, the methods of deriving motion information, performed at respective steps, and the order of respective steps are not limited to the above-described configurations.

At each search step of bilateral matching, motion information in BM_NUM directions among the motion information in the L0 direction and the motion information in the L1 direction may be refined. BM_NUM may be 0, 1, 2 or a positive integer. BM_NUM values used at steps of bilateral matching may be identical to or different from each other.

For example, when BM_NUM is 1 at the specific search step, refinement of the motion information may be performed only for motion information in LX_{BM} direction at the specific search step.

For example, when BM_NUM is 1 and X_{BM} is 0 at the specific search step, only a search in the L0 direction may be performed in the state in which the template in the L1 direction and the motion information in the L1 direction are fixed, at the specific search step.

X_{BM} may be 0, 1 or a positive integer.

X_{BM} may be predefined.

For example, the X_{BM} direction may be a direction having a greater POC interval out of the L0 direction and the L1 direction. POC interval may be the difference between the POC of the reference image (in a specific direction) and the POC of the target image.

For example, the X_{BM} direction may be a direction having higher template matching cost of the L0 direction and the L1 direction. Here, the template matching cost for the specific direction may be template matching cost for motion information in the specific direction.

For example, the information about X_{BM} may be signaled/encoded/decoded.

For example, X_{BM} may be 0 when a first POC difference is greater than a second POC difference. X_{BM} may be 1 when the first POC difference is less than or equal to the second POC difference.

For example, X_{BM} may be 1 when the first POC difference is greater than the second POC difference. X_{BM} may be 0 when the first POC difference is less than or equal to the second POC difference.

The first POC difference may be the difference between the POC of a target image and the POC of a reference image in the L0 direction. The second POC difference may be the difference between the POC of the target image and the POC of a reference image in the L1 direction.

For example, X_{BM} may be determined based on a context model and/or a probability model that are used to perform entropy encoding and entropy decoding on the motion information and the coding parameter of the target block.

For example, X_{BM} may be determined based on at least one of a context model and/or a probability model that are used in entropy encoding and entropy decoding on the inter-prediction indicator of the target block.

For example, a more powerful direction for the target block between unidirectional prediction in the L0 direction and unidirectional prediction in the L1 direction may be selected as the LX_{BM} direction, based on the context model and/or the probability model that are used in entropy encoding and entropy decoding on the inter-prediction indicator. For example, a more powerful direction for the target block between unidirectional prediction in the L0 direction and unidirectional prediction in the L1 direction may be selected as the LX_{BM} direction, based on the context model and/or the probability model that are used in entropy encoding and entropy decoding on the inter-prediction indicator.

Alternatively, a more powerful direction for the target block between unidirectional prediction in the L0 direction and unidirectional prediction in the L1 direction may be selected as an L(1−X_{BM}) direction, based on the context model and/or the probability model that are used in entropy encoding and entropy decoding on the inter-prediction indicator. For example, a more powerful direction for the target block between unidirectional prediction in the L0 direction and unidirectional prediction in the L1 direction may be selected as an L(1−X_{BM}) direction, based on the context model and/or the probability model that are used in entropy encoding and entropy decoding on the inter-prediction indicator.

The more powerful direction may refer to a direction which fewer bits are used in performing entropy encoding using the context model and/or the probability model. Alternatively, the more powerful direction may refer to a direction having a higher probability of being indicated by the context model and/or the probability model.

For example, LX_{BM} may be determined based on the weights of inter bi-prediction for the target block. For example, LX_{BM} may be a direction having a higher inter bi-prediction weight of the L0 direction and the L1 direction. Alternatively, for example, LX_{BM} may be a direction having a lower inter bi-prediction weight of the L0 direction and the L1 direction.

For example, X_{BM} may be determined based on at least one of pieces of motion information and pieces of coding information of neighboring blocks.

For example, X of the target block may be determined based on at least one of pieces of motion information and pieces of coding information of one or more neighboring blocks corresponding to at least one of A0, A1, B0, B1 and B2 of FIG. 11.

For example, X_{BM} of the target block may be determined based on at least one of inter-prediction indicators and inter bi-prediction weights of the neighboring blocks.

For example, one or more context models and/or probability models may be used to perform entropy encoding and entropy decoding on X_{BM}.

Among the multiple context models and/or multiple probability models, the context model and/or the probability model to be used for entropy encoding and entropy decoding on X_{BM} of the target block may be determined, based on at least one of the pieces of motion information and pieces of coding information of the neighboring blocks.

For example, context models and/or probability models used to perform entropy encoding and entropy decoding on X_{BM} in blocks may be identical to each other. Alternatively, context models and/or probability models used to perform entropy encoding and entropy decoding on X_{BM} in blocks may be different from each other depending on at least one of the inter-prediction direction and inter bi-prediction weight of the corresponding neighboring block.

At the search steps of bilateral matching processes, the same X_{BM} may be used. Alternatively, at the search steps of bilateral matching processes, different X_{BM} values may be respectively used.

For example, when bilateral matching is performed, a cost function used for the calculation of the bilateral matching cost may be determined based on the weights in inter bi-prediction with weights for the target block and/or the weight indices of inter bi-prediction with weights.

In embodiments, bi-prediction with weights may refer to bi-prediction with CU-level weights (BCW).

For example, when a first weight and a second weight of the target block are identical to each other, bilateral matching cost may be calculated using SAD or SATD. When the first weight and the second weight of the target block are different from each other, bilateral matching cost may be calculated using MR-SAD or MR-SATD. Here, the first weight may be the weight of inter bi-prediction with weights in the L0 direction. The second weight may be the weight of inter bi-prediction with weights in the L1 direction.

BM_NUM may be 0, 1, 2 or a positive integer.

BM_NUM may be predefined.

BM_NUM at each search step of bilateral matching may be determined based on coding parameters. Alternatively, BM_NUM may be determined based on at least one of motion information, the search step of bilateral matching, matching cost at a previous search step, matching cost for initial motion information at a current search step, and BM_NUM at the previous search step.

For example, at the first search step of bilateral matching, BM_NUM may be 1 or 2.

For example, BM_NUM at the current search step may be determined based on the matching cost at the previous search step.

For example, when the difference between the matching cost for the initial motion information at the previous search step and matching cost for refined motion information at the previous search step is less than COSTDIFF_FORBMNUM, BM_NUM at the current search step may be 0.

COSTDIFF_FORBMNUM_INIT may be 0, 1, 2, 4, 8, 16 or a positive integer.

For example, COSTDIFF_FORBMNUM may be determined based on the size of the target block. COSTDIFF_FORBMNUM may be the product of the number of pixels in the target block and a specific value. The specific value may be 0, 1, 2, 4, 8 or a positive integer.

For example, when BM_NUM at the previous search step is 0, BM_NUM at the current search step may be 0.

For example, when matching cost for the initial motion information at the current search step is less than COSTDIFF_FORBMNUM_INIT, BM_NUM of the target block may be 0.

COSTDIFF_FORBMNUM_INIT may be 0, 1, 2, 4, 8, 16 or a positive integer.

For example, COSTDIFF_FORBMNUM_INIT may be determined based on the size of the target block. COSTDIFF_FORBMNUM_INIT may be the product of the number of pixels in the target block and a specific value. The specific value may be 0, 1, 2, 4, 8 or a positive integer.

For example, when motion refinement is performed at the search step of bilateral matching, refinement of motion information in the L0 direction may be performed only in the case where matching cost for L0 direction motion information of the initial motion information at the current search step is greater than COSTDIFF_FORBMNUM_INIT.

For example, when motion refinement is performed at the search step of bilateral matching, refinement of motion information in the L1 direction may be performed only in the case where matching cost for L1 direction motion information of the initial motion information at the current search step is greater than COSTDIFF_FORBMNUM_INIT.

COSTDIFF_FORBMNUM may be 0, 1, 2, 4, 8, 16 or a positive integer.

For example, COSTDIFF_FORBMNUM_INIT may be determined based on the size of the target block. COSTDIFF_FORBMNUM_INIT may be the product of the number of pixels in the target block and a specific value. The specific value may be 0, 1, 2, 4, 8 or a positive integer.

The case where BM_NUM at the specific search step of bilateral matching is 0 may indicate that the refinement of motion information is not performed at the specific search step. Alternatively, the case where BM_NUM at the specific search step of bilateral matching is 0 may indicate that the specific search step is not performed.

For example, when bilateral matching is performed, BM_NUM at a motion information derivation step for the entire block may be 1, and BM_NUM at a motion information derivation step for a subblock may be 2. In this case, at the motion information derivation step for the entire block, only motion information in the LX_{B}M direction may be refined, and at the motion information derivation step for the subblock, both motion information in the L0 direction and motion information in the L1 direction may be refined.

FIG. 36 illustrates bilateral matching according to an example.

In FIG. 36, the case where BM_NUM at a motion information derivation step for the entire block in bilateral matching is 2 is illustrated.

MV0 may be initial motion information in L0 direction.

MV1 may be initial motion information in L1 direction.

MV_{diff} may refer to a motion information refinement value derived through bilateral matching.

MV0′ and MV1′ may be pieces of motion information derived through bilateral matching.

In bilateral matching, the magnitude of the motion information refinement value for the L0 direction and the magnitude of the motion information refinement value for the L1 direction may be identical to each other. The direction of the motion information refinement value for the L0 direction and the direction of the motion information refinement value for the L1 direction may be opposite to each other. That is, the following Equations 6 and 7 may be satisfied.

$$M V {0}^{′} = M V 0 + M {V}_{d i f f} \qquad [ Equation 6 ]$$

$$MV {1}^{′} = MV 1 - {MV}_{d i f f} \qquad [ Equation 7 ]$$

### Average Template

In bilateral matching, instead of using a reference block in an L0 direction and a reference block in an L1 direction as templates and determining and/or changing the motion information of the target block based on the result of calculating a cost function between two templates, an average template may be used.

The motion information of the target block may be determined and/or changed based on at least one of the result of calculating a cost function between the reference block in the L0 direction and the average template; and the result of calculating a cost function between the reference block in the L1 direction and the average template.

For example, bilateral matching cost may refer to the sum of the result of calculating a cost function between the reference block in the L0 direction and the average template; and the result of calculating a cost function between the reference block in the L1 direction and the average template.

In embodiments, description of the target block and the reference block may also be equally applied to the target template. For example, such a description may include a block configuration method, subsampling, and the like.

The average template may be determined based on at least one piece of motion information.

For example, the average template may be a block indicated by one piece of motion information.

Alternatively, for example, the average template may be determined based on N blocks indicated by N pieces of motion information.

Alternatively, for example, the average template may be determined to be the statistical value of N blocks indicated by N pieces of motion information.

For example, the average template may be determined to be the statistical value, described in embodiments, of N blocks indicated by N pieces of motion information.

For example, the statistical value may be one of an average value, a median value, and a weighted average value.

N may be 2, 3, 4, 5, 6, 8, 12, or a positive integer.

N may be a fixed value, and may be a value determined regardless of the target block. Alternatively, N may be a value determined based on at least one of the prediction mode of the target block; the motion information of the target block; the coding parameter of the target block; the size of the target block; the range of values the luma component of the target block can have; the range of values the chroma component of the target block can have; the availability of the neighboring block of the target block; the coding parameter of the neighboring block of the target block; the surrounding sample of the target block; and motion information.

For example, assuming that the value of N is 2, a first reference template is configured as {sample1(1), sample 1(2)}, a second reference template is configured as {sample2(1), sample2(2)}, the average and the weighted average value of the first reference template and the second reference template may be {(sample1(1)+sample2(1))/2, (sample1(2)+sample2(2))/2} and {α×sample1(1)+(1−α)×sample2(1), α×sample1(2)+(1−α)×sample2(2)}, respectively.

α may be a real number.

At least one of pieces of motion information required to determine the average template may be at least one of motion information of the surroundings of the target block and/or motion information in a specific motion information list.

Location from which Motion Information Required to Determine Average Template is Derived

Reference is again made to FIGS. 35A and 35B. FIG. 35A may illustrate first locations from which motion information is to be derived according to an example. FIG. 35B may illustrate second locations from which motion information is to be derived according to an example. The first locations may be the locations determined based on a col block. The second locations may be locations determined based on a target block.

At least one of pieces of motion information required to determine the average template may be at least one of motion information of the surroundings of the target block and/or motion information in a specific motion information list.

For example, at least one of pieces of motion information required to determine the average template may be motion information at a specific location around the target block.

The specific location may be one of shaded locations in FIGS. 35A and 35B.

For the shaded locations in FIGS. 35A and 35B, whether motion information is present may be checked based on a predetermined order. For the location for which motion information is first determined to be present, a block indicated by motion information at the corresponding location may be used as an average template.

Alternatively, for the shaded locations in FIGS. 35A and 35B, whether motion information is present may be checked based on a predetermined order. For NN locations for which motion information is first determined to be present, the average value of the blocks indicated by pieces of motion information at the corresponding NN locations may be used as the average template.

For example, at least one of pieces of motion information required to determine the average template may be one of pieces of motion information in an AMVP candidate list or a merge candidate list.

For example, for NN pieces of motion information having the lowest index in the merge candidate list, the average value of blocks indicated by the pieces of motion information may be used as the average template.

NN may be 2, 3, 4, 5, 6, 8, 12, or a positive integer.

NN may be a fixed value, and may be a value determined regardless of the target block. Alternatively, NN may be a value determined based on at least one of the prediction mode of the target block; the motion information of the target block; the coding parameter of the target block; the size of the target block; the range of values the luma component of the target block can have; the range of values the chroma component of the target block can have; the availability of the neighboring block of the target block; the coding parameter of the neighboring block of the target block; the surrounding sample of the target block; and motion information.

### Subsampling

### Subsampling Method

Subsampling in embodiments may be performed based on at least one of whether template matching is performed; an indicator indicating whether template matching is performed; whether bilateral matching is performed; an indicator indicating whether bilateral matching is performed; motion information of a target block; the coding parameter of the target block; and a search step in template matching and/or bilateral matching.

For example, the subsampling method may be determined based on at least one of whether template matching is performed; an indicator indicating whether template matching is performed; whether bilateral matching is performed; an indicator indicating whether bilateral matching is performed; motion information of a target block; the coding parameter of the target block; and a search step in template matching and/or bilateral matching.

For example, in performing template matching and/or bilateral matching, a subsampling method that is used may be identical for search steps.

Alternatively, for example, in performing template matching and/or bilateral matching, a subsampling method that is used may differ depending on the search steps.

### Whether Subsampling is Performed

Whether subsampling in embodiments is performed may be determined based on at least one of whether template matching is performed; an indicator indicating whether template matching is performed; whether bilateral matching is performed; an indicator indicating whether bilateral matching is performed; motion information of a target block; the coding parameter of the target block; and a search step in template matching and/or bilateral matching.

For example, whether subsampling is performed may be determined based on at least one of whether template matching is performed; an indicator indicating whether template matching is performed; whether bilateral matching is performed; an indicator indicating whether bilateral matching is performed; motion information of a target block; the coding parameter of the target block; and a search step in template matching and/or bilateral matching.

For example, in performing template matching and/or bilateral matching, whether subsampling is performed may be identical for search steps.

Alternatively, for example, in performing template matching and/or bilateral matching, whether subsampling is performed may differ depending on the search steps.

For example, whether subsampling is performed in a horizontal direction and whether subsampling is performed in a vertical direction may be identical to each other.

For example, whether subsampling is performed in a horizontal direction and whether subsampling is performed in a vertical direction may be different from each other.

In template matching and/or bilateral matching, a subsampling method at a search step in which search for the entire target block is performed and a subsampling method at a search step in which search for a subblock in the target block is performed may be identical to each other. Alternatively, in template matching and/or bilateral matching, a subsampling method at a search step in which search for the entire target block is performed and a subsampling method at a search step in which search for a subblock in the target block is performed may be different from each other.

### Decoder-Side Motion Information Derivation (DMID)

In embodiments, a decoder-side motion information derivation method may include 1) template matching, 2) bilateral matching, 3) derivation of new motion information using refinement of motion information, 4) reordering of motion information based on matching cost, and 5) specification of location in a search area based on matching cost.

### Derivation of New Motion Information Using Refinement of Motion Information

As decoder-side motion information derivation, second motion information may be derived by performing refinement on the motion information.

A prediction block for the target block may be generated by performing prediction using the second motion information.

At least one of reference blocks of the target block may be specified using the second motion information.

In embodiments, refinement of specific information may refer to amending, correcting, or updating the specific information. In embodiments, the terms “refinement”, “amendment”, and “correction” may be used interchangeably with each other. Refined information may be generated by performing refinement on the specific information.

Performing refinement on the specific motion information may mean that at least one of the following methods is performed on the specific motion information.
1) Changing specific information included in the specific motion information to a predetermined offset
2) Changing specific information included in specific motion information to a result derived by performing a specific operation on the specific information and a predetermined offset

Here, the specific operation may include at least one of squaring, weighted averaging, weighted summation, four fundamental arithmetic operations, and filtering.

The predetermined offset may include at least one of a motion vector, a reference picture index, an inter-prediction indicator, reference picture list information, a reference image, a motion vector candidate, a motion vector candidate index, a merge candidate, a merge index, a block vector, a block vector candidate, and a block vector candidate index.

For example, the predetermined offset may be specified from a predetermined offset candidate list.

Information for specifying the predetermined offset may be signaled/encoded/decoded.

An index for specifying at least one offset from the predetermined offset candidate list may be signaled/encoded/decoded.

### Reordering of Motion Information Based on Matching Cost

As decoder-side motion information derivation, reordering of at least one of pieces of motion information in a list composed of N pieces of motion information may be performed based on matching costs of respective pieces of motion information in the list.

In embodiments, reordering of a specific target may refer to sorting of the specific target or elements in the specific target.

For example, the order of pieces of motion information in the list composed of N pieces of motion information may be reordered in ascending order of matching cost.

For example, the order of at least one piece of motion information in the list composed of N pieces of motion information may be reordered in ascending order of matching cost.

For example, after at least one piece of motion information in the list composed of N pieces of motion information is reordered, the list may be reconstructed.

Reconstructing the specific motion information list may mean at least one of 1) constructing a list using only some of pieces of motion information constituting the specific motion information list; 2) removing at least one of pieces of motion information constituting the specific motion information list from the list; and 3) inserting at least one piece of new motion information into the specific motion information list.

For example, in inserting the new motion information, the new motion information may be motion information determined based on at least one piece of motion information in the motion information list. For example, the new motion information may be the average or weighted average of two pieces of motion information having the lowest index in the motion information list.

Alternatively, for example, in inserting the new motion information, the new motion information may be default motion information.

N may be 2, 3, 4, 6, 8, 12 or a positive integer.

At least one piece of motion information may be specified from the reordered list.

A prediction block for the target block may be generated by performing prediction using the motion information specified from the reordered list.

At least one of reference blocks of the target block may be specified using the motion information specified from the reordered list.

For example, the list composed of N pieces of motion information may refer to a motion information merge candidate list for the target block. For example, the list composed of N pieces of motion information may refer to a list constructed by a decoder-side motion information derivation method.

### Specification of Location in Search Area Based on Matching Cost

As decider-side motion information derivation, a method for specifying at least one location in a search area based on matching cost and/or a method for specifying at least one of some locations in the search area based on matching costs may be used.

In embodiments, “location” and “motion information” may be used interchangeably with each other.

In embodiments, “specific location” may be used interchangeably with “motion information indicating a movement from the target block to the specific location”. In embodiments, the specific location may refer to motion information indicating a movement from the target block to the specific location.

In embodiments, the specific motion information may refer to a location indicated by the specific motion information from the target block.

In embodiments, specifying the location may mean that a sample at the described location is specified.

In embodiments, specifying the location may mean that motion information indicating a movement from the target block to the described location is specified.

For example, the decoder-side motion information derivation method may specify locations having the lowest N matching costs among locations within the search area.

The matching cost for the specific location may represent matching cost for motion information indicating a movement from the target block to the specific location.

For example, N locations having the lowest N matching costs within the search area may be specified. Alternatively, N locations having the lowest N matching costs among some locations within the search area may be specified.

N may be 1, 2, 3, 4, 5, 6, 8, 12 or a positive integer.

A list may be constructed using the specified N locations. At least one location may be specified in the constructed list, and prediction for the target block may be performed based on the specified location.

Information for specifying the location from the list may be signaled/encoded/decoded.

### Another Embodiment of Reordering and Specification of Motion Information

In embodiments, as criteria for the reordering of motion information and the specification of motion information, matching cost for the motion information has been described.

In addition to reordering and specification in ascending order of matching cost, reordering and specification may be performed using other criteria.

In the following description, each candidate may refer to motion information, location, or sample.

In a reordering and/or specification process according to an embodiment, when the difference between the costs of a candidate and a predecessor of the candidate is inferior to λ (i.e., |D1−D2|<λ), the candidate may be considered to be redundant. Here, D1 and D2 may be costs obtained during first reordering of motion information, and λ may be a Lagrangian parameter used in a RD criterion on the encoder side. Alternatively, D1 and D2 may be the template matching costs of the candidate and the predecessor of the candidate, respectively, or template matching costs of the predecessor of the candidate and the candidate, respectively.

A proposed algorithm may be defined as follows:

The minimum cost difference between each candidate and the predecessor of the candidate, among all candidates in a list, is determined.

When the minimum cost difference is equal to or greater than λ, the list may be considered to be sufficiently diverse and reordering may be stopped.

When the minimum cost difference is less than λ, the candidate may be considered to be redundant, and may be moved to a further position in the list. Such a further position may be a first position where the candidate becomes sufficiently diverse compared to the predecessor of the candidate.

The algorithm may be stopped after a finite number of repetitions are performed (if the minimum cost difference is not less than λ).

Such an algorithm may be applied to a regular merge mode, a TM merge mode, a BM merge mode, and an affine merge mode.

### Adaptive Filter Selection

In order to improve image coding efficiency, an image encoding/decoding method, apparatus, and bitstream storage medium, which include an adaptive filter selection method, are disclosed in embodiments.

In performing image encoding/decoding, at least one of filters used in a target block may be adaptively selected through an adaptive filter selection method. By means of this selection, coding efficiency may be improved.

The filter in embodiments may refer to at least one of a motion compensation filter, an interpolation filter, a reference sample filter, a prediction block filter, a prediction block boundary filter, an in-loop filter, a deblocking filter, an adaptive sample offset, an adaptive in-loop filter, a reference block filter, an upsampling filter, and a downsampling filter.

For example, filtering using the filter selected through the adaptive filter selection method may be performed on the reference block of the target block. Here, the reference block filter may refer to a filter applied to the reference block.

For example, down-filtering that uses the filter selected through the adaptive filter selection method may be performed on a luma component block of the target block.

For example, a prediction block for the target block may be generated by performing filtering on a first block using at least one of the filters selected through the adaptive filter selection method.

For example, when the target block is a luma component block, the first block may refer to at least one of at least one of reference blocks of the target block; a neighboring block of the target block; and a chroma component block corresponding to the target block.

For example, when the target block is a chroma component block, the first block may refer to at least one of at least one of reference blocks of the target block; a chroma component of at least one of reference blocks of the target block; a neighboring block of the target block; a luma component block corresponding to the target block; and a block generated by applying a downsampling filter to the luma component block corresponding to the target block.

For example, filtering may be performed on the prediction block of the target block using at least one of filters selected through an adaptive filter selection method.

The prediction mode of the target block may include at least one of intra-prediction, inter-prediction, template matching, cross-component prediction, and intra block copy. Furthermore, the prediction mode of the target block may refer to another prediction method described in embodiments.

Cross-component prediction may refer to a prediction method for generating a prediction sample of a chroma component by deriving a mapping model from a luma component sample to a chroma component sample and by applying the derived mapping model to luma component samples.

For example, the luma component sample may include at least one of a luma component prediction sample, a luma component reconstructed sample, a luma component residual sample, a downsampled luma component sample, and a luma component sample on which filtering using a predetermined filter is performed.

The predetermined filter may be a filter selected through the adaptive filter selection method.

For example, cross-component prediction may include a Cross-Component Linear Model (CCLM).

In embodiments, the filter may include at least one of a one-dimensional (1D) filter, a two-dimensional (2D) filter, and a three-dimensional (3D) filter.

For example, filter f may be applied, as shown in the following [Equation 8].

$$Y = f ( X ) \qquad [ Equation 8 ]$$

Here, Y may denote the result of filtering. X may denote the filter input of the filter.

For example, before filtering is performed, a predetermined operation may be performed on filter inputs, and filtering may be performed using the result of the operation. That is, instead of the above-described [Equation 8], the following [Equation 9] may be applied.

$$Y = f ( {X}^{′} ) \qquad [ Equation 9 ]$$

Here, X′ may denote a result derived by performing a predetermined operation on the filter input.

For example, the predetermined operation may be an operation of adding a certain value to the filter input, or an operation of subtracting a certain value from the filter input.

For example, the certain value may be the median value of values the luma component sample can have, the median value of values the chroma component sample can have, the average value of surrounding luma component samples of the target block, or the average value of surrounding chroma component samples of the target block.

For example, filter input X and filtering result Y may be defined by the following [Equation 10] and [Equation 11], respectively.

$$X = \{ {x}_{1} , {x}_{2} , … , {x}_{FILTER \_ INPUT \_ NUM} \} \qquad [ Equation 10 ]$$

$$Y = \{ {y}_{1} , {y}_{2} , … , {y}_{FILTER \_ INPUT \_ NUM} \} \qquad [ Equation 11 ]$$

Here, filter f may have the forms such as those in the following [Equation 12] and [Equation 13].

$${y}_{1} = {α}_{1 , 1} \times {x}_{1} + {α}_{2 , 1} \times {x}_{2} + … + {α}_{2 , 1 ( FILTER \_ INPUT \_ NUM ) , 1} \times {x}_{FILTER \_ INPUT \_ NUM} \qquad [ Equation 12 ]$$

$${y}_{2} = {α}_{1 , 2} \times {x}_{1} + {α}_{2 , 2} \times {x}_{2} + … + {α}_{2 , 1 ( FILTER \_ INPUT \_ NUM ) , 2} \times {x}_{FILTER \_ INPUT \_ NUM} \qquad [ Equation 13 ]$$

Here, α_{i,j} may denote the coefficient of filter f.

i may have one of the values from 1 to FILTER_INPUT_NUM.

j may have one of the values from 1 to FILTER_OUTPUT_NUM.

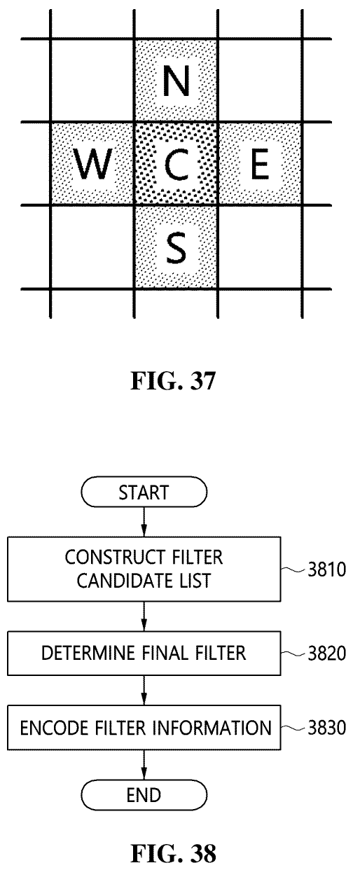

FIG. 37 illustrates a sample at a position on which current filtering is performed and samples adjacent to the sample according to an example.

The input of a filter may include a squared value of a specific sample value.

For example, in FIG. 37, C may denote a sample at the position on which current filtering is performed. In this case, the input of the filter may include a squared value of a sample value at the position corresponding to at least one of C, N, W, E, and S.

For example, the filter may have a form such as that shown in the following [Equation 14].

$$filtering result = c 0 \times C + c 1 \times N + c 2 \times S + c 3 \times E + c 4 \times W + c 5 \times {C}^{′} + c 6 \times B \qquad [ Equation 14 ]$$

C′ may be a squared value of C. Alternatively, C′ may be defined by the following

$${C}^{′} = ( C \times C + M ) >> BD \qquad [ Equation 15 ]$$

BD may denote a bit depth (bitdepth).

M may be the median value of a luma component or a chroma component. Alternatively, M may be defined by the following [Equation 16].

$$M = ( 1 << ( BD - 1 ) ) \qquad [ Equation 16 ]$$

B may be a bias value. For example, B may be (1<<(BD−1)), or the average value of surrounding luma component samples of the target block or the average value of surrounding chroma component samples of the target block.

### Filters in Embodiments

Hereinafter, embodiments in which an adaptive filter selection method is implemented will be described.

In embodiments, filters may be classified based on whether the filter is applied, filter coefficients, filter strength, a filter shape, a filter form, a filter length, the number of filter taps, the number of filters applied, the type of function used to derive the filter coefficients, the number of phases of the filter, the preprocessing method of filtering, the post-processing method of filtering, whether filtering is performed on a luma component, whether filtering is performed on a chroma component, whether different filters are used for the luma component and the chroma component, the symmetrical form of the filter, or the like. However, the criteria for classifying the filters are not limited to the above-described elements, and the features, attributes and/or information of the filter described in the embodiments may also be used as criteria for classification.

For example, the filter strength may refer to the strength of a deblocking filter.

For example, the number of filter taps may refer to at least one of a horizontal length, the vertical length, a first diagonal length, or a second diagonal length of the filter, and the number of filter coefficients in the filter.

For example, the number of filter taps may be at least one of 2-tap, 4-tap, 6-tap, 8-tap, 10-tap, 12-tap, 16-tap, 20-tap, and 24-tap, but the number of filter taps is not limited thereto.

For example, the function used to derive the filter coefficients may be at least one of a sinc function, a Discrete Cosine Transform-Interpolation Filter (DCT-IF) function, a DCT-2 function, a DCT-8 function, and a DST-7 function, but the type of function used to derive the filter coefficients is not limited thereto.

For example, the number of filter phases may be 2, 4, 8, 16, 32 or a positive integer.

For example, in applying the filter, filtering may be performed by utilizing two or more filters sequentially and/or in parallel.

For example, before the filter is applied, preprocessing may be performed on samples that are the target of filtering.

Although such preprocessing may be at least one of value clipping, transform using an activation function, adding a specific offset, and multiplying a specific offset, the type of preprocessing is not limited thereto. For example, the specific offset may be, but is not limited to, an integer.

For example, after the filter is applied, post-processing may be performed on samples to which filtering has been applied.

Although such post-processing may be at least one of value clipping, transform using an activation function, adding a specific offset, and multiplying a specific offset, the type of post-processing is not limited thereto. For example, the specific offset may be, but is not limited to, an integer.

The symmetrical form of the filter may refer to at least one of a point-symmetrical form, a horizontal-symmetrical form, a vertical-symmetrical form, and a combination of these forms.

For example, the filter may be classified based on the coefficients of a deblocking filter, the filter taps of the deblocking filter, the strength of the deblocking filter, and the shape/form of the deblocking filter.

The filter may be classified based on information indicating whether an adaptive in-loop filter is applied, the coefficients of the adaptive in-loop filter, filter taps of the adaptive in-loop filter, and the shape/form of the adaptive in-loop filter.

For example, the filter may be classified based on information indicating whether an adaptive sample offset is applied, an adaptive sample offset value, an adaptive sample offset category, an adaptive sample offset type, a band offset, and an edge offset.

### Encoding and Decoding Using Adaptive Filter Selection Method

FIG. 38 is a flowchart of an encoding method according to an embodiment.

Steps 3810, 3820, and 3830 may be performed by the processing unit 1610 of the encoding apparatus 1600.

At step 3810, a filter candidate list may be constructed. The filter candidate list may include multiple filter candidates.

At step 3820, a final filter may be determined. The final filter may be a filter determined to be used for filtering among the multiple filter candidates.

At step 3830, filter information may be encoded.

The filter information may indicate the final filter. Alternatively, the filter information may include information used to specify the final filter.

The filter information may include information used to construct the filter candidate list. The filter information may include information required to construct multiple filter candidates of the filter candidate list.

The encoding of filter information may refer to performing encoding on the filter information to generate encoded filter information. The encoded filter information may be generated through the encoding of the filter information.

The encoding of the filter information may refer to generating a bitstream including the filter information.

A bitstream including the filter information or the encoded filter information may be generated.

The communication unit 1620 of the encoding apparatus 1600 may transmit the bitstream to the decoding apparatus 1700.

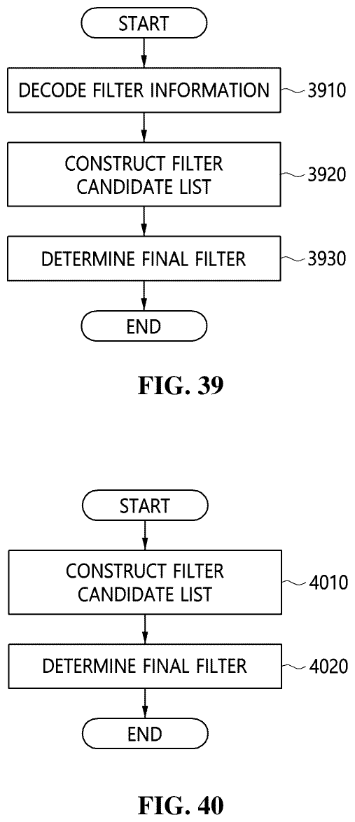

FIG. 39 is a flowchart of a decoding method according to an embodiment.

Steps 3910, 3920, and 3930 may be performed by the processing unit 1710 of the decoding apparatus 1700.

The communication unit 1720 of the decoding apparatus 1700 may receive the bitstream from the encoding apparatus 1600.

The bitstream may include filter information or encoded information.

At step 3910, the filter information may be decoded.

The decoding of the filter information may refer to obtaining the filter information from the bitstream.

The decoding of the filter information may refer to generating filter information by performing decoding on the encoded filter information obtained from the bitstream.

At step 3920, a filter candidate list may be constructed. The filter candidate list may include multiple filter candidates.

The filter information may include information used to construct the filter candidate list. The filter information may include information required to construct multiple filter candidates of the filter candidate list.

The filter candidate list may be constructed based on the filter information.

At step 3930, a final filter may be determined. The final filter may be a filter determined to be used for filtering among the multiple filter candidates.

The filter information may indicate the final filter. Alternatively, the filter information may include information used to specify the final filter.

The final filter may be determined using the filter information.

FIG. 40 illustrates the determination of a final filter excluding encoding/decoding according to an example.

In the encoding method described above with reference to FIG. 38, encoding of filter information may be skipped. In this case, step 4010 may correspond to step 3810. Step 4020 may correspond to step 3820.

In the decoding method described above with reference to FIG. 39, decoding of filter information may be skipped. In this case, step 4010 may correspond to step 3920. Step 4020 may correspond to step 3930.

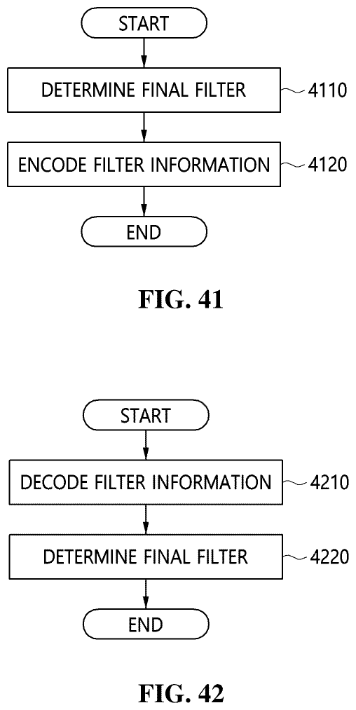

FIG. 41 illustrates the determination of a final filter excluding the construction of a list in encoding according to an example.

In the encoding method described above with reference to FIG. 38, a filter candidate list may not be explicitly constructed. In other words, the construction of the filter candidate list may be skipped. In this case, step 4110 may correspond to step 3820. Step 4120 may correspond to step 3830.

FIG. 42 illustrates the determination of a final filter excluding the construction of a list in decoding according to an example.

In the decoding method described above with reference to FIG. 39, a filter candidate list may not be explicitly constructed. In other words, the construction of the filter candidate list may be skipped. In this case, step 4210 may correspond to step 3910. Step 4220 may correspond to step 3930.

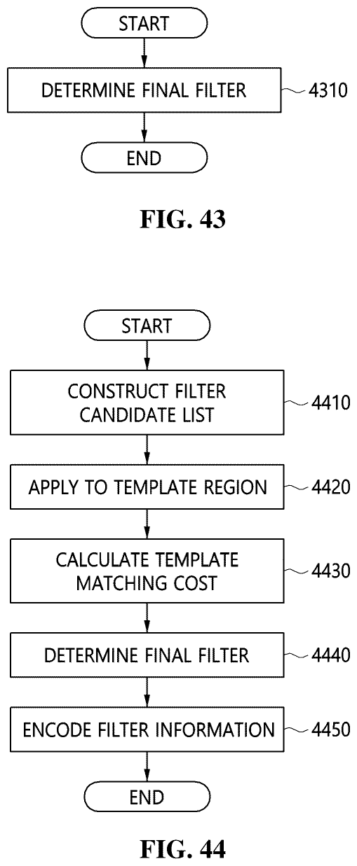

FIG. 43 illustrates the determination of a final filter excluding encoding/decoding and the construction of a list according to an example.

In the encoding method described above with reference to FIG. 38, the construction of a filter candidate list and the encoding of filter information may be skipped. In this case, step 4310 may correspond to step 3820.

In the decoding method described above with reference to FIG. 39, the decoding of filter information and the construction of the filter candidate list may be skipped. In this case, step 4310 may correspond to step 3930.

FIG. 44 is a flowchart of an encoding method using template matching costs according to an embodiment.

Steps 4410, 4420, 4430, 4440, and 4450 may be performed by the processing unit 1610 of the encoding apparatus 1600.

At step 4410, a filter candidate list may be constructed. The filter candidate list may include multiple filter candidates.

At step 4420, multiple filter candidates in a filter candidate list may be applied to a template region of a template.

At step 4430, template matching cost may be calculated.

At step 4440, a final filter may be determined. The final filter may be a filter determined to be used for filtering among the multiple filter candidates.

The final filter may be determined based on the matching costs of multiple filter candidates.

At step 4450, the filter information may be encoded.

The filter information may indicate the final filter. Alternatively, the filter information may include information used to specify the final filter.

The filter information may include information used to construct the filter candidate list. The filter information may include information required to construct the multiple filter candidates of the filter candidate list.

The encoding of filter information may refer to performing encoding on the filter information to generate encoded filter information. The encoded filter information may be generated through the encoding of the filter information.

The encoding of the filter information may refer to generating a bitstream including the filter information.

A bitstream including the filter information or the encoded filter information may be generated.

The communication unit 1620 of the encoding apparatus 1600 may transmit the bitstream to the decoding apparatus 1700.

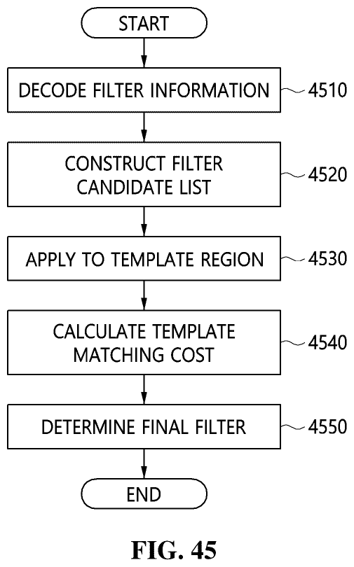

FIG. 45 is a flowchart of a decoding method using template matching costs according to an embodiment.

Steps 4510, 4520, 4530, 4540, and 4550 may be performed by the processing unit 1700 of the decoding apparatus 1710.

The communication unit 1720 of the decoding apparatus 1700 may receive a bitstream from the encoding apparatus 1600.

The bitstream may include filter information or encoded information.

At step 4510, the filter information may be decoded.

The decoding of the filter information may refer to obtaining the filter information from the bitstream.

The decoding of the filter information may refer to generating filter information by performing decoding on the encoded filter information obtained from the bitstream.

At step 4520, a filter candidate list may be constructed. The filter candidate list may include multiple filter candidates.

The filter information may include information used to construct the filter candidate list. The filter information may include information required to construct the multiple filter candidates of the filter candidate list.

The filter candidate list may be constructed based on the filter information.

At step 4530, multiple filter candidates in a filter candidate list may be applied to a template region of a template.

At step 4540, template matching cost may be calculated.

At step 4550, a final filter may be determined. The final filter may be a filter determined to be used for filtering among the multiple filter candidates.

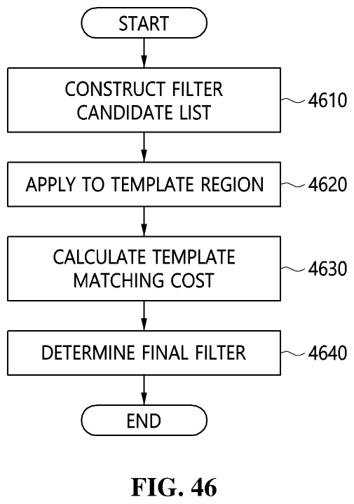

FIG. 46 illustrates the determination of a final filter excluding encoding/decoding according to an example.

In the encoding method described above with reference to FIG. 44, the encoding of filter information may be skipped. In this case, step 4410, step 4420, step 4430, and step 4440 may correspond to step 4610, step 4620, step 4630, and step 4640, respectively.

In the decoding method described above with reference to FIG. 45, the decoding of filter information may be skipped. In this case, step 4520, step 4530, step 4540, and step 4550 may correspond to step 4610, step 4620, step 4630, and step 4640, respectively.

### Adaptive Filter Selection Method

In encoding, an adaptive filter selection method according to an embodiment may include at least one of steps 3810, 3820, and 3830.

In decoding, the adaptive filter selection method according to an embodiment may include at least one of steps 3910, 3920, and 3930.

In encoding, the adaptive filter selection method according to an embodiment may include at least one of steps 4410, 4420, 4430, 4440, and 4450.

In decoding, the adaptive filter selection method according to an embodiment may include at least one of steps 4510, 4520, 4530, 4540, and 4550.

For example, by using the final filter selected through the adaptive filter selection method, at least one of interpolation filtering in inter-prediction, motion compensation filtering in inter-prediction, reference sample filtering, prediction block filtering, block boundary filtering, in-loop filtering, deblocking filtering, adaptive sample offset, and adaptive in-loop filtering may be performed.

For example, the final filter selected through the adaptive filter selection method may be determined to be at least one of an interpolation filter, a motion compensation filter, a reference sample filter, a prediction block filter, a block boundary filter, an in-loop filter, a deblocking filter, an adaptive sample offset, and an adaptive in-loop filter in the target block, and the final filter may be used for filtering.

For example, the final filter may be selected by the adaptive filter selection method based on at least one of interpolation and motion compensation(s) performed in inter-prediction for the target block, and at least one of interpolation filtering and motion compensation filtering may be performed using the selected final filter.

For example, for the inter-prediction for the target block, motion compensation using the final filter selected by the adaptive filter selection method may be performed in at least one of 1) a prediction block generation process and 2) a process of performing a decoder-side motion information derivation method. However, the case where motion compensation using the final filter selected through the adaptive filter selection method in inter-prediction is performed is not limited to the above-listed processes.

For example, although the decoder-side motion information derivation method in embodiments may refer to at least one of a template matching-based decoder-side motion information derivation method, a bilateral matching-based decoder-side motion information derivation method, and an optical flow-based decoder-side motion information derivation method, the type of the decoder-side motion information derivation method is not limited thereto.

For example, although the decoder-side motion information derivation method in embodiments may refer to at least one of a decoder-side motion vector refinement method, a Local Illumination Compensation (LIC) method, a method for reordering the order of candidates in a candidate list, a method for specifying one candidate from the candidate list, and a method of deriving sign information of a motion vector difference, the type of the decoder-side motion information derivation method is not limited thereto.

The local illumination compensation mode in embodiments may be a mode in which at least one of a weight and an offset is derived by calculating a correlation between the template of the target block and the template of the reference block, and at least one of the derived weight and the derived offset is multiplied by or added to a part the target block or the entire target block.

For example, the final filter selected by the adaptive filter selection method may be determined to be the motion compensation filter and/or the interpolation filter of the target block.

In an embodiment, the final filter of the target block may be specified from the filter candidate list of the target block.

Alternatively, in an embodiment, the final filter of the target block may be determined without a process of constructing the filter candidate list.

The final filter of the target block may be determined for a specific unit.

The specific unit may refer to at least one of units such as a sequence, a picture, a tile, a tile group, a slice, a Coding Tree Unit (CTU), a Coding Unit (CU), and a Prediction Unit (PU). However, the unit in which the final filter is selected is not limited to the above-listed units. The final filter may be applied to a unit used as the target of encoding/decoding described in embodiments.

### Determination of Whether Adaptive Filter Selection Method is Performed

For example, whether an adaptive filter selection method is performed on a target block may be determined by signaling/encoding/decoding information indicating whether the adaptive filter selection method is performed on the target block.

The information indicating whether the adaptive filter selection method is performed on the target block may be an indicator indicating whether the adaptive filter selection method is performed.

The information indicating whether the adaptive filter selection method is performed on the target block may be determined in at least one of the units described in embodiments, such as a sequence, a picture, a tile, a tile group, a slice, a CTU, a CU, or a PU.

For example, the adaptive filter selection method may always be performed on the target block.

For example, whether the adaptive filter selection method is performed on the target block may be implicitly determined.

For example, whether the adaptive filter selection method is performed on the target block may be determined based on at least one of the size of a target picture, the size of the target block, motion information of the target block, and the coding parameter of the target block.

For example, when a bi-prediction mode is used for a target block, whether adaptive filter selection methods for an L0 direction and an L1 direction are performed may be determined from a single integrated indicator.

For example, when the bi-prediction mode is used for the target block, whether an adaptive filter selection method is performed for each of the L0 direction and the L1 direction may be determined from an indicator for each of the directions.

For example, for the first direction, the adaptive filter selection method may be performed, and for the second direction, the adaptive filter selection method may not be performed. Here, the first direction and the second direction may refer to the L0 direction and the L1 direction, respectively. Alternatively, the first direction and the second direction may refer to the L1 direction and the L0 direction, respectively.

### Cross-Component Dependency

For example, a final filter for a chroma component may be determined based on at least one of a filter candidate list for a luma component and a final filter candidate for the luma component.

For example, the number of taps of the final filter for the chroma component may be determined based on the number of taps of the final filter for the luma component. For example, the number of taps of the final filter for the chroma component may be half the number of taps of the final filter for the luma component.

### Selection of Adaptive Filter Based on Modification of Filter

An adaptive filter selection method in embodiments may include the configuration of a filter or the modification of the filter depending on a specific method.

For example, adaptive filter selection may refer to changing the attributes, features and/or information of the filter depending on the specific method.

For example, adaptive filter selection may include the change of coefficients of the filter. The change of filter coefficients may be performed by a specific operation between the coefficient of the filters and an offset.

For example, a predetermined offset may be added to at least one coefficient of a first filter. Alternatively, a predetermined offset may be multiplied by at least one coefficient of the first filter. Alternatively, a predetermined offset may be subtracted from at least one coefficient of the first filter. Alternatively, at least one coefficient of the first filter may be divided by the predetermined offset.

Information about the predetermined offset may be signaled/encoded/decoded.

For example, the predetermined offset may be specified from an offset candidate list.

For example, information about the predetermined offset may be an index, and an offset corresponding to the index in an offset candidate list may be added to or multiplied by at least one coefficient of the first filter.

For example, the first filter may be determined based on surrounding samples of the target block. Alternatively, for example, the information about the first filter may be signaled/encoded/decoded, and the first filter may be determined based on this information.

As the coefficient of the filter is changed due to the offset, the determination of the offset described in embodiments may also be included in the adaptive filter selection method.

### Construction of Filter Candidate List

Below, the construction of the filter candidate list at steps 3810, 3920, 4410 and 4520 will be described.

The final filter of the target block may be specified from the filter candidate list.

For example, the filter candidate list may be constructed to include NUM_FILTER filter candidates. Alternatively, the maximum size of the filter candidate list may be NUM_FILTER.

NUM_FILTER may be a positive integer of 1 or more.

For example, NUM_FILTER may be determined by signaling/encoding/decoding the NUM_FILTER information.

For example, NUM_FILTER may be implicitly determined.

For example, NUM_FILTER may be implicitly determined for a specific unit described in embodiments. For example, the specific unit may be a CU or a PU.

For example, although NUM_FILTER may be determined based on at least one of the size of the target block, the motion information of the target block, the intra-prediction mode of the target block, and the coding parameter of the target block, the method for determining NUM_FILTER is not limited thereto.

For example, NUM_FILTER may be determined in at least one of the units described in embodiments, such as a sequence, a picture, a tile, a tile group, a slice, a CTU, a CU, or a PU.

For example, although NUM_FILTER may be determined based on at least one of the size of a picture, the size of a tile, the size of a tile group, and the size of a slice, the method for determining NUM_FILTER is not limited thereto.

NUM_FILTER may be determined in at least one of the units described in embodiments, such as a sequence, a picture, a tile, a tile group, a slice, a CTU, a CU, or a PU.

For example, at least one of filter candidates constituting the filter candidate list may be determined based on at least one of the targets of encoding/decoding, described in embodiments, such as a target picture, a target slice, a target tile, a target tile group, a target CTU, and a target block.

The target picture may refer to a picture to which the target block belongs.

The target slice may refer to a slice to which the target block belongs.

The target tile may refer to a tile to which the target block belongs.

The target tile group may refer to a tile group to which the target block belongs.

The target CTU may refer to a CTU to which the target block belongs.

For example, at least one of filter candidates constituting the filter candidate list may be determined based on at least one of the size of a target picture, the size of a target slice, the size of a target tile, the size of a target CTU, and the size of the target block.

For example, at least one of the filter candidates constituting the filter candidate list may be determined based on at least one of motion information of the target block, the intra-prediction mode of the target block, and the coding parameter of the target block.

For example, at least one of filter candidates constituting the filter candidate list may be determined based on at least one of prediction samples of the target block, reconstructed samples of the target block, samples derived as a result of applying filtering using a specific filter to the prediction samples of the target block, and samples derived as a result of applying filtering using a specific filter to the reconstructed samples of the target block.

For example, the specific filter may refer to at least one of a weighted average filter, a filter for calculating a gradient for a specific angle, an average filter, and an edge detection filter. However, the type of the specific filter is not limited to the above-listed filter types.

For example, the specific angle may refer to at least one of 0 degrees, 15 degrees, 30 degrees, 45 degrees, . . . , 330 degrees, and 345 degrees.

For example, at least one of filter candidates constituting the filter candidate list may be determined based on the statistical value of at least two of prediction samples of the target block, reconstructed samples of the target block, samples derived as a result of applying filtering using a specific filter to the prediction samples of the target block, and samples derived as a result of applying filtering using a specific filter to the reconstructed samples of the target block.

Here, the statistical value may be one of the statistical values described in embodiments, and may include at least one of an average, a weighted average, a sum, and a weighted sum.

For example, at least one of the filter candidates constituting the filter candidate list may be determined based on VAL₁, VAL₂, . . . , VAL_{NUM_VAL}.

NUM_VAL may be 1, 2 or a positive integer. Alternatively, NUM_VAL may be a value determined by the attribute of the target block. For example, NUM_VAL may be the width of the target block or the height of the target block.

Each of VAL₁, VAL₂, . . . VAL_{NUM_VAL} may be a weighted sum of at least one sample belonging to a first sample set and at least one sample belonging to a second sample set.

For example, the first sample set may include at least one of samples present to the left of a specific vertical sample boundary within a target block. For example, the second sample set may include at least one of samples present to the right of a specific vertical sample boundary in the target block.

For example, the first sample set may include at least one of samples present above a specific horizontal sample boundary within the target block. For example, the second sample set may include at least one of samples present below a specific horizontal sample boundary in the target block.

Such specific vertical/horizontal sample boundaries may be determined based on at least one of the size of the target block, motion information of the target block, the intra-prediction mode of the target block, the coding parameter of the target block, the prediction samples of the target block, the reconstructed samples of the target block, samples derived as a result of applying filtering using a specific filter to the prediction samples of the target block, and samples derived as a result of applying filtering using a specific filter to the reconstructed samples of the target block.

For example, each of VAL₁, VAL₂, . . . , VAL_{NUM_VAL} may refer to the weighed sum of 1) at least one first sample belonging to the first sample set and 2) at least one second sample present at a position symmetrical to the first sample with respect to a specific horizontal/vertical sample boundary within the target block.

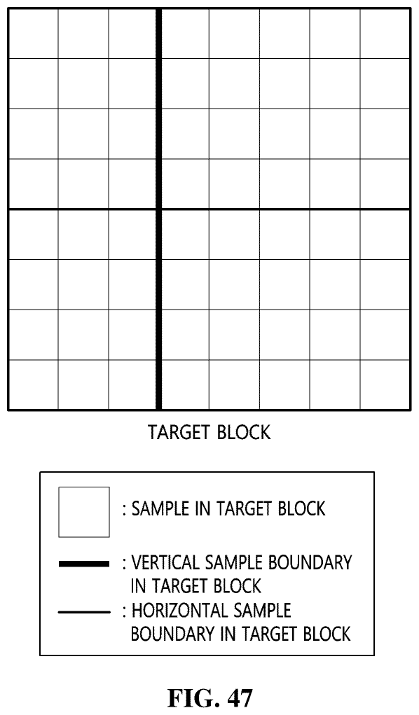

FIG. 47 illustrates a vertical sample boundary and a horizontal sample boundary for a target block according to an example.

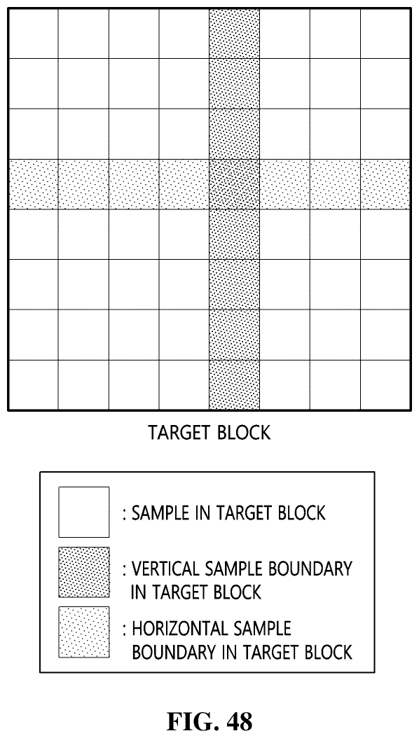

FIG. 48 illustrates a vertical sample boundary and a horizontal sample boundary for a target block according to an example.

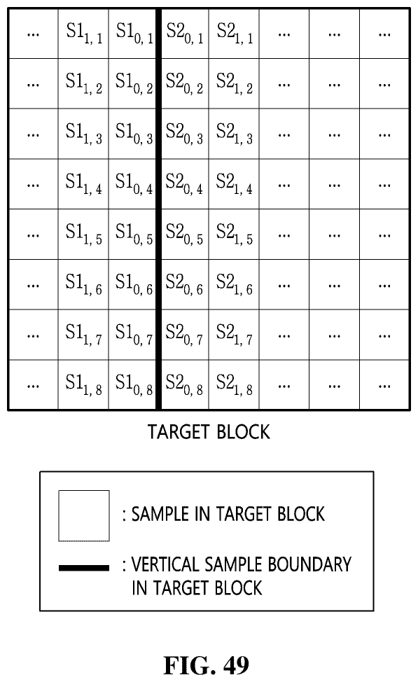

FIG. 49 illustrates values for determining a filter candidate according to an example.

In FIG. 49, sample sets used to derive the values of the above-described VAL₁, VAL₂, . . . , VAL_{NUM_VAL} are illustrated.

For example, the first sample set may be composed of S1_{0,1}, S1_{0,2}, . . . , S1_{1,1}, S1_{1,2}, . . . illustrated in FIG. 49.

For example, the first sample set may be composed of S2_{0,1}, S2_{0,2}, . . . , S2_{1,1} and S2_{1,2}, . . . illustrated in FIG. 49.

For example, for a positive number i, VALᵢ may be calculated as represented by at least one of the following [Equation 17] to [Equation 20].

$$V A {L}_{i} = {w}_{s 1 ( 0 )} \times S {1}_{0 , i} + {w}_{s 2 ( 0 )} \times s {2}_{0 , i} \qquad [ Equation 17 ]$$

$${VAL}_{i} = {w}_{s 1 ( 0 , i )} \times S {1}_{0 , i} + {w}_{s 2 ( 0 , i )} \times s {2}_{0 , i} \qquad [ Equation 18 ]$$

$${VAL}_{i} = {w}_{s 1 ( 1 )} \times S {1}_{1 , i} + {w}_{s 1 ( 0 )} \times s {2}_{0 , i} + {w}_{s 2 ( 0 )} \times s {2}_{0 , i} + {w}_{s 2 ( 1 )} \times s {2}_{1 , i} \qquad [ Equation 19 ]$$

$${VAL}_{i} = {w}_{s 1 ( 1 , i )} \times S {1}_{1 , i} + {w}_{s 1 ( 0 , i )} \times s {2}_{0 , i} + {w}_{s 2 ( 0 , i )} \times s {2}_{0 , i} + {w}_{s 2 ( 1 , i )} \times s {2}_{1 , i} \qquad [ Equation 20 ]$$

In [Equation 17] to [Equation 20], wₛ₁₍ᵢ₎, wₛ₂₍ᵢ₎, w_{s1(j,i)}, and w_{s2(j,i)} may refer to weights used in the weighted sum.

For example, one processing among the construction, reconstruction, and update of a filter candidate list, may be performed in at least one unit among units, described in embodiments, such as a sequence, a picture, a tile, a tile group, a slice, a CTU, a CU, and a PU.

Updating the filter candidate list may refer to at least one of 1) removing at least one of filter candidates in the filter candidate list, and 2) adding a new filter candidate to the filter candidate list.

For example, filter candidate lists used in a specific unit may be identical to each other.

For example, the specific unit may refer to the unit of at least one of the units, described in embodiments, such as a sequence, a picture, a tile, a tile group, a slice, a CTU, a CU, or a PU.

For example, a filter candidate list for a specific unit may be determined in a unit higher than the specific unit. Alternatively, for example, as the filter candidate list for the specific unit, a filter candidate list for a unit higher than the specific unit may be used.

For example, the specific unit may refer to the unit of at least one of the units, described in embodiments, such as a sequence, a picture, a tile, a tile group, a slice, a CTU, a CU, or a PU.

For example, the unit higher than the CU may be a unit, described as including the CU in embodiments, such as a sequence, a picture, a tile, a tile group, a slice, and a CTU.

For example, the unit higher than the PU may be a unit, described as including the PU in embodiments, such as a sequence, a picture, a tile, a tile group, a slice, and a CTU.

In embodiments, the higher unit may refer to a higher level.

For example, a filter candidate list for a chroma component may be determined based on at least one of a filter candidate list for a luma component and a final filter candidate for the luma component.

For example, at least one filter candidate list may be specified through the signaling/encoding/decoding of information for the corresponding filter candidate list among NUM_FILTER_LIST filter candidate lists. The final filter in the adaptive filter selection method may be selected from such a specified filter candidate list.

Signaling/encoding/decoding of the information for the filter candidate list may be performed in at least one unit among the units, described in embodiments, such as a sequence, a picture, a tile, a tile group, a slice, a CTU, a CU, and a PU.

For example, one filter candidate list may be implicitly specified among NUM_FILTER_LIST filter candidate lists. The final filter in the adaptive filter selection method may be selected from such a specified filter candidate list.

For example, the specified filter candidate list may be a filter candidate list having the lowest index (e.g., index 0) among the NUM_FILTER_LIST filter candidate lists.

For example, when a bi-prediction mode is used for the target block, a single integrated filter candidate list may be constructed for an L0 direction and an L1 direction.

For example, when a bi-prediction mode is used for the target block, a single integrated filter candidate list may be used for an L0 direction and an L1 direction.

For example, when the bi-prediction mode is used for the target block, separated filter candidate lists for the L0 direction and the L1 direction may be constructed and used, respectively.

For example, the filter candidate list may include an offset candidate list. For example, each candidate in the filter candidate list may refer to an offset in an adaptive sample offset.

The offset may refer to at least one of a band offset and an edge offset.

### Use of Filter Candidate List of Other Blocks

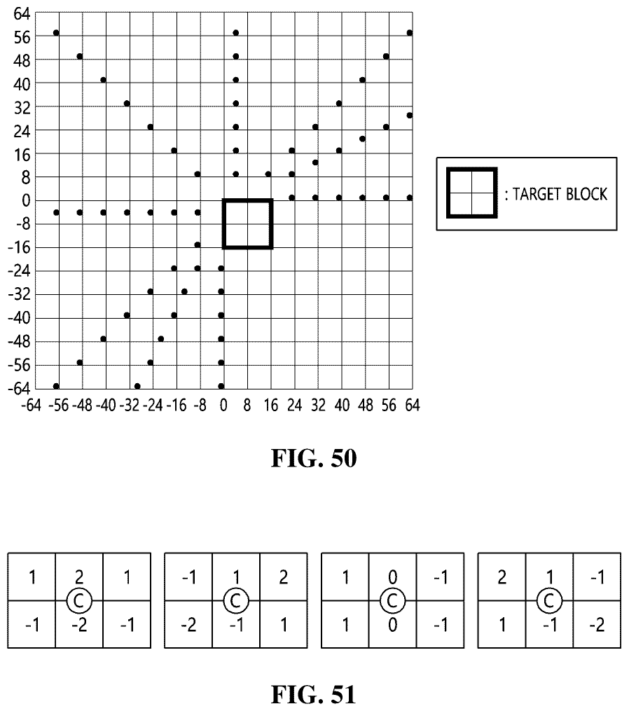

FIG. 50 illustrates blocks not adjacent to a target block according to an example.

For example, at least one of the filter candidate lists used in the blocks adjacent to the target block may be referenced, and the referenced filter candidate list may be used as the filter candidate list of the target block.

For example, at least one of a filter candidate and a filter, used in at least one of an adjacent block, a non-adjacent block, or a temporally adjacent block of the target block, and a non-adjacent block of a col block may be used as the filter candidate and the filter of the target block.

Alternatively, at least one of coefficients of a filter candidate and/or a filter, used in at least one of an adjacent block, a non-adjacent block, or a temporally adjacent block of the target block, and a non-adjacent block of a col block may be used as the coefficients of at least one of the filter candidates of the target block and/or the filter.

In embodiments, a merge candidate may refer to a filter candidate of a reference block to be used as the filter candidate of the target block. The reference block may include at least one of the adjacent block, the non-adjacent block, or the temporally adjacent block of the target block, and the non-adjacent block of the col block.

For example, the adjacent object may include at least one of blocks adjacent to at least one of the top, top-left, top-right, left, and bottom-left of the target block, as illustrated in FIGS. 35A and 35B.

The non-adjacent block may include a block having a distance of N from at least one of the top boundary and the left boundary of the target block, as illustrated in FIG. 50. Here, N may be an integer such as 4, 8, or 16.

Merge candidates may be derived from adjacent blocks. After the merge candidates are derived from the adjacent blocks, merge candidates may then be derived using non-adjacent blocks.

For example, a merge candidate may be derived from a block for which at least one of a horizontal distance and a vertical distance from the top-left position of the target block is a unit distance or N times the unit distance.

For example, when the top-left position of the target block is (x, y), a merge candidate may be derived from a block, the top-left position of which is (x−(N*horizontal), y), (x, y−((N*vertical)) or (x−(N*horizontal), y−(N*vertical)).

The temporally adjacent block may be a block (i.e., col block) corresponding to the location of the target block in a col picture, as illustrated in FIG. 35A. Alternatively, the temporally adjacent block may be an adjacent block of the col block.

For example, the temporally adjacent block may be a block located at the right, below, right-below, left-above, or left-below position of the col block.

The number of temporally adjacent blocks for deriving the candidates of the target block may be N.

N may be 0, 1, 2, 3, 6, 12 or a positive integer.

Further, in the target block, the number of merge candidates derived from the temporally adjacent blocks may be M. M may be 0, 1, 2, 3, 6, 12 or a positive integer.

The number of temporally adjacent blocks may be adaptively determined depending on the number of available spatially adjacent blocks.

A merge candidate may be derived from the non-adjacent block of the col block.

For example, a merge candidate may be derived based on a temporal block for which at least one of a horizontal distance and a vertical distance from the top-left position of the col block is a unit distance or N times the unit distance.

For example, when the top-left position of the col block is (x, y), a merge candidate may be derived from a temporal block, the top-left position of which is (x−(N*horizontal), y), (x, y−((N*vertical)) or (x−(N*horizontal), y−(N*vertical)).

Here, the term ‘horizontal’ may represent a unit distance in a horizontal direction. The term ‘vertical’ may represent a unit distance in a vertical direction.

The unit distance may be determined depending on the size of the target block. For example, the horizontal unit distance and the vertical unit distance may be set to equal to the width and height of the target block, respectively.

N may be a natural number of 1 or more. In the case where a temporal block, derived when a first value is applied to N, is unavailable, N may be increased by 1, after which a temporal block may be searched.

A shifted temporal block may be a block at a location determined by applying a shift to a temporal block.

A merge candidate may be derived from the shifted temporal block. Here, the shifted temporal block may be located at a position spaced apart from the location of the temporal block by a motion vector.

Here, the motion vector may be the motion vector of the spatially adjacent block of the target block. For example, a shifted temporal block may be determined based on the motion vector of a left neighbor block or an above neighbor block of the target block. Alternatively, when spatial neighbor blocks of the target block are searched for in a predefined order, a shifted temporal block may be determined based on the motion vector of an available block that is first found in the search.

Whether a temporally adjacent block is available may be determined based on at least one of a picture/slice type and the coding parameter of the target block. Here, the picture/slice type may indicate whether a picture/slice is an I-picture/I-slice.

FIG. 51 illustrates a luma component position corresponding to the position of a chroma component sample according to an example.

When a target block is a chroma component block, a filter candidate list may include at least one of filters illustrated in FIG. 51 as a filter candidate.

In FIG. 51, C may denote the luma component position corresponding to the position of a chroma component sample.

### Determination of Final Filter

Below, the determination of the final filter at steps 3820, 3930, 4440, and 4550 will be described.

For example, when NUM_FILTER is 1, a single filter candidate present in the filter candidate list may be selected as the final filter.

For example, when the number of filter candidates in the filter candidate list is 1, a single filter candidate present in the filter candidate list may be selected as the final filter.

For example, when the number of filter candidates in the filter candidate list is 1, a single filter candidate present in the filter candidate list may be considered to be selected as the final filter.

For example, when NUM_FILTER is 2 or more, the final filter may be selected from the filter candidate list by signaling/encoding/decoding information about the final filter.

For example, when the number of filter candidates in the filter candidate list is 2, the final filter may be specified from the filter candidate list by signaling/encoding/decoding the information about the final filter.

For example, the information about the final filter may refer to an index for specifying the final filter.

For example, whether the information about the final filter in the target block is signaled/encoded/decoded may be determined based on at least one of the size, motion information or coding parameter of the target block and whether the adaptive filter selection method for the target block is enabled.

Whether the adaptive filter selection method for the target block is enabled may be determined in at least one unit among units to which the target block belongs. For example, the units may include a sequence, a picture, a tile, a tile group, a slice, a CTU, a CU, and a PU, and may include another target for encoding/decoding described in embodiments.

For example, the final filter may be implicitly selected from the filter candidate list.

For example, a candidate corresponding to the lowest index (e.g., index 0) may be selected as the final filter from a filter candidate list composed of NUM_FILTER filter candidates.

For example, when a bi-prediction mode is used for the target block, a single filter specified from an integrated filter candidate list may be determined to be the final filter for an L0 direction and an L1 direction.

For example, when the bi-prediction mode is used for the target block, a final filter for the L0 direction and a final filter for the L1 direction may be separately selected from the integrated filter candidate list.

For example, the final filter may be selected in the unit of at least one of the units, described in embodiments, such as a sequence, a picture, a tile, a tile group, a slice, a CTU, a CU, or a PU.

For example, the same final filter may be used in a specific unit.

For example, the specific unit may refer to at least one of the units, described in embodiments, such as a sequence, a picture, a tile, a tile group, a slice, a CTU, a CU, or a PU.

For example, the final filter for the specific unit may be determined in a unit higher than the specific unit. Alternatively, for example, a final filter in the unit higher than the specific unit may be used as the final filter in the specific unit.

For example, the specific unit may refer to at least one of the units, described in embodiments, such as a sequence, a picture, a tile, a tile group, a slice, a CTU, a CU, or a PU.

For example, the unit higher than the CU may be a unit, described as including the CU in embodiments, such as a sequence, a picture, a tile, a tile group, a slice, and a CTU.

For example, the unit higher than the PU may be a unit, described as including the CU in embodiments, such as a sequence, a picture, a tile, a tile group, a slice, and a CTU.

In embodiments, the higher unit may refer to a higher level.

The fact that a first unit is the unit higher than a second unit may mean that the second unit is included in the first unit.

The fact that a first level is a level higher than a second level may mean that the second level is included in the first level.

For example, the final filter may be determined without a process of constructing the filter candidate list.

For example, the final filter to be used for the target block may be determined based on at least one of surrounding samples and neighboring blocks of the target block.

For example, a first sample set and a second sample set may be configured using the surrounding samples of the target block. A filter value at which a filtering result most similar to that of the second sample set is generated when filtering is performed on the first sample set, may be derived, and a filter corresponding to the derived filter value may be determined to be the final filter.

For example, the derivation of filter values may be performed by a (linear) regression method.

The surrounding samples of the target block may include at least one of a luma component reconstructed sample, a luma component prediction sample, a luma component residual sample, a chroma component reconstructed sample, a chroma component prediction sample, and a chroma component residual sample.

For example, when filtering is performed on surrounding luma component samples of the target block, a filter value at which a filtering result most similar to that of chroma component samples at a position corresponding to the luma component is generated may be derived. A filter corresponding to the derived filter value may be determined to be the final filter.

In embodiments, the expression “most similar” may mean that “the difference between sample values is the smallest”.

The difference between the sample values may be calculated using a cost function.

The cost function may be at least one of the Sum of Absolute Differences (SAD), the Sum of Absolute Transformed Differences (SATD), the Mean-Removed Sum of Absolute Differences (MR-SAD), Mean Squared Error (MSE), and the Sum of Squared Error (SSE).

However, cost functions are not limited to the above-listed items, and functions related to cost, described in embodiments, may be included as cost functions.

### Application to Template Region

Below, application to a template region at steps 4420 and 4530 is described.

For example, for NUM_FILTER_FOR_TM filter candidate(s) in the filter candidate list of a target block, 1) a template region may be predicted using each filter candidate. 2) Template matching cost for a template predicted using each filter candidate may be calculated. 3) At least one of filter candidates in the filter candidate list may be reordered based on the template matching cost of each filter candidate. Alternatively, a filter candidate list may be reconstructed based on the template matching cost for each filter candidate.

The template matching cost of each filter candidate may refer to template matching cost for a template predicted using each filter candidate.

For example, the order of filter candidates in the filter candidate list may be reordered in ascending order of template matching cost.

For example, the filter candidate list may be reconstructed using only NUM_FILTER_FOR_RECON filter candidates having the lowest template matching costs among filter candidates in the filter candidate list.

For example, a filter candidate having the lowest template matching cost may be selected as the final filter from among filter candidates in the filter candidate list.

The template of the target block may include at least one of samples and/or positions located in a left-below region, a left region, a left-above region, an above region, and a right-above region of the target block. For example, the template region may include a set of samples in the template or a set of the positions of the samples in the template.

For example, the template of the target block may include at least one of 1) at least one sample among samples included in TMSIZE_LEFT lines adjacent to the left of the target block, 2) at least one of positions included in TMSIZE_LEFT lines adjacent to the left of the target block, 3) at least one of samples included in TMSIZE_ABOVE lines adjacent to the top of the target block, and 4) at least one of positions included in TMSIZE_ABOVE lines adjacent to the top of the target block. However, positional relationships between templates and the target block or template configuration methods are not limited to the above-described relationships or methods.

TMSIZE_LEFT and/or TMSIZE_ABOVE may be implicitly determined values.

TMSIZE_LEFT and/or TMSIZE_ABOVE may be determined based on at least one of the size, motion information or coding parameter of the target block, and whether an adaptive filter selection method for the target block is enabled.

Each of TMSIZE_LEFT and TMSIZE_ABOVE may be 0, 1, 2, 3, 4, or a positive integer of 4 or more.

TMSIZE_LEFT and TMSIZE_ABOVE may be equal to each other. Alternatively, TMSIZE_LEFT and TMSIZE_ABOVE may be different from each other.

For example, when the target block is an inter-prediction block, a total of NUM_FILTER_FOR_TM templates may be generated by performing inter-prediction for a template region using each filter candidate, for NUM_FILTER_FOR_TM filter candidate(s) in the filter candidate list at the step of application to the template region.

For example, each filter candidate may be used as at least one of a motion compensation filter and an interpolation filter.

For example, inter-prediction for the template region may be performed using at least one of the motion information of the target block and motion information derived based on the motion information of the target block.

For example, when a bi-prediction mode is used for the target block, motion information derived based on the motion information of the target block may refer to the L0 direction motion information or L1 direction motion information of the target block.

For example, when a bi-prediction mode is used for the target block, a total of NUM_FILTER_FOR_TM templates may be generated by performing bi-prediction that uses L0 direction motion information and L1 direction motion information of the target block and each filter candidate, for NUM_FILTER_FOR_TM filter candidate(s) in an integrated filter candidate list for the L0 direction and the L1 direction.

For example, when the bi-prediction mode is used for the target block, a total of NUM_FILTER_FOR_TM templates may be generated by performing uni-prediction that uses specific direction motion information of the target block and each filter candidate, for NUM_FILTER_FOR_TM filter candidate(s) in a filter candidate list for a specific direction.

The specific direction may represent the L0 direction or the L1 direction.

For example, when an affine mode is used for the target block, a template and/or a template region of the target block may be determined based on CPMVs of the target block.

For example, when the affine mode is used for the target block, subblock templates may be configured based on CPMVs of the target block. The template and/or template region of the target block may be a combination of subblock templates and/or a combination of subblock template regions.

For example, template matching cost in the affine mode may be the sum of template matching costs of subblock templates or the average of template matching costs of the subblock templates (e.g., A0, A1, A2, A3, L0, L1, L2 and L3).

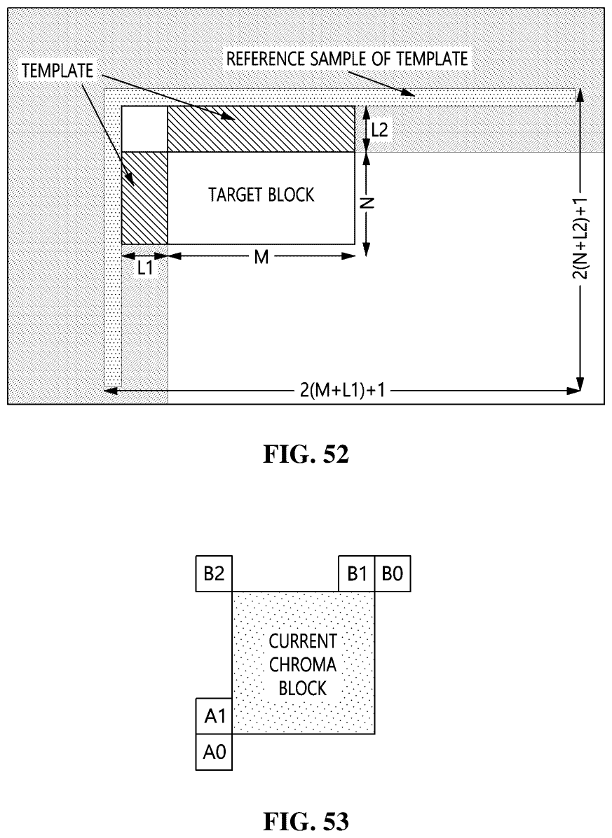

FIG. 52 illustrates intra-prediction for a template region according to an example.

For example, when a target block is an intra-prediction block, a total of NUM_FILTER_FOR_TM templates may be generated by performing intra-prediction for a template region using each filter candidate, for NUM_FILTER_FOR_TM filter candidate(s) in the filter candidate list at the step of application to the template region.

For example, each filter candidate may be used as a reference sample filter.

For example, at least one of an intra-prediction mode and a coding parameter used for intra-prediction for the template region may be identical to at least one of the intra-prediction mode and the coding parameter of the target block.

FIG. 52 illustrates intra-prediction for a template region when a target block is an intra-prediction block.

Intra-prediction for the template region may be performed using a reference sample of the template.

For example, a total of NUM_FILTER_FOR_TM templates may be generated by applying in-loop filtering that uses each filter candidate to reconstructed samples in the template region of the target block, for NUM_FILTER_FOR_TM filter candidate(s) in the filter candidate list at the step of application to the template region.

For example, a total of NUM_FILTER_FOR_TM templates may be generated by applying deblocking filtering that uses each filter candidate to reconstructed samples in the template region of the target block, for NUM_FILTER_FOR_TM filter candidate(s) in the filter candidate list at the step of application to the template region.

For example, a total of NUM_FILTER_FOR_TM templates may be generated by applying an adaptive sample offset that uses each candidate offset to reconstructed samples in the template region of the target block for NUM_FILTER_FOR_TM candidate offset(s) in the filter candidate list at the step of application to the template region.

For example, a total of NUM_FILTER_FOR_TM templates may be generated by applying adaptive in-loop filtering that uses each filter candidate to reconstructed samples in the template region of the target block, for NUM_FILTER_FOR_TM filter candidate(s) in the filter candidate list at the step of application to the template region.

For example, NUM_FILTER_FOR_TM may be a value less than or equal to NUM_FILTER.

For example, NUM_FILTER_FOR_TM may be implicitly determined.

NUM_FILTER_FOR_TM may be 1, 2, 3, 4, 6, 8, 12 or a positive integer.

NUM_FILTER_FOR_TM may be determined based on at least one of NUM_FILTER and the size, motion information, and coding parameter of the target block.

For example, information about NUM_FILTER_FOR_TM may be signaled/encoded/decoded.

### Calculation of Template Matching Cost

Below, the calculation of template matching cost at steps 4430 and 4540 is described.

For example, the template matching cost for a template generated using a specific filter candidate may refer to the result of calculation that uses a cost function for at least one of 1) at least one of prediction samples, reconstructed samples, and decoded samples present in a template region of the target block; and 2) a sample present in a template generated using the specific filter candidate.

The cost function may be at least one of the Sum of Absolute Differences (SAD), the Sum of Absolute Transformed Differences (SATD), the Mean-Removed Sum of Absolute Differences (MR-SAD), Mean Squared Error (MSE), and the Sum of Squared Error (SSE). However, cost functions are not limited to the above-listed items, and functions related to cost, described in embodiments, may be included as cost functions.

The cost function used in the adaptive filter selection method may be implicitly determined. Alternatively, information about the cost function used in the adaptive filter selection method may be signaled/encoded/decoded.

In embodiments, a decoded sample may refer to a reconstructed sample to which in-loop filtering is applied.

For example, when the selection of a motion compensation filter and/or an interpolation filter is performed by an adaptive filter selection method, template matching cost of the template generated using each filter candidate may be calculated using at least one of prediction samples and reconstructed samples present in the template region.

For example, when the selection of a reference sample filter is performed by the adaptive filter selection method, template matching cost of the template generated using each filter candidate may be calculated using at least one of prediction samples and reconstructed samples present in the template region.

For example, when the selection of at least one of a prediction block boundary filter, an in-loop filter, a deblocking filter, an adaptive sample offset and adaptive in-loop filter loop is performed by the adaptive filter selection method, template matching cost for each template generated using each filter candidate may be calculated using at least one of prediction samples, reconstructed samples, and decoded samples present in the template region.

At the step of calculating the template matching cost, template matching cost may be calculated for each of NUM_FILTER_FOR_TM templates generated using NUM_FILTER_FOR_TM filter candidates in the corresponding filter candidate list for at least one of filter candidate lists of the target block.

For example, based on the template matching cost, reordering of the order of at least one of the filter candidates in the filter candidate list of the target block may be performed.

For example, based on the template matching cost, the filter candidate list of the target block may be reconstructed.

For example, the filter candidate list may be reconstructed using NUM_FILTER_FOR_RECON filter candidates having the lowest template matching cost.

NUM_FILTER_FOR_RECON may be a value less than or equal to NUM_FILTER_FOR_TM.

NUM_FILTER_FOR_RECON may be 1, 2, 3, 4, 6 or a positive integer.

For example, when a target block is an inter-prediction block, the filter candidate list of the target block may refer to at least one of a filter candidate list integrated for an L0 direction and an L1 direction, a filter candidate list for the L0 direction, and a filter candidate list for the L1 direction.

### Encoding/Decoding of Filter Information

Below, the encoding/decoding of filter information at steps 3830, 3910, 4450, and 4510 will be described.

At the step of encoding/decoding the filter information, coding information related to an adaptive filter selection method may be signaled/encoded/decoded.

The filter information may include information about at least one of a motion compensation filter, an interpolation filter, a reference sample filter, a prediction block boundary filter, an in-loop filter, a deblocking filter, an adaptive sample offset, an adaptive in-loop filter, a reference block filter, an upsampling filter, a downsampling filter, and an adaptive filter selection method.

Coding information related to the adaptive filter selection method may be entropy-encoded/decoded in at least one of units, described in embodiments, such as a sequence, a picture, a tile, a tile group, a slice, a CTU, a CU, and a PU.

The case where encoding/decoding is performed in the unit of a sequence may mean that encoding/decoding of information in a sequence parameter set in a bitstream is performed.

The case where encoding/decoding is performed in the unit of a picture may mean that encoding/decoding of information in a picture parameter set in a bitstream is performed.

The case where encoding/decoding is performed in the unit of a slice may mean that encoding/decoding of information in a slice header and/or slice data in a bitstream is performed.

The coding information related to the adaptive filter selection method may include at least one of information whether the adaptive filter selection method is performed, information indicating which one of multiple filter candidate lists is used, information about NUM_FILTER_LIST, information about NUM_FILTER, information about NUM_FILTER_FOR_TM, information of at least one filter candidate constituting the filter candidate list, and index information for selecting the final filter from the filter candidate list.

The filter information may include at least one of information indicating whether the filter is applied, filter coefficients, filter strength, a filter shape, a filter form, a filter length, the number of filter taps, the number of filters applied, the type of function used to derive the filter coefficients, the number of filter phases, the preprocessing method of filtering, the post-processing method of filtering, information indicating whether filtering is performed on a luma component, information indicating whether filtering is performed on a chroma component, information indicating whether different filters are used for the luma and chroma components, and information about the symmetrical form of the filter.

When at least one of pieces of filter information is not present in a bitstream, the at least one piece of information that is not present in the bitstream may be inferred as a first value (e.g., 0).

### Cross-Component Prediction Merge (CCP Merge)

FIG. 53 illustrates the locations of adjacent spatial candidates according to an example.

In order to exploit a cross-component correlation, Cross-Component Prediction (CCP) including a Cross-Component Linear Model (CCLM), a Convolutional Cross-Component Model (CCCM), and a Gradient Linear Model (GLM) may be used.

In an embodiment, a CCP merge mode may be used as a new CCP mode.

Cross-component model parameters of the current chroma block coded in CCP merge may be inherited from neighboring blocks coded in CCP. Through CCP merge, CCP may be further efficiently performed with a lower signaling overhead.

In the CCP merge, the final cross-component model parameters of the current chroma block may be inherited from spatially adjacent neighbors and spatially non-adjacent neighbors of the current chroma block, or may be inherited from default models.

A list may be generated. The list include CCP models from spatially adjacent and spatially non-adjacent neighbors that are coded in a CCLM mode, a Multi-Model Liner Model (MMLM) mode, a CCCM mode, a GLM mode, a chroma fusion mode, and a CCP merge mode.

After the list includes neighboring CCP models, the default models may be further included to fill empty locations remaining in the list.

In order to prevent redundant CCP models from being included in the list, pruning operations may be applied.

### Spatially Adjacent Neighboring Candidates

The locations of the spatially adjacent candidates are illustrated in FIG. 53.

The spatial candidates may be included in the order of (B1, A1, B0, A0, B2).

### Spatially Non-Adjacent Neighboring Candidates

The spatially non-adjacent neighboring candidates may be taken into consideration after all of spatially adjacent neighbors have been checked.

In an embodiment, in an inter-merge mode, two sets of spatially non-adjacent neighboring candidates may be obtained.

In an embodiment, the locations of spatially non-adjacent neighboring candidates from a first set and the order of inclusion thereof may be used.

### CCLM Candidates Having Default Scaling Parameters

If a list is not full after spatially adjacent and non-adjacent candidates are included, CCLM candidates having default scaling parameters may be taken into consideration.

The default scaling parameters may be {0, ⅛, −1/8, 2/8, −2/8, ⅜}, and offset parameters may be derived depending on 1) selected default scaling parameters, 2) average neighboring reconstructed luma sample value (Y_{avg}), and 3) average neighboring reconstructed Cb/Cr sample value (C_{avg}).

### Merge Model Candidates

When a CCLM candidate is merged, only scaling parameters may be inherited. The offset parameters may be derived using the inherited scaling parameters and Y_{avg} and C_{avg}.

When an MMLM candidate is merged, the scaling parameters and a classification threshold may be inherited.

An offset parameter in each class may be derived depending on the inherited classification threshold, and Y_{avg} and C_{avg} in each class.

If any neighboring reconstructed samples are not available in each class, the offset parameters may be directly inherited from candidates.

When a CCCM candidate is merged, all convolution parameters, offsets (e.g., offsetLuma, offsetCb, and offsetCr) and the classification threshold may be inherited.

If a GLM candidate is 3-parameter CLM mode when the GLM candidate is merged, all gradient pattern indices and model parameters may be inherited. Otherwise, when the GLM candidate is a 2-parameter GLM mode, the offset parameters may be derived using the inherited scaling parameters and Y_{avg} and C_{avg}.

When a chroma fusion candidate is merged, derived MMLM parameters may be inherited, and may be used to merge MMLM candidates.

For CPP merge, when the merge candidate mode of a CPP merge block is CCLM, MMLM, CCCM or GLM, the merge candidate mode may be stored as a propagation mode of the current chroma block. Otherwise, when the merge candidate mode of the CPP merge block is chroma fusion, the propagation mode may be set to MMLM. When the CPP merge candidate is merged, how CCP parameters are to be inherited or derived may be dependent on the propagation mode of the CPP merge candidate, as described in the foregoing paragraphs.

### Signaling

After a syntax element cclm_mode_flag, an additional flag may be signaled to indicate whether CCMerge is used.

When CPP merge is used, a candidate index may be additionally signaled. The signaled candidate index may be shared with Cb/Cr color components.

The maximum number of allowed candidates may be set to 6 by default. When the maximum number of allowed candidates is modified into 1, the candidate index may not need to be signaled. Each bin of the candidate index may be context coded with separate context.

### Determination of Block to be Referenced for Parameter Inheritance

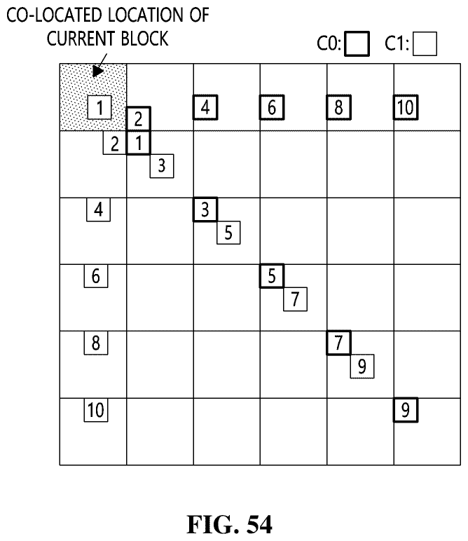

FIG. 54 illustrates the locations of temporal candidates according to an example.

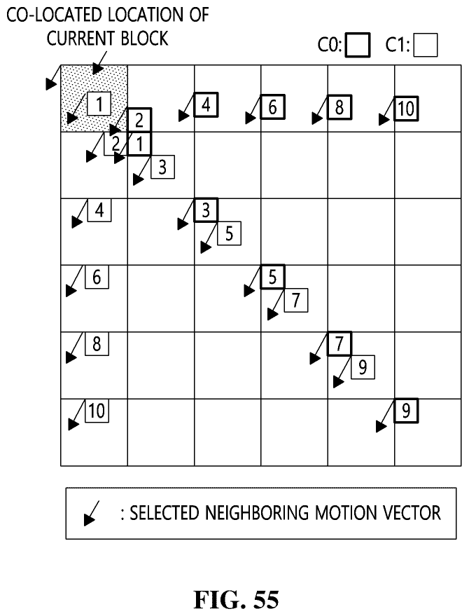

FIG. 55 illustrates the locations of shifted temporal candidates according to an example.

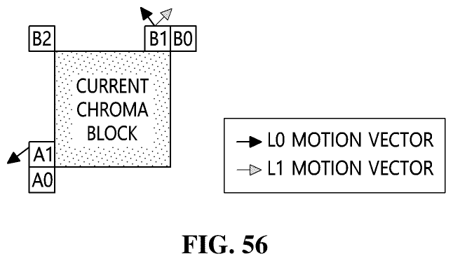

FIG. 56 illustrates locations for selection of a neighboring motion vector.

A Cross-Component Prediction (CCP) merge mode may be used to enhance the coding efficiency of chroma intra-coding.

In the CCP merge mode, cross-component model parameters of the current chroma block may be inherited from spatially adjacent candidates, spatially non-adjacent candidates, history-based candidates, and default candidates of the current chroma block.

Such CCP models may be inherited from blocks that are coded in a CCLM mode, a Multi-Model Liner Model (MMLM) mode, a CCCM mode, a GLM mode, a chroma fusion mode, and a CCP merge mode.

In embodiments, methods for additionally inheriting CCP parameters from temporal candidates and results thereof are disclosed.

In the CCP merge mode, a CCP merge candidate list may include spatially adjacent candidates, spatially non-adjacent candidates, and history-based candidates that are coded in a CCLM mode, an MMLM mode, a CCCM mode, a GLM mode, a chroma fusion mode, and a CCP merge mode.

After the candidates are included, default models may be included in the merge list to fill empty locations if necessary.

In order to remove redundant CCP models in the merge list, pruning operations may be applied.

The candidates in the list may be reordered based on SAD costs obtained using a neighboring template of the current block.

In order to enhance coding efficiency of the CCP merge mode, two types of candidates, referred to as temporal candidates and shifted temporal candidates, may be included in a merge list for non-intra slices.

The temporal candidates may be added to the merge list after spatially adjacent candidates.

The shifted temporal candidates may be added to the merge list after history-based candidates.

Details of the two types of candidates will be described below.

For chroma blocks having sizes of 16 or less, the CCP merge mode may be allowed to be applied into non-intra slices.

The temporal candidates may be selected from a collocated picture.

FIG. 54 may depict the locations of temporal candidates and the inclusion order thereof. The locations and the inclusion order may be identical to the locations of temporal candidates in an inter-merge mode and the inclusion order thereof.

The definition of the collocated picture may be identical to the definition thereof in other embodiments.

The inclusion order of the temporal candidates may be (C0₁, C0₂, . . . , C0₁₀).

When C0₁ is located outside a picture/slice boundary, and C1ᵢ is located inside the picture/slice boundary, C1ᵢ may be used instead of C0ᵢ. Here, i may be an integer of 1 or more and 10 or less. Otherwise, the next inclusion location may be checked.

As depicted in FIG. 55, shifted temporal candidates may also be selected from the collocated picture.

The location of a collocated block may be shifted by a neighboring motion vector that is selected.

Therefore, the locations of C0ᵢ and C1ᵢ may be shifted by the same neighboring motion vector.

The inclusion order of the shifted temporal candidates may be identical to the inclusion order of temporal candidates.

As illustrated in FIG. 56, an adjacent motion vector may be selected from among motion vectors of neighboring blocks.

The order of checking may be represented by the following [Equation 21].

(L0_{B1},L1_{B1},L0_{A1},L1_{A1},L0B₀,L1_{B0},L0_{A0},L1_{A0},L0_{B2},L1_{B2}) [Equation 21]

A first motion vector that uses the collocated picture as a reference picture may be selected. When such a motion vector is not detected, no shifted temporal candidates may be added.

### Cross-Component Residual Model (CCRM) Based on Chroma Prediction

CCRM based on chroma prediction may be used to improve the compression efficiency of inter slices.

Chroma samples of a block that has a CCRM and is inter or IBC coded may be predicted from reconstructed luma samples.

A CCRM model may be constructed using a total of eight coefficients such as six spatial non-downsampled luma samples, a nonlinear term, and a bias term.

The CCRM model coefficients may be derived from correlations between reference luma samples and reference chroma samples.

A TU-level flag may be signaled to indicate such a mode.

When a luma-coded block flag is non-zero, and the prediction mode of the CU is an inter mode or an IBC mode, the encoding apparatus may perform RD determination within a transform selection loop for a chroma component.

In a first method, a multi-model CCRM may be used. Here, samples in the block may be classified into two groups, and each group may derive an individual CCRM model.

A threshold by which luma and chroma pairs are separated may be calculated from the average of non-downsampled luma sample values in a reference block.

A method according to an embodiment may take the use of an implicit CCRM mode derivation method. Therefore, extra bits may not need to be signaled.

In particular, in order to determine whether to apply a single-model CCRM or multi-model CCRM, decoder-derived cost may be calculated by applying the CCRM model to reference luma samples.

SAD between predicted reference chroma sample values and true reference chroma sample values may be treated as cost. Therefore, a CCRM mode having lower cost may be finally selected for the block.

Furthermore, because the theoretical rationale of CCRM heavily relies on the luma residuals, CCRM may be disabled when the luma coefficients are small.

In a second method, a CCRM merge mode may be used.

A CCRM merge list may be constructed from previous CCRM-coded blocks.

Instead of calculating a CCRM model on-the-fly from samples in a reference region, the CCRM model may be inherited from a CCRM merge candidate, and may be directly applied to the current luma samples so as to generate predicted chroma samples.

A first available CCRM merge candidate may be used without signaling of an index.

In order to indicate whether the current block is coded in a regular CCRM or CCRM merge mode, a flag may be conditionally signaled depending on the TU level CCRM flag.

### Extension of CCP Prediction and CCP Merge

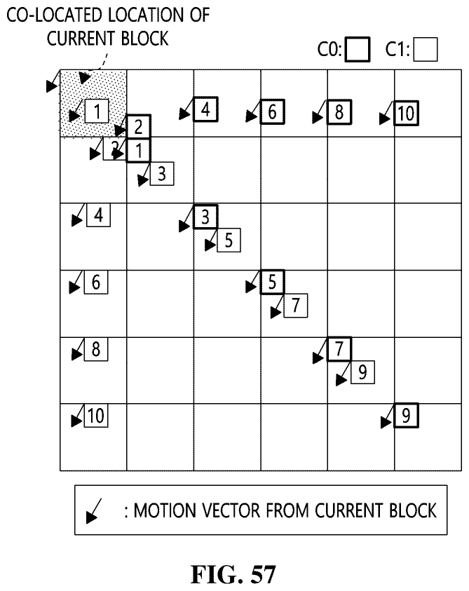

FIG. 57 illustrates the derivation of shifted temporal candidates based on a current motion vector according to an example.

A Cross-Component Prediction (CCP) merge mode may be used to improve the coding efficiency of chroma intra-coding.

In the CCP merge mode, the cross-component model parameters of the current chroma block may be inherited from a selected candidate in a CCP merge list. The CCP merge list may include spatially adjacent candidates, spatially non-adjacent candidates, history-based candidates, and default candidates.

In addition, for non-intra slices, a temporal candidate and a shifted temporal candidate may be further included in the CCP merge list.

Moreover, due to the introduction of inter CCM, inter blocks may use CCP to refine chroma inter-prediction. The methods and results in embodiments may extend the CCP merge mode to chroma inter-coding by utilizing CCP models from the intra-block and an inter block.

In embodiments, a flag may be first used to indicate whether the method according to the embodiment is used for a chroma inter-block.

When the method according to the embodiment is used, a CCP model may be implicitly selected from the CCP merge list.

Final prediction of the current chroma inter-block may be formed by combining cross-component predicted signals derived by utilizing signals predicted by motion compensation and the selected CCP model.

Weights for combined predictions may be fixed by the following [Equation 22].

(w_{CCP},wᵢₙₜₑᵣ)=(¾,¼) [Equation 22]

Details of the method according to the embodiment will be described below.

### Construction of CCP Merge List for Chroma Inter-Coding

For a chroma inter-block, a CCP merge list may include the second type of shifted temporal candidates in addition to existing candidates of a CCP merge mode. In addition, the CCP models in the list may be inherited from an intra-block and an inter-block.

After the CCP merge list is constructed, a candidate having lowest template cost may be implicitly selected.

### Second Type of Shifted Temporal Candidates

The locations of first-type shifted temporal candidates may be derived based on neighboring motion vectors, whereas the locations of second-type candidates may be derived based on the current motion vector. The current motion vector may be the motion vector of the current block.

As depicted in FIG. 57, the location of a collocated block and the locations of C0ᵢ and C1ᵢ may be shifted by a motion vector from the current block. C0ᵢ and C1ᵢ may be the locations of temporal candidates. Here, i may be an integer of 1 or more and 10 or less.

Inheritance of CCP Models from Inter-Blocks

CCP models may also be inherited from inter-blocks in addition to a CCLM mode, a MMLM mode, a CCCM mode, a GLM mode, a chroma fusion mode, and a CCP merge mode.

For each inter-block, a CCP model may be stored after the block is coded.

The stored model may be inherited by the following coding blocks coded in a CCP merge mode in chroma intra-coding and chroma inter-coding.

When the inter-block is coded in an inter-CCCM mode or inter-CCP merge mode, the CCP model may be stored. Otherwise, a CCP model to be stored may be retrieved from a reference location that is located by the motion vector of an inter-block based on the rules of Intra Prediction Mode (IPM) propagation.

### On-the-Fly Derived Candidates

A CCP model may be derived on-the-fly based on neighboring reconstructed samples of the current block.

The on-the-fly CCP models may be derived without accessing luma reconstructed samples of the current block.

When any of derived CCCM/CCLM model parameters of Cb and Cr is non-zero, the on-the-fly derived candidate may be inserted into the beginning of a CCP merge list.

A maximum of four on-the-fly derived candidates may be inserted into the CCP merge list for an inter-CCP merge mode. The maximum of four on-the-fly derived candidates may include a single-model CCCM, a multi-model CCCM, a single-model CCLM, and a multi-model CCLM.

Intra Block Copy with Local Illumination Compensation (IBC-LIC) Model Merge Mode

IBC-LIC may compensate for illumination variation between a CU coded in IBC and a prediction block of the CU within a picture by using a linear equation “α*p[x]+β”.

Parameters in the linear equation may be derived using the same method as LIC for inter-prediction, except that a reference template in the IBC-LIC is generated with a block vector.

IBC-LIC may be applied both to an IBC-AMVP mode and to an IBC-merge mode.

In an IBC-AMVP mode, an IBC-LIC flag may be signaled, and when the IBC-LIC flag is true, there may be four available modes such as L-shaped, multi-models, top-only, and left-only IBC-LIC modes.

In the IBC-merge mode, an IBC-LIC flag may be inferred from merge candidates, and only an L-shaped IBC-LIC mode may be used.

An IBC-LIC model merge mode may inherit IBC-LIC model parameters from previously coded blocks, may update a R parameter from the selected model, and may apply the updated R parameter to a reference block.

The IBC-LIC model merge mode may inherit IBC-LIC model parameters from previously coded blocks.

In detail, the IBC-LIC model for the IBC-LIC model merge mode may be obtained, as will be described below.

a) A model candidate list composed of model parameters may be constructed from spatially adjacent and non-adjacent neighbors, history candidates, and default models. The size of the candidate list may be 12.

Similar to the CCP merge method, IBC-LIC models may be collected from previously coded IBC-LIC and IBC-LIC model merge modes within adjacent and non-adjacent locations.

When an IBC-LIC model candidate is a multi-model IBC-LIC coded block, parameters from two linear models and a classification threshold may be inherited depending on the model candidate.

In addition, similar to a HMVP table, a history IBC-LIC model table having a size of 6 may be maintained.

Spatial neighbors and IBC-LIC models from the history IBC-LIC model table may be added to an IBC-LIC model merge candidate list.

When the list is not full, a default model and scaled models may be subsequently added to the list. In order to prevent redundant models, a pruning operation may also be applied.

b) An IBC-LIC model may be selected from a candidate list, and the index of the selected IBC-LIC model may be signaled in a bitstream.
1) A parameter β of an LIC model may be inherited, and may not be modified.
2) In an IBC-merge mode, a selected LIC model may be applied to a reference template during reordering of a merge list.
3) Next, an IBC merge list may be further sorted by the inherited IBC-LIC flags. A mode in an embodiment may be used only when there is an adjacent block that is coded only in IBC-LIC or a mode according to an embodiment.
3) In an IBC-AMVP mode, a selected LIC model may be applied to a reference template during the prediction of BVD.

A flag indicating whether an IBC-LIC merge mode is applied may be signaled.

When this flag is true, an index may be further signaled to indicate which candidate model is used by the current block.

The flag may be signaled only when the current block is not coded in an IBC-CIIP, IBC-GPM, TM-merge and skip mode.

Each of the encoding apparatus 1600 and the decoding apparatus 1700 may perform at least one of 1) signaling/encoding/decoding of information indicating whether an adaptive filter selection method is performed, 2) derivation of whether an adaptive filter selection method is performed, 3) determination of a filter candidate list (e.g., signaling/encoding/decoding of a filter candidate list index and derivation of a filter candidate list index), 4) determination of a candidate filter to be included in a filter candidate list, 5) construction, reconstruction, and determination of a filter candidate list, 6) determination of a final filter candidate (e.g., signaling/encoding/decoding of a filter candidate index and derivation of a filter candidate index), 7) determination of a final filter, 8) configuration of a template, 9) determination of a template region (e.g., the size of a template region and/or determination of the location of a template region), 10) interpolation filtering, 11) motion compensation filtering, 12) reference sample filtering, 13) prediction block filtering, 14) in-loop filtering, 15) deblocking filtering, 16) reference block filtering, 17) upsampling, 18) downsampling, 19) filtering using an adaptive sample offset, 20) adaptive in-loop filtering, and 21) signaling/encoding/decoding process of the filter information by utilizing at least one of embodiments described above in relation to 1) signaling/encoding/decoding of information indicating whether an adaptive filter selection method is performed, 2) derivation related to whether an adaptive filter selection method is performed, 3) determination of a filter candidate list (e.g., signaling/encoding/decoding of a filter candidate list index and derivation of the filter candidate list index), 4) determination of candidate filters to be included in the filter candidate list, 5) construction, reconstruction, and determination of a filter candidate list, 6) determination of a final filter candidate (e.g., signaling/encoding/decoding of a filter candidate index and derivation of a filter candidate index), 7) determination of a final filter, 8) configuration of a template, 9) determination of a template region (e.g., the size of a template region and/or determination of the location of a template region), 10) interpolation filtering, 11) motion compensation filtering, 12) reference sample filtering, 13) prediction block filtering, 14) in-loop filtering, 15) deblocking filtering, 16) reference block filtering, 17) upsampling, 18) downsampling, 19) filtering using an adaptive sample offset, 20) adaptive in-loop filtering, and 21) signaling/encoding/decoding process of the filter information.

The embodiments have been described with respect to the case where two reference picture lists are used. However, inter-prediction to which embodiments are applied is not limited to inter-prediction that uses two reference picture lists. The embodiments may be applied even to the case where NUM_REFPICLIST reference picture lists are used. For example, NUM_REFPICLIST may be 1, 2, 3 or a positive integer.

The embodiments may be applied depending on the size of at least one of a coding block, a prediction block, a block, and a unit. Here, the size may refer to a minimum size and/or maximum size to which the embodiments are to be applied, and may indicate a fixed size to which the embodiments are applied. Further, a first embodiment may be applied to a first size, and a second embodiment may be applied to a second size. That is, the embodiments may be compositely applied depending on the sizes of the target. Further, the embodiments may be applied to the case where the size of the target is equal to or greater than the minimum size and less than or equal to the maximum size. That is, the embodiments may be applied only to the case where the size of the target falls within a specific range.

Furthermore, the embodiments may be applied only to the case where the size of the target is equal to or greater than the minimum size and less than or equal to the maximum size. Here, each of the minimum size and the maximum size may be the size of one of a block and a unit. That is, a block to which the limitation of the minimum size is applied and a block to which the limitation of the maximum size is applied may be different from each other. For example, embodiments may be applied only to the case where the size of the target block is equal to or greater than the minimum size and less than or equal to the maximum size of the block.

For example, the embodiments may be applied only to the case where the size of the target block is equal to or greater than 8×8. For example, the embodiments may be applied only to the case where the size of the target block is equal to or greater than 16×16. For example, the embodiments may be applied only to the case where the size of the target block is equal to or greater than 32×32. For example, the embodiments may be applied only to the case where the size of the target block is equal to or greater than 64×64. For example, the embodiments may be applied only to the case where the size of the target block is equal to or greater than 128×128. For example, the embodiments may be applied only to the case where the size of the target block is 4×4. For example, the embodiments may be applied only to the case where the size of the target block is less than or equal to 8×8. For example, the embodiments may be applied only to the case where the size of the target block is less than or equal to 16×16. For example, the embodiments may be applied only to the case where the size of the target block is equal to or greater than 8×8 and less than or equal to 16×16. For example, the embodiments may be applied only to the case where the size of the target block is equal to or greater than 16×16 and less than or equal to 64×64.

In the above-described embodiments, at least one of information indicating whether an adaptive filter selection method is performed, a filter candidate list index, information about a candidate filter to be included in a filter candidate list, information related to determination of a final filter candidate, information about a method for configuring and determining a template, and a probability model or context model to be used in entropy encoding/decoding of filter information may be determined.

The filter in embodiments may include at least one of an interpolation filter, a motion compensation filter, a reference sample filter, a prediction block filter, an in-loop filter, a deblocking filter, an adaptive sample offset, and an adaptive in-loop filter.

The filter information may include at least one of information indicating whether the filter is applied, filter coefficients, filter strength, a filter shape, a filter form, a filter length, the number of filter taps, the number of filters applied, the type of function used to derive the filter coefficients, the number of filter phases, the preprocessing method of filtering, the post-processing method of filtering, information indicating whether filtering is performed on a luma component, information indicating whether filtering is performed on a chroma component, information indicating whether different filters are used for the luma and chroma components, and information about the symmetrical form of the filter.

As described above in embodiments, a reference image set (reference picture set) used for a process of reference image list generation (reference picture list construction) and reference picture list modification may use one or more reference image (picture) lists among reference picture list L0, reference picture list L1, reference picture list L2, and reference picture list L3.

In accordance with an embodiment, the motion information of the target block may be used to calculate boundary strength in a deblocking filter. Here, one or more pieces of motion information may be used. A maximum of N pieces of motion information may be used. N may be a positive integer of 1 or more. For example, N may be 2, 3 or 4.

The embodiments may be applied even to the case where the unit of a motion vector is one or more of a 16-pel unit, 8-pel unit, 4-pel unit, integer-pel unit, ½-pel unit, ¼-pel unit, ⅛-pel unit, 1/16-pel unit, 1/32-pel unit, and 1/64-pel unit. At least one of the above-described pel-units may be selectively used as the unit of a motion vector in the process of signaling/encoding/decoding the target block. A motion vector in a process of encoding/decoding a target block may be selectively used as the unit of pixels. One or more of the following binarization, debinarization, and encoding/decoding methods may be used for one or more of indicators, indexes, and flags which are encoded by encoding apparatus 1600 and are decoded by the decoding apparatus 1700, such as syntax elements related to 1) determination of a neighboring block to be included in a motion information candidate list, 2) configuration, reconfiguration, and determination of a motion information candidate list, 3) determination of motion information (for example, determination of a motion information index, derivation of an index using a decoder-side motion information derivation method, and derivation of motion information using the decoder-side motion information derivation method), 4) an operation with a motion information offset, 5) an operation of adding a motion vector difference to motion information, 6) amendment of motion information using a decoder-side motion information derivation method, 7) motion vector difference, 8) reference picture index, and 9) motion information index.
Signed 0-th order Exp_Golomb binarization/debinarization method (abbreviated as se(v))
Signed k-th order Exp_Golomb binarization/debinarization method (abbreviated as sek(v))
0-th order Exp_Golomb binarization/debinarization method for an unsigned positive integer (abbreviated as ue(v))
k-th order Exp_Golomb binarization/debinarization method for an unsigned positive integer (abbreviated as uek(v))
Fixed-length binarization/debinarization method (abbreviated as f(n))
Truncated Rice binarization/debinarization method or truncated unary binarization/debinarization method (abbreviated as tu(v))
Truncated binary binarization/debinarization method (abbreviated as tb(v))
Context-adaptive arithmetic encoding/decoding method (abbreviated as ae(v))
Bit string in bytes (abbreviated as b(8))
Signed integer binarization/debinarization method (abbreviated as f(n))
Unsigned positive integer binarization/debinarization method (abbreviated as u(n)) (where ‘u(n)’ may denote a fixed-length binarization/debinarization method).
Unary binarization/debinarization method

Only one limited embodiment among the embodiments is not necessarily applied to signaling/encoding/decoding of a target block. A specific embodiment or at least one combination of embodiments may be used for signaling/encoding/decoding of the target block.

The embodiments may be performed using the same method by the encoding apparatus 1600 and by the decoding apparatus 1700. Also, the image may be encoded/decoded using at least one of the embodiments or at least one combination thereof.

The order of application of the embodiments may be different from each other by the encoding apparatus 1600 and the decoding apparatus 1700, and the order of application of the embodiments may be (at least partially) identical to each other by the encoding apparatus 1600 and the decoding apparatus 1700.

The embodiments may be performed for each of a luma signal and a chroma signal, and may be equally performed for the luma signal and the chroma signal.

The form of a block to which the embodiments are applied may have a square or non-square shape.

Whether at least one of the above-described embodiments is to be applied and/or performed may be determined based on a condition related to the size of a block. In other words, at least one of the above-described embodiments may be applied and/or performed when the condition related to the size of a block is satisfied. The condition includes a minimum block size and a maximum block size. The block may be one of blocks described above in connection with the embodiments and the units described above in connection with the embodiments. The block to which the minimum block size is applied and the block to which the maximum block size is applied may be different from each other.

For example, when the block size is equal to or greater than the minimum block size and/or less than or equal to the maximum block size, the above-described embodiments may be applied and/or performed. When the block size is greater than the minimum block size and/or less than or equal to the maximum block size, the above-described embodiments may be applied and/or performed.

For example, the above-described embodiments may be applied only to the case where the block size is a predefined block size. The predefined block size may be 2×2, 4×4, 8×8, 16×16, 32×32, 64×64, or 128×128. The predefined block size may be (2*SIZE_{X})×(2*SIZE_{Y}). SIZE_{X} may be one of integers of 1 or more. SIZE_{Y} may be one of integers of 1 or more.

For example, the above-described embodiments may be applied only to the case where the block size is equal to or greater than the minimum block size. The above-described embodiments may be applied only to the case where the block size is greater than the minimum block size. The minimum block size may be 2×2, 4×4, 8×8, 16×16, 32×32, 64×64, or 128×128. Alternatively, the minimum block size may be (2*SIZE_{MIN_X})×(2*SIZE_{MIN_Y}). SIZE_{MIN_X} may be one of integers of 1 or more. SIZE_{MIN_Y} may be one of integers of 1 or more.

For example, the above-described embodiments may be applied only to the case where the block size is less than or equal to the maximum block size. The above-described embodiments may be applied only to the case where the block size is less than the maximum block size. The maximum block size may be 2×2, 4×4, 8×8, 16×16, 32×32, 64×64, or 128×128. Alternatively, the maximum block size may be (2*SIZE_{MAX_X})×(2*SIZE_{MAX_Y}). SIZE_{MAX_X} may be one of integers of 1 or more. SIZE_{MAX_Y} may be one of integers of 1 or more.

For example, the above-described embodiments may be applied only to the case where the block size is equal to or greater than the minimum block size and is less than or equal to the maximum block size. The above-described embodiments may be applied only to the case where the block size is greater than the minimum block size and is less than or equal to the maximum block size. The above-described embodiments may be applied only to the case where the block size is equal to or greater than the minimum block size and is less than the maximum block size. The above-described embodiments may be applied only to the case where the block size is greater than the minimum block size and is less than the maximum block size.

In the above-described embodiments, the block size may be a horizontal size (width) or a vertical size (height) of a block. The block size may indicate both the horizontal size and the vertical size of the block. The block size may indicate the area of the block. Each of the area, minimum block size, and maximum block size may be one of integers equal to or greater than 1. In addition, the block size may be the result (or value) of a well-known equation using the horizontal size and the vertical size of the block, or the result (or value) of an equation in embodiments.

Further, in the embodiments, a first embodiment may be applied to a first size, and a second embodiment may be applied to a second size. That is, the embodiments may be compositely applied according to the size.

The embodiments may be applied depending on a temporal layer. In order to identify a temporal layer to which the embodiments are applicable, a separate identifier may be signaled, and the embodiments may be applied to the temporal layer specified by the corresponding identifier. Here, the identifier may be defined as the lowest (bottom) layer and/or the highest (top) layer to which the embodiments are applicable, and may be defined as being indicating a specific layer to which the embodiments are applied. Further, a fixed temporal layer to which the embodiments are applied may also be defined.

For example, the embodiments may be applied only to the case where the temporal layer of a target image is the lowermost layer. For example, the embodiments may be applied only to the case where the temporal layer identifier of a target image is equal to or greater than 1. For example, the embodiments may be applied only to the case where the temporal layer of a target image is the highest layer.

A slice type or a tile group type to which the embodiments to which the embodiments are applied may be defined, and the embodiments may be applied depending on the corresponding slice type or tile group type.

In the above-described embodiments, it may be construed that, during the application of specific processing to a specific target, assuming that specified conditions may be required and the specific processing is performed under a specific determination, a specific coding parameter may be replaced with an additional coding parameter when a description has been made such that whether the specified conditions are satisfied is determined based on the specific coding parameter, or such that the specific determination is made based on the specific coding parameter. In other words, it may be considered that a coding parameter that influences the specific condition or the specific determination is merely exemplary, and it may be understood that, in addition to the specific coding parameter, a combination of one or more additional coding parameters functions as the specific coding parameter.

In the above-described embodiments, although the methods have been described based on flowcharts as a series of steps or units, the present disclosure is not limited to the sequence of the steps and some steps may be performed in a sequence different from that of the described steps or simultaneously with other steps. Further, those skilled in the art will understand that the steps shown in the flowchart are not exclusive and may further include other steps, or that one or more steps in the flowchart may be deleted without departing from the scope of the disclosure.

The above-described embodiments include examples in various aspects. Although all possible combinations for indicating various aspects cannot be described, those skilled in the art will appreciate that other combinations are possible in addition to explicitly described combinations. Therefore, it should be understood that the present disclosure includes other replacements, changes, and modifications belonging to the scope of the accompanying claims.

The above-described embodiments according to the present disclosure may be implemented as a program that can be executed by various computer means and may be recorded on a computer-readable storage medium. The computer-readable storage medium may include program instructions, data files, and data structures, either solely or in combination. Program instructions recorded on the storage medium may have been specially designed and configured for the present disclosure, or may be known to or available to those who have ordinary knowledge in the field of computer software.

A computer-readable storage medium may include information used in the embodiments of the present disclosure. For example, the computer-readable storage medium may include a bitstream, and the bitstream may contain the information described above in the embodiments of the present disclosure.

A bitstream may include computer-executable code and/or program. The computer-executable code and/or program may include pieces of information described in the embodiments, and may include syntax elements described in the embodiments. In other words, the pieces of information and syntax elements described in the embodiments may be regarded as a computer-executable code in the bitstream, and may be regarded as at least a part of the computer-executable code and/or program represented by the bitstream. The computer-readable storage medium may include a non-transitory computer-readable medium.

Examples of the computer-readable storage medium include all types of hardware devices specially configured to record and execute program instructions, such as magnetic media, such as a hard disk, a floppy disk, and magnetic tape, optical media, such as compact disk (CD)-ROM and a digital versatile disk (DVD), magneto-optical media, such as a floptical disk, ROM, RAM, and flash memory. Examples of the program instructions include machine code, such as code created by a compiler, and high-level language code executable by a computer using an interpreter. The hardware devices may be configured to operate as one or more software modules in order to perform the operation of the present disclosure, and vice versa.

As described above, although the present disclosure has been described based on specific details such as detailed components and a limited number of embodiments and drawings, those are merely provided for easy understanding of the entire disclosure, the present disclosure is not limited to those embodiments, and those skilled in the art will practice various changes and modifications from the above description.

Accordingly, it should be noted that the spirit of the present embodiments is not limited to the above-described embodiments, and the accompanying claims and equivalents and modifications thereof fall within the scope of the present disclosure.

1. A decoding method, comprising:
constructing a filter candidate list including multiple filter candidates; and
determining a final filter among the multiple filter candidates.

2. The decoding method of claim 1, wherein the final filter is determined based on matching costs of the multiple filter candidates.

3. The decoding method of claim 2, wherein the filter candidate list is reconstructed based on the matching costs.

4. The decoding method of claim 2, wherein reordering of the multiple filter candidates in the filter candidate list is performed based on the matching costs.

5. The decoding method of claim 2, wherein the matching costs are results of a calculation that uses a cost function for samples present in templates generated using the multiple filter candidates.

6. The decoding method of claim 1, wherein the multiple filter candidates are applied to a template region of a template.

7. The decoding method of claim 1, wherein a filter candidate used in an adjacent block of a target block is used as one of the multiple filter candidates of the target block.

8. An encoding method, comprising:
constructing a filter candidate list including multiple filter candidates; and
determining a final filter among the multiple filter candidates.

9. The encoding method of claim 8, wherein the final filter is determined based on matching costs of the multiple filter candidates.

10. The encoding method of claim 9, wherein the filter candidate list is reconstructed based on the matching costs.

11. The encoding method of claim 9, wherein reordering of the multiple filter candidates in the filter candidate list is performed based on the matching costs.

12. The encoding method of claim 9, wherein the matching costs are results of a calculation that uses a cost function for samples present in templates generated using the multiple filter candidates.

13. The encoding method of claim 8, wherein the multiple filter candidates are applied to a template region of a template.

14. The encoding method of claim 8, wherein a filter candidate used in an adjacent block of a target block is used as one of the multiple filter candidates of the target block.

15. A non-transitory computer-readable storage medium for storing a bitstream for image decoding, wherein:
the bitstream comprises filter information,
a filter candidate list including multiple filter candidates is constructed, and
a final filter is determined among the multiple filter candidates based on the filter information.

16. The non-transitory computer-readable storage medium of claim 15, wherein the final filter is determined based on matching costs of the multiple filter candidates.

17. The non-transitory computer-readable storage medium of claim 16, wherein the filter candidate list is reconstructed based on the matching costs.

18. The non-transitory computer-readable storage medium of claim 16, wherein reordering of the multiple filter candidates in the filter candidate list is performed based on the matching costs.

19. The non-transitory computer-readable storage medium of claim 16, wherein the matching costs are results of a calculation that uses a cost function for samples present in templates generated using the multiple filter candidates.

20. The non-transitory computer-readable storage medium of claim 15, wherein the multiple filter candidates are applied to a template region of a template.
